(19) United States
(12) Patent Application Publication
(10) Pub. No.: US 2026/0121861 A1
(43) Pub. Date: Apr. 30, 2026

(54) Blockchain Sharding Systems and Zero-Knowledge Proof Systems

(71) Applicant: Luis Eduardo Gutierrez-Sheris, Glen Rock, NJ (US)

(72) Inventor: Luis Eduardo Gutierrez-Sheris, Glen Rock, NJ (US)

(21) Appl. No.: 18/973,091

(22) Filed: Dec. 8, 2024

Related U.S. Application Data
(60) Provisional application No. 63/608,018, filed on Dec. 8, 2023.

(51) Int. Cl. G06Q 20/38; G06Q 20/36; H04L 9/32

(52) U.S. Cl. CPC H04L 9/3218; G06Q 20/36; G06Q 20/3823; G06Q 2220/00

(57) ABSTRACT

Embodiments are directed toward a blockchain system including a global state and an assemblage of blocks, each block representing a collection of state transformation records, each state transformation record describing a state transformation performed on the global state, where preceding blocks referenced by any given block contain state transformation records describing state transformations performed on the global state prior to the evaluation of the given block, and where at least one state transformation record is a zero-knowledge transformation record encoding a zero-knowledge state transformation description, which zero-knowledge transformation record comprises at least the following elements: paths identifying the locations of the elements of a discrete data subset, a revised data subset, and a transition proof implemented as a non-interactive zero-knowledge proof, which transition proof proves that the transition from the discrete data subset to the revised data subset follows the established rules of the blockchain system.

### RELATED APPLICATION

This application claims the benefit of U.S. Provisional Application No. 63/608,018, filed on Dec. 8, 2023. The entire teachings of this application and appendices filed therewith are incorporated herein by reference.

### BACKGROUND

Zero-knowledge proofs (ZKPs) are a cryptographic process that can allow parties to verify a statement's truth without revealing information beyond the statement itself. ZKPs can be used in blockchain technology to validate transactions. In an example, a “prover” creates a proof using their knowledge of a system's inputs, and a “verifier” confirms the proof was calculated correctly. Typically, the verifier cannot see the information, but they can confirm the proof is valid.

### SUMMARY

While Zero-Knowledge Proofs (ZKPs)'s can help blockchain systems with privacy compliance, issues remain. For example, ZKPs implemented on blockchain systems come at high computational cost, complexity in implementation, potential scalability issues, lack of user-friendliness, and suffer from interoperability challenges between different blockchains, which can hinder their widespread adoption despite the promise of enhanced privacy.

Example embodiments disclosed herein can address some of the drawbacks related to conventional ZKPs and blockchain systems. The present disclosure includes exemplary blockchain systems that address issues related to management and mitigation of risks presented by probabilistic blockchain consensus mechanisms, and the optimization of transaction processes, including payment channels. Such systems described herein provide, for example, enhanced security, scalability, and efficiency of blockchain-based systems.

In some embodiments described herein, a system may be provided that leverages the use of payment channels and payment channel networks to optimize transaction scalability, reduce fees, and enhance privacy. In one or more embodiments, payment channels operate as time-locked escrow contracts, enabling two parties to transact off-chain while potentially utilizing the blockchain only for the opening and closing of the channel.

An embodiment is directed toward a computer-implemented blockchain system including a global state and an assemblage of blocks, each block representing a collection of state transformation records, each state transformation record describing a state transformation performed on the global state, and each block referencing one or more preceding blocks, where preceding blocks referenced by any given block contain state transformation records describing state transformations performed on the global state prior to the evaluation of the given block, and where at least one state transformation record is a zero-knowledge transformation record encoding a zero-knowledge state transformation description, which zero-knowledge transformation record includes at least the following elements: one or more addresses or paths identifying or referencing the one or more locations of the elements of a discrete data subset within the global state, which discrete data subset includes either a contiguous subset or a non-contiguous subset of the data comprised by the global state; a revised data subset, representing a new revised version of some portion of or subset of said discrete data subset; and a transition proof implemented as a non-interactive zero-knowledge proof, which transition proof proves that the transition from the discrete data subset to the revised data subset follows the established rules of the blockchain system.

In an embodiment, the zero-knowledge transformation record includes one of: the discrete data subset itself, one or more cryptographic hashes of one or more elements of the discrete data subset, or both the discrete data subset and one or more cryptographic hashes of one or more elements of the discrete data subset.

In an embodiment, the transition proof corresponds to one of a set of pre-defined transition types for which corresponding non-interactive zero-knowledge proofs may be generated.

In a further embodiment, each pre-defined transition type corresponds to an encoded state-transition implementation encoded as an algorithmic encoding, which algorithmic encoding may comprise one or more of an algebraic circuit, a virtual algebraic circuit, an algebraic intermediary representation, or other algebraic encoding or algorithmic encoding.

In a further embodiment, the encoded state-transition implementation receives certain data as input, and generates certain data as output, and where a portion of the input data is private input data, and the remainder of the input data is public input data.

In a further embodiment, the public input data includes the discrete data subset.

In a further embodiment, the public input data includes the revised data subset.

In a further embodiment, the output of the encoded state-transition implementation includes the revised data subset.

In a further embodiment, the transition proof is generated by a process that includes: a compilation step where the algorithmic encoding is compiled into a set of polynomial equations, an evaluation of the polynomial equasions at one or more random points, producing values that are included in the transition proof.

In an embodiment, the transition proof is implemented as a zero-knowledge succinct non-interactive argument of knowledge (zk-SNARK).

In an embodiment, the transition proof is implemented as a zero-knowledge succinct transparent argument of knowledge (zk-STARK).

In an embodiment, an issuer of a currency denominated token is configured to hold a reserve for every corresponding unit of currency denominated tokens issued by the issuer,

In an embodiment, the reserve may be a collection of assets or a store of value.

In an embodiment, a token may be issued by a token issuer to a plurality of users, the token issuer configured to: (i) approve use of the token to at least a subset of the plurality of users, and (ii) disapprove use of the token to at least a second subset of the plurality of users.

In an embodiment, a decision indicator may be configured to mark at least a user of the plurality of users as approved, wherein only approved users may have access to a payment channel on the blockchain.

In an embodiment, the decision indicator is a user account.

An embodiment includes the decision indicator being associated with an edge node on the blockchain, the decision indicator further configured to indicate that an account belongs to an edge node or an interconnection node.

In an embodiment the token is configured with a permissioning constraint configured to permit a first interconnection account to open a payment channel with a second interconnection account, wherein the payment channel is opened by at least the first account and the second account, and wherein at least one permission constraint prohibits the payment channel transactions or records that are signed by the first account but do not reference the second account.

An embodiment includes using a first cryptographic key for sending payments across a payment channel network, and a second cryptographic key for receiving payments across the payment channel network.

In an embodiment the first cryptographic key includes a restriction disallowing funds to be removed from a wallet of a user,

In an embodiment, the first cryptographic key may be used to negotiate the receipt of payment.

In an embodiment, the first cryptographic key may be used to sign data elements sent during the receipt of payment.

An embodiment is further configured to generate, by a user, an alternative pair of cryptographic keys, provide the alternative pair of cryptographic keys to a persistent server, associate an account with at least one permissioning constraint configured to restrict the use of the alternative pair of cryptographic keys such that the pair of cryptographic keys may only be used to sign payment channel records or transactions that update payment channels in such a manner that the user's payment channel balance increases compared to the previous channel state.

An embodiment further includes one or more permissioning constraints configured to determine whether one or more cryptographic keys are permitted to authorize a payment channel record or transaction.

In an embodiment any payment negotiated using a cryptographic key is in the direction of the user.

In an embodiment the blockchain is further configured to open, close, and update payment channels on-chain through zero-knowledge payment channel records or transactions.

In an embodiment an account on the blockchain is configured with one or more private ledgers represented in a blockchain global state by one or more cryptographic hash digests.

An embodiment further includes an open payment channel configured on the blockchain with a channel private ledger, wherein the channel private ledger is configured to encode a token balance of at least two participants within the payment channel.

An embodiment further includes implementing a zero-knowledge algorithmic encoding corresponding to a pre-defined type of global state information.

An embodiment further includes an expression of a permission constraint encoding corresponding to a zero-knowledge expression encoding, wherein zero-knowledge expression encoding includes a zero-knowledge algorithmic encoding, each zero-knowledge expression encoding configured to perform an operation that is encoded by its corresponding expression.

An embodiment further includes at least one anchor block configured to limit the reorganization of blocks beyond a threshold block depth.

In an embodiment, the anchor block further configured to be spaced at regular intervals.

Another embodiment is directed toward validating and accepting zero-knowledge transformation records. The method includes a validating computer configured to store the blockchain's global state in a retrievable storage medium, a wallet computer connected to the validating computer via a computer network, the wallet computer generating a new zero-knowledge transformation record. The validating computer receiving the zero-knowledge transformation record from the wallet computer, and subsequently performing validation of the zero-knowledge transformation record. Said validation includes the validating node retrieving a retrieved data subset from the global state, which subset of global state data corresponds to the discrete data subset referenced or included in the zero-knowledge transformation record, the validating node verifying that the discrete data subset included in the zero-knowledge transformation record or referenced by the zero-knowledge transformation record is equivalent to the retrieved data subset, the validating node verifying that the non-interactive zero-knowledge proof is valid when verified combination with the discrete data subset (or retrieved data subset) and revised data subset—and possibly in combination additional Public Input Data included with the zero-knowledge record in certain cases, in the case that the non-interactive zero-knowledge proof is successfully verified and the zero-knowledge transformation record is deemed valid, the validating node replacing some portion of the discrete data subset with elements of the revised data subset, where the portion of the discrete data subset that is replaced by elements of the revised data subset is decided according to which pre-defined transition type the non-interactive zero-knowledge proof corresponds to.

In embodiments, the discrete data subset includes at least one permission encoding, which permission encoding either is itself interpretable by the encoded state-transition implementation, or transformed into an equivalent format interpretable by the encoded state-transition implementation.

In embodiments, the permission encoding, or a transformation thereof, is interpreted or evaluated within the encoded state-transition implementation.

In embodiments, a state transformation corresponding to the encoded state-transition implementation is undertaken only if the permission encoding is interpreted or evaluated with a result indicating that said state transformation is permitted.

In embodiments, the permission encoding includes a logical function encoded as interpretable or executable computer code.

In embodiments, the logical function is configured to accept one or more permission inputs and the logical function is configured to output a permission output.

In embodiments, the permission output corresponds to either a permitted transition status or a not-permitted transition status, given the one or more permission inputs. Whereby the state transformation corresponding to the encoded state-transition implementation is undertaken only in cases where the permission output given the one or more permission inputs corresponds to the permitted transition status, and the state transformation is not undertaken in cases where the permission output given the one or more permission inputs corresponds to the non-permitted transition status.

In embodiments, the one or more permission inputs comprise a subset of the public input data and private input data received by the encoded state-transition implementation.

In embodiments, the logical function, or a transformation thereof into an equivalent format interpretable by the algorithmic encoding, is interpreted or executed within the algorithmic encoding.

In embodiments, the non-interactive zero knowledge proof is deemed valid only in the case where the logical function outputs a value corresponding to the permitted transition status within the algorithmic encoding.

In embodiments, the permission encoding includes a pattern encoding, where the state transformation corresponding to the encoded state transformation implementation is permitted only in the case that the pattern encoding matches at least a portion of the private input data, or a portion of the public input data, or a combination thereof.

In embodiments, the pattern encoding, or a transformation thereof into an equivalent format interpretable by the algorithmic encoding, is compared to a portion of the input data received by the algorithmic encoding, within the algorithmic encoding itself, and in which the transition proof is verified successfully only in the case where the pattern encoding matches said input data within the algorithmic encoding.

In embodiments, the discrete data subset includes one or more account records, each account record including one or more private ledgers, each private ledger including at least one cryptographic hash digest the preimage of which is an unmasked private ledger, which at least one unmasked private ledger contains one or more token balances.

In embodiments, the at least one unmasked private ledger is implemented as a Hash Tree or Merkle Tree, where the root of the tree corresponds to the private ledger's cryptographic hash digest.

In embodiments, the at least one unmasked private ledger is implemented as a Merkle Trie or Merkle Patricia Trie, where the root of the trie corresponds to the private ledger's cryptographic hash digest.

In embodiments, the at least one unmasked private ledger is implemented as a Merkle Proof or partial Merkle Tree or partial Merkle Patricia Trie, and where the root of the proof, tree or trie corresponds to the private ledger's cryptographic hash digest.

In embodiments, the private input data includes the at least one unmasked private ledger, which at least one unmasked private ledger is excluded from the discrete data subset and from the public input data; and where the private input data also includes information regarding at least one quantity of tokens.

In embodiments, the encoded state transformation implementation includes a private state transformation. Including the encoded state transformation implementation computing at least one derived hash, which derived hash is the cryptographic hash of the at least one unmasked private ledger, the encoded state transformation implementation determining that such at least one derived hash equals the at least one cryptographic hash digest of the private ledger which corresponds to that at least one unmasked private ledger, the encoded state transformation implementation modifying the unmasked private ledger in a manner consistent with the token quantity information included in the private input data, and the encoded state transformation implementation computing a revised cryptographic hash digest of the modified unmasked private ledger, which revised cryptographic hash digest corresponds to the output of the encoded state transformation implementation.

In embodiments, the private state transformation also includes a step whereby at least one permission encoding included in the public input data is evaluated in combination with a portion of the input data received by the encoded state transformation implementation, whereby the state transformation corresponding to the encoded state transformation implementation is only undertaken if the permission encoding is interpreted or evaluated in a manner indicating that said state transformation is permitted.

In embodiments, a zero-knowledge transformation record is accepted and included in the blockchain only in the case where one or more permission encodings included in the record's discrete data subset are interpreted or evaluated in a manner indicating that the state transformation corresponding to the zero-knowledge transformation record is permitted.

In embodiments, the validating computer replaces at least one cryptographic hash digest of the one or more account record's one or more private ledgers in the global state with the revised cryptographic hash digest, in the event that the zero-knowledge transformation record is accepted and included in the blockchain.

Another embodiment is directed toward a computer implemented method of updating data of a blockchain divided into a plurality of shards, including assigning a mining node to a shard of the blockchain. Further, at the mining node, generating a candidate block representing transactions involving accounts associated with the shard, and transmitting the candidate block to a peer node assigned to the shard. Further, at the peer node, selecting among the candidate block and a plurality of other candidate blocks for inclusion in a respective one of a plurality of block sequences, the selection being based on a fitness value of the candidate block, developing the plurality of block sequences by generating subsequent blocks in each of the plurality of block sequences, selectively discarding a subset of the plurality of block sequences in response to detecting an invalid step within the block sequence, and updating the shard to include at least one of the plurality of block sequences.

An embodiment further includes, assigning the mining node to at least two shards of the blockchain including the shard, an account associated with the mining node being included in one of the at least two shards.

In an embodiment, generating the candidate block includes generating a bloom filter indicating all of the accounts with which the mining node has interacted.

In an embodiment, preventing the mining node from mining transactions involving accounts that are not included in the shards assigned to the mining node.

In an embodiment, generating the candidate block includes generating a candidate block header that indicates a quantity of fuel tokens.

In an embodiment, determining whether the candidate block header is valid based on whether the quantity of fuel tokens exceeds a quantity of fuel tokens held by an account associated with the mining node.

Another embodiment includes, performing a fraud analysis of the plurality of block sequences, wherein detecting the invalid step is based on the fraud analysis.

An embodiment is directed toward a computer-implemented blockchain sharding system. The system comprising a global state and at least two block-building nodes, wherein the global state includes at least four shards, each shard comprising a mutually exclusive portion of the global state, each block building node configured to store global state data comprising at least two shards, and at least one of the at least two block building nodes configured to store global data excluding at least two shards.

An embodiment is configured to implement a consensus procedure, the consensus procedure is performed in sequential rounds, each new block built belongs to a single round, and operates on at least two shards of the global state, and each round includes one or more new blocks operating on non-overlapping mutually exclusive shards of the global state.

In an embodiment, each new block includes a block hash of one or more preceding blocks of the preceding round, the block has configured to reference a preceding block operating on at least one of the same shards as the new block.

An embodiment is directed toward a computer-implemented blockchain sharding system. The system includes a global state and two or more block building nodes.

In an embodiment, the global state includes at least three shards. Each shard includes a mutually exclusive portion of the global state, and each block-building node is configured to store global data, excluding at least one shard.

An embodiment is configured to implement a consensus procedure performed in sequential rounds. Each new block built belongs to a specific round, operating on at least one shard of the global state, each round includes one or more new blocks operating on non-overlapping mutually exclusive shards of the global state.

In an embodiment, each new block includes a block hash of one or more preceding blocks of the preceding round, the block hash configured to reference a preceding block operating on at least one of the same shards as the new block.

An embodiment is directed toward a computer-implemented method for accepting electronic payment. The system includes a point-of-sale computer device, at least one authorization computer devices, and a consumer smartphone with at least one camera, and a processor and memory with computer code instructions stored thereon. The processor and the memory are configured to cause the system to connect the point-of-sale computer device to a packet-switched computer network, connect the at least one authorization computer devices to the packet-switched computer network, connect the consumer smartphone to the packet-switched computer network, configure the point-of-sale computer device with at least one graphical display, configure the point-of-sale computer device to share a session identifier with the at least one of the one or more authorization computer devices, display, on the point-of-sale consumer device graphical display, a graphical encoding of a payment request, wherein the graphical encoding of the payment request includes an encoding of the session identifier, capture, via the at least one camera of the consumer smart phone, an image of the graphical encoding of the payment request, display, on the consumer smart phone, a user-acceptance message, wherein the message requests acceptance of the payment request by a user of the consumer smart phone, indicate acceptance of the payment request via an indication of acceptance of the user of the consumer smart phone, construct a data record configured to encode a payment instruction to conform to the payment request, wherein the data record encoding of the payment instruction encodes the session identifier, and transmit the data record to at least one of the one ore more authorization computer devices via the packet-switched computer network. The at least one of the one or more authorization computer devices are configured to perform a verification of the correctness and authenticity of the payment instruction encoded in the data record. The point-of-sale computer device is configured to receive, via the packet-switched computer network, a confirmation that the correctness and authenticity of the payment instruction encoded in the data record has been verified.

An embodiment further includes a cryptographic signature of the data record attached to the data record prior to transmission to the one or more authorization computer devices. The cryptographic signature is generated using an asymmetric cryptographic signature algorithm. The cryptographic signature is generated using a private key corresponding to a public key stored in a data storage of at least one of the one or more authorization computer devices.

In an embodiment, the public key corresponds to a money balance stored in at least one of the one or more authorization computer devices; and wherein the verification of the correctness and authenticity of the payment instruction encoded in the data record includes a verification that the cryptographic signature is valid and was generated with a private key corresponding to said public key.

In an embodiment, at least one of the one or more authorization computer devices is a blockchain validation computer device hosting a blockchain validation software program. The blockchain validation software program is configured to maintain a connection to one or more additional blockchain validator computer devices hosting one or more additional blockchain validation software programs. The blockchain validator computer devices are connected to the packet-switched computer network. The data record is a blockchain data record, the acceptance of which by the blockchain configured to effectuate a change to a global state of the blockchain.

In an embodiment, the data storage includes an encoding of the blockchain's global state, and wherein the data record is configured to encode a transformation to the blockchain's global state.

In an embodiment, the point-of-sale computer device is configured to open a socket connection to at least one of the one or more authorization computer devices before displaying on the graphical display the graphical encoding of the payment request.

In an embodiment, the point-of-sale computer device, after displaying the graphical encoding of the payment request on the graphical display, is configured to poll at least one of the one or more authentication computer devices, sending in reference to the session ID.

In an embodiment, the point-of-sale computer device is configured as part of a cash-register system at a physical retail location.

In an embodiment, the point-of-sale computer device is a personal computer, the personal computer being configured to execute a web browser software, and wherein the graphical representation of the payment request is displayed in a graphical-user-interface window of the web browser software.

An embodiment is directed toward a distributed electronic ledger configured in the electronic memory of one or more computers in a blockchain system, the distributed electronic ledger having a plurality of backward-linked interconnected blocks, arranged as one or more instances of linear blockchain data structures, non-linear block arrangements, n-dimensional mesh or lattice data structures, or directed acyclic graphs; configuring each of the interconnected blocks to include an ordered set of individual data records, such that at least one of the records reflects a transformation of at least a portion of the global state of the distributed electronic ledger; configuring the blockchain system to comprise a peer-to-peer network of computer nodes, with one or more computers configured as wallet nodes, and with one or more computers configured as block-building nodes; configuring the one or more wallet nodes to transmit one or more of the data records to one or more block-building nodes in the peer-to-peer network; and configuring the one or more block-building nodes to construct one or more interconnected blocks in the distributed electronic ledger by selecting and ordering one or more of the data records to be included in said one or more new interconnected blocks.

An embodiment further includes the blockchain system comprising at least one or more of the following software system components: payment channel liquidity, payment channel permissioning, safe offline payment channel availability, zero-knowledge permissioning, anchor blocks, block-building and protocol validation functions, message signing protocol, consensus protocols, synchronization with traditional database systems, and integration with external off-chain payment systems.

An embodiment is directed towards a system for securing ownership of tokens, cryptocurrency, or other assets held or tracked on a blockchain by using cryptographic key pairs to sign one or more records, the system comprising at least one blockchain account having one or more cryptographic key pairs, and wherein at least one of the one or more records is configured to encode one or more transformations to a global state maintained by the blockchain.

An embodiment further includes the system for securing ownership of tokens, cryptocurrency, or other assets held or tracked on a blockchain comprising at least one of the following software system components: payment channel liquidity, payment channel permissioning, safe offline payment channel availability, zero-knowledge permissioning, anchor blocks, block-building and protocol validation functions, message signing protocol, consensus protocols, synchronization with traditional database systems, and integration with external off-chain payment systems.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating a comparison of the relative risk of reorganization occurring for an example smaller blockchain network and an example larger blockchain network.

FIG. 2 is an illustration of certain anchor block concepts, according to an embodiment.

FIG. 3 is a diagram illustrating how anchor blocks may serve as an additional risk mitigator for payment channel operations, according to an embodiment.

FIG. 4 is a payment channel network illustrating the progress of a payment in a network, and how a payment is conveyed to a recipient from a sender, according to an embodiment.

FIG. 5 is a diagram illustrating that the individual payment channels established between nodes are implemented as a payment channel structure which may be established through a sequence of defined steps and states, according to an embodiment.

FIG. 6 is a diagram illustrating a payment channel lifecycle demonstrating how two channel partners may conduct multiple value transfers while maintaining only two on-chain transactions, according to an embodiment.

FIGS. 7A-7E are diagrams illustrating that each iteration or round of a consensus process forms a “block ring” that should include blocks that incorporate transformations of mutually-exclusive shards, according to an embodiment.

FIG. 8 is a diagram of an example sharding system, according to an embodiment.

FIGS. 9A and 9B are diagrams illustrating elements of an invalid transaction fraud proof, according to an embodiment.

FIG. 10A is a diagram illustrating elements of a state-disjunction fraud proof, according to an embodiment.

FIGS. 10B and 10C are diagrams illustrating elements a of state-disjunction fraud proof, according to an embodiment.

FIG. 10D is a diagram illustrating elements of an invalid-transaction fraud proof, according to an embodiment

FIGS. 10E and 10F are diagrams illustrating elements of an invalid transaction fraud proof, according to an embodiment.

FIG. 11 is a diagram of an example sharding system, according to an embodiment.

FIGS. 12A-12B is a diagram illustrating elements of a synchronization system, according to an embodiment.

FIGS. 13A and 13B are diagrams of elements of a synchronization system architecture, according to an embodiment.

FIGS. 14A-14E are diagrams of elements of a synchronization system architecture, according to an embodiment.

FIGS. 15A and 15B are diagrams of elements of a synchronization system architecture, according to an embodiment.

FIG. 16 is a schematic view of a computer network in which embodiments may be implemented.

FIG. 17 is a block diagram illustrating an embodiment of a computer node in the computer network of FIG. 16.

FIG. 18 is a schematic illustration of a mobile device interacting with a quick response code on a computer monitor, according to an embodiment.

FIG. 19A is a block diagram of an example structure of a blockchain system utilized on a distributed data interchange network according to an example embodiment.

FIG. 19B is a simplified block diagram showing exemplary blockchain layers according to an embodiment.

### DETAILED DESCRIPTION

A description of example embodiments follows.

The teachings of all patents, published applications and references cited herein are incorporated by reference in their entirety.

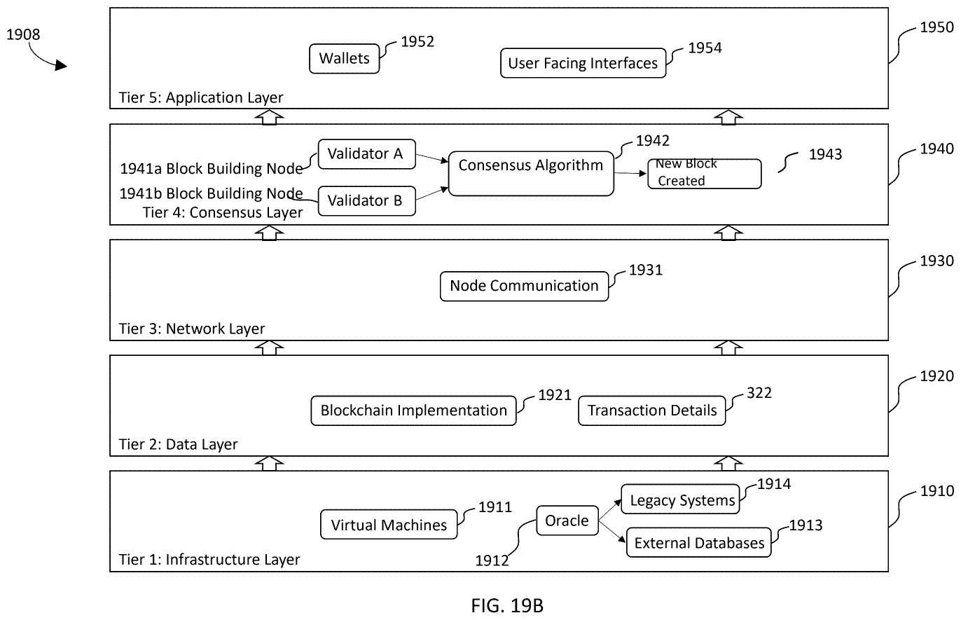

FIG. 19A is a block diagram of an example structure of a blockchain system 2000 utilized on a distributed data interchange network according to an example embodiment. In one example, the blockchain system 2000 may be configured as described in U.S. Pat. No. 11,509,464 issued Nov. 22, 2022, the entire teachings of which are incorporated herein by reference.

A blockchain system 2000 typically includes a blockchain processing device 2010, a wallet device 2020, a blockchain data browsing device 2030, and a vendor device 2040, all of which may be connected to the internet 2090 (or a distributed network). The blockchain system may include multiple blockchain processing devices 2010, multiple wallet devices 2020, multiple blockchain data browsing devices 2030, and multiple vendor devices 2040, each connected to the internet 2090. In addition to separate blockchain processing devices 2010, separate wallet devices 2020, separate blockchain data browsing devices 2030, and separate vendor devices 2040, a blockchain system may contain combination devices that combine features and functionality of all or some portion of these devices, or that simultaneously may perform the function of all or some portion of these devices, and which are also connected to a distributed network (e.g. internet) 2090.

The blockchain processing device 2010 may be a computational device, such as a computing device, computer, mobile phone, smartphone, tablet, laptop, desktop computer, server computer, purpose-built computation device, or other type of computation device, with one or more computer processors 2012, computer memory 2014 for storing computer instructions, a database 2016 for processing blockchain information (including records and/or transactions), and a communication module 2018 for connecting to the internet 2090 and/or the distributed network. The blockchain processing device may also optionally include a display 2055 (not shown), and may consist of multiple computers or a network of computers (either directly connected or distributed), all of the same type or of different types. The wallet device 2020, the blockchain data browsing device 2030, the vendor device 2040, and the combination device typically have the same or similar components as the blockchain processing device 2010.

The blockchain processing device 2010 functions as a “block-building node”, which may be referred to as a “miner” in proof-of-work blockchains, and may be referred to as a “miner” in certain embodiments. Block-building nodes are responsible for assembling new blocks that reflect the inclusion of new records or transactions in the blockchain, and for linking those blocks to the blockchain. Block-building nodes are also responsible for algorithmically confirming whether the blocks that have been linked to the blockchain are valid, and whether records or transactions are validly included in the blockchain. Block-building nodes are also responsible for propagating blocks and data records within the network. In at least one embodiment, each block-building node may be associated with an account or address on the blockchain, to which account or address block mining rewards may be assigned. Such an account or address can be used by a block building node to securely identify itself and its activities within the network and on the chain through the use of cryptographic signatures.

In an embodiment, the wallet device 2020 functions as a wallet that acts to securely store cryptographic keys, which keys are used to cryptographically sign new data records that are proposed for inclusion in the blockchain. Cryptographic signatures can ensure that block building nodes include data records that are appropriately authorized. In addition to storing cryptographic keys and other secure data, wallets may be able to generate and cryptographically sign new data records and transmit them to one or more block-building nodes, typically via the internet 2090 or other network.

The blockchain data browsing device 2030 functions to provide users with a means to read, view or otherwise access data associated with the blockchain, on a read-only basis.

The vendor device 2040 may include one or more computers or other computer processing devices that facilitate the activity of blockchain vendors. A blockchain vendor may be an entity that offers, issues, sells or distributes any token to one or more users, or that provides services that are in some manner verified, confirmed, provided or conveyed via a blockchain—for example, identity verification services. A vendor device runs software that enables Blockchain Vendors to provide such services.

A node may be a computational device, such as a computing device, mobile phone, smartphone, tablet, laptop, desktop computer, server computer, a purpose-built computation device or other computation device that runs blockchain peer-to-peer software and communicates with other similar computers operating on a connected distributed data interchange network like the Internet.

A node network may be a collection of computers running the same blockchain peer-to-peer software, working to build a single, shared blockchain, and connected to each other via a connected distributed data interchange network like the Internet.

Data records accepted for inclusion in a blockchain may be stored or referenced in the blocks of a distributed ledger or blockchain. Individual blocks may contain record and/or transaction data. Alternately, blocks may reference such data via a cryptographic hash or digest summarizing the data, which hash or digest may be generated by a separate data structure that contains the records and transactions, for example a Merkle tree. For cryptocurrency blockchains, cryptocurrency ownership may be linked to unique addresses or account numbers included as data within these records and transactions. In such cryptocurrency blockchains, the cryptocurrency balance associated with a particular address or account number may be derived from the entire history of records and transactions preserved by the distributed ledger or Blockchain, beginning at its origin.

### Blockchain System and Zero-Knowledge Architectures

In an embodiment, a computer-implemented blockchain system may be provided. The system may include a global state and an assemblage of blocks, where each block may be configured to represent a collection of records and/or transactions. Each record or transaction may be configured to describe a state transformation performed on the global state, and each block may be configured to reference one or more preceding blocks. Preceding blocks referenced by any given block may contain records and/or transactions which may be configured to describe state transformations performed on the global state.

In one or more embodiments, the global state is a shared or replicated distributed ledger or other data representation replicated by one or more computer nodes connected to the blockchain system, which represents the current state of data stored on the blockchain.

The terms “state transformation”, “state transition”, “transformation” and “transition” and “state change” herein refer to the process by which the global state is updated to reflect new information. These terms are used interchangeably herein to describe the same process of state change.

In certain embodiments, the terms “record” and “transaction”, as used herein, may refer to data, operations, instructions or other encoded elements submitted for inclusion in the blockchain that, when validated and incorporated into one or more new blocks by one or more block-building nodes, effectuate a state transformation. These terms are used without distinction and are intended to encompass a broad range of activities or data types, including but not limited to value transfers, state updates, instructions for smart contract execution, or any other information that may alter the global state of the blockchain. Records and/or transactions may be validated and incorporated into the blockchain in accordance with the blockchain's consensus and protocol rules and logic. In various embodiments, according to such rules and logic, records and/or transactions may be cryptographically signed, which signature, and the public key associated with the signature, is evaluated as part of the process of validating said records and/or transactions. Upon successful incorporation into a new block, a record or transaction updates the blockchain's global state to reflect the change to the global state encoded by said record or transaction according to the rules of the blockchain state transformation protocol implemented and/or enforced by the blockchain node. The terminology used herein is maximally inclusive and does not limit the type, format, or purpose of the data or actions represented by records and transactions, unless otherwise explicitly and unambiguously specified.

In one or more embodiments, the process of updating the blockchain's global state relies on the successful execution of operations defined and/or encoded by records or transactions, which may include, but are not limited to, transfers of value, modifications to stored data, the creation or execution of smart contracts, creation, configuration, issuance, minting or transfer of tokens, or other computational or state transformation tasks. These updates are effectuated by block-building nodes, which validate, organize, and append records or transactions into a new block. Each new block extends the blockchain, thereby recording the associated state transformations and effectuating that the global state be updated in a manner consistent with the protocol rules implemented and enforced by the one or more block-building nodes.

In various embodiments, terms such as tokens, balances, funds, units of value, and similar expressions, both singular and plural, are used interchangeably to describe the representation of value within the network. For the purposes of this description, references to one term should be understood to encompass embodiments of the others, as they all reflect the same underlying concept of a quantifiable measure of ownership, entitlement, or utility associated with a blockchain address or account. This interchangeable usage is intentional to streamline the explanation and avoid repetitive distinctions between terms that functionally overlap.

In certain embodiments, said blockchain system comprises a blockchain network, which may comprise a plurality of nodes, serving distinct roles to support the functionality, security, and accessibility of the system.

In certain embodiments, a node within said blockchain network is defined as a single computing device equipped with one or more processors (e.g., central processing units (CPUs) and/or graphics processing units (GPUs)), memory (e.g., volatile memory such as RAM), storage (e.g., non-volatile storage such as solid-state drives or hard disk drives), and network connectivity hardware (e.g., Ethernet or wireless communication interfaces). A node may operate by executing software configured to interact with the blockchain network. This software may include, but is not limited to, functionality for transmitting, receiving, validating, and storing blockchain data, as well as performing specific roles such as block building, transaction validation, or cryptographic signing. In various embodiments, nodes may vary in computational capability and configuration, ranging from resource-constrained devices (e.g. smart phones and hardware crypto wallets) to high-performance servers, and may operate independently or in coordination with other nodes. Nodes may also be virtual nodes, whereby one or more of the elements that constitute a physical node are implemented in software, or whereby the physical attributes of a single physical computing device or system are shared by a plurality of virtual nodes compartmentalized by software. The definition of a node is non-limiting and may encompass any computing device or system capable of executing the blockchain software and fulfilling the requirements of the protocol.

In one or more embodiments, nodes may communicate between and among themselves through one or more computer networks, network protocols and/or communication protocols, including communication protocols such as, for example, Internet Protocol (IP), Transmission Control Protocol (TCP), User Datagram Protocol (UDP), and/or various packet-switched network protocols. In one or more embodiments, various nodes and servers within a blockchain network may communicate and exchange, broadcast and/or transmit data through a decentralized, peer-to-peer (P2P) architecture, and data may be shared, transmitted, broadcast, received or exchanged through the use of a peer-to-peer communications protocol, which may be a gossip protocol or other protocol. Such network connectivity between and among nodes may allow one or more of messages, records, transactions and/or state updates to be shared, propagated, transmitted, and/or broadcast by, between and/or among the various nodes.

In one or more embodiments, nodes may include one or more of block-building nodes, validator nodes, wallet nodes, and interface servers. Individual nodes may be specialized in the role they perform, or single physical or virtual nodes may perform multiple roles, such as, for example, acting simultaneously as a block-building node, validator node, wallet node, or interface server, depending on the implementation and configuration of the system.

One or more embodiments may include Block-building nodes which function to incorporate records and/or transactions into a blockchain by incorporating said records and/or transactions into new blocks, which blocks may in turn be incorporated into said blockchain. They also act to ensure the integrity and consistency of the blockchain's state by implementing, executing and enforcing the rules of the blockchain protocol. Block-building nodes may exchange critical data such as block headers, block data, record and/or transaction encodings, transaction metadata, cryptographic proofs and other data with other nodes of the network. Block-building nodes may also receive, send, and/or exchange data with other nodes and receive user-submitted records and/or transactions from other nodes and provide information regarding the global state.

In one or more embodiments, validator nodes may perform most of the tasks and activities of block-building nodes, but excluding some tasks, such as, for example, building new blocks and appending such blocks to the blockchain, depending on the embodiment. Validator nodes, like block-building nodes, replicate, synchronize and/or maintain at least a portion of the global state. In some embodiments, a node may serve both as a block-builder and validator, combining the tasks of producing blocks and verifying the validity of new blocks produced by other nodes in the blockchain network. In some such embodiments where the block-building node and validator node roles may overlap, the terms “validator node” and “block-building node” may be used interchangeably; however, in embodiments where the roles do not overlap, each term retains a distinct meaning.

In one or more embodiments, wallet nodes may serve as means of access for users to interact with the blockchain, providing a means for said users to access to and/or retrieve blockchain data, and enabling the creation, encoding, cryptographic signing, sharing, and/or transmission of blockchain records and/or transactions.

In one or more embodiments, wallet nodes securely store private cryptographic keys, which cryptographic keys may be used to sign records and/or transactions and thereby potentially authorize the state transformation encoded on said records and/or transactions. Wallet nodes may send signed records or transactions to block-building nodes or interface servers for processing and validation. They may also retrieve blockchain updates, such as account balances or transaction confirmations, directly from interface nodes, validator nodes, block-building nodes, or other nodes. In various embodiments, wallet nodes may be implemented in various forms, including as software applications, hardware devices, or embedded components within other systems, such as smartphones, desktop applications, or web interfaces.

In one or more embodiments, nodes referred to herein as interface servers may act as intermediaries, facilitating interactions between a blockchain and a plurality of off-chain devices, systems, services, protocols, applications and/or data (external systems). Interface servers may provide connectivity for applications and third-party systems by exposing APIs, RPC endpoints, or other interfaces that allow, for example, records and/or transactions to be submitted and blockchain data to be queried. Interface servers may handle high-level functionality, such as translating user-friendly inputs into protocol-compliant records and/or transactions, exposing or retrieving blockchain data, or aggregating blockchain data for analysis and reporting. In one or more embodiments, interface servers comprise artificially intelligent components or interface with artificially intelligence systems to perform analysis of system activity, to generate content, media or data that may be written to the blockchain, or to assist in various interactions between an interface server and other nodes within the blockchain system. In some embodiments, an interface server may also function as a wallet node, validator node or other type of node, combining roles to streamline operation.

According to various embodiments, communication between nodes may follow structured protocols designed for scalability and security. Nodes may exchange data such as transaction details, block updates, and state proofs using predefined messaging formats. For example, wallet nodes may send signed transactions to block-building nodes for validation and inclusion, while interface servers may facilitate high-volume communication by aggregating user interactions and forwarding them to appropriate nodes.

In various embodiments, the terms account and address may be used to describe elements of the blockchain system. While the terms are largely used interchangeably herein, subtle distinctions may exist depending on the nature of the embodiment. An account generally refers to a logical construct within a blockchain's global state, encompassing both an identifier (such as an address) and persistent on-chain data, such as, for example, balances, user identity data, cryptographic proofs, permissions, permissioning constraints, device identifiers, configurations, statistics, key-value data, smart contract code, cryptographic keys, or other data that may be encoded. An address, in contrast, may refer to a public-facing identifier acting as a reference to on-chain data, including account data, and which may in certain embodiments be derived from cryptographic keys. An address may also be used to designate the originator, target, or receiver of a record or transaction. In one or more embodiments the term address, like the term account, may be used both to refer to the identifier or reference associated with one or more on-chain data elements, or it may be used to refer to the on-chain data elements themselves.

In certain embodiments, for example, an address may reference an account among a plurality accounts, whereby the blockchain global state comprises persistent (although potentially mutable) state data elements or state data structures each directly associated with an account. In alternate embodiments, an address may reference unspent transaction outputs (UTXOs), which represent discrete units of value created and consumed by transactions. In UTXO-based systems, an address serves to identify the owner or recipient of these outputs, but the state is managed at the level of individual UTXOs rather than aggregated at the account level. Some embodiments may support hybrid models, where addresses may simultaneously represent and/or reference accounts, UTXOs, or other constructs depending on the context.

For the purposes of this description, where the term account is used, it should be understood that an address may be substituted where appropriate, and vice versa. This flexibility accommodates the wide variety of blockchain designs and implementations that may leverage different mechanisms for tracking and managing state. The use of these terms is non-limiting and intended to cover all configurations where accounts, addresses, UTXOs, or other analogous constructs are employed to achieve the described functionality. For example, in account-based systems, an address may map directly to an account, while in UTXO-based systems, an address may serve as a reference to multiple UTXOs. In either case, the terms account and address should be interpreted in a manner consistent with the blockchain architecture in use.

The term blockchain as used in this description is non-limiting and is intended to encompass a wide variety of distributed ledger and/or distributed database structures and implementations. The term blockchain is often associated with a sequential chain of blocks linked to each other through backwards references, with each such backwards reference (backreference) being a cryptographic hash digest of the referenced block; however, the term may also refer to other arrangements of block data, including but not limited to directed acyclic graphs (DAGs), parallel blockchains, lattice or mesh data structures, sharded chains, sidechains, or hybrid models. The use of the term blockchain is therefore intended to cover any distributed ledger technology or architecture that achieves similar objectives of decentralized, secure, and immutable recordkeeping.

In certain embodiments, the terms on-chain and off-chain are used to distinguish between various operations, data, records, transactions, processes, executable code, interactions and other elements of a blockchain system based on their relationship to the blockchain's global state. On-chain refers to various operations, data, records, transactions, processes, executable code, interactions and/or other elements that are directly incorporated into a blockchain, effectuating updates to a global state and/or becoming part of an immutable ledger. Conversely, off-chain refers to elements of the blockchain system not directly incorporated into the blockchain's global state, or not occurring as part of the evaluation, execution and application of records and/or transactions in the process of performing transformations of the global state but which instead may exist or occur in systems or environments external to the blockchain.

Various implementations of non-interactive zero-knowledge proof systems comprise a mechanism for encoding algorithms or other computational processes, procedures or instructions in a form that may be used to generate a zero-knowledge proof. Such implementations include ZK-SNARK implementations, which may encode algorithms or other computational process, procedures or instructions as algebraic circuits and/or virtual algebraic circuits, and include ZK-STARK implementations which may encode algorithms or other computational process, procedures or instructions as algebraic intermediary representations, among other implementations. Such algebraic circuits, arithmetic circuits, and algebraic intermediary representations and other algorithm and computation encoding are herein referred to as “zero-knowledge algorithmic encodings”, “algorithmic encodings” or “algebraic encodings”. The terms “zero-knowledge algorithmic encodings”, “algorithmic encodings”, “algebraic encodings”, etc, herein include such possible encodings as algebraic circuits used by known ZK-SNARK systems, and “algebraic intermediary representations” used by known ZK-STARK systems, among others

Any embodiment, system or method herein described which comprises a non-interactive zero-knowledge proof may be optionally implemented using any ZK-SNARK system, ZK-STARK system, or other non-interactive zero-knowledge proof system, interchangeably. Likewise, any embodiment, system or method describe herein which comprises an algorithmic encoding or a zero-knowledge algorithmic encoding may be optionally implemented using any algebraic circuit, algebraic intermediary representation, or other algorithmic encoding suitable for use in the generation of a non-interactive zero-knowledge proof.

Blockchain Synchronization with Traditional Database Systems

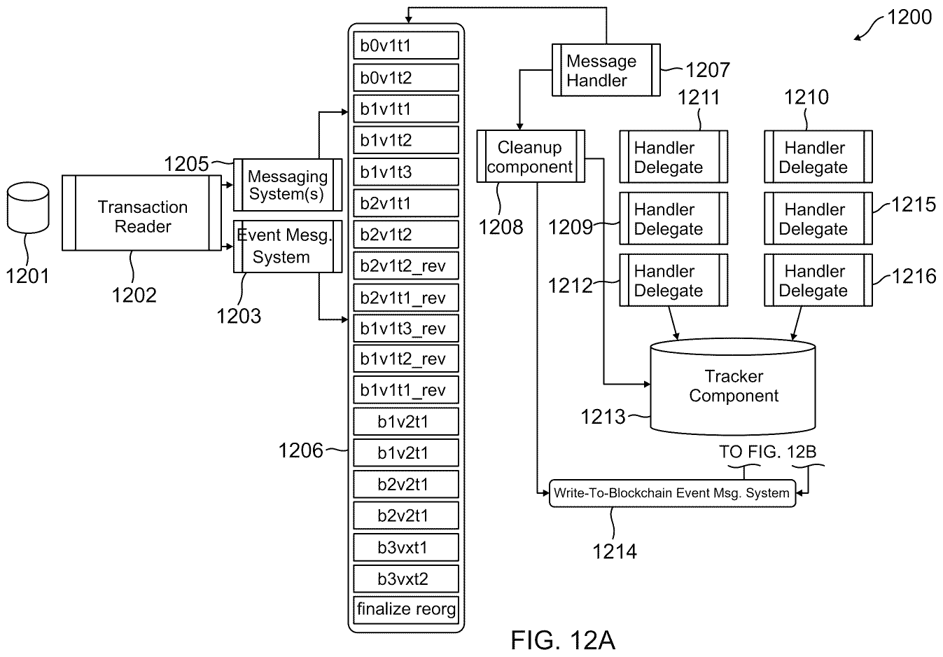

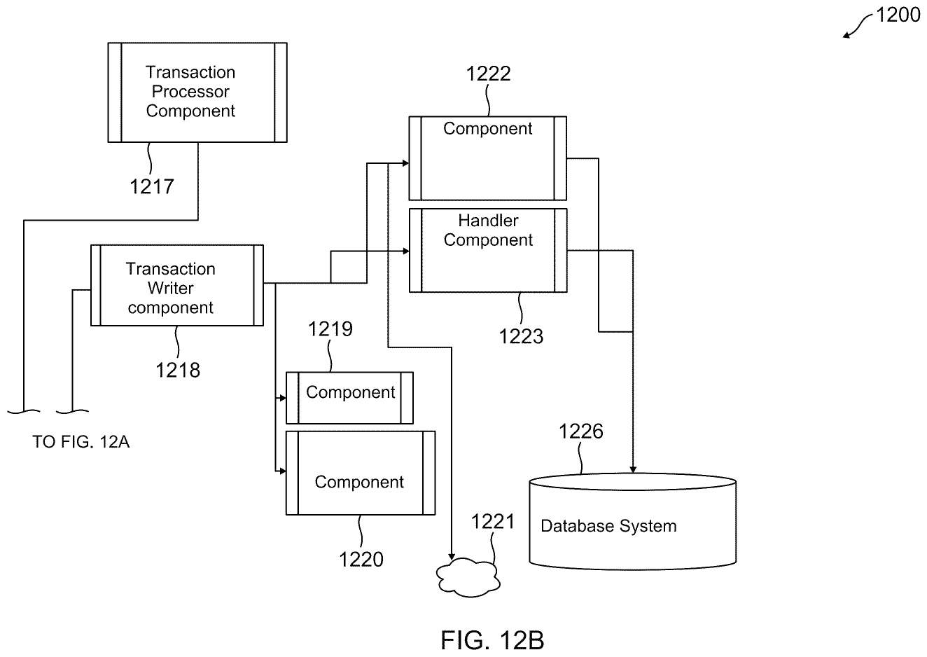

In accordance with various embodiments of the present invention, a blockchain system may be implemented comprising one or more synchronization systems (See FIG. 12) configured to maintain consistency between a blockchain network and one or more off-chain databases or external data management systems, including such systems as relational databases, relational database management systems (RDBMS), document-oriented databases, graph databases, key-value stores, time-series databases, and other data management systems, which individually and collectively may be referred to herein as “traditional databases” or “traditional database systems”. In certain embodiments, said one or more synchronization systems may comprise one or more interface nodes and/or said traditional database systems may operate separate and apart from the block-building and protocol validation functions of the block-building and validator nodes of the blockchain system's blockchain network.

In one or more embodiments, said one or more synchronization systems may be configured to handle various operational scenarios, including, but not limited to, one or more of the following: handling of synchronous off-chain payment authorization requests; blockchain reorganization events which occurs prior blockchain finalization; reorganization events occurring after transaction finality has been reached; situations where transferred value may be unavailable due to reorganization after an external transfer has been authorized or finalized; expiration of pending transactions that have not yet been incorporated into any block; conflicts between endogenous transactions (originating from within the system) and exogenous transactions (originating from outside the system); and/or cases where messages may be lost or delayed between the blockchain network and the one or more traditional databases.

In accordance with various embodiments of the present invention, synchronization systems are configured to read data from blockchain networks and make updates to database entries in one or more traditional database systems—where these database entries are broadly defined as individual units of data stored within any type of database system, including but not limited to records or rows in relational databases, documents in document-oriented databases, key-value pairs in key-value stores, nodes and edges in graph databases, and other data structures used to represent and store information.

In at least one embodiment, the one or more synchronization systems may optionally maintain separate data structures for tracking pending transactions, finalized transactions, and/or transactions that may require reconciliation due to reorganization events. In some embodiments, the synchronization system may comprise, incorporate, interact with, connect to, and/or use one or more event streaming platforms or publish-subscribe messaging systems, which individually and collectively may be referred to herein as “event messaging systems”, and which systems may include without limitation message brokers, event logs, message buses, and other messaging infrastructures, examples of which may include, but are not limited to, Apache Kafka, RabbitMQ, Apache Pulsar, Amazon Kinesis, Google Cloud Pub/Sub, or similar capabilities implemented in a more generalized database such as an RDBMS, object oriented database, etc. In one or more embodiments, such one or more event messaging systems may provide guaranteed message delivery and order preservation, and/or may be capable of retaining messages for configurable periods of time, and/or may be designed to handle real-time data flows.

In accordance with one or more embodiments of the present invention, one or more synchronization systems may be implemented that processes both external blockchain records and/or transactions and internally-generated blockchain records and/or transactions. The synchronization system may include one or more nodes configured to detect and process blockchain records and/or transactions that are directed to one or more accounts or addresses recorded by the synchronization system, which records and/or transactions may be referred to as “exogenous” transactions in that they originate from outside of the synchronization system and its connected wallet nodes. Additionally, the synchronization system may be configured to generate and transmit to the blockchain network one or more transactions of its own, which transactions may be referred to as “endogenous” transactions in that they originate from within a synchronization system itself, or in one or more implementations from wallet nodes connected to or integrated with the synchronization system. In various embodiments, the synchronization system may include one or more interfaces through which external processes may communicate with the synchronization system, and through which requests may be received that cause the synchronization system to generate and/or transmit to the blockchain network endogenous blockchain records and/or transactions. Said synchronization systems may be configured to track the state of both exogenous and endogenous transactions as they progress through various stages of blockchain inclusion and finalization, and may maintain in one or more traditional databases entries reflecting the state of such transactions. In at least one embodiment, the synchronization system may include one or more processes for detecting and handling blockchain reorganization events that may affect either exogenous or endogenous transactions that have been previously added to the blockchain.

As a general matter, and as pertain to one or more embodiments of the present invention, certain technical challenges may arise from fundamental architectural differences between blockchain networks and traditional databases. In many implementations, a blockchain network may process all transactions asynchronously, with transactions remaining in a pending status for an indefinite period before being added to a block, and with the possibility that transactions may be reorganized or reversed even after being added to a block or otherwise incorporated into the blockchain. A blockchain network may implement logical constraints and validation rules and/or protocol rules that are enforced internally within the block-building nodes and validator nodes, potentially resulting in transactions being rejected, modified, or reordered after submission. In contrast, a traditional database system may be configured to process transactions synchronously and atomically, with immediate success/failure status, and may, in various implementations, be tightly integrated with real-time financial and business systems that require instantaneous confirmation of transaction status. Furthermore, many traditional database implementations may maintain referential integrity and transaction isolation through database-level locking mechanisms that presume reliable transaction ordering and finality. An architectural mismatch between the asynchronous, eventually-consistent nature of blockchain networks and the synchronous, immediately-consistent nature of many traditional database systems may present significant technical challenges when attempting to bridge these two paradigms, particularly in financial applications where transaction ordering, finality, and consistency are critical requirements.

Generally, and as pertain to various embodiments, technical challenges described above may be further complicated in implementations where financial institutions or payment networks may require real-time transaction confirmation and settlement, while nonetheless integrating blockchain systems for various purposes, including to leverage the benefits of blockchain networks for certain aspects of transaction processing, record keeping, or inter-institutional settlement. In at least one embodiment, special consideration may need to be given to scenarios where reorganization or reversal of blockchain transactions could impact real-world financial settlements that have already been processed through traditional banking systems. Additional, in various implementations, complexity may arise from differences in how such systems handle transaction atomicity—while a traditional database may provide some or all ACID (Atomicity, Consistency, Isolation, Durability) guarantees within a single database instance, a blockchain network may need to achieve consensus across multiple distributed nodes before transaction finality can be assured, potentially leading to temporary inconsistencies between the blockchain state and corresponding records in a traditional database.

Accordingly, various embodiments of the present invention address and resolve these issues by providing synchronization systems that manage and maintain consistency between the blockchain network and traditional database systems.

At least one embodiment of the present invention comprises a system and/or method to maintain authoritative balance tracking within a blockchain-based system while also supporting real-time payment systems. Such real-time payment systems, which may include without limitation payment card networks, point-of-sale networks, automated teller machine networks, and other transaction processing networks, typically require synchronous authorization to be obtained from an authoritative system before a transaction may be completed. However, blockchain system implementations may operate in a fundamentally asynchronous manner, whereby transactions submitted to the blockchain network may not reach finality until some number of blocks have been added to the blockchain after the block containing the transaction. This asynchronous operation may create difficulties in some implementations when attempting to use blockchain account balances as an authoritative source for real-time transaction authorization, as the state of account balances within a blockchain may be subject to reorganization or reversion for some time after a record or transaction is broadcast, shared or posted to the blockchain network. For instance, and without limitation, a first transaction appearing to authorize a payment card transaction may be superseded by a second transaction that depletes the account balance before the first transaction reaches finality, potentially creating a situation where an already-authorized payment cannot be settled.

Various embodiments of the present invention address these technical challenges through at least two distinct approaches. In a first approach, embodiments of said synchronization system may provide an interface or connection between such real-time payment systems and one or more payment channels that are constructed on top of the blockchain system. Such payment channels may, in at least one embodiment, provide synchronous transaction capability by relying on the finality characteristics of payment channel networks, which in various embodiments are able to offer instantaneous finality by relying on escrow balances that have already reached finality within escrow accounts on the blockchain. Various embodiments of the present invention comprise a connection between one or more such real-time payment systems and one or more payment channels or payment channel networks implemented as described variously elsewhere herein.

One or more embodiments may consist of a real-time payment authorization request of a real-time payment network causing a synchronization service to use a cryptographic key of an account or address to authorize a payment channel payment (wherein such payment channel payment is implemented as described variously elsewhere herein) from such account or address to an account or address which is a treasury account which holds balances which include value owed to the real-time payment network. In various embodiments, said payment may be effectuated within a single payment channel or it may be effectuated through a multi-step or multi-hop payment in a payment channel network.

One or more embodiments may consist of a computer device or mobile device which may authorize payments issued from a source account (which may be a bank, savings and loan, brokerage, pre-paid, stored-value, or other money account held in a traditional database system) issuing an instruction to a forwarding service (which may implement, incorporate or comprise one or more of a synchronization service, an interface node, or a payment channel node) with instructions to make a payment to an account or address of a payment channel network (destination account), where said forwarding service may reduce the balance of the source account, and issue a payment channel payment to the destination account, from an account or address controlled, owned or managed by said server computer device. Said account or address in various embodiments may comprise a treasury account aggregating value owned, used or controlled by the forwarding service, or said account or address may comprise a synchronized and replicated account corresponding to the source account.

In a second approach, which in one or more embodiments may be implemented either separately from or in combination with the first approach, a synchronization system may be implemented that includes one or more interface nodes. Such interface nodes may comprise or interact with traditional database systems, which traditional database systems maintain synchronized database entries that correspond to both pending and finalized blockchain transactions, in one or more embodiments enabling the interface nodes to provide synchronous responses to real-time payment systems while managing the risk that blockchain reorganizations or other blockchain events may affect the finality of transactions. The interface nodes may, in various embodiments, implement one or more strategies to ensure that real-time payment authorizations do not create undue risk of payment default, reversal or conflict when synchronized with a blockchain system, including without limitation maintaining designated treasury accounts, implementing exposure limits, and coordinating failover procedures in the event that blockchain reorganizations affect transaction finality.

In accordance with various aspects of the present invention, additional technical challenges may arise when attempting to synchronize data between a blockchain network and a traditional database system. In one or more embodiments, a blockchain reorganization event may occur when one or more blocks previously added to a blockchain are removed and replaced by one or more different blocks, which blocks may contain different sets of transactions and may reflect different transformations of the global state. Reorganization events may, in certain embodiments, create a technological challenge in maintaining synchronization between blockchain state and traditional database system state, particularly in cases where a traditional database already stores data from transactions that may have been previously incorporated into blocks that may be eliminated by the reorganization. The difficulty may be further complicated in implementations where the traditional database is being used to provide synchronous responses to user requests, such that the traditional database may need to maintain an accurate representation of account balances and transaction status even while reorganization events may occur, may have occurred, or may be in the process of occurring. This synchronization challenge may be particularly acute in cases where the reorganization affects blocks that had previously been considered “final”. In some embodiments, one or more solutions to this technical challenge may be required to ensure reliable operation of any system that connects, synchronizes or bridges blockchain networks and traditional database implementations.

Certain embodiments of the present invention may address these technical challenges by implementing one or more synchronization systems comprising one or more interface nodes configured to manage synchronization between blockchain and traditional database implementations, which interface nodes may continue to manage or maintain this synchronization even in the event of blockchain reorganization. In various embodiments, such interface nodes may comprise, incorporate, interact with, connect to, and/or use one or more traditional database systems and/or event messaging systems, and may implement a system and/or method to track both blockchain state and traditional database system state in a manner that permits recovery from reorganization events.

One or more embodiments may comprise one or more synchronization systems that implement a two-phase update process, whereby available balances may be adjusted immediately upon transaction initiation, while current (or final) balances may only be modified after transaction finality has been confirmed. In one or more embodiments, synchronization systems may maintain a principle of updating traditional database system state quickly when an update, operation or event may be protective of or may reduce financial or operational risk, may increase liability or loss, or is otherwise undesirable to the operators of said system; and updating traditional system state slowly when an operation or event may increase financial or operational risk, may decrease liability or loss, or is otherwise beneficial to the operators of said system.

The synchronization systems may, in various embodiments, maintain two distinct balance values for accounts that it manages: an “available balance” and a “current balance.” The available balance may be reduced as soon as a record or transaction that spends or otherwise decreases an account's balance is initiated, even before that transfer has been added to any block. Conversely, the available balance may be increased only when an inbound transfer or other record or transaction increasing the balance has reached finality, and the current balance may also only be modified when transactions reach finality. In various embodiments, “double spending” is prevented because various operations are blocked from occurring if they result in a negative available balance, including, for instance, providing authorization for real-time non-blockchain payments.

Nevertheless, in at least one embodiment, the available balance may potentially be less than zero in certain circumstances, for example in the case where a reorganization results in an exogenous record or transaction being added to the blockchain before an endogenous transaction that is generated to fund an already-approved external real-time payment. In various such cases, a previously-unknown exogenous record or transactions reduces account balances to less than the amount of an already-approved endogenous transaction, resulting in the settlement obligation crated by authorizing the external real-time transaction being un-funded. In certain embodiments, the on-chain balance for an account cannot be less than zero; in other embodiments, the on-chain balance can reflect a negative. One or more processes within the synchronization system may monitor accounts having negative balances (either within the traditional database, or within the blockchain, or both) and may automatically generate new blockchain transactions to reclaim value transferred to such accounts, potentially implementing one or more strategies to maximize the probability that such reclamation transactions will be successful.

### Synchronization System Components and Interactions

According to various embodiments of the present invention, one or more synchronization systems may comprise one or more of (a) a transaction processing component that receives transaction requests from wallet nodes and/or external systems and initiates various system operations; (b) a transaction writer component that submits cryptographically signed records and/or transactions to the blockchain network for inclusion in blocks, including records and/or transactions it may sign using secured private keys; (c) a transaction reader component that monitors the blockchain for new blocks and for reorganization events; (d) a message handler that processes blockchain transactions and updates traditional database system state; and/or (e) a transaction tracker component that maintains synchronization between blockchain and traditional database systems even while reorganization is occurring. Each aforementioned component, according to example embodiments, may be implemented in software running on one or more interface nodes or other computing devices, and may be run as two or more separate runtimes, or may be combined together into a single executable software.

These one or more synchronization systems may, in certain embodiments, maintain pending database entries in the one or more traditional database systems that reflect blockchain records and/or transactions that have not yet reached finality, and may update those pending database entries if a reorganization eliminates or modifies any such non-final transactions. One or more such synchronization systems may also maintain reversal database entries in certain implementations, which reversal database entries may be used to compensate for reorganizations that affect transactions previously considered final.

### Transaction Origination and Writing to the Blockchain

In accordance with various embodiments, one or more transaction processing components may comprise one or more interface nodes and/or other computer devices configured to process records and/or transactions received from one or more external systems and/or wallet nodes. Said external systems and/or wallet nodes may include, without limitation, mobile devices, desktop computers, servers, or other computing devices running software capable of connecting to and/or communicating with said transaction processing components via a computer network. In certain embodiments, said transaction processing components may write or transmit these received records and/or transactions to the blockchain network, and may also generate and write or transmit additional blockchain records and/or transactions in response to one or more events or requests. These events and requests may include, but are not limited to, payment channel open, close and update events, payment authorization requests from point-of-sale systems, account recovery requests from wallet nodes, card activation requests, transfer requests from external payment networks, withdrawal requests, identity verification events, multi-device registration events, and account configuration updates.

In certain embodiments, if said events and/or requests do not themselves comprise valid and complete cryptographically-signed blockchain requests and/or transactions, or if additional requests and/or transactions are required according to the nature of the event or request, a synchronization system may process such events and requests by generating one or more corresponding records and/or transactions, which may include without limitation payment channel records, transfer records, configuration records, account update records, or other types of blockchain records or transactions. A synchronization system may sign these generated records and/or transactions using one or more cryptographic keys associated with treasury accounts, user accounts, or other system accounts or addresses, and may submit these signed records and/or transactions to the blockchain network for inclusion in one or more blocks.

A transaction processing component may comprise one or more web servers, application servers, database servers, and associated software components that collectively provide transaction processing services, including but not limited to validating incoming transactions, maintaining account state and balances, tracking transaction status, managing user profiles and credentials, processing authorization requests, handling multi-device registration, coordinating with external payment networks, implementing identity verification workflows, and/or synchronizing state between the blockchain network and local databases. A transaction processing component may implement various means for users and external services and applications to access and interact with the synchronization system specifically and the blockchain network generally, which means of access and interaction include but are not limited to JSON-RPC APIs, REST APIs, WebSocket connections, OAuth2 authentication flows, webhook integrations, mobile application SDKs, browser-based interfaces, command-line interfaces, and programmatic library interfaces. These interfaces may enable functions including account management, transaction submission, balance queries, transaction history retrieval, blockchain status monitoring, smart contract interaction, and system configuration.

In at least one embodiment, a transaction processing component may interface with wallet nodes and/or external systems via one or more network interfaces, and a transaction writer component may manage cryptographic keys and sign blockchain transactions, which components may exchange messages or otherwise communicate with each other via one or more event messaging systems. In one or more embodiments, said transaction processing component may receive and process requests via one or more network interfaces, may maintain account state in one or more databases, and/or may generate events or messages to be processed by the transaction writer component. In various embodiments, the transaction writer component may store and manage cryptographic keys, may sign blockchain transactions, and/or may update the transaction processing component via events or messages with regards to blockchain interactions. In several embodiments, the separation of these components may enhance security by isolating cryptographic operations and key storage from public network interfaces. The event messaging system may provide reliable communication between these subsystems while maintaining their isolation, and may enable asynchronous processing of blockchain operations in a manner that is independent from request processing operations.

In various embodiments, a transaction processing component may implement one or more public API endpoints that receive and process various requests, including without limitation money transfer requests, account management requests, requests to write or transmit records and/or transactions to a blockchain network, and other operational requests from wallet nodes and/or external systems. The component may process these requests by performing one or more traditional database operations-including operations to record transaction details, perform account updates, or make configuration changes—and may generate one or more entries written to an event messaging system directing the transaction writer component to write or transmit corresponding blockchain transactions to a blockchain network. For payment-related requests, in at least one embodiment, the transaction processing component may interact with one or more payment card networks to authorize charges, process refunds, or handle other card-related operations. In certain embodiments, the component may comprise a network connection to, or a means of exchanging messages with, various types of payment networks, including, without limitation, credit card networks, debit card networks, electronic funds transfer systems, automated clearing house (ACH) networks, wire transfer systems, online payment gateways, mobile payment platforms, digital wallet services, peer-to-peer payment systems, and other financial transaction processing networks.

According to various embodiments, the transaction processing component may maintain transaction, event and account state information in one or more traditional databases, with database entries potentially having multiple possible statuses including, but not limited to, pending and final status. A pending status may indicate that a blockchain operation is still in process, with an associated record or transaction not yet added to a block, or a block not yet final, while a final or confirmed status may indicate that the corresponding blockchain operation has been completed and confirmed final. According to an embodiment, a transaction processing component specifically, and a synchronization system generally, may track multiple balance values for accounts and/or addresses, including an available balance that reflects pending operations, records and/or transactions, and a current balance that reflects only finalized operations, records and/or transactions. In certain embodiments, various account operations and record/transaction processing decisions may depend on the state of relevant database records—for example, new records and/or transactions may be rejected if an account's available balance would become negative, even if pending transactions have not yet been finalized.

In various embodiments, for payment card and other real-time payment operations, the transaction processing component may implement interfaces to one or more payment networks to enable real-time payment authorization and settlement. According to one or more embodiments, synchronization systems may process real-time payment authorizations by one or more of the following: a transaction processing component writing traditional database entries in a pending status; a transaction writer component generating appropriate blockchain records and/or transactions; the transaction processing component updating traditional database entries based on settlement messages received from payment networks; and a transaction reader component writing updates based on on-chain blockchain activity. In one or more embodiments, the transaction processing component may support multiple types of payment operations including, but not limited to, purchases, refunds, chargebacks, and card activation requests. Each such operation may involve multiple blockchain state transformations and traditional database updates as the operation progresses through various stages of completion.

In accordance with various embodiments, a transaction writer component may perform various functions, including, but not limited to, one or more of the following: (a) it may receive fully-formed blockchain records and/or transactions via an event messaging system, and may add these to a blockchain network transaction pool for eventual inclusion in new blocks; (b) it may monitor one or more event message queues for transaction creation requests from the transaction processing subsystem, and in response to such requests, may create and cryptographically sign one or more blockchain transactions and add these to a blockchain network transaction pool; (c) it may monitor the expiration of transactions that have not yet been incorporated into any block, and may generate replacement transactions in certain circumstances; (d) it may handle blockchain reorganizations by processing transaction reversals and re-submissions.

In one or more embodiments, one or more components of synchronization systems including but not limited to the transaction writer component, the transaction reader component, or the message handler—may transmit status updates regarding expired and replacement transactions to various other subsystems via, for example, but not limited to, event messaging systems, web service notifications, or publish-and-subscribe mechanisms. Depending on the embodiment, they may implement timeout and retry mechanisms for operations that depend on external systems or blockchain confirmation, allowing operations to be cancelled or retried if they do not complete within expected timeframes.

According to one or more embodiments, in the event of a blockchain reorganization, where previously processed blocks are replaced by a different chain of blocks, the transaction writer component may identify affected transactions and initiate appropriate remedial actions. The component may evaluate whether re-submitted transactions require modified parameters, such as updated nonces or gas prices.

In one or more embodiments, a transaction writer component may maintain transaction queues to manage the ordering and timing of transaction submissions to the blockchain network. In several embodiments, these queues may ensure proper nonce ordering for transactions from the same account and may implement rate limiting or batching of transaction submissions.

### Block and Transaction Reading

In accordance with at least one embodiment of the present invention, a synchronization system may be implemented that includes one or more transaction reader components operating on one or more interface nodes. Such transaction reader components may monitor the blockchain network for new blocks and may process the records and/or transactions contained within such blocks as the blocks are added to the blockchain.

In one or more embodiments, said transaction reader component processing said records and/or transactions comprises the transaction reader component writing entries corresponding to records and/or transactions and/or other blockchain events to an event messaging system. As said entries are written to said event messaging system, a message handler (running concurrently, in parallel, or sequentially with the transaction reader) reads each transaction in turn. As the message handler reads each record or transaction, it may update one or more database entries in the traditional database system, including without limitation updating account balances, transaction status indicators, transaction histories, account and/or address configurations, user data associated with accounts and/or addresses, order books, sale and purchase orders, new token creation events, and token configurations.

In at least one embodiment, the message handler may identify whether processed transactions originated from interface nodes within the synchronization system (“endogenous” transactions) or from external sources (“exogenous” transactions), and may update the traditional database system differently depending on the origin of such transactions. Furthermore, in various embodiments, the message handler may, upon reading an entry from the event messaging system, communicate with other systems over a network—for instance, by calling APIs, invoking webhooks, or utilizing other communication protocols—to exchange data, execute algorithms, trigger events, or coordinate operations, possibly enhancing interoperability and integration with third-party services or applications.

In various embodiments, the one or more synchronization systems may implement one or more strategies to handle blockchain reorganizations, including without limitation rewinding database updates that were performed in response to transactions that are eliminated due to blockchain reorganization. Such rewinding processes may, in at least one embodiment, distinguish between transactions that have not yet reached finality and transactions that have reached finality, implementing different reversal strategies in each case. For transactions that have not yet reached finality, the rewinding process may return database entries to their previous state and may re-queue transactions (for example, endogenous transactions) for re-submission to the blockchain. For transactions that have reached finality, the rewinding process may generate compensating database entries to reverse the effects of eliminated transactions while maintaining a record of such transactions and their reversals.

The interface nodes implementing the synchronization system may, in various embodiments, communicate with each other and with the blockchain network using one or more event messaging systems. Such event messaging systems may enable the interface nodes to coordinate their activities and to ensure that database entries remain synchronized across various synchronization systems. In at least one embodiment, an event messaging system may be used to transmit information about pending transactions, finalized transactions, and blockchain reorganizations between interface nodes. The event messaging systems may also be used to coordinate the re-submission of transactions that are eliminated due to blockchain reorganization.

In accordance with at least one embodiment of the present invention, the synchronization process may proceed in a series of one or more distinct steps. A transaction reader component operating on one or more interface nodes may first detect that a new block has been added to the blockchain. The transaction reader component may examine each record and/or transaction contained within the new block; for each record and/or transaction, the transaction reader component may generate one or more entries in an event messaging system reflecting a pending status for that blockchain record or transaction. These database entries may include one or more of the following elements, without limitation: the block number of the block containing the transaction, a transaction identifier, source and destination account information, token type and quantity information, and current status information.

In one or more embodiments, an additional type of transaction reader component may be implemented which read records and/or transactions from the pending transaction pool (mempool) of a blockchain network, before they have been included in any block. In certain embodiments, records and/or transactions read from the mempool may be added to a traditional database in a “pending but not yet accepted” status, in a similar manner as new endogenous records and transactions. By incorporating these pending transactions into the traditional database sooner, a synchronization system can prevent conflicts making provisional updates-such as updates to an account or address' available balance-before the transactions are confirmed on the blockchain. This approach allows for earlier detection of potential conflicts (such as double-spending) and enhances the consistency between the blockchain network and off-chain database systems. Conversely, exogenous transactions in certain alternate embodiments may only be known to the synchronization system when the transaction is detected within a block.

In accordance with at least one embodiment, as said records and/or transactions are written to one or more event messaging systems by one or more transaction reader components, said records and/or transactions may be read by one or more message handlers. Upon detecting a blockchain record or transaction that comprises a transfer of value between one or more accounts managed by synchronization systems, said one or more message handlers may update the traditional database, recording that transfer as a database object in a pending status. The transfer may persist in a pending status until the record or transaction reaches finality, which may occur after a configurable number of blocks have been added to the blockchain following the block containing the record or transaction, determined according to various heuristics or algorithms, depending on the embodiment. While the transfer remains in pending status, the available balance of the source/sending account may be decreased to reflect the pending outflow, but the current balance may remain unchanged until finality is deemed to be reached. After finality is deemed to be reached, according to the embodiment, the one or more synchronization systems may update the database entries to reflect that the transfer has been finalized, potentially updating both available and current balances.

Records and/or transactions that perform transformations of global blockchain state other than transfers of value may also effectuate provisional updates and insertions within the traditional database system when first read by a message handler; the traditional database entries corresponding to such records and/or transaction would only be updated to reflect a final status when such records and/or transactions are deemed final.

In certain embodiments, two message handlers may read from the same event messaging system, one at an offset from the other. The first message handler may treat each record or transaction as pending, and would make appropriate updates and insertions in the traditional database system to reflect a provisional status. The second message handler may read each transaction at an offset equal to a finalization block depth or finalization time duration, such that each transaction would be finalized when read. The second message handler would perform a finalization update for every traditional database entry corresponding to a record or transaction that had been read, so as to reflect a non-provisional or final status (for instance, by causing a balance change made to available balance to also be reflected in current balance).

In one or more embodiments, the synchronization process may vary depending on whether the record or transaction originated from within the synchronization system (“endogenous”) or from an external source (“exogenous”). For endogenous records or transactions transferring or otherwise using funds out of an account or address, an available balance may be reduced—or the traditional database state may be otherwise provisionally updated-before the transaction is submitted to the blockchain network, and a database entry tracking said endogenous records or transactions may be placed into a pending status within the database. In several embodiments, the synchronization system may update the database entries pertaining to exogenous records and/or transactions upon detection within a new block, potentially recording the block number and updating status information, but maintaining the pending status until finality is reached. In one or more embodiments, endogenous records and/or transactions may be received and/or generated by a transaction processing component or a transaction writer component, while exogenous records and/or transactions may be first detected and/or processed by a transaction reader component or a message handler.

### Reorganization Handling

In accordance with various embodiments of the present invention, one or more interface nodes of the one or more synchronization systems may implement a multi-step procedure to maintain synchronization between blockchain and traditional database systems in the event of a reorganization.

Various embodiments of the present invention may utilize an event messaging system that maintains an ordered sequence of blockchain events, including blocks, records and/or transactions, even after they have been synchronized with a traditional database system, thereby preserving the original processing order within the event messaging system itself. When interface nodes detect a blockchain reorganization event, by, for example observing that a newly-received block references a different previous block hash than the last block processed, they may append a “reorganization marker” to this ordered sequence to indicate the position of the last common block shared between the old and new blockchain forks, and then begin appending new blocks from the reorganized chain. Message handlers monitoring the data structure, upon encountering the reorganization marker, initiate a “rewind” process by iterating backwards through the preserved event sequence to the last common block, enabling precise reversal of state transitions affected by the reorganization. After completing the rewind, message handlers process the newly appended blocks, records and/or transactions following the reorganization marker, potentially comparing them against a transaction tracker component to identify transactions that may need to be regenerated or resubmitted, thus facilitating accurate reconstruction of the database state.

In some embodiments, a transaction reader component of an interface node may first detect a reorganization event by observing that a newly-received block references a different previous block hash than the last block processed. The transaction reader may then iterate backwards through previously-processed entries corresponding to records, transactions, blocks and/or other blockchain events stored by an event messaging system until discovering a “last common block” that exists in both the old and new blockchain forks. The transaction reader may also, during the same iteration, or in a separate iteration over the same data, construct a list of entries potentially subject to reversal and re-submission or re-processing (the reversal entries).

In an alternate embodiment, the transaction reader my discover the last common block and construct the list of reversal entries though a direct interaction with one or more block-building nodes; in yet another version, a message handler may undertake either approach.

Upon identifying this last common block, the transaction reader may, in some implementations, add a reorganization marker to the event messaging system with information regarding the reorganization. In one or more embodiments, the transaction reader component may append to the event messaging system each of the reversal entries, in reverse order, such that by progressing forward through the entries a consumer would move backwards through the history of the blockchain's execution. Upon adding a reorganization marker to the event messaging system and/or appending the reversal entries to the event messaging system, the transaction reader may, in one or more embodiments, re-initiate its previous block-reading activities, and process the blocks of the previously-unknown fork starting from the block following the “last common block”. In one or more embodiments, concurrent with, parallel with or subsequent to this reorganization processing by the transaction reader component, the one or more message handlers may then process the reorganization by iterating forward through the reversal entries, initiating a reversal operation of each reversal entry against corresponding data in the traditional database system.

In various embodiments, the specific nature of each reversal operation performed by the message handler may depend on whether corresponding records and/or transactions have achieved finality. For non-final records and/or transactions, the message handler may in some embodiments revert pending status of a database entry and place affected records, transactions or other blockchain events back into a “pending but not yet accepted” status, which may be indicative of records, transactions and/or other blockchain events that have been proposed but have not yet been including in any block. For final records and/or transactions, one or more message handlers may instead generate reversal records in the traditional database system while leaving the original database entries in place, potentially also applying certain modifications, but without reversing the entry entirely. In certain embodiments, account balances in may potentially be allowed to become negative, either only in the traditional database system, or in both the traditional database system and the blockchain global state. After processing the reversal entries, one or more message handlers may proceed to process entries corresponding to new blocks from the reorganized chain, potentially comparing newly-processed transactions against the records, transactions and/or blockchain events added to a transaction tracker component, so as to identify records, transactions and/or blockchain events that may potentially need to be re-applied to the traditional database state, and/or may potentially need to be re-submitted to the blockchain network.

In one or more embodiments, either the transaction reader or the message handler may potentially add individual reversed records and/or transactions to said transaction tracker component, while either process iterates through the reversal entries as per its respective process. Following a reorganization, after the message handler has processed all reversal entries and then all entries corresponding to records and/or transactions of new blocks introduced by the reorganization, the synchronization systems may initiate a process to once again add to the blockchain one or more records and/or transactions still remaining with the transaction tracker component, which process may also involve a transaction writer component or other component, depending on the embodiment.

In various embodiments of the present invention, the synchronization system may also implement special handling for endogenous transactions during reorganization processing. In certain embodiments only endogenous transactions that may be added to the transaction tracker component, particularly in embodiments where such transactions may need to be re-submitted to the blockchain. In an alternate embodiment, both endogenous and exogenous records and transactions may be added to the transaction tracker component, but endogenous transactions are handled in a different manner.

After a synchronization system attempts to submit remaining records and/or transactions of the transaction tracker component to the blockchain, the synchronization system may, in some embodiments, attempt to regenerate one or more of any remaining endogenous records and/or transactions, potentially with updated nonce values and expiration dates. This may occur in an embodiment if the original records and/or transactions have expired or have become invalid without first being successfully incorporated into a block. In certain implementations, interface nodes may also split larger transactions into one or more smaller transactions during regeneration, or may otherwise make other modifications to these replacement records and/or transactions, particularly in cases where reduced account balances or other features of said records and/or transactions may have prevented the originals from being processed. Through this coordinated processing of reorganization events, one or more embodiments of the present invention may maintain consistency between blockchain and traditional database system state while preserving the intent of endogenous transactions wherever possible.

In some embodiments of the present invention, said one or more synchronization systems may implement additional compensating actions related to reorganization processing. In certain implementations, account operations may be frozen or restricted when reorganization causes account balances to become negative. Interface nodes may also, in some embodiments, implement an “exposure limit” mechanism that caps the total value of non-final transactions that may be processed for a given account, thereby limiting potential losses from reorganization events. Various implementations may also include notification mechanisms to alert system operators and/or end users when reorganization events occur, particularly in cases where such events affect transactions previously considered final. Through these various mechanisms, operating individually, or in coordination, embodiments of the present invention may provide robust handling of blockchain reorganization events while maintaining synchronization between blockchain and traditional database systems.

### Expiration

In accordance with at least one embodiment of the present invention, blockchain records or transactions may be configured to include an expiration time or expiration block height, after which the records or transactions may no longer be considered valid according to the blockchain protocol. This expiration capability may provide significant advantages over transactions or records that do not specify any expiration, given that non-expiring transactions may potentially be executed at any time after they are signed unless explicit double-spend prevention techniques are employed. For instance, and without limitation, if a first transaction is signed but not immediately added to the blockchain, a user may have difficulty constructing a second transaction that spends or otherwise interacts with a source account's balance. In some embodiments, a second transaction cannot be included without either blocking the first transaction, or succeeding it on the blockchain, due to the known technique of implementing a sequential transaction counter for addresses and/or accounts. In other embodiments, the second transaction may not block or depend on the first, but may nonetheless use the same token balance, leading to an indefinitely confusing contingency. By incorporating expiration times or expiration block heights, various embodiments of the present invention may prevent such scenarios.

In at least one embodiment, when a transaction or record includes an expiration time or block height, the blockchain network may reject as invalid any attempt to add that transaction or record to the blockchain after the specified expiration. This may enable the synchronization system to identify and handle expired transactions without requiring complex coordination between interface nodes. For instance, and without limitation, if a transaction expires before being added to any block, the synchronization system may detect this expiration and may automatically update database entries to reflect that the transaction has been canceled. In some embodiments, the synchronization system may attempt to re-generate expired transactions with new expiration times, potentially implementing various strategies to maximize the probability that re-generated transactions will be successfully added to the blockchain.

Various embodiments may implement different strategies for selecting appropriate expiration times or expiration block heights. These strategies may be contingent on, without limitation, estimated block generation times, network congestion levels, transaction and/or record priority, blockchain fees/pricing, and historical transaction processing times. The expiration time or expiration block height may, in at least one embodiment, be selected to provide sufficient time for the transaction to be added to the blockchain under normal operating conditions while still preventing indefinite transaction validity. The synchronization system may, in several embodiments, monitor transaction expiration and may implement various strategies to handle cases where transactions are at risk of expiring, potentially including, without limitation, re-generating records and/or transactions with extended expiration times and/or increased transaction fees, or simply allowing such transactions and/or records to expire.

In accordance with at least one embodiment of the present invention, when a wallet node connected to the synchronization system, or when an interface node within the synchronization system generates a record or transaction, said record and/or transaction may be configured with an expiration time or expiration block height. An interface node may then create database entries reflecting a pending status for said record or transaction, including the expiration time or block height. In certain embodiments, these database entries may affect available balances immediately, even before the transaction is added to any block, in order to prevent duplicate spending.

Subsequently, in various embodiments, an expiration detection routine implemented in one or more interface nodes of a synchronization system may monitor both the blockchain network and pending database entries in order to identify expired transactions. Upon detecting an expired transaction, said synchronization system may initiate an expiration handling procedure.

In an embodiment, following detecting an expired transaction that has not yet been added to any block, an expiration handling procedure may include one or more of, without limitation: updating database entries to reflect that the transaction has been canceled due to expiration, reversing any changes made to available balances when the transaction was initiated, and/or potentially initiating generation of a new transaction to replace the expired transaction, depending on the nature of the embodiment, and depending on the type or configuration of the expired record or transaction. In an embodiment, the expiration handling procedure may also trigger notifying other interface nodes about the expired transaction, enabling those nodes to update their database entries accordingly.

Conversely, in possible embodiments, upon detecting a record or transaction that has been added to a block, but which has not yet reached finality, where such record or transaction has a configured expiration date occurring in the past, an interface node of said synchronization system may implement a different expiration handling procedure. This procedure may include, without limitation, monitoring subsequent blocks to determine whether the expired transaction is eliminated from the blockchain due to reorganization, and potentially initiating generation of a new transaction only if the expired transaction is subsequently eliminated. As with other records and/or transactions not yet finalized, in one or more embodiments, the synchronization system may maintain the database entry associated with such records and/or transactions in a pending status until either finality is reached, or the record or transaction is eliminated from the blockchain in a reorganization.

In at least one embodiment, the synchronization system may implement retry procedures for expired transactions. These procedures may vary depending on the circumstances of expiration. For instance, and without limitation, if a transaction expires due to network congestion before being added to any block, the synchronization system may generate a new transaction with an increased transaction fee and an extended expiration time. However, if a transaction expires after being added to a block but before reaching finality, the synchronization system may wait to determine whether that transaction will be finalized (or, alternately, removed from the blockchain in a reorganization) before attempting to generate a replacement transaction. The retry procedures may implement various strategies to prevent duplicate transactions and to ensure that replacement transactions are properly sequenced.

The synchronization system may also, in various embodiments, maintain historical records of expired transactions and their replacements. These records may be used to implement various monitoring and reporting functions, potentially including without limitation: identifying patterns of transaction expiration, evaluating the effectiveness of different expiration time selection strategies, and generating alerts when transaction expiration rates exceed configured thresholds. The historical records may also be used to prevent duplicate transaction submission and to ensure proper sequencing of replacement transactions.

In various embodiments of the present invention, the synchronization system may incorporate additional handling to address transaction and/or record expiration during reorganization processing. During reorganization processing, one or more interface nodes may need to evaluate whether tracked transactions have expired or will expire before they can be re-submitted to the blockchain network. In certain embodiments, removed/eliminated transactions that have not expired may be added again to the blockchain after a reorganization, while transactions that have already expired may require special handling or cancellation.

In accordance with certain aspects of the present invention, interface nodes may implement different expiration handling procedures depending on the type of transaction being processed. For endogenous transactions originating from interface nodes of the synchronization system or related systems, one or more interface nodes may attempt to regenerate expired transactions with new expiration values, particularly in implementations where the original transaction intent can still be fulfilled. When regenerating such transactions, interface nodes may in some embodiments also update other transaction parameters such as gas prices and nonce values to improve the probability of successful processing. For exogenous transactions originating from external sources, one or more interface nodes may instead need to cancel or reverse expired transactions and potentially initiate compensating updates to data within the traditional database system, such as reversing pending status changes or notifying external systems of the expiration.

Various embodiments of the present invention may also implement special handling for expired records and/or transactions in the event of a reorganization. In some implementations, a reorganization event may result in transactions to expiring before they can be reprocessed, particularly in cases where the original expiration values were close to the current block height. Interface nodes may, in certain embodiments, implement a “time buffer” mechanism that ensures that records and/or transactions they generate have sufficient time to be processed before expiration. Some implementations may also include retry logic that attempts to reprocess expired transactions multiple times with progressively larger expiration windows before considering them permanently failed.

### Smart Contract Synchronization

In accordance with at least one embodiment of the present invention, the synchronization system may process smart contract executions detected within blocks added to the blockchain. When processing a block containing a smart contract execution, a transaction reader component may examine log entries generated during that execution to identify token movements and other state changes affecting accounts managed and/or tracked by the synchronization system. In various implementations, these log entries may be processed to generate corresponding database entries within the synchronization system, potentially implementing various strategies to process smart contract execution pending and finalized states for effects of smart contract execution.

In accordance with various embodiments of the present invention, a smart contract is a program that executes on a blockchain network's virtual machine environment—such as the Ethereum Virtual Machine (EVM), WebAssembly (WASM), or similar execution platforms. Smart contracts may be Turing-complete, depending on a gas budget to limit execution time, or they may not be Turing-complete, potentially lacking loop or recursion capabilities, as in the case of Bitcoin Script. These programs are composed of executable code and, depending on the embodiment, may define functions and state variables. In one or more embodiments, smart contracts may perform computations, manage data storage, and interact with other contracts or accounts or addresses on the blockchain. Smart contracts operate deterministically, meaning that given the same input and state, they will produce the same output and state changes across all nodes in the network.

A contract execution record or transaction refers to the data generated when a smart contract is invoked or executed on the blockchain network through the inclusion of a specialized record or transaction in a new block. In various embodiments, this transaction may include details such as the sender's address, the recipient's address (which may be a smart contract), input data (such as function calls and parameters), and computational resource metrics such as gas budget, which may be directly specified or derived from other values. The execution of the transaction results in the execution of the smart contract, effectuating state transformations resulting from the execution of the smart contract code.

In an embodiment of the present invention, a block-building node generates a receipt in the process of executing a smart contract. This receipt may comprise details including, but not limited to: a transaction hash, a block number, gas consumed, execution status (success or failure), state changes to accounts or storage variables, execution timestamp, sender and recipient addresses, possible output data produced by the smart contract functions, and emitted logs or events. By generating and recording this receipt, the block-building node provides a verifiable record of the smart contract's execution, which can be stored on the blockchain ledger and accessed for auditing, confirming transaction outcomes, and ensuring the integrity of operations within the blockchain network.

In one or more embodiments, each state transformation effectuated by a smart contract execution may correspond to a log entry included in the receipt. Because all state transformations effectuated by a smart contract execution are encoded as log entries in the receipt, in at least one embodiment the synchronization system may not need to predict or simulate the outcome of that execution in order to synchronize said state modifications with one or more traditional database systems. Rather, the synchronization system may, in at least one embodiment, read and process said log entries in the manner described elsewhere herein as pertain to the synchronization system's record and/or transaction processing.

In one or more embodiments, the synchronization system may process smart contract state transformations in a manner equivalent to the state transformations effectuated by individual records and/or transactions. In a manner comparable to the handling of records and/or transactions, in one or more embodiments, these log entries may be read by a transaction reader, they may be written to an event management system, and upon being read by a message handler, they effectuate the creation, modification or configuration of database entries tracking value transferred between and among accounts as a result of the smart contract execution. In at least one embodiment, these database entries may include references to the original smart contract invocation, potentially enabling the synchronization system to link related elements and potentially track the provenance of value transfers resulting from smart contract execution. In certain embodiments, database entries are also configured with a reference to the individual log entries that they correspond to. In at least one embodiment, one or more state transformations that may be effectuated by a smart contract execution may correspond on a one-to-one basis to one or more analogous record or transaction types that effectuate the same one or more state transformations.

In at least one embodiment, database entries generated and configured according to this process may be assigned the block number or block height of the block containing the execution record or transaction that generated the corresponding log entries. In various embodiments, these records may be subject to the same finality requirements as other blockchain transactions, potentially remaining in a pending status until this block has been deemed final by the synchronization system.

In accordance with at least one embodiment of the present invention, the synchronization system may perform one or more different operations, including but not limited to the following: first, the synchronization system may update the database entries for the original transfer to include the block number; second, the synchronization system may examine log entries generated during the smart contract execution to identify any transfers or other effects relevant to accounts managed by the synchronization system. third, for each relevant log entry, the synchronization system may generate new database entries tracking those effects.

The transaction reader process may, in various embodiments, handle different types of log entries in specific ways. For log entries indicating transfers to managed accounts, the process may generate pending in-transfer records and may increase the available balance of the destination account. For log entries indicating transfers from managed accounts, the process may generate pending out-transfer records and may verify that sufficient balance remains available. In at least one embodiment, all database entries generated from log entries may be assigned the block number of the block containing the smart contract execution, and may remain in a pending status until that block reaches finality.

In one or more embodiments, the synchronization system may maintain detailed audit records of all smart contract interactions and their effects. Such records may include, without limitation, the original invocation transaction, all generated log entries, all subsequent database entries and balance updates, and any reorganization events affecting those records. In at least one embodiment, these audit records may enable the synchronization system to reconstruct the complete history of any smart contract interaction, potentially including all intermediate states and any subsequent modifications or reversals. This audit capability may be particularly valuable when troubleshooting complex smart contract interactions or when investigating suspected errors in the synchronization process.

### Third-Party Payment for Requests, Records, or Transactions

In various blockchain systems, cryptographic signatures are essential for authorizing updates to the global state of a blockchain network. Specifically, any record or transaction that intends to modify the blockchain's state may need to be authenticated using a cryptographic signature. This signature may be generated using a private key associated with an originating account or address, ensuring that only the legitimate owner of an account or address can authorize actions affecting assets or data owned by, controlled by, or otherwise belonging to that account or address. The use of cryptographic signatures may serve as a security mechanism to prevent unauthorized modifications by malicious actors, thereby maintaining the integrity and trustworthiness of the blockchain network.

For example, when a user wishes to transfer tokens from their account to another, they may need to create a record or transaction and sign it with their private key. The cryptographic signature may serve to verify the authenticity of the transaction and prove that it was authorized by the account holder. Similarly, deploying a new smart contract or executing a function within an existing smart contract may require the initiator to sign the transaction. By enforcing the use of cryptographic signatures for these types of updates, blockchain networks may ensure that all changes to the global state are properly authorized and can be independently verified by all participating nodes.

In many blockchain networks, transaction fees, also called gas fees, may be required for executing and validating transactions and smart contracts. These fees may typically be paid by the originator of the transaction, who pays to cover the computational resources used. This mechanism may improve the efficient allocation of network resources and may deter malicious activities by imposing costs on network use. However, it may also present a challenge when one party wishes to pay fees on behalf of another. For example, a service provider may want to sponsor transaction fees to enhance user experience or promote adoption of a decentralized application. Known protocols require the sender's account to have enough balance to cover the fees. This complicates scenarios where end-users lack tokens required to pay fees or when simplifying blockchain interactions is desired.

To address this challenge, one or more embodiments of the present invention implement a two-phase process, whereby a blockchain record or transaction is first signed by the originator of the blockchain operation and is then signed by a separate account that pays the transaction fees.

In accordance with at least one embodiment of the present invention, a synchronization system or interface node may be implemented that enables one or more blockchain records to be submitted to a blockchain system by one or more wallet accounts, where such records may include signatures authorizing transfers or other state changes, but where blockchain processing fees for such records may be paid by one or more accounts or addresses controlled by the synchronization system or interface node, instead of accounts or addresses controlled by the one or more wallet accounts.

In at least one embodiment, the synchronization system may receive one or more signed records from a wallet account, where the one or more signed records have been cryptographically signed using a private key associated with one or more source accounts or addresses. The synchronization system may then encapsulate or wrap the records within a new blockchain transaction, which transaction may be signed by a private key controlled by the synchronization system or interface node, and which transaction may provide for payment of blockchain processing fees. The synchronization system may then transmit the new blockchain transaction to one or more blockchain nodes for validation and inclusion in a new block. In this way, wallet accounts may be relieved of the burden of maintaining a balance of native blockchain tokens used for payment of processing fees, as the synchronization system may pay such fees on behalf of the wallet accounts. The signed records submitted by wallet accounts may include, but are not limited to, transfer records moving token value between accounts, smart contract invocations, configuration records modifying account settings, updates made to identity information stored on accounts, and other records affecting blockchain state.

In at least one embodiment of the present invention, a synchronization system or interface node may receive one or more signed records submitted from one or more wallet accounts, and may aggregate or group those records as constituent records within a composite transaction. The composite transaction may then be configured by the synchronization system or interface node to ensure that blockchain processing fees are paid by accounts or addresses controlled by the synchronization system, covering the fees for executing the one or more constituent records, while the underlying constituent records remain signed by private keys controlled by the one or more wallet accounts that originated those records. This configuration enables the composite transaction to maintain cryptographic proof of authorization by the originating wallet accounts while delegating payment of processing fees to the synchronization system or interface node.

In accordance with at least one embodiment of the present invention, requests submitted by wallet nodes to an interface node may comprise one or more constituent records to be incorporated into atomic records or atomic transactions, which atomic records or atomic transactions may be encoded in a manner that ensures said one or more constituent records will be executed together along with an atomic transaction envelope, as per the blockchain protocol. The constituent records submitted to the interface node may thus be wrapped or encapsulated within an atomic transaction signed by the interface node, which atomic transaction provides for payment of blockchain processing fees by an account controlled by the interface node. In one or more embodiments, the interface node may configure atomic transaction records and atomic record chains to ensure that blockchain processing fees are paid by one or more accounts or addresses controlled by the interface node, while the underlying constituent records remain signed by private keys controlled by the one or more wallet accounts that originated those records. In this way, cryptographic proof of authorization by the wallet accounts may be maintained while delegating fee payment responsibility to the interface node. In one or more embodiments, said interface node constitutes a portion of, or comprises, a synchronization system.

In one or more embodiments, the composite transactions and/or the atomic transactions may also be configured with additional validation rules, criteria or conditions that may need to be satisfied before the constituent records may be processed, which rules, criteria or conditions may include, without limitation: requiring certain blockchain account annotations to be present; requiring certain token balances to be available; requiring certain smart contract conditions to be met; defining dependencies between constituent records that are satisfied for successful processing; requiring that the constituent records be executed on an all-or-nothing basis; requiring that the constituent records execute until the first record that fails; and/or requiring other configurable criteria to be satisfied.

In an alternate embodiment, rather than encapsulating or wrapping the original signed record with a new transaction, the synchronization system or interface node may append an additional cryptographic signature to the original record, where the additional signature is interpreted by the blockchain protocol of the blockchain network as belonging to a separate account that is responsible for paying transaction fees of the original record.

According to certain embodiments, instead of receiving signed records as part of requests submitted from wallet nodes, a synchronization system comprising one or more computer devices may read atomic transactions and/or composite transactions from a pending transaction pool of a blockchain network, and unwrap the constituent records encapsulated by said atomic transactions and/or composite transactions. The synchronization system may then encapsulate or wrap said constituent transactions again with a new atomic transaction or composite transaction, which new atomic transaction or new composite transaction may include a transaction fee paid by an account or address controlled by the synchronization system, before writing, sharing or transmitting said atomic transaction or composite transaction on the blockchain network. By this method said synchronization system may offer a service of paying for blockchain records and/or transactions without those records and/or transactions needing to be submitted directly to said synchronization system.

In various embodiments, one or more synchronization systems may accept one or more forms of compensation from the users of wallet accounts for the payment of blockchain processing fees and other services. Such compensation may be received in advance of any services being rendered, or may be received in arrears after services have been performed, or may be drawn from one or more funding accounts maintained by users with the synchronization system. The compensation may be provided in various forms including, but not limited to: official currency deposits, cryptocurrency transfers, credit card payments, automated clearing house (ACH) transfers, wire transfers, bank-to-bank transfers, prepaid value cards, electronic payment systems, mobile payment applications, digital wallet transfers, merchant services payments, remittance networks, app-store payments, mobile payments, or other electronic value transfer mechanisms. Said one or more synchronization systems may, in at least one embodiment, maintain records of services provided and fees paid, and may implement various accounting and reconciliation processes to ensure proper tracking of compensation received and services rendered; such accounting and reconciliation processes may, certain embodiments, track payments made and services rendered according to the one or more blockchain accounts or addresses of its users and/or customers. The synchronization system may optionally implement different fee structures, payment schedules, and compensation arrangements for different users, user categories, or transaction types. In some embodiments, the synchronization system may automatically draw required compensation from designated funding sources when balances fall below specified thresholds, or may implement various automated billing and collection processes for compensation owed.

According to various embodiments, a synchronization system or interface node may implement a message authentication system comprising one or more application programming interfaces (APIs) that accept requests signed using cryptographic keys associated with blockchain accounts. The system may authenticate such requests by verifying that messages have been cryptographically signed using private keys corresponding to public keys recorded within the blockchain for the accounts initiating such requests. In at least one embodiment, an API request message may include a payload containing the details of the requested operation, a signature generated by signing said payload with a private key, and information identifying the account making the request. The system may verify the signature against the public key associated with the identified account before processing the request. In an embodiment, a request may be an HTTP or HTTPS request, the payload may comprise the body of an HTTP or HTTPS message combined in a deterministic way with certain metadata and/or certain HTTP or HTTPS header data, while the cryptographic signature may be included along with the account information as one or more fields of the HTTP or HTTPS header. The message signing protocol may be implemented using various cryptographic schemes including asymmetric key cryptography, elliptic curve cryptography, or other suitable cryptographic methods. Such signed API requests may be used in various embodiments for various operations including, but not limited to: submitting transactions, querying account information, requesting blockchain status updates, managing account settings, initiating token transfers, deploying smart contracts, updating account configurations, managing identity information, and other account-related operations.

In accordance with at least one embodiment, the blockchain system may associate signed API requests with payment accounts or payment arrangements, such that requests properly signed by accounts having payment arrangements may be automatically accepted and processed. The system may maintain records linking blockchain accounts to payment methods, payment accounts, or compensation arrangements. When a signed API request is received from a wallet or other client application, the system may verify both the cryptographic signature and the existence of valid payment arrangements for the signing account. If both the signature is valid and payment arrangements are confirmed, the system may process the request and perform any associated operations, with fees being charged according to the established payment arrangements.

In at least some embodiments, a synchronization system or interface node may pay blockchain transaction fees, API request fees, or other service fees on behalf of wallet accounts without requiring direct compensation, in order to achieve various business objectives. Such objectives may include incentivizing adoption of the blockchain system by new users, encouraging increased transaction volume, promoting specific token types or smart contracts, supporting promotional campaigns, or enabling access to other revenue-generating services. The synchronization system or interface node may implement different fee payment policies for different categories of users, time periods, geographic regions, or blockchain operations. The payment of fees may be subject to various conditions such as maximum amounts, time restrictions, volume caps, or service utilization requirements. The synchronization system or interface node may dynamically adjust these policies based on factors including network congestion, fee rates, user behavior patterns, marketing objectives, or system economics.

### Synchronization System Illustrations

In accordance with at least one embodiment of the present invention, and with reference to FIGS. 12A and 12B, a synchronization system (1200) may include one or more transaction reader components (1202) that monitor a block-building node or validator node (1201) for new blocks. The transaction reader components may write information about new blocks, records and/or transactions to one or more event messaging systems (1206), which may include entries labeled in the diagram with version and fork information (e.g., b1v1t1, b1v1t2, etc.). The transaction reader (1202) may comprise components responsible for reading from the event messaging system(s) (1205) and for writing to the event messaging system(s) (1203). In an example implementation, said event messaging system (1206) may be implemented as an Apache Kafka instance comprising various topics. At least one message handler (1207) may read entries from the event messaging system(s) (1206). The message handler may delegate all or a portion of this responsibility to one or more handler delegates (1209, 1210, 1211, 1212, 1215, 1216) that each are implemented to handle specific types of record or transaction. The message handler and message handler delegates may be responsible for updating the traditional database system (1226) which comprises account and address data storage, so as to reflect whatever state transformation may be encoded in the event messaging system entry they are handling.

According an embodiment, the synchronization system illustrated in FIGS. 12A and 12B may implement specific procedures for handling blockchain reorganizations. When a reorganization is detected, the transaction reader (1202) may write (1203) reversal entries to the event messaging system (indicated as b1v1t1_rev, b1v1t2_rev, etc.) which entries are then processed by the message handler (1207) and one or more handler delegates (1210 1215, 1216) specifically responsible for reversal events. These reversal handler delegates operate on the traditional database system (1226) which (as stated above) comprises account and address data traditional database, to temporarily store reversed records and/or transactions subject to re-entry. Said message handler and handler delegates may process incoming blockchain events, validate transaction parameters, update account balances in the RDBMS, and maintain pending transaction records until finality is reached.

A cleanup component (1208) may be implicated in the reorganization-handling process at the final stage, after all the new fork's blocks, records, transactions, and/or events have been processed by the message handler (1207) and its delegates. Said cleanup component (1208) may read all the records, transactions and/or events that remain in the transaction tracker component (1213) and evaluate them for re-creation or re-introduction to the blockchain. The cleanup component will add eligible records, transactions and/or events from the transaction tracking component to a write-to-blockchain event messaging system (1214) that is monitored by a transaction writer component (1218) responsible for submitting new transactions to the blockchain network.

In addition to the cleanup component (1208), in one or more embodiments a transaction processing component (1217) may also add record, transaction, and/or event entries to the write-to-blockchain event messaging system (1214), with the intent of passing them to the transaction writer component (1218) for them to be submitted to the blockchain network.

For transactions that expire before being added to the blockchain, one or more embodiments may implement specific handling procedures through an expiration handler component (1223), which may construct new records or transactions as replacements of original expired records or transactions; in at least one embodiment, such new records and/or transactions may include an “excludes” field referencing the original transaction, potentially preventing both transactions from being added to the blockchain simultaneously. Another component (1222) may create new transactions based on system events or requirements. The system may update a traditional database system (1226) when constructing new transactions, potentially implementing various strategies to ensure that the new transaction remains valid given current blockchain state. New transactions may be submitted to the mempool of the blockchain network (1221) for inclusion into the blockchain.

The system may also include a component (1219) for writing or transmitting wallet-generated records and/or transactions with the blockchain network (1221), as well as a component (1220) for writing or transmitting records and/or transactions that need to be re-submitted to the blockchain because they were eliminated in a prior reorganization.

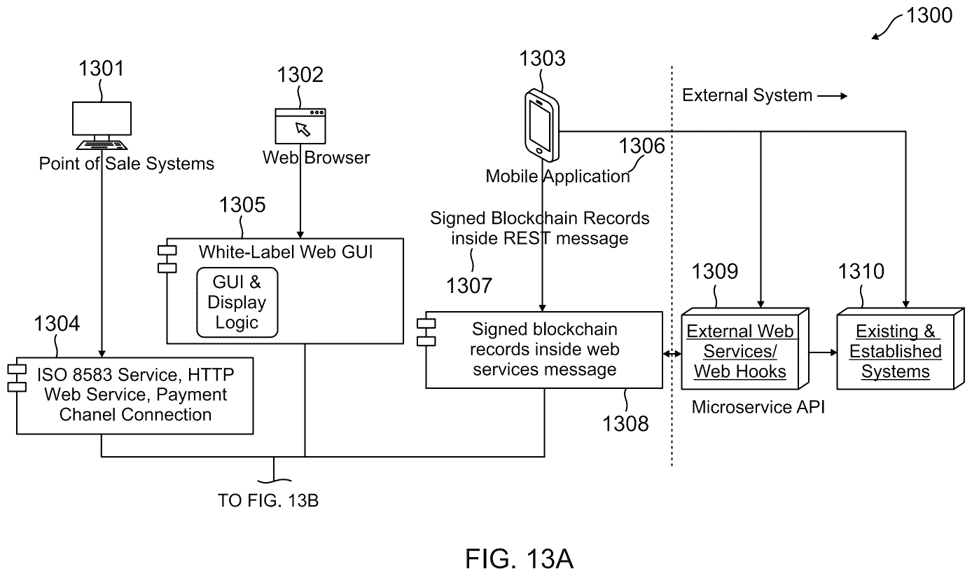

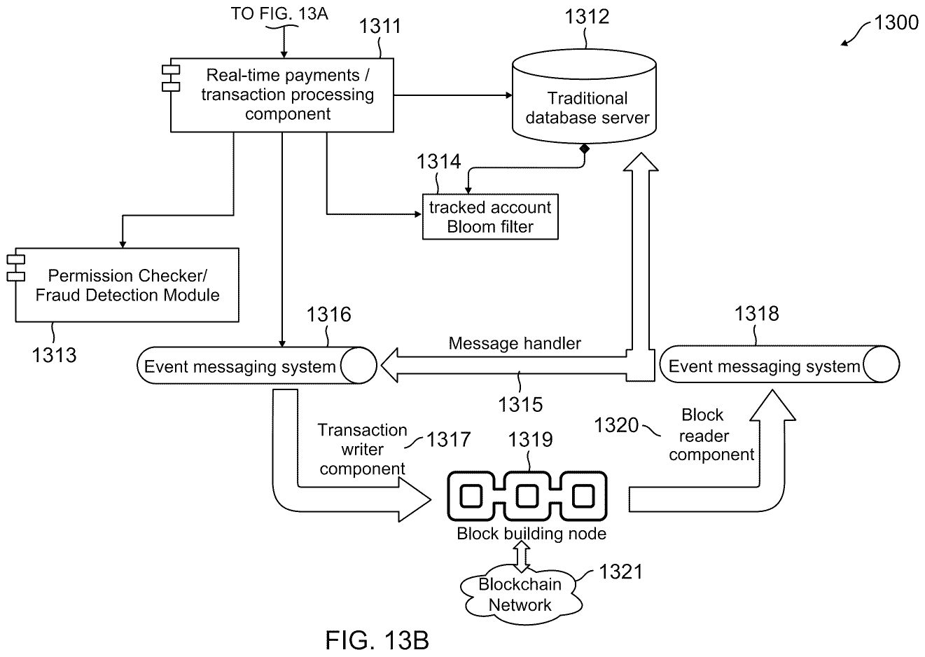

FIGS. 13A and 13B are diagrams of synchronization system (1300), according to an embodiment. The synchronization system 1300 may include a point of sale system (POS) (1301) comprising a user interface that provides means for, among other things, the acceptance and origination of payment transactions, payment messages, payment requests, and/or payment instructions. Said POS may relay such payment-related elements to—or coordinate regarding the origination of such payment-related elements with—a transaction processing component (1311) of the synchronization system (1300) using various interfaces and/or protocols, such as ISO 8583 service, HTTP web service, or payment channel connection (1304).

The synchronization system (1300) may also interface with a web browser (1302) displaying a White-Label Web GUI (1305) rendered by the synchronization system. In various embodiments, said White-Label Web GUI may implement a user interface providing user access to transaction history data and/or provide means to modify system configuration.

A mobile device (1303) acting as a wallet node may execute a mobile application (1306) which may generate, sign, send, and/or transmit one or more payment messages, payment transactions, blockchain records, blockchain transactions, and/or other messages or communications or combinations thereof. Such communications may include the transmission of signed blockchain records (1307) transmitted inside messages of a web service protocol, which in example embodiments may be implemented using, for instance, “representational state transfer” (REST) or “javascript object notation remote procedure calls” JSON-RPC or a similar HTTP or HTTPS protocol, or another networking protocol.

In certain embodiments, said mobile device (1303) may also communicate with one or more external systems (1309, 1310) which operate outside the synchronization system but connect to it via one or more web services or microservice APIs, including systems that may implement web Services and/or web hooks (1309) and other existing and established systems (1310).

In an example implementation, the POS (1301) may exchange HTTP web service message packets (or packets of another protocol) with a transaction processing component of the synchronization system (1311), in order to initiate a payment session and obtain a session identifier or request identifier. Said POS (1301) may render a QR code or other graphical encoding of payment instructions or a payment request, which may encode such details as a session identifier or request identifier. In certain embodiments, the POS may open and maintain a socket connection, which may be implemented as a WebSocket connection, with said transaction processing component, which socket connection may stay open for the duration of a payment session. The mobile device (1303) via the mobile application (1306) and using a camera of the mobile device may then capture a digital image of said QR code or said graphical encoding and interpret said payment instructions or said payment request, loading the details of said payment instructions or said payment request into a memory storage of said mobile device.

In an embodiment, said mobile application may display one or more details of said payment instructions or said payment request on a graphical display or screen of said mobile device, which details may also include merchant identifying information regarding the owner or controller of a merchant blockchain account, which merchant identifying information is also included in the details of said payment instructions or said payment request. The mobile application may retrieve account data or an account data structure of said merchant blockchain account by, for example, (a) sending a message or request—for example, in an embodiment, an HTTPS web service message such as a JSON-RPC request or REST request—to the synchronization system via the transaction processing component (1311), which may retrieve said account data or account data structure that has been cached in a traditional database server (1301), or (b) retrieving said account data structure from a blockchain global state by communicating with a block-building node integrated into the synchronization system (1319, connection not shown), or by communicating directly with another validator node or block-building node of the blockchain network (1321).

In various embodiments, the mobile application (1303) may compare the identifying information of the payment instructions or payment request with the account data or account data structure, and display a result of that comparison on the screen of said mobile device, warning a user of a mismatch and cautioning against proceeding against a transaction if there is a mismatch between the merchant identifying details encoded in the payment instructions or payment request, and the merchant identifying details encoded in the account data structure of the merchant blockchain account. In one or more embodiments, said comparison may comprise the comparison of a hash digest of a canonical encoding of said merchant identifying details, which hash digest may be calculated by the mobile application using the merchant identifying details encoded in the payment instructions or payment request, and which hash digest may be included in the account data structure of the merchant blockchain account.

In an example embodiment, said mobile application may, through a graphical user interface rendered on its graphical display or screen, present a user with an option to approve a payment conforming to the payment instructions or payment request, and upon user approval, said mobile application (1303), which may store one or more cryptographic keys of one or more wallet blockchain accounts in a memory of the mobile device, may use said one or more keys to cryptographically sign one or more blockchain records and/or transactions authorizing a transfer of tokens from a wallet blockchain account to said merchant blockchain account. Said mobile application may then encapsulate the one or more blockchain records inside one or more network messages (for example, a web service message such as a REST message or JSON-RPC message, or another type of network message) (1307) and send such messages to said transaction processing component (1311), to be processed as a payment satisfying the payment instructions or payment request of said POS (1301). In one or more embodiments, said one or more blockchain records or said one or more web service messages may incorporate or encode the session identifier or request identifier of the original payment instructions or payment request.

Said messages and/or signed blockchain records and/or transactions (1307) sent by said mobile application (1306) to said transaction processing component (1311) may be submitted by the transaction processing component to a permission checking/fraud detection module (1313), which may perform a risk assessment calculation or other evaluation to estimate or determine a probability or a risk metric that the payment effectuated by said messages, records and/or transactions may be reversed subsequent to initial acceptance, if it is accepted. In certain embodiments, said evaluation may incorporate a consultation of an available balance of said wallet blockchain account, which may or may not be tracked in a traditional database; if the available balance less the payment amount is less than zero, then the message, record or transaction will be rejected. In various embodiments, said probability or risk metric may represent a probability (a) that a blockchain record and/or transaction may become invalid or may be otherwise blocked as a result of a blockchain reorganization or other blockchain events or operations, and/or that (b) upon final asynchronous evaluation and execution by a block-building node, that the wallet blockchain account will have insufficient funds and cause the record or transaction to be invalid, blocking the payment within the blockchain. In certain embodiments, said fraud detection module may be configured to include a machine-learning model trained on a dataset that includes, for example, fraudulent and non-fraudulent messages, records and transactions, a history of blockchain records and/or transactions, a history of blockchain reorganization events, and/or other transactional or behavioral data.

In one or more embodiments, provided that said permission checking/fraud detection module (1313) calculates a probability value or a risk metric within an acceptable threshold, and otherwise does not deem a message, record or transaction invalid or unacceptable, said transaction processing component may perform one or both of the following actions: (a) insert or update various data in the traditional database server (1312); and/or (b) cause one or more messages, events, records and/or transactions to be written as entries to an event messaging system (1316), which entries will ultimately be read and processed by a transaction writer component (1317). In one or more embodiments, successful processing of said entries by said transaction writer component (1317) will result in one or more records and/or transactions being submitted to the block-building node (1319) (i.e. “endogenous payments”) for promulgation to the blockchain network (1321) and ultimate execution and inclusion into the blockchain.

In one or more embodiments, upon successfully updating the traditional database server and/or adding entries to the event messaging system, the transaction processing component (1311) may transmit a message to the POS system (1301) indicating that the payment associated with said session identifier or request identifier was completed, which session identifier or request identifier said transaction processing component may read from the messages and/or signed blockchain records and/or transactions (1307) sent by said mobile application (1306).

In certain embodiments, the mobile application (1303), upon receiving payment approval from a user, rather than sending a one or more messages, records and/or transactions (1307) to the transaction processing component (1311), the mobile application will transmit one or more blockchain records and/or transactions directly to a block building node or validator node of the blockchain network (1321) in order to satisfy the payment instructions or payment request, which record and/or transactions will ultimately be processed as exogenous transactions.

In one or more embodiments, the mobile application may submit a record or transaction directly to the blockchain network (i.e. an “exogenous payment”) in order to satisfy the payment instructions or payment request of the POS system may incorporate or encode a session identifier or request identifier corresponding to the payment instructions or payment request. An exogenous payment may be incorporated into a new block by a block-building node (1319), which block may be read by a block reader component (1320), which will write the block details, including the exogenous payment, into an event messaging system (1318). A message handler (1315) may subsequently read the exogenous payment from the event messaging system (1318) and then write to the traditional database server (1312) relevant data with regards to the exogenous payment, updating status.

The transaction processing component (1311), upon detecting an update made to the traditional database server (1312) reflecting the completion of the pending payment corresponding to the session identifier or request identifier (1312), or otherwise being notified of the exogenous payment, may then transmit a message to the POS system (1301) indicating that the payment associated with said session identifier or request identifier was completed. In an alternate embodiment, the message handler itself, or a separate component invoked by the message handler, may communicate such an update to the POS system regarding the completion of the payment associated with the session identifier or request identifier, instead of the transaction processing component.

In various embodiments, a notification regarding the completion and/or satisfaction of payment instructions or payment requests, which completion and/or satisfaction is achieved by the incorporation into the blockchain of one or more cryptographically signed blockchain records and/or transactions authorizing a transfer of tokens from a wallet blockchain account to a merchant blockchain account-which records and/or transactions may be exogenous, or, alternately, exogenous—may be sent to the POS system after the block containing said one or more records and/or transactions reaches finality, or before it reaches finality, based on a configuration of the synchronization system (1300), or based on a risk determination made by the transaction processing component or the permission checker/fraud detection model.

According to some embodiments, in the event of a reorganization, the message handler (1315) will also serve the purpose of adding to the event messaging system (1316) one or more records and/or transactions that have been removed from the blockchain as a result of the reorganization, which removed records and/or transactions may be resubmitted to the Block-building node (1319) by the transaction writer component (1317).

In at least one embodiment, the one or more synchronization systems may optionally maintain separate data structures for tracking pending transactions, finalized transactions, and/or transactions that may require reconciliation due to reorganization events. In some embodiments, the synchronization system may comprise, incorporate, interact with, connect to, and/or use one or more event streaming platforms or publish-subscribe messaging systems, which individually and collectively may be referred to herein as “event messaging systems”, and which systems may include without limitation message brokers, event logs, message buses, and other messaging infrastructures, examples of which may include, but are not limited to, Apache Kafka, RabbitMQ, Apache Pulsar, Amazon Kinesis, Google Cloud Pub/Sub, or similar capabilities implemented in a more generalized database such as an RDBMS, object oriented database, etc. In one or more embodiments, such one or more event messaging systems may provide guaranteed message delivery and order preservation, and/or may be capable of retaining messages for configurable periods of time, and/or may be designed to handle real-time data flows.

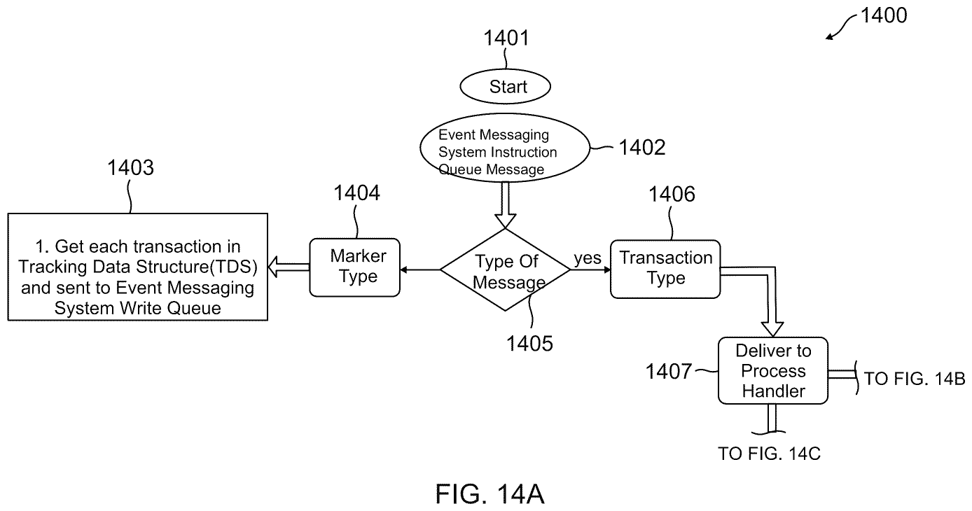

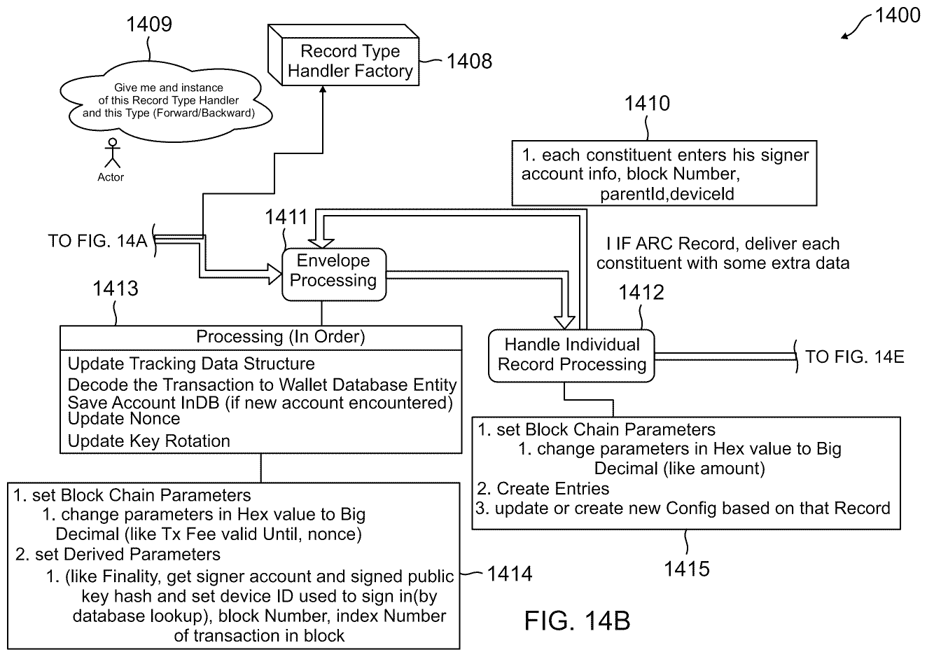

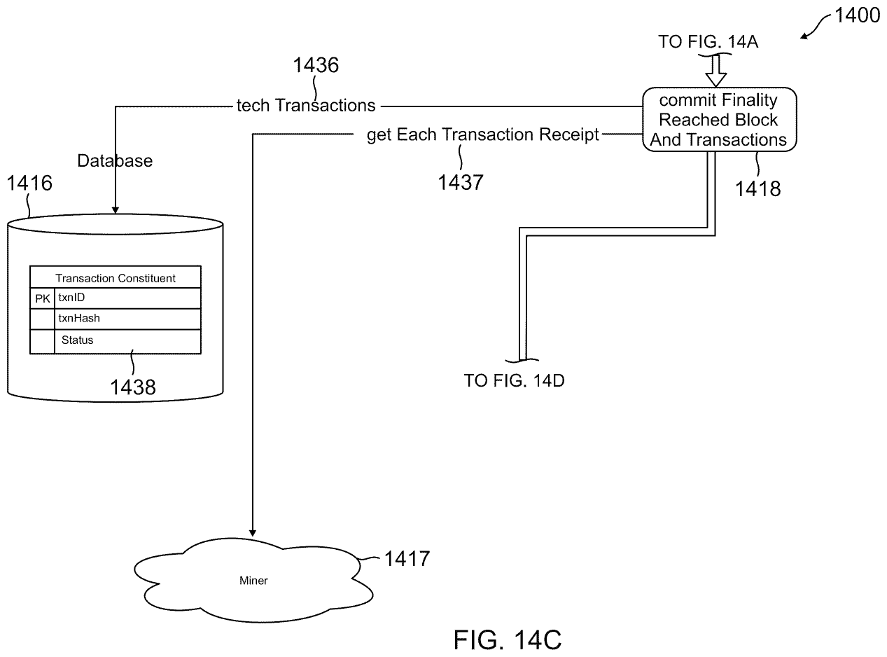

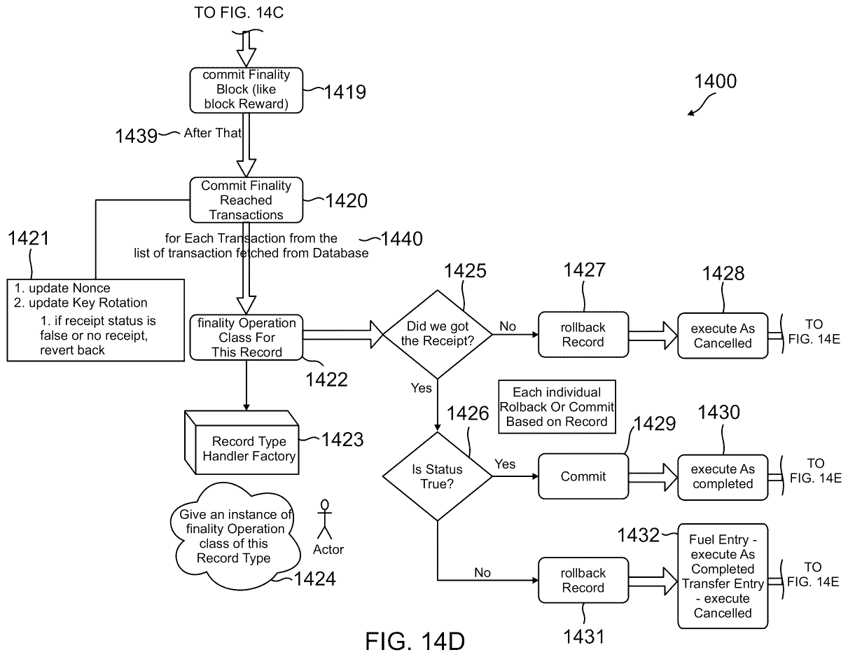

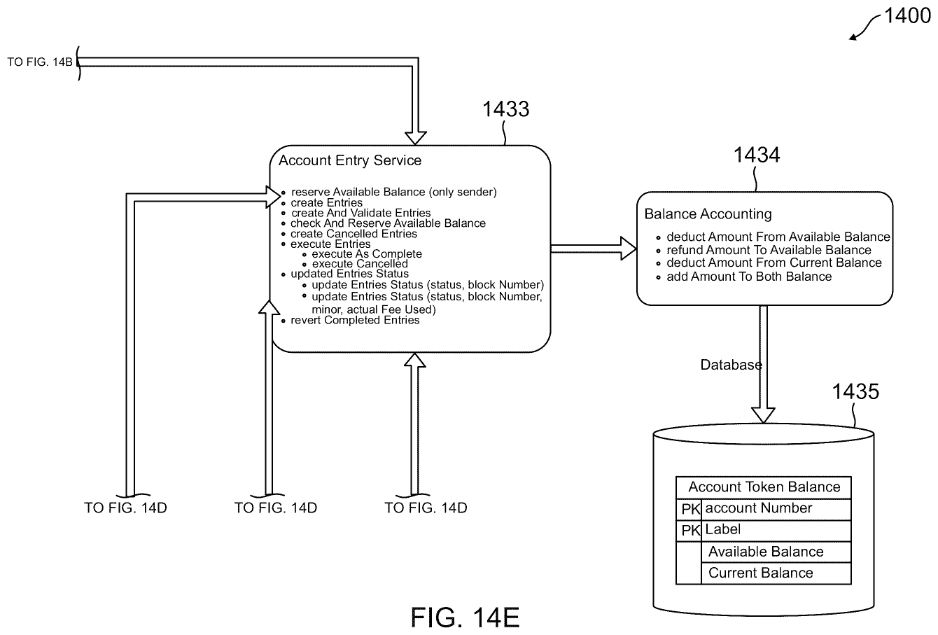

FIGS. 14A-14B are diagrams of an example implementation of a synchronization system 1400 including a distributed data streaming platform that can store, process, and analyze transaction data in real time (event messaging system), according to an embodiment. The synchronization system is initialized 1401, and the distributed data streaming platform that is configured to generate an instruction queue message 1402 (event messaging system message), such as, Apache Kafka, RabbitMQ, Apache Pulsar, Amazon Kinesis, Google Cloud Pub/Sub, or similar capabilities implemented in a more generalized database such as an RDBMS, object oriented database, etc. In an embodiment, the instruction queue message may be configured with a specific topic that acts as an instruction queue, essentially containing commands or directives for a system to perform a specific action, where each message is processed in order by one or more users within a consumer group, effectively creating a queue-like behavior within the publish-subscribe model of event messaging system.

In an embodiment, one example technical advantage of integrating an event messaging system in the synchronization system 1400 as an instruction queue is its exceptional ability to handle high volumes of messages with low latency, making it ideal for real-time data streaming and processing in the synchronization system 1400. Further, the synchronization system 1400 may be configured to utilize event messaging system messages to help improve scalability, fault tolerance, and durable message storage. In this way, the synchronization system 1400 can provide reliable data delivery even in implementations of large-scale distributed systems; this may be beneficial for this example embodiment of the synchronization system 1400 as it may be configured with event-driven architecture, while utilizing log aggregation and real-time analytics, in various embodiments.

At 1404-1406, the type of event messaging system message is assessed by the synchronization system 1400. Event messaging system messages typically consist of a variable-length header, a variable-length opaque key byte array and a variable-length opaque value byte array and have an associated API. The data type of the event messaging system message may be assessed from the event messaging system topic, from which the synchronization system 1400 can determine the message format, which provide information about, among other things, the appropriate APIs, the wire protocol, or the on disk storage associated with the event messaging system message.

For example, in a possible embodiment, event messaging system messages may be written in batches (record batches). A record batch contains one or more records. In a degenerate case, a record batch may contain a single record. When assessing the type of event messaging system message, in an embodiment the synchronization system 1400 may process the event messaging system message's CRC and CRC32. Said CRC may cover the data from the attributes to the end of the batch, and may be located after the magic byte. The synchronization system may configure the clients to parse the magic byte before deciding how to interpret the bytes between the batch length and the magic byte. In an example embodiment, the partition leader epoch field may not typically be included in the CRC computation of the event messaging system to avoid the need to recompute the CRC when this field is assigned for every batch that is received by the broker. The CRC-32C (Castagnoli) polynomial may be used for such computation, in an example implementation.

At 1403, the event messaging system tracking data structure is computed, which is a specialized data structure used to keep track of the offset (position) of a consumer within a topic partition, essentially remembering where a consumer left off reading messages within a specific partition to ensure efficient message processing and prevent data loss.

At 1407, the event messaging system message is delivered to the process handler where envelope processing 1411, 1414 is handled. At 1412, the process handler performs individual record processing, and blockchain parameters are configured at 1415. The process handler further assesses signer account info, blockch number, parentld, and deviceID 1410. If the event messaging system message includes ARC Record at 1412, the process handler delivers each constituent with extra data and sets the blockchain parameters at 1415. A constituent ARC record is configured as a single, individual piece of data that makes up a larger, complex message, essentially a building block within a structured event messaging system message that can be processed independently within a stream processing pipeline.

At 1433, the account entry service process of the synchronization system, 1400 is executed, which may include the following processes and configurations (1) reserving Available Balance (only sender), (2) creating entries, (3) creating and validate entries, (4) checking and reserving available balance, (5) creating cancelled entries, (6) executing the entries, (7) executing as complete, (8) executing cancelled, (9) updating entries status, (10) updating entries status (status, block number) updating entries Status (status, block Number, minor, actual fee used), and (11) reverting completed entries.

At 1434, accounting is performed by the synchronization system 1400, where the following processes and configurations may be performed (1) deducting amount from available balance, (2) refunding amount to available balance, (3) deducting amount from current balance, (4) adding Amount To Both Balance. At 1435, the account token balance is stored to one or more off-chain databases or external data management systems.

The process handler at 1418-1424 commits block finality, meaning that the transaction is confirmed and added to a blockchain's block, and the transaction receipt 1437 is sent to the minor 1417.

At 1436, this blockchain state change is recorded on the event messaging system data mesh architecture of the synchronization system 1400, including the blockchain ledger and one or more off-chain databases or external data management systems. The reward for the blockchain building node (minor) 1419 is committed, such as a reward block. At 1439, the synchronization system 1420, 1421, 1422, 1423 commits finality for each transaction fetched 1440, and the synchronization system 1400 checks ensures that a receipt is generated 1425-1432.

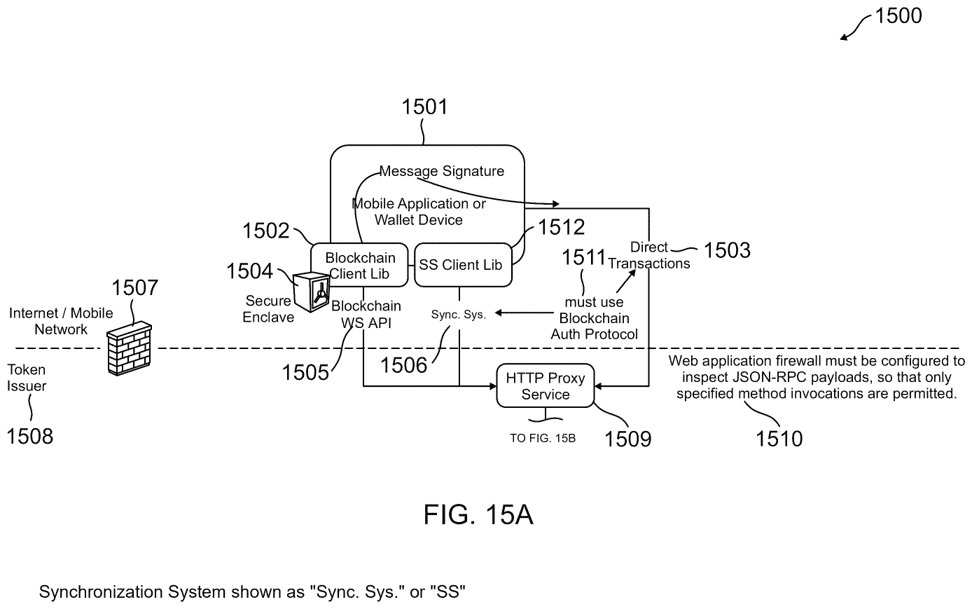

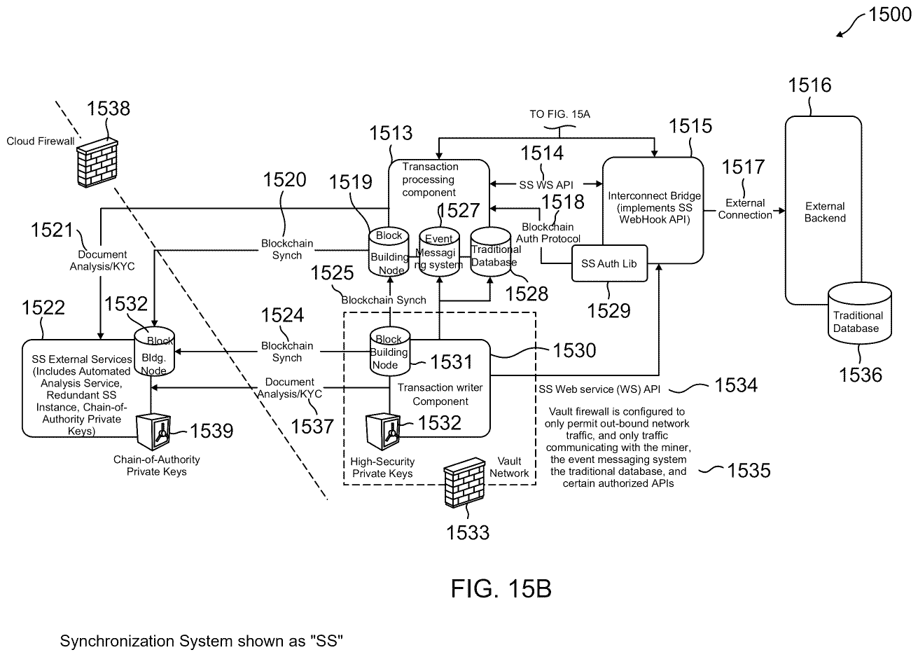

FIGS. 15A and 15B are diagrams of synchronization system architecture, according to an embodiment. The synchronization system 1500 includes a mobile application or wallet device 1501, which is configured to interface with the synchronization system client library 1512, blockchain client library 1502, and secure enclave 1504. The synchronization system 1500 configures the mobile application/wallet device 1501, client library 1502 to interface with the blockchain API 1505 and token issuer 1508 using the internet/mobile network 1507 through the HTTP Proxy Service 1509 via Wallet Link RPC API 1506. The mobile application or wallet device 1501 may be configured by the synchronization system 1500 to direct transactions 1503 to the HTTP Proxy Service 1509 with the token issuer 1508. The web application firewall 1510 at the internet/mobile network 1507 may be configured to inspect JSON-RPC payloads so that only specified method invocations are permitted. The synchronization system 1500 may be configured to interface with interconnect bridge 1515, which implements the synchronization system WebHook API. The transaction processing component 1513 can be configured to interface with a blockchain KYC utility compliance system 1521 to provide document analysis, ensure KYC compliance, limit fraud, money laundering, terrorist financing, and other illegal and other illicit activities. The synchronization system 1500 can be configured to execute external services, such as automated analysis service, redundant instance, chain-of-authority private keys at 1522 through the cloud firewall 1538. The synchronization system 1500 may include block building node 1531, transaction writer component 1532, and the chain-of-authority private keys 1539. The interconnect bridge 1515 may communicate via an external connection 1517 with the external backend 1516 and various databases 1536. The transaction processing component 1513 may interface with a block building node 1519, an event messaging system 1527, and databases 1528. Block building node 1519 processes may cause a blockchain synch 1520. Through an interconnect bridge 1515, the transaction processing component 1513 may access to a synchronization system authentication library 1529. The transaction writer component 1530 may interface with a vault network 1533, high-security vault keys 1532 and a blockchain building node 1531.

### Digital Processing Systems

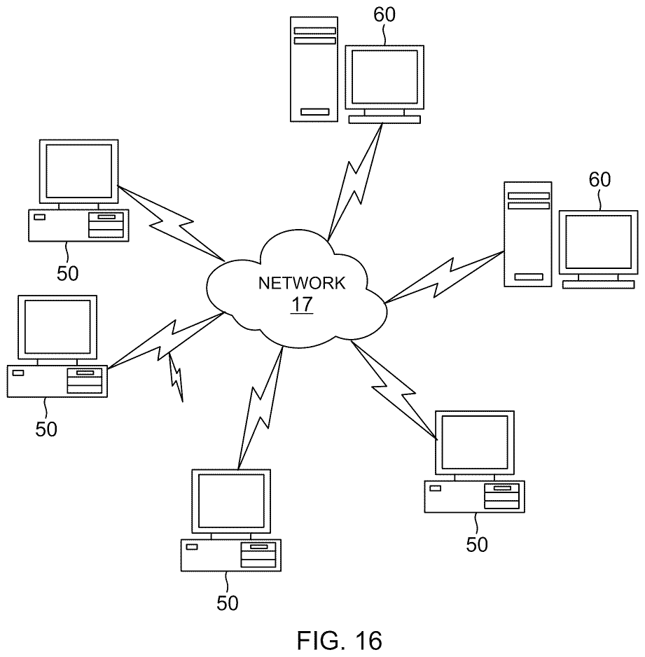

FIG. 16 is a schematic view of a computer network in which embodiments may be implemented.

Client computer(s)/devices 50 and server computer(s) 60 provide processing, storage, and input/output (I/O) devices executing application programs and the like. The server 60 may be a gateway or a persistent server. Client computer(s)/device(s) 50 can also be linked through communications network 70 to other computing devices, including other client device(s)/processor(s) 50 and server computer(s) 60. Communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are suitable.

In certain embodiment of the present invention, at least one wallet node may be implemented as software application executing on a client computer (50), which wallet node may implement a zero-knowledge proof prover. Said wallet node (50) may execute said zero-knowledge proof prover so as to generate a zero-knowledge proof; said wallet node may then incorporate said zero-knowledge proof into a zero-knowledge record, which it may then submit for processing over a computer network (17) to one or more block-building nodes comprising one or more servers (60) connected to said network. Said one or more block-building nodes may then verify said zero-knowledge proof though the use of a zero-knowledge proof verifier software executing within the computer memory of said server (60).

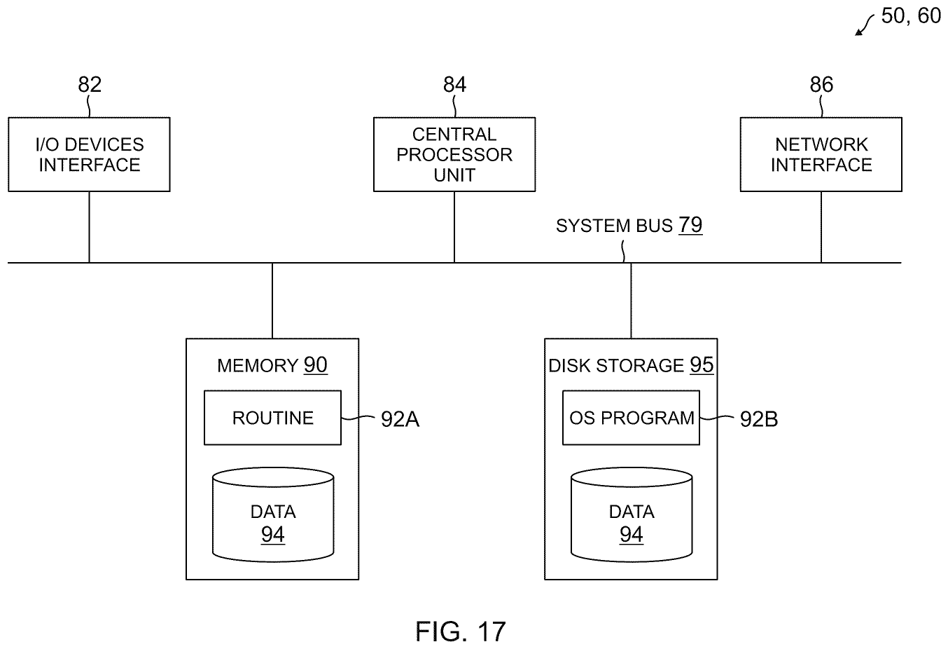

FIG. 17 is a block diagram illustrating an example embodiment of a computer node (e.g., client processor(s)/device(s) 50 or server computer(s) 60) in the computer network 70 of FIG. 16. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 16). A memory 90 provides volatile storage for computer software instructions 92a and data 94a used to implement an embodiment of the present disclosure. A disk storage 95 provides non-volatile storage for the computer software instructions 92b and data 94b used to implement an embodiment of the present disclosure. A central processor unit 84 is also attached to the system bus 79 and provides for execution of computer instructions.

Software components 92A, 92B of the computer-implemented system may be configured using any known programming language, including any high-level, object-oriented programming language or configured in firmware. The computer-implemented system may include instances of processes that enable execution of transactions and recordation of transactions. The computer-implemented system may include instances of a blockchain software components described herein, which can be implemented a computing device that communicates with the blockchain network, for example, through a blockchain protocol, secure sockets layer (SSL), or any other suitable protocol. The computer-implemented system may be configured with blockchain software components 92A, 92B that can help enable implementations disclosed herein, such as payment channel liquidity, payment channel permissioning, safe offline payment channel availability, zero-knowledge permissioning, anchor blocks, block-building and protocol validation functions, message signing protocol, and consensus protocols.

In an example mobile implementation, a mobile agent implementation may be provided. A client-server environment can be used to enable mobile services. It can use, for example, the Extensible Messaging and Presence Protocol (XMPP) to tether a wallet on the device 50. The blockchain network or a server 60 can then issue commands to the mobile device on request. The mobile user interface framework used to access certain components of the computer-implemented system may be based on XHP, Javelin, or WURFL. In another example mobile implementation for OS X and iOS operating computer-implemented systems and their respective APIs, Cocoa and Cocoa Touch may be used to implement the client-side components using Objective-C or any other high-level programming language that adds Smalltalk-style messaging to the C programming language.

An example embodiment includes device code 92A, 92B executed in the trusted execution environment (TEE) or trust platform module (TPM). The TEE or TPM is a hardware environment that runs instructions and stores data outside the main operating computer-implemented system (OS) of a device. This protects sensitive code and data from malware or snooping with purpose-built hardware governed by an computer-implemented system of endorsements, beginning with the device manufacturer. The computer-implemented system may perform checks on the TEE or TPM, such as executing BIOS checks, to verify that the folders (e.g., wallets) stored in the TEE/TPM have not been altered by malicious actors.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein.

In one embodiment, the processor routines 92a-92b and data 94a-94b are a computer program product (generally referenced as 92), including a computer readable medium (e.g., a removable storage medium such as DVD-ROM(s), CD-ROM(s), diskette(s), tape(s), etc.) that provides at least a portion of the software instructions for the disclosure system. Computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network (such as the network 70 of FIG. 16). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a Software as a Service (SaaS) implementation, or other installation or communication supporting end-users.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

### Quick Response (QR) Embodiment

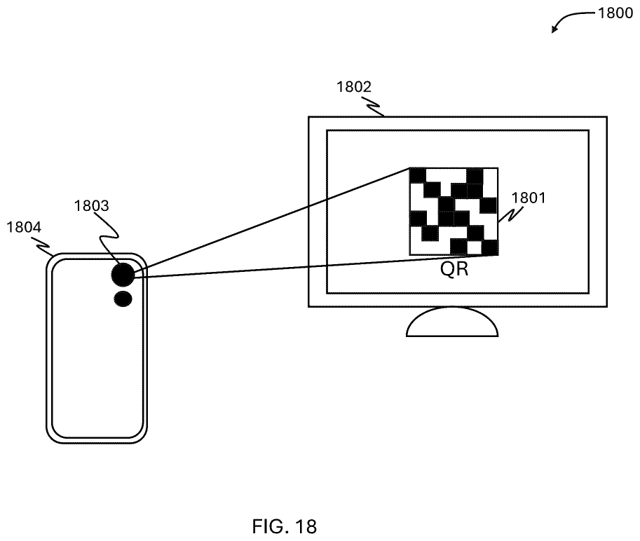

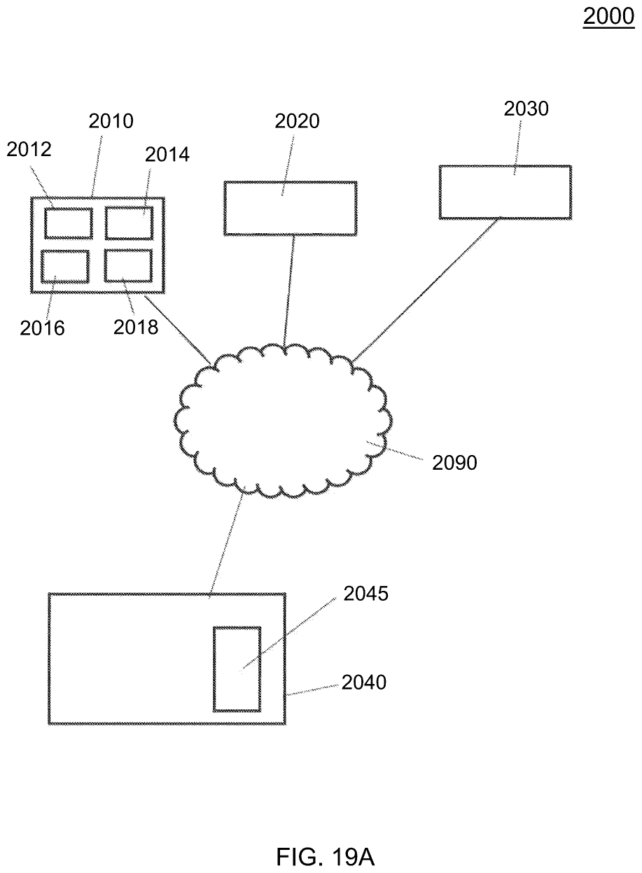

At least one embodiment is directed toward a computer-implemented method 1800 for accepting electronic payment. FIG. 18 shows a diagram illustrating an embodiment wherein a mobile device, such as a cell phone, captures a quick response (QR) code shown on a computer screen. The method includes a point-of-sale computer device 1802, at least one authorization computer devices (which in certain embodiments may constitute, comprise or form a part of a synchronization system), and a consumer smartphone 1804 with at least one camera 1803, and a processor and memory with computer code instructions stored thereon. The method connects the point-of-sale computer device to a packet-switched computer network, as well as connecting the at least one authorization computer devices to the packet-switched computer network, and the smartphone to the packet-switched computer network.

The point-of-sale computer device may have at least one graphical display. The method configures the point-of-sale computer device to share a session identifier with the at least one of the one or more authorization computer devices. The point-of-sale consumer device then will display, a graphical encoding of a payment request 1801 (e.g., a QR code), wherein the graphical encoding of the payment request comprises an encoding of the session identifier (which may also be a request identifier in certain embodiments). The smart phone will capture an image of the graphical encoding of the payment request. The smart phone will display a user-acceptance message, wherein the message requests acceptance of the payment request by a user of the consumer smart phone. The user of the smartphone may then accept the payment request using the smart phone, and the phone will indicate acceptance of the payment request.

The method constructs a data record configured to encode a payment instruction to conform to the payment request, wherein the data record encoding of the payment instruction encodes the session identifier (which in certain embodiments may be a request identifier) and transmits the data record to at least one of the one or more authorization computer devices via the packet-switched computer network. The at least one of the one or more authorization computer devices is configured to perform a verification of the correctness and authenticity of the payment instruction encoded in the data record. The point-of-sale computer device is configured to receive, via the packet-switched computer network, a confirmation that the correctness and authenticity of the payment instruction encoded in the data record has been verified.

In an embodiment, a cryptographic signature of the data record may be attached to the data record prior to transmission to the one or more authorization computer devices. The cryptographic signature may be generated using an asymmetric cryptographic signature algorithm, and the cryptographic signature may be generated generated using a private key corresponding to a public key stored in a data storage of at least one of the one or more authorization computer devices.

In an embodiment, the public key may correspond to a money balance stored in at least one of the one or more authorization computer devices; and wherein the verification of the correctness and authenticity of the payment instruction encoded in the data record may comprise a verification that the cryptographic signature is valid and was generated with a private key corresponding to said public key.

In an embodiment, the at least one of the one or more authorization computer devices is a blockchain validation computer device hosting a blockchain validation software program. The blockchain validation software program is configured to maintain a connection to one or more additional blockchain validator computer devices hosting one or more additional blockchain validation software programs. The blockchain validator computer devices are connected to the packet-switched computer network. The data record is a blockchain data record, the acceptance of which by the blockchain configured to effectuate a change to a global state of the blockchain.

In an embodiment, the data storage comprises an encoding of the blockchain's global state, and wherein the data record is configured to encode a transformation to the blockchain's global state.

In an embodiment, the point-of-sale computer device is configured to open a socket connection to at least one of the one or more authorization computer devices before displaying on the graphical display the graphical encoding of the payment request.

In an embodiment, the point-of-sale computer device, after displaying the graphical encoding of the payment request on the graphical display, is configured to poll at least one of the one or more authentication computer devices, sending in reference to the session ID.

In an embodiment, wherein the point-of-sale computer device is configured as part of a cash-register system at a physical retail location.

In an embodiment, wherein the point-of-sale computer device is a personal computer, the personal computer being configured to execute a web browser software, and wherein the graphical representation of the payment request is displayed in a graphical-user-interface window of the web browser software.

### Zero Knowledge Systems

In an embodiment, at least one record or transaction may be configured as a zero-knowledge record or transaction encoding of a zero-knowledge state transformation description. The encoding of the zero-knowledge record may include at least the following elements: (1) one or more addresses or paths identifying or referencing the one or more locations of the elements of a discrete data subset within the global state, which discrete data subset comprises either a contiguous subset or a non-contiguous subset of the data comprised by the global state, (2) a revised data subset, representing a new revised version of some portion of or subset of said discrete data subset, or (3) a transition proof implemented as a non-interactive zero-knowledge proof, which transition proof proves that the transition from the discrete data subset to the revised data subset follows the established rules of the blockchain system.

In an embodiment, a zero-knowledge record may include at least one of: (1) the discrete data subset itself, (2) one or more cryptographic hashes of one or more elements of the discrete data subset, or (3) both the discrete data subset and one or more cryptographic hashes of one or more elements of the discrete data subset. The transition proof may be configured to correspond to one of a set of pre-defined transition types for which corresponding non-interactive zero-knowledge proofs may be generated. Each pre-defined transition type may be configured to correspond to an encoded state-transition implementation encoded as a zero-knowledge algorithmic encoding. The encoded state-transition implementation may be configured to receive certain data as input, and generates certain data as output, and where a portion of the input data is private input data, and the remainder of the input data is public input data. The public input data may be configured to include the discrete data subset. The output of the encoded state-transition implementation is the revised data subset.

In an embodiment, the transition proof may be generated by a process that includes: (1) a compilation step where the zero-knowledge algorithmic encoding is compiled into a set of polynomial equations, and (2) evaluation of the polynomials at one or more random points, producing values that are included in the transition proof.

In one or more embodiments, said transition proof may be generated through any zero-knowledge proof system or method which implements the requisite features and capabilities, including zero-knowledge succinct non-interactive argument of knowledge (zk-SNARK) systems or methods, and/or a zero-knowledge succinct transparent argument of knowledge (zk-STARK) systems or methods. See, for example, U.S. Provisional Application No. 63/608,018, filed on Dec. 8, 2023, Appendix (Zero-Knowledge Succinct Transparent Argument of Knowledge (zk-STARK)), which is incorporated herein by reference in its entirety.

In various embodiments, methods and systems for validating and accepting zero-knowledge records and/or transactions may be provided. A validating computer may be configured to store the blockchain's global state in a retrievable storage medium. A wallet computer node, connected to the validating computer node via a computer network, may be configured to generate a new zero-knowledge record. The validating computer node may be configured to receive the zero-knowledge record from the wallet computer node, and may subsequently perform validation of the zero-knowledge record. Such validation may include configuring the validating node to retrieve a retrieved data subset from the global state, which may be a subset of global state data that corresponds to the discrete data subset referenced or included in the zero-knowledge record. The validating node may be configured to verify that the discrete data subset included in the zero-knowledge record or referenced by the zero-knowledge record is equivalent to the retrieved data subset. The validating node may be configured to verify that the non-interactive zero-knowledge proof is valid when verified combination with the discrete data subset (or retrieved data subset) and revised data subset—and possibly in combination additional Public Input Data included with the zero-knowledge record in certain cases.

In an embodiment, in the case that the non-interactive zero-knowledge proof is successfully verified and the zero-knowledge record is deemed valid, the validating node may be configured to replace some portion of the discrete data subset with elements of the revised data subset, where the portion of the discrete data subset that is replaced by elements of the revised data subset is decided according to which pre-defined transition type the non-interactive zero-knowledge proof corresponds to. The discrete data subset may be configured to include at least one permission encoding, which permission encoding either is itself interpretable by the encoded state-transition implementation, or is transformed into an equivalent format interpretable by the encoded state-transition implementation. The permission encoding, or a transformation thereof, may be interpreted or evaluated within the encoded state-transition implementation.

In an embodiment, a state transformation corresponding to the encoded state-transition implementation is undertaken only if the permission encoding is interpreted or evaluated with a result indicating that said state transformation is permitted. The permission encoding may comprise a logical function encoded as interpretable or executable computer code. The logical function may be configured to accept one or more permission inputs and the logical function is configured to output a permission output. The permission output may correspond to either a permitted transition status or a not-permitted transition status, given the one or more permission inputs. The state transformation corresponding to the encoded state-transition implementation may be undertaken only in cases where the permission output given the one or more permission inputs corresponds to the permitted transition status, and the state transformation may not be undertaken in cases where the permission output given the one or more permission inputs corresponds to the non-permitted transition status. One or more permission inputs may comprise a subset of the public input data and private input data received by the encoded state-transition implementation. The logical function, or a transformation thereof may be configured into an equivalent format interpretable by the zero-knowledge algorithmic encoding, and may be interpreted or executed within the zero-knowledge algorithmic encoding. An example implementation of a zero-knowledge algorithmic encoding (e.g., Arithmetic Circuit) is disclosed in U.S. Provisional Application No. 63/608,018, filed on Dec. 8, 2023 Appendix 4, incorporated herein by reference in its entirety. In an embodiment, the zero-knowledge algorithmic encoding may be implemented in a CPU with embedded Zero Knowledge Processing Unit (ZPU) and programmable hardware accelerator. This hybrid CPU/ZPU may be optimized to improve packet processing for verifying blockchain transactions using zkSNARK transaction processing.

In an embodiment, the non-interactive zero knowledge proof may be deemed valid only in the case where the logical function outputs a value corresponding to the permitted transition status within the zero-knowledge algorithmic encoding. In the event the permission encoding comprises a pattern encoding, the state transformation corresponding to the encoded state transformation implementation may be permitted only in the case that the pattern encoding matches at least a portion of the private input data, or a portion of the public input data, or a combination thereof. The pattern encoding, or a transformation thereof may be configured into an equivalent format interpretable by the zero-knowledge algorithmic encoding, which may then be compared to a portion of the input data received by the zero-knowledge algorithmic encoding, within the zero-knowledge algorithmic encoding itself, and in which the transition proof is verified successfully only in the case where the pattern encoding matches said input data within the zero-knowledge algorithmic encoding. The discrete data subset may include one or more account records, each account record including one or more private ledgers, each private ledger comprising at least one cryptographic hash digest the preimage of which is an unmasked private ledger, which at least one unmasked private ledger contains one or more token balances. At least one unmasked private ledger may be implemented as a Hash Tree or Merkle Tree, where the root of the tree corresponds to the private ledger's cryptographic hash digest. At least one unmasked private ledger may be implemented as a Merkle Trie or Merkle Patricia Trie, where the root of the trie corresponds to the private ledger's cryptographic hash digest. At least one unmasked private ledger may be implemented as a Merkle Proof or partial Merkle Tree or partial Merkle Patricia Trie, and where the root of the proof, tree or trie corresponds to the private ledger's cryptographic hash digest. The private input data may include the at least one unmasked private ledger, which at least one unmasked private ledger is excluded from the discrete data subset and from the public input data; and where the private input data also includes information regarding at least one quantity of tokens.

In an embodiment, the encoded state transformation implementation may be configured as a private state transformation. The encoded state transformation implementation computing at least one derived hash, which derived hash is the cryptographic hash of the at least one unmasked private ledger. The encoded state transformation implementation may be configured to determine that such at least one derived hash equals the at least one cryptographic hash digest of the private ledger which corresponds to that at least one unmasked private ledger. The encoded state transformation implementation may be configured to modify the unmasked private ledger in a manner consistent with the token quantity information included in the private input data. The encoded state transformation implementation may be configured to compute a revised cryptographic hash digest of the modified unmasked private ledger, which revised cryptographic hash digest corresponds to the output of the encoded state transformation implementation. The private state transformation may be configured to include a computational process whereby at least one permission encoding included in the public input data is evaluated in combination with a portion of the input data received by the encoded state transformation implementation, whereby the state transformation corresponding to the encoded state transformation implementation is only undertaken if the permission encoding is interpreted or evaluated in a manner indicating that said state transformation is permitted. The zero-knowledge record may be accepted and included in the blockchain only in the case where one or more permission encodings included in the record's discrete data subset are interpreted or evaluated in a manner indicating that the state transformation corresponding to the zero-knowledge record is permitted.

In an embodiment, the validating computer may be configured to replace at least one cryptographic hash digest of the one or more account record's one or more private ledgers in the global state with the revised cryptographic hash digest if the zero-knowledge record is accepted and included in the blockchain.

### Zero-Knowledge-Encoded Global State Transformations

One or more non-limiting embodiments of the present invention comprises blockchain systems that comprise block-building nodes evaluating zero-knowledge records and/or zero-knowledge transactions which records and/or, when valid, encodes transformations to the global states of said blockchain systems.

In one or more possible such embodiments, transformations to said global state may be effectuated by the inclusion of one or more zero-knowledge records and/or zero-knowledge transactions in one or more blocks added to the blockchain. In at least one embodiment, a zero-knowledge record or zero-knowledge transaction is a blockchain record or blockchain transaction that encodes a global state transformation in the form of a non-interactive zero-knowledge proof, which non-interactive zero-knowledge proof comprises updates and modifications to the global state, to which updates and modifications to the global state may be confirmed to be valid through the verification of the zero-knowledge proof.

In one or more embodiments, said zero-knowledge records and/or transactions may improve the execution speed of blockchain systems by reducing the time required to assess the validity of records and/or transactions added to the blockchain, and by reducing the time required to apply the global state transformations encoded by said records and/or transactions. In certain configurations, said zero-knowledge records and/or transactions may also improve the privacy of blockchain systems by allowing certain values to be hidden which might otherwise be public on the blockchain. One or more embodiments of the present invention may also incorporate the interpretation of permissioning constraints into the creation and verification of zero-knowledge proofs, which zero-knowledge interpretation of permissioning constraints may permit a public proof of compliance with regulatory requirements to be publicly posted on a public blockchain without revealing publicly the details of a blockchain record and/or transaction.

In one or more embodiments, one or more zero-knowledge record types and/or zero-knowledge transaction types trigger one or more types of transformation to the global state, such that global state transformations of said type occur when records and/or transactions of said types are added to the blockchain following one or more validations of said records and/or transactions, whereby said one or more validations are performed by evaluating a non-interactive zero-knowledge proof included in the encoding of said one or more zero-knowledge records and/or transactions.

In one or more embodiments, relevant elements of the initial global state prior to state transformation may be included as public inputs to the non-interactive zero-knowledge proof's algorithmic encoding, and updates and modifications to the blockchain global state that result from said global state transformation may be included among public outputs of the algorithmic encoding. In an embodiment, a zero-knowledge record and/or transaction comprises these inputs and outputs, as well as the non-interactive zero-knowledge proof demonstrating that said state transformation is valid.

In one or more alternate embodiments, updates and modifications to the blockchain global state that result from said global state transformation may be included among public inputs of a algorithmic encoding, and a public output of the of the zero-knowledge algorithmic encoding may comprise a Boolean values, an integer, or some other data element or elements that result from a confirmation that the updates and modifications to the blockchain global state are valid transformations of the initial global state elements provided as inputs to the zero-knowledge algorithmic encoding, according to the rules of the algorithmic encoding.

In at least one embodiment, said zero-knowledge record and/or zero-knowledge transaction may comprise one or more zero-knowledge proofs, one or more algorithmic encodings or references to one or more pre-specified algorithmic encodings, one or more public inputs to the one or more algorithmic encodings, and/or one or more public outputs of the one or more algorithmic encodings, among other elements.

In one or more embodiments of the present invention, one or more public inputs and/or private inputs to a non-interactive zero-knowledge proof's algorithmic encoding may comprise one or more complex or nested data structures encoded according to a standardized format or representation—for example, according to the “Recursive Length Prefix” format utilized by the Ethereum blockchain, or the “JSON Canonicalization Scheme” specified by IETF RFC 8785, or the “Concise Binary Object Representation” specified by RFC 7049, or some other deterministically ordered and encoded data representation. In at least one embodiment, such standardized encoding format or representation is an encoding format or representation which may be deterministically transformed back and forth between other encoding formats or representations, and may be transformed back and forth to the encoding format of the blockchain's global state as it is encoded in a block-building node of the blockchain system. Complex or nested data structures encoded according to a standardized format or representation as described herein are also called “deterministic data” or “deterministic data structures”; data extracted or copied from the blockchain global state as it is encoded in a block-building node of the blockchain is also called “state data” or “state data structures”.

In one or more embodiments, a zero-knowledge proof verification implementation may be encapsulated inside an encapsulating function implemented in software, which function accepts as input one or more state data structures and/or deterministic data structures, and as output returns one or more state data structures and/or deterministic data structures. In an embodiment, the implementation of the encapsulating function may comprise one or more transformations of one or more state data structures into one or more deterministic data structures, and vice-versa, or one or more transformations between different deterministic data structures. In an embodiment, one or more data structures that can contain arrays, dictionaries, integers, strings, etc., map onto various internal data elements of one or more deterministic data structures.

In an embodiment, a zero-knowledge record or zero-knowledge transaction may be passed as an argument into said encapsulating function, which function may verify the zero-knowledge proof of the transaction along with possible other elements of the transaction. The encapsulating function may thereby authorize a block-building node to apply the global state transformation encoded by the zero-knowledge record or zero-knowledge transaction; or, alternately, if the record or transaction is deemed invalid, thereby cause the block-building node to discard the record or transaction, or add the record or transaction to a new block without applying the global state transformation.

In one or more embodiments, deterministic data structures representing token configurations or wallet accounts may be passed into a zero-knowledge algorithmic encoding, allowing an encoded permissioning constraint to be extracted from said deterministic data structures. In one or more embodiments, an interpreter of one or more encoded permissioning constraints may be implemented within the algorithmic encoding. In an embodiment, a permissioning constraint may be executed inside the algorithmic encoding, and the rules of the permissioning constraint may be enforced according to the result of said execution in the off-chain computation encoded by the non-interactive zero-knowledge proof.

In one or more embodiments of the present invention, zero-knowledge algorithmic encodings may be implemented corresponding to a variety of possible state transformations. Some such state transformations may comprise simple state transformations corresponding to simple zero-knowledge algorithmic encodings, and some such state transformations may comprise complex state transformations corresponding to more complex zero-knowledge algorithmic encodings. A non-exhaustive list of possible zero-knowledge algorithmic encodings that may or may not be implemented, and corresponding state transformations, include the following:
(a) Token transfer algorithmic encodings, which may encode transfers of tokens between and among blockchain accounts and/or addresses within the global state.
(b) Permission-constrained algorithmic encodings, which may encode various global state transformations that comprise a computational step which determines whether a permissioning constraint is satisfied or not.
(c) Privacy algorithmic encodings, which may encode global state transformations where one or more data values being transformed are subjected to a cryptographic hash before being written to the public global state encoding within a block-building node.

In an embodiment, global state transformations may be effectuated both by standard blockchain records and/or transactions on the one hand, which such records and/or transactions do not comprise any zero-knowledge proof element, and, on the other hand, zero-knowledge records and/or zero-knowledge transactions. In such an embodiment, a block-building node may evaluate one or more zero-knowledge records and/or zero-knowledge transactions for inclusion in a new block, which evaluation comprises an evaluation of the zero-knowledge proof, specified algorithmic encoding, public inputs and public outputs of said zero-knowledge records and/or transactions; in addition, within the same block, said block-building node may also evaluate for inclusion one or more blockchain records and/or transactions that do not comprise any zero-knowledge element, the evaluation of which may require the step-by-step execution of state transformation computation before the validity of such records and/or transactions can be established.

In an embodiment, a global state transformation corresponding to a zero-knowledge algorithmic encoding may be defined as a transformation made to the input data that results in the output data.

In an alternate embodiment, a global state transformation corresponding to a zero-knowledge algorithmic encoding may be defined as a transformation made to one or more input data elements of the algorithmic encoding, which transformation results in one or more other input data elements of the algorithmic encoding. In such an embodiment, one or more output data elements of said algorithmic encoding may comprise a Boolean value, an integer, or some other data element or elements that result from a confirmation that said transformation is valid.

In one or more embodiments, zero-knowledge records and/or zero-knowledge transactions may configure one or more of the following fields, among others:
(a) A list of accounts and/or addresses within the global state, which addresses correspond to public inputs to the zero-knowledge algorithmic encodings of the zero-knowledge records and/or transactions, which accounts and/or addresses may be used to retrieve the state data comprising said public inputs.
(b) A zero-knowledge algorithmic encoding type, identifying a pre-defined zero-knowledge algorithmic encoding which been used to compute a state transformation and generate a zero-knowledge proof. An embodiment may configure a separate field for algorithmic encoding type, or, alternately, a more general record type field may indirectly imply the algorithmic encoding, with a different record type for each algorithmic encoding type implemented.
(c) A non-interactive zero-knowledge proof generated by the sender of the record or transaction, generated using the algorithmic encoding type specified.
(d) One or more data elements corresponding to outputs of the zero-knowledge algorithmic encoding. In an embodiment, if the record or transaction is deemed valid, one or more of said data elements will replace global state elements located at one or more accounts and/or addresses specified in the first field above. In various embodiments said data may be simple or complex; said data may be added to the global state in its original encoding or after having been transformed into a different encoding; said data may comprise deterministic data structures or other data representations. In an alternate embodiment, said data elements may comprise output of the of the zero-knowledge algorithmic encoding a confirmation that a data transformation encoded by the algorithmic encoding is executed correctly, which output data elements may including such possibilities as a Boolean value, an integer, or some other data element or elements.
(e) One or more data elements corresponding to additional public inputs to the zero-knowledge algorithmic encoding. In an embodiment, said data elements may be deterministic data structures, and may be passed in as inputs to the algorithmic encoding either in an original state or after having been transformed into a different encoding format. In an embodiment, said input data elements may include data the formation of which results from a valid and successful data transformation encoded by the zero-knowledge algorithmic encoding.
(f) One or more cryptographic signatures generated using one or more private keys corresponding to one or more public keys associated with the accounts and/or addresses specified in the first field above.

In one or more embodiments, the processing of zero-knowledge records and/or zero-knowledge transactions by block-building nodes comprises a procedure having one or more of the following steps:
(a) It is confirmed that the one or more cryptographic signatures do in fact correspond to the appropriate accounts and/or addresses specified.
(b) The state data structures that are stored at the given accounts and/or addresses within the global state are retrieved.
(c) An encapsulating function is called, which function encapsulates the processing of the indicated algorithmic encoding, accepting as arguments the input data elements, the non-interactive zero-knowledge proof, the output data elements, and any record or transaction metadata that might be required for the processing of that particular algorithmic encoding—for instance, information regarding which addresses, accounts, or devices signed the record or transaction. Inside that function:
   i. The input data elements and output data elements are transformed into the format acceptable for the proof evaluation;
   ii. The proof inputs and outputs are assembled into the appropriate aggregate form for proof evaluation;
   iii. The proof's validity is determined, as informed by the inputs and outputs.
(d) If the proof is invalid, the function outputs an indicator of that invalidity, potentially as an error code or other computational encoding of invalidity.
(e) If the proof is valid, then the function outputs a mapping of the output data elements to one or more accounts and/or addresses within the global data structure, or to some constituent element of the state data corresponding to said one or more accounts and/or addresses.
(f) If the proof is valid, the global data structure is updated, replacing the state data structures previously corresponding with by those account addresses with the deterministic data structures specified as output.

In an embodiment, the construction of each type of zero-knowledge algorithmic encoding, and the creation of each non-interactive zero-knowledge proof that is included with each zero-knowledge record and/or transaction, are particular to the type of transformation of the sate data structure which corresponds to that specific algorithmic encoding type.

In one or more possible embodiments of the present invention, a zero-knowledge token transfer procedure may be implemented comprising one or more of the following steps:
(a) An algorithmic encoding may be implemented to accept as public input one or more state data structures of the sender and recipient accounts or addresses. The private input of the algorithmic encoding may be the details of the transfer: one or more token quantity values, and optionally one or more token types. The public output may be two new state data structures, corresponding to the blockchain accounts or addresses of each of the parties participating in the transfer. Alternately, said two new state data structures may also be among the public inputs to the algorithmic encoding, and the public output instead includes one or more indicators as to whether the transfer was successful, which indicators may comprise Boolean values, integer values, or other data elements.
(b) The algorithmic encoding may perform the operation of generating a new sender state data structure wherein the sender's balances of the indicated tokens are decreased by the indicated quantities, and a new recipient state data structure where the recipient's balances of the indicated tokens are increased by the indicated quantities.
(c) The wallet of the sender may execute this algorithmic encoding with the indicated inputs and capture the outputs and generate the non-interactive zero-knowledge proof. The wallet may then generate a zero-knowledge record comprising various data fields.
(d) The zero-knowledge record is sent to the miner/validator network, and when it is successfully verified and included in a new block, one or more sender and recipient state data structures are replaced with one or more input and/or output data elements including in the zero-knowledge record.

One or more embodiments implement the preceding zero-knowledge token transfer process, but also include the interpretation of permissioning constraints within an algorithmic encoding, also referred to as zero-knowledge permissioning. This implementation requires that an interpreter of a permissioning constraint encoding be implemented as a zero-knowledge algorithmic encoding, or a portion, aspect or sub-routine of an algorithmic encoding within a larger algorithmic encoding.

In one or more embodiments, each expression of a permissioning constraint encoding corresponds to a particular zero-knowledge expression encoding, which zero-knowledge expression encoding comprises a particular zero-knowledge algorithmic encoding, or to a particular portion, aspect or sub-routine of an algorithmic encoding, which particular zero-knowledge algorithmic encoding, or particular portion, aspect or subroutine of an algorithmic encoding may be incorporated into a larger zero-knowledge algorithmic encoding. Each zero-knowledge expression encoding within the context of a larger non-interactive zero-knowledge proof system performs the operation that is encoded by its corresponding expression. An interpreter of permissioning constraint encodings implemented within a zero-knowledge algorithmic encoding comprises a number of zero-knowledge expression encodings which operate on a permissioning constraint as it is interpreted within the zero-knowledge algorithmic encoding. Non-limiting examples of possible expressions that may correspond to particular zero-knowledge expression encodings include Boolean equivalence expressions, inequalities, negations, data retrieval operations,

In an embodiment, such zero-knowledge expression encodings may avoid implementing any non-terminating operations, or operations that may not terminate depending on input data, and therefore said zero-knowledge expression encodings may avoid implementing such operations as loops, recursive functions, and/or variable assignments. Similarly, in an embodiment, a permissioning constraint interpreter implemented in a zero-knowledge algorithmic encoding may avoid implementing any non-terminating operations, or operations that may not terminate depending on input data, and therefore said permissioning constraint interpreter implemented in a zero-knowledge algorithmic encoding may avoid implementing such operations as loops, recursive functions, and/or variable assignments.

In an embodiment, such zero-knowledge expression encodings may exclude function declarations, definitions or implementations, such that only built-in functions are available for use within permissioning constraints. Any such built-in function in such a scenario should therefore correspond to a particular zero-knowledge expression encoding.

In an embodiment, functions that operate on lists may be capped in terms of the number of iterations they are permitted to undertake. Such functions when implemented as zero-knowledge expression encodings may or may not be implemented using looping logic, depending on the capabilities of the underlying zero-knowledge algorithmic encoding system or method.

### Zero-Knowledge Privacy Ledgers

Known blockchain systems are known to make the value of tokens held by accounts and/or addresses public. If an account or address using such a blockchain system is identified as belonging to a particular person or business, the token balance information of that person or business becomes publicly known.

One or more potential embodiments of the present invention solve this problem by implementing privacy-enhancing zero-knowledge blockchain systems or methods comprising accounts which hide the value of tokens currently held by those accounts.

In one or more potential embodiments, a blockchain account or address may comprise a state data structure containing a masked privacy ledger. Said masked privacy ledger may comprise a hash digest which is a hash of an unmasked privacy ledger, which unmasked privacy leger comprises a deterministic data structure stored off-chain. Alternately, a masked privacy ledger may itself comprise a deterministic data structure comprising masked elements and unmasked elements, which masked elements comprise one or more hash digests of one or more data elements of an unmasked privacy ledger, and which unmasked elements comprise one or more data elements equivalent to one or more data elements of the unmasked privacy ledger, which unmasked privacy ledger comprises a deterministic data structure stored off-chain.

In one or more embodiments, said unmasked privacy ledger may comprise a Merkle tree or trie, herein referred to as an unmasked Merkle ledger. In one or more possible embodiments, the root of an unmasked Merkle ledger may constitute a hash digest of the masked privacy ledger. Alternately, the masked privacy ledger may comprise a masked Merkle ledger which is a Merkle tree or trie comprising a transformation of the unmasked Merkle ledger such that one or more branches or leaves of said unmasked Merkle ledger are replaced within the masked Merkle ledger by stub branches or leaves comprising individual hash digests of said branches or leaves.

In one or more embodiments, said masked Merkle ledger may be configured as a “privacy tree” comprising one or more of the following aspects:
(a) In an embodiment, one or more nodes of a privacy tree may contain unhashed original data, which nodes may have one or more siblings which are stub branches or leaves that may act as expansion points of the privacy tree.
(b) In an alternate embodiment, a privacy tree may exclude non-hashed original data, and may comprise only stub branches and leaves. One or more stub branches or leaves may each comprise a random or pseudo-random value.
(c) In an embodiment, each node comprising non-hashed original data of the privacy tree may be accompanied by two or more stub branch siblings. In such an embodiment, when new content is added to the privacy tree, it is added in a balanced way, such that nodes at a tree depth of N+1 are only added when all stub branches have already been replaced with new content at tree depth N. In other words, in such a configuration, it would only be permitted for new nodes to be added to the privacy tree in a manner that improves the tree's balance; otherwise, such an addition would be invalid.
(d) In an embodiment, only a user that owns or controls an account or address knows all the non-hashed original data of the unmasked Merkle ledger corresponding to a privacy tree constituting the privacy ledger of the account or address, but any valid private transaction moving tokens into the account may nonetheless add to the account. In such an embodiment, tokens may be transferred to said account or address in a blockchain record or transaction signed by the sender of said tokens, without requiring the signature of the recipient account or address. In an embodiment, a recipient account or address of such a transfer may use said tokens through the inclusion in the blockchain of a zero-knowledge record or transaction the zero-knowledge-proof of which comprises a transformation of the privacy tree to incorporate the received token values.

In an embodiment, a user that desires to receive a transfer from a sender may share all or a portion of their unmasked privacy ledger with the sender, which recipient's unmasked privacy ledger may be included among the private inputs to a zero-knowledge algorithmic encoding of the zero-knowledge record or transaction. Such a zero-knowledge algorithmic encoding may be of a type that includes among its outputs masked private ledger data for both sender and receiver accounts, all of which may be updated in the global state upon inclusion of the valid record or transaction in the blockchain. In an embodiment, if the unmasked privacy ledger is an unmasked Merkle ledger, then only a Merkle proof inclusive of the node comprising the token balance being updated would need to be shared, because such data in combination with public global state data would be sufficient to generate an updated masked private ledger.

In an embodiment, rather than a recipient sharing all or a portion of their unmasked private ledger with a sender, a recipient may share nothing in advance. Instead, a zero-knowledge algorithmic encoding may accept among its public inputs a masked private ledger of the recipient, and include among its outputs an updated masked private ledger which will be used to update the masked private ledger on the recipient's account. In an embodiment, the updated masked private ledger may incorporate token values received as a new unmasked element; in this embodiment, the amount transferred would public, even if the balances held by both parties are not. In an alternate embodiment, the zero-knowledge algorithmic encoding includes among its outputs one or more unmasked elements of the unmasked private ledger, in addition to the updated masked private ledger; said unmasked elements of the masked private ledger would not be incorporated in the blockchain's global state, but instead would be transmitted privately to the recipient, to be stored privately by the recipient, and used subsequently by the recipient to retrieve said tokens received, or in an alternate embodiment, to effectuate the inclusion of the zero-knowledge record or transaction in the blockchain.

In one or more embodiments, a private zero-knowledge record or transaction may be configured as a zero-knowledge record or transaction comprising a zero knowledge proof generated using a privacy-preserving zero-knowledge algorithmic encoding, which is a zero-knowledge algorithmic encoding which includes among its private inputs the unmasked privacy ledger of one or more parties participating in the token transfer (as senders or recipients). In one or more embodiments, said privacy-preserving zero-knowledge algorithmic encoding may also include as private inputs the transfer details of the state transformation, including one or more of the following private inputs, among others: one or more token values being spent or transferred, one or more token types being spent or transferred, token configuration state data, and/or token permissioning constraints associated with one or more token types. Public inputs to said privacy-preserving zero-knowledge algorithmic encoding may include the state data structures corresponding to one or more of the accounts and/or addresses participating in the transfer. In an alternate embodiment, token type, token configuration, and/or token permissioning constraints associated with one or more tokens may instead be included among the public inputs to said privacy-preserving zero-knowledge algorithmic encoding, rather than the private inputs.

In one or more embodiments, a privacy-preserving zero-knowledge algorithmic encoding may extract one or more permissioning constraint encodings from one or more account or address state data structures or from one or more token configuration state data structures, and interpret said permissioning constraints to determine whether the transfer is permitted. Said privacy-preserving zero-knowledge algorithmic encoding may then compute the transfer instruction included in the private inputs by decrementing the value of said tokens in the unmasked privacy ledger of the sender. A new hash of the unmasked privacy ledger node from which the transfer is extracted would be generated, and that node would be updated in the masked privacy ledger, and relevant hash digests would be computed. In an embodiment, an indicator of which node of the unmasked privacy ledger is to be used to fund the transfer may be included in the private inputs.

In an embodiment, the output of a zero-knowledge algorithmic encoding comprises at least one updated masked privacy ledger derived from the unmasked privacy ledger after it has been updated within the zero-knowledge algorithmic encoding. Upon evaluation of a private zero-knowledge record or transaction, and upon verification of the validity of the zero-knowledge proof said record or transaction comprises, a block-building node may replace one or more masked ledgers of the global state with one or more updated masked ledgers output from the zero-knowledge algorithmic encoding.

In an alternate embodiment, one or more updated masked private ledgers are included among the public inputs of the zero-knowledge algorithmic encoding, which one or more updated masked private ledgers may be used by a block-building node to replace one or more masked private ledgers of the global state upon evaluation and successful validation of a private zero-knowledge record or transaction. In such an embodiment, the public output of the zero-knowledge algorithmic encoding may be a Boolean value, an integer, or some other data element or elements that result from a successful evaluation of the one or more masked private ledger inputs within the zero-knowledge algorithmic encoding, which evaluation establishes that said one or more masked private ledger public inputs are one or more valid transformations of one or more unmasked private ledger private inputs, as may be appropriate depending on the other inputs to said zero-knowledge algorithmic encoding.

In one or more embodiments, because token types and token values are included as part of the private data, the nature of a transfer encoded by a private zero-knowledge record or transaction will not be publicly known when the record or transaction is added to the chain.

In one or more alternate embodiments, the inclusion of token types and/or token configuration state data among the necessary public data reveals some information about which tokens were transferred. In an embodiment, however, type and state data pertaining to some unused additional token types may be added in order to obfuscate the question.

In one or more alternate embodiments, Token type information and token configuration state data may be included in the public data in order to simplify the evaluation of permissioning constraints. If token configuration state data and token type are public, then the permissioning constraints can be evaluated by the operation of the block-building node, rather than being interpreted within a zero-knowledge algorithmic encoding. Such an embodiment requires a less complex implementation than the alternative.

In one or more embodiments, private zero-knowledge records and/or transactions are not able to hide the fact that one or more accounts and/or addresses have transacted with each other, in part because the masked privacy ledger of one or more accounts and/or addresses should be updated upon acceptance, execution and inclusion of said private zero-knowledge records and/or transactions in the blockchain, which requires a global state of a public blockchain to be modified to reflect updated privacy ledgers of said one or more accounts and/or addresses.

In an embodiment, a recipient's the privacy tree may add new nodes with every inbound transfer; as a result, the size of the privacy tree may grow with every transfer into the account.

In an embodiment, a privacy tree may undergo a consolidation transformation in order to re-claim space. Such a consolidation transformation may comprise one or more of the following aspects:
(a) A zero-knowledge algorithmic encoding may be defined which algorithmic encoding performs a consolidation of a privacy tree, or, alternatively, confirms that an updated masked privacy tree is a consolidated version of an original masked privacy tree.
(b) A zero-knowledge record or transaction may be configured which corresponds to the consolidation algorithmic encoding, which zero-knowledge record and/or transaction, when it is properly formed with a valid zero-knowledge proof and is incorporated into a new block by a block-building node, effectuates a consolidation transformation of a privacy tree of an account or address of a blockchain global state.
(c) A public input to the algorithmic encoding may comprise a masked privacy tree that is undergoing a consolidation. A private input to the algorithmic encoding may comprise the unmasked version of said unconsolidated privacy tree, with all the non-hashed content directly accessible.
(d) A consolidated version of the unmasked privacy tree (unmasked consolidated privacy tree) may be included as a private input or a private output of the algorithmic encoding. A masked version of said consolidated privacy tree (masked consolidated privacy tree) may constitute a public input or public output of the algorithmic encoding.
(e) The zero-knowledge algorithmic encoding may implement one or more of the following steps:
   i. confirm that the unmasked version of the privacy tree does in fact conform to the masked version of the privacy tree;
   ii. deterministically transform the unmasked version of the original privacy tree into an unmasked consolidated privacy tree (the consolidation transformation);
   iii. transform the unmasked consolidated privacy tree into a masked consolidated privacy tree (the masking transformation);
   iv. validate that the unmasked consolidated privacy tree is in fact the correct unmasked version of the privacy tree that is included among the private inputs or private outputs of the algorithmic encoding; and/or
   v. validate that the masked consolidated privacy tree is in fact the correct masked version of the privacy tree that is included among the private inputs and/or private outputs of the algorithmic encoding.
(f) The consolidation transformation may comprise a combining of all non-hashed elements of an unmasked privacy tree pertaining to a particular token type (or other unit of value) into a single node of the privacy tree, for each token type or other units of value found in the privacy tree. Although individual transfers may result in real content nodes that comprise token ledgers containing only one token balance each, the consolidated node may potentially comprise a token ledger that contains multiple token balances; alternately, different nodes may each contain separate token balances or other units of value.
(g) This algorithmic encoding may allow portions of the unmasked privacy tree to contain masked nodes. This may be necessary to allow for the consolidation of derived from private transfers that the account/address owner was never notified of. For the account/address owner to know the unmasked content of all of the real content nodes, it would need to have been informed by senders of unmasked data corresponding to the masked data added by the senders. This data, and any token balances or other value it may correspond to, would be inaccessible to
(h) The consolidation transformation may also involve a step whereby data is discarded if the that the zero-knowledge record and/or transaction is configured to discard such data. Such discarded data may be either data present in the unmasked privacy tree in an non-hashed, unmasked state, and data that remains masked. The instructions to discard should somehow also be included in the private inputs of the circuit. Such tokens or values would effectively be destroyed.

### Two-Phase Zero-Knowledge Transfers

According to a possible set of embodiments, a blockchain account or address may correspond to a privacy ledger the masked version of which is encoded in the global state only as a hash digest. The unmasked version of said privacy ledger, which may be stored off-chain, may comprise a Merkle tree or trie, or may comprise other less complex data, such as a simple string, or a deterministic data structure that is not a Merkle tree or trie.

In one or more embodiments, a transfer of tokens or other units of value from one privacy ledger to another privacy ledger would comprise a two-step process involving two zero-knowledge records and/or transactions. The first record or transaction authorizes the movement of tokens or other value units out of a sender's privacy ledger, and the second record or transaction allows the movement of said tokens or value units into a recipient's privacy ledger.

The sender zero-knowledge record may be added to the blockchain by the sender of tokens or other units of value. The sender zero-knowledge record includes inputs and outputs of a sender zero-knowledge algorithmic encoding which algorithmic encoding corresponds to a state transformation whereby the sender's masked private ledger is transformed to an updated masked private ledger.

In an embodiment, the public inputs to the sender zero-knowledge algorithmic encoding may include an original masked private ledger extracted from a state data structure of a sender's account or address. The private inputs may include transfer details, including type, configuration and quantity information regarding transferred token values or other units of value transferred, as well as an original unmasked private ledger of the sender, which original unmasked private ledger may be hashed within the recipient zero-knowledge algorithmic encoding to produce a hash digest equivalent to the original masked private ledger.

In an embodiment, an updated masked private ledger of the sender may be included as an input or as an output of the sender zero-knowledge algorithmic encoding. If the updated masked private ledger is included as an output, said algorithmic encoding will compute this output value first by transforming the sender's original unmasked private ledger into an updated unmasked private ledger, and then by hashing said updated unmasked private ledger to produce a hash digest, which hash digest will form said output. If the updated masked private ledger is included as an input, said algorithmic encoding will first compute said hash digest, and then will compare said hash digest to the updated masked private ledger provided as input.

Similarly, in an embodiment, a transfer hash digest comprising a hash digest of the transfer's token or unit of value type, configuration and/or quantity may also be included as an input or as an output of the sender zero-knowledge algorithmic encoding. If the transfer hash digest is included as an output, said algorithmic encoding will compute this output value by computing a hash digest of the transfer's token/value type, configuration and/or quantity data included as a private input, which hash digest will form said output. If the transfer hash digest is included as an input, said algorithmic encoding will first compute a hash digest of the transfer's token/value type, configuration and/or quantity data, and then will compare said hash digest to the transfer hash digest provided as input.

In an embodiment, said sender zero-knowledge record may be generated through a first zero-knowledge proving process by which a zero-knowledge proof is generated and incorporated into said recipient zero-knowledge record. Said zero-knowledge proof comprises a non-interactive zero knowledge proof which encodes a proof of one or more of the following data relationships:
(a) the updated masked private ledger of the sender account or address is a hash digest computed by hashing the updated unmasked private ledger of the sender account or address;
(b) the updated unmasked private ledger of the sender account or address is a transformation of the original unmasked private ledger, which transformation comprises a decrease in the quantity of the transferred tokens or value units specified in the private input;
(c) the original masked private ledger of the sender account or address is a hash digest computed by hashing the original unmasked private ledger of the sender account or address;
(d) transfer hash digest is a hash digest computed by hashing the transfer's token/value type, configuration and/or quantity data included among the algorithmic encoding's private inputs

In an embodiment, when an instance of said sender zero-knowledge record/transaction is evaluated, additional validation steps will be performed on said zero-knowledge record or transaction. Such validation steps may include, among others: a confirmation that a recipient account or address is encoded in the record or transaction; a confirmation that a sender's account or address is encoded in the record or transaction; a confirmation that the original masked privacy ledger provided as an input to the sender zero-knowledge algorithmic encoding is a hash digest value equal to the hash digest value of the sender's current masked privacy ledger referenced by the sender's account or address stored in the global state. Only public inputs and outputs will be included with the record/transaction, and not any private inputs or outputs.

Upon said sender zero-knowledge record or transaction being validated successfully and incorporated into a block by a block-building node, said block-building node will cause the original masked privacy ledger of the sender to be replaced with the updated masked privacy ledger of the sender.

The recipient zero-knowledge record may be added to the blockchain after the sender zero-knowledge record is added to the blockchain. The recipient zero-knowledge record references the first transaction, and includes inputs and outputs of a recipient zero-knowledge algorithmic encoding which algorithmic encoding corresponds to a state transformation whereby the recipient's original masked private ledger is transformed to an updated masked private ledger.

In an embodiment, the public inputs to the recipient zero-knowledge algorithmic encoding may include an original masked private ledger extracted from a state data structure of a recipient's account or address. The private inputs may include transfer details, including type, configuration and quantity information regarding transferred token values or other units of value transferred, as well as an original unmasked private ledger of the recipient, which original unmasked private ledger may be hashed within the recipient zero-knowledge algorithmic encoding to produce a hash digest equivalent to the original masked private ledger.

In an embodiment, an updated masked private ledger of the recipient may be included as an input or as an output of the recipient zero-knowledge algorithmic encoding. If the updated masked private ledger is included as an output, said algorithmic encoding will compute this output value first by transforming the recipient's original unmasked private ledger into an updated unmasked private ledger, and then by hashing said updated unmasked private ledger to produce a hash digest, which hash digest will form said output. If the updated masked private ledger is included as an input, said algorithmic encoding will first compute said hash digest, and then will compare said hash digest to the updated masked private ledger provided as input.

Similarly, in an embodiment, a transfer hash digest comprising a hash digest of the transfer's token or unit of value type, configuration and/or quantity may also be included as an input or as an output of the recipient zero-knowledge algorithmic encoding. If the transfer hash digest is included as an output, said algorithmic encoding will compute this output value by computing a hash digest of the transfer's token/value type, configuration and/or quantity data included as a private input, which hash digest will form said output. If the transfer hash digest is included as an input, said algorithmic encoding will first compute a hash digest of the transfer's token/value type, configuration and/or quantity data, and then will compare said hash digest to the transfer hash digest provided as input.

In an embodiment, said recipient zero-knowledge record may be generated through a recipient zero-knowledge proving process by which a zero-knowledge proof is generated and incorporated into said recipient zero-knowledge record. Said zero-knowledge proof comprises a non-interactive zero knowledge proof which encodes a proof of one or more of the following data relationships:
(a) the updated masked private ledger of the recipient's account or address is a hash digest computed by hashing the updated unmasked private ledger of the recipient's account or address;
(b) the updated unmasked private ledger of the recipient's account or address is a transformation of the original unmasked private ledger, which transformation comprises an increase in the quantity of the transferred tokens or value units specified in the private input;
(c) the original masked private ledger of the recipient account or address is a hash digest computed by hashing the original unmasked private ledger of the recipient account or address;
(d) transfer hash digest is a hash digest computed by hashing the transfer's token/value type, configuration and/or quantity data included among the algorithmic encoding's private inputs

In an embodiment, when an instance of said recipient zero-knowledge record/transaction is evaluated, additional validation steps will be performed on said zero-knowledge record or transaction. Such validation steps may include, among others: a confirmation that a reference to or identifier of a sender zero-knowledge record or transaction is encoded in the recipient zero-knowledge record or transaction; a confirmation that the a recipient account or address encoded in the referenced sender zero-knowledge record or transaction matches the account or address of the recipient; a confirmation that the original masked privacy ledger provided as an input to the recipient zero-knowledge algorithmic encoding is a hash digest value equal to the hash digest value of the recipient's current masked privacy ledger referenced by the recipient's account or address stored in the global state. Only public inputs and outputs will be included with the record/transaction, and not any private inputs or outputs.

Upon said recipient zero-knowledge record or transaction being validated successfully and incorporated into a block by a block-building node, said block-building node will cause the original masked privacy ledger of the recipient to be replaced with the updated masked privacy ledger of the recipient.

In an embodiment, the sender and the recipient may exchange information off-chain regarding the transaction, via one or more electronic or non-electronic means, which means may include (but are not limited to) messages transmitted over a packet-switched network, messages transmitted via analogue or digital radio transmission, messages transmitted via infrared signal, messages encoded as images scanned by an optical scanning device, magnetically-encoded media, messages conveyed by sound, and other communications media. Said information shared by the sender to the recipient may include one or more of the following:
(a) One or all of the type, configuration and/or quantity of the token(s) or unit(s) of value that were transferred, hashed to produce the transfer hash digest;
(b) A reference number or transaction number the sender may use to identify the zero-knowledge record or transaction;
(c) The zero-knowledge record or transaction itself.

In an embodiment, a recipient may construct, assemble or encode a recipient zero-knowledge record or transaction by incorporating one or more information elements shared by the sender.

In an embodiment, a recipient zero-knowledge record or transaction may be added to the blockchain after a sender zero-knowledge record or transaction has already been added to the blockchain, or, optionally, the recipient zero-knowledge record or transaction may be added to the blockchain together with the sender zero-knowledge record or transaction, in combination in a manner that the second record or transaction executes immediately following the first record or transaction without any interruption, to be executed atomically in a single combined state transformation.

In an embodiment, said two-step process involving two zero-knowledge records and/or transactions may co-exist with other zero-knowledge record and/or transaction implementation described herein.

One or more of the embodiments described above may also include systems or methods of applying permissioning constraints to the process of generating and/or validating the zero-knowledge records or transactions described.

In one or more embodiments, a permissioning constraint may be executed and evaluated by a block-building node prior to validating the zero-knowledge proof and other elements of a zero-knowledge transaction or record. Said permissioning constraint may be associated, for instance, with a particular account or address, or with a particular token type, or other element of the global state which is implicated by the publicly-readable encoding of the zero-knowledge record or transaction being evaluated. In an embodiment, a permissioning constraint may evaluate whether, in a non-limiting example, a particular type of token or unit of value may be used or referenced somehow by a one or more zero-knowledge records or transactions, or, in another non-limiting example, whether a particular account or address may originate or be referenced by one or more zero-knowledge records or transactions.

In one or more embodiments, a permissioning constraint may be encoded in a manner that is interpretable executed and evaluated within a zero-knowledge algorithmic encoding associated with one or more zero-knowledge records or transactions, such that said permissioning constraint may operate on private non-public data of a zero-knowledge proof of the zero-knowledge record or transaction, and whereby said zero-knowledge proof may prove whether or not the permissioning constraint has been satisfied by the private and public data thereof.

In one or more possible embodiments described herein, the zero-knowledge algorithmic encodings used should not contain or implement any loops or recursions. A permissioning constraint interpreter may need to unroll any iterative function into a branching logic of fixed depth. In an embodiment, the number of iterations available for a permissioning constraint may be limited; alternately, the size of data structures upon which a permissioning constraint may operate may be limited so that iterations are only of a maximum length.

### Consensus and Reorganization Risk

Various embodiments disclosed herein include improvements in blockchain systems related to the management and mitigation of risks presented by probabilistic blockchain consensus mechanisms, and the optimization of transaction processes through off-chain solutions, including as payment channels. Such details described herein provide means enhance the security, scalability, and efficiency of blockchain-based systems. Each described feature is optional, and various configurations or combinations of the described features may be implemented in various embodiments.

Blockchain networks rely on consensus protocols to validate and append new blocks of transactions to the blockchain. Such protocols may include such protocols as, for example, Proof of Work (PoW), Proof of Stake (PoS), Delegated Proof of Stake (DPoS), Fitness Gradient Consensus (FGC), and hybrid systems combining one or more of these mechanisms. In an example embodiment, protocols like PoW, PoS, FGC, and their variants, depending on the nature of the embodiment, may be susceptible to blockchain reorganization in the event of a network partition, as nodes may create divergent chains that require reconciliation once the partition is resolved.

This susceptibility to reorganization highlights the importance of transaction finality in blockchain systems. Transaction finality refers to the assurance that a transaction, once confirmed, is permanently included in the blockchain and cannot be altered or reversed. For example, in consensus protocols like PoW, PoS and FCG, finality is probabilistic, meaning that the certainty of a transaction being final increases as more blocks are appended after it. However, during events such as, for example, network partitions or attacks, these protocols may experience temporary chain divergences, leaving transactions vulnerable to reorganization.

Reorganization occurs when a blockchain replaces a previously accepted sequence of blocks with a new, longer chain, typically due to network partitions or competing forks. Transactions in the discarded blocks are not invalidated but may be delayed, reordered, or excluded from the new chain, creating uncertainty for users. A key risk is that a reorganized transaction may result in a double-spend, where the same tokens or funds are spent in conflicting transactions on different branches of the chain. This risk is particularly significant in off-chain scenarios, such as payments for goods or services, where recipients may act on a transaction before it is final. In such cases, a double-spend could leave recipients without payment, eroding trust in the blockchain's reliability.

This highlights the importance of transaction finality, which is the point at which the probability of reorganization becomes negligible, ensuring that confirmed transactions are permanently recorded, such that transformations to the global state effectuated by said records and/or transactions cannot be altered or reversed.

One aspect of the embodiment addresses the risks posed by a blockchain reorganization generally, as well as the specific risk of a “51% attack,” a vulnerability of some probabilistic consensus protocols, and a possible vulnerability of embodiments of the present invention that utilize such probabilistic consensus protocols. A 51% attack may occur when an entity or a coordinated group of entities gains control of the majority of a network's computational power or is able to harness new computational power greater than the computational power of the network. This majority control may enable the attacker to potentially rewrite blockchain history by reorganizing blocks already incorporated into the blockchain, thereby enabling actions such as the deletion of transactions. Note, however, that random reorganizations or those caused by network partitions pose similar if not the same risks to users as a 51% attack; furthermore, networks that are not susceptible to 51% attacks may nonetheless be susceptible to reorganizations under other circumstances. Regardless of the cause, a reorganization may delay, reorder, or exclude transactions, creating uncertainty and undermining trust in the blockchain. For users, the cause of the reorganization is irrelevant—the lack of finality impacts the system's reliability and security.

The probability that a particular block will be reorganized out of existence—or that a 51% attack may succeed in effectuating a reorganization diminishes with increasing block age and network size. Specifically, the amount of computational power that may be required to successfully execute such an attack increases for older blocks or for blockchains with larger mining networks. Thus, in embodiments involving larger blockchain networks, transactions embedded in older blocks may be less susceptible to reorganization.

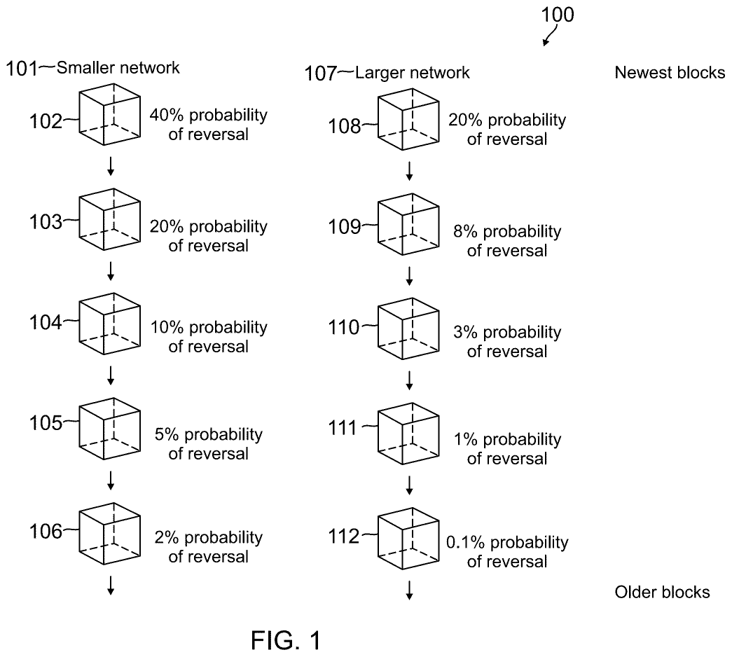

FIG. 1 illustrates a comparison 100 of the relative risk of reorganization occurring for a smaller network 101 and a larger network 107, according to various example embodiments or implementations. It should be understood that the probability values depicted in FIG. 1 are provided purely for illustrative and exemplary purposes to demonstrate relative differences in attack vulnerability between smaller networks 101 and larger networks 107. The specific numerical values shown are exemplary only and actual networks may exhibit different probability values, where the probability represents that there will be a reorganization at the same depth if there is a fork, at different times. This probability recedes as you go deeper into the blockchain, where a higher depth corresponds to a greater age of a block. For blockchain networks that may be subject to reorganization, a payment channel network may provide finality as long as the timeclock of the payment channel is longer than the likely depth of a reorganization.

These payment channels provide a solution for the finality of payments. The smaller networks 101 may exhibit a difference in reorganization vulnerability depending on the recency of the network, in an example implementation. The recent small-network block 102 may experience a probability value of 40%, the less recent small-network block 103 may experience a probability value of 20% the aging small-network block 104 may experience a probability value of 10%, the older small-network block 105 may experience a probability value of 5%, and the oldest small-network block 106 may experience a probability value of 2%. The larger networks 107 may also exhibit a difference in reorganization vulnerability depending on the recency of the block. The recent large-network block 108 may experience a probability value of 20%, the less recent large-network block 109 may experience a probability value of 8% the aging large-network block 110 may experience a probability value of 3%, the older large-network block 111 may experience a probability value of 1%, and the oldest large-network block 112 may experience a probability value of 0.1%. A key principle illustrated is that larger networks 107 generally demonstrate lower reversal probabilities than smaller networks 101 for blocks of comparable age, and that reversal probabilities generally decrease as blocks age within both network sizes, i.e., as you go deeper. The anchor block solution is that the depth can be guaranteed through an anchor. The anchor blocks have a feature that makes it harder to reorganize. In an embodiment, the anchor block may get a fitness enhancement, for example through a formal mechanical aspect that enables issuers of tokens to have extra weight when creating a block, therefore making it less likely or impossible for a reorganization to occur past the depth where one or more of these blocks have been included in the blockchain. This is important for payment channels because even in the event of a reorganization, as long as the payment channels are longer than the probabilistic limit of the length of the reorganization's new fork, the payment channel may not be removed from the blockchain. Therefore, the payment channel provides a mechanism of finality provided that the timelock on the escrow contract is longer than the length or age of the fork. The anchor block decreases the probability of a fork at that block.

The nature of reorganization risk in certain embodiments is illustrated in diagram 100 of FIG. 1 discussed herein. Depending on the nature of the embodiment, reorganization risk may be described in the form of block reversal probabilities, which may vary based on multiple factors including, but not limited to, network size and block age. For example, in some embodiments involving smaller networks 101, newer blocks may face relatively higher reversal probabilities, which is shown in the diagram to be 40% 102 in some cases. In various embodiments, such probabilities may demonstrate progressive reduction with block age, shown in the diagram to decrease to 20% 103, then to 10% 104, then to 5% 105, and potentially reaching 2% 106 for older blocks.

Some embodiments involving larger networks 107 may demonstrate a similar pattern of probability reduction with block age while maintaining comparatively lower probabilities across all block ages. For instance, in the example illustrated by the diagram, newer blocks in larger networks may face reversal probabilities of 20% 108, with such probabilities potentially decreasing to 8% 109 for somewhat older blocks, then to 3% 110, then to 1% 111, and potentially reaching 0.1% 112 for the oldest blocks. In various embodiments, this pattern may demonstrate both the enhanced security of larger networks and the increasing security of older blocks.

Nonetheless, in various embodiments, a particular “certainty value” may be assigned to blocks, indicating the likelihood of their permanence based on the observed network size and mining power distribution. Depending on the embodiment, said certainty value may be purely conceptual, or it may be computed or evaluated heuristically by participating nodes, and used to make various decisions and/or to compute various conditionals in the course of the implementation's operation.

Various embodiments of the present invention implement mitigation strategies to reduce the probability or the impact of reorganization. These modifications may reduce the time required for block confirmations and adjust computational power requirements to disincentivize majority control.

### Finality Determination

In various embodiments, systems and methods may be provided for determining blockchain consensus finality through various computational frameworks. For example, some implementations may employ calculations to determine potential reorganization probabilities based measurements or estimates of network computational power, token ownership distribution among block-building nodes, age of token ownership distribution among such nodes, the performance of a random function, or another variable or set of variables the values of which are dependent on network makeup or network performance or on a stochastically or probabilistically determined metric related to said blockchain.

Certain embodiments may implement such certainty calculations with recognition that block reversal probabilities may vary based on multiple factors including, but not limited to, network size and block age. Such probabilities may demonstrate progressive reduction with block age in some embodiments. Such calculations may, in certain embodiments, enable assignment of certainty values to individual blocks, where such certainty values may represent likelihoods that specific blocks (inclusive of subsequent blocks) may be removed from the blockchain through a reorganization. In other variated embodiments, blockchain finality is determined according to a more simple heuristic, for example whether or not a block has reached a certain depth or age.

In certain embodiments, said probability frameworks may enable implementation of dynamic confirmation threshold systems. For example, some implementations may establish one or more certainty thresholds that may be achieved at varying times depending on network characteristics. Such timing variations may, in some embodiments, result in a block and its transactions being deemed final within broad timeframes, potentially ranging from a few seconds to up to or even more than an hour or several hours or more, with specific timing potentially being determined by network size and other relevant factors. Various embodiments may implement systems whereby records and/or transactions may be designated as “confirmed” upon their containing blocks achieving designated certainty thresholds, which records and/or transactions are designated as “pending” until it's block is deemed final.

Some implementations may employ such confirmation frameworks to implement loss prevention systems. For example, certain embodiments may incorporate timing controls that maintain holds on various activities until relevant certainty thresholds are achieved. Such activities may include, but are not limited to, transmission of off-chain or external payment, initiation of shipping processes, execution of asset transfers, transmission of money-transfers, crediting of bank accounts, application of refunds, or activation of payment channels funded by on-chain transactions. Various embodiments may thereby provide protection mechanisms against potential losses that might otherwise occur during chain reorganization events. In some implementations, such protection mechanisms may be particularly relevant to high-value transactions that may require confirmation by one or more anchor blocks before being considered final.

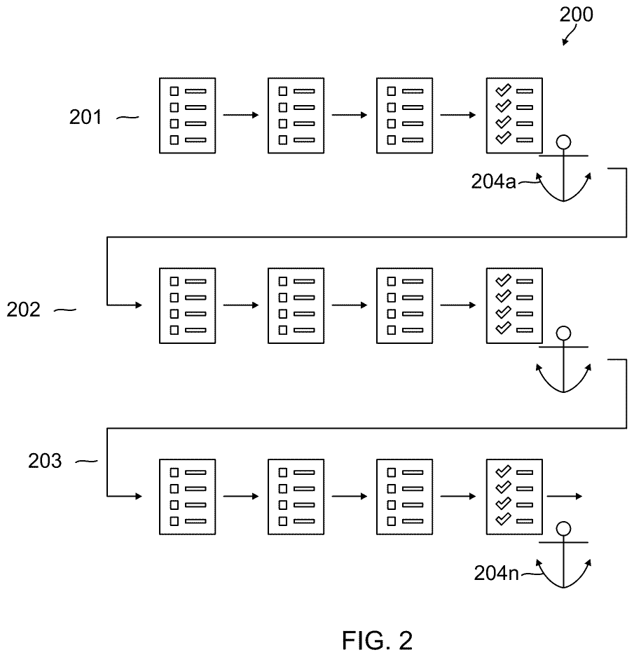

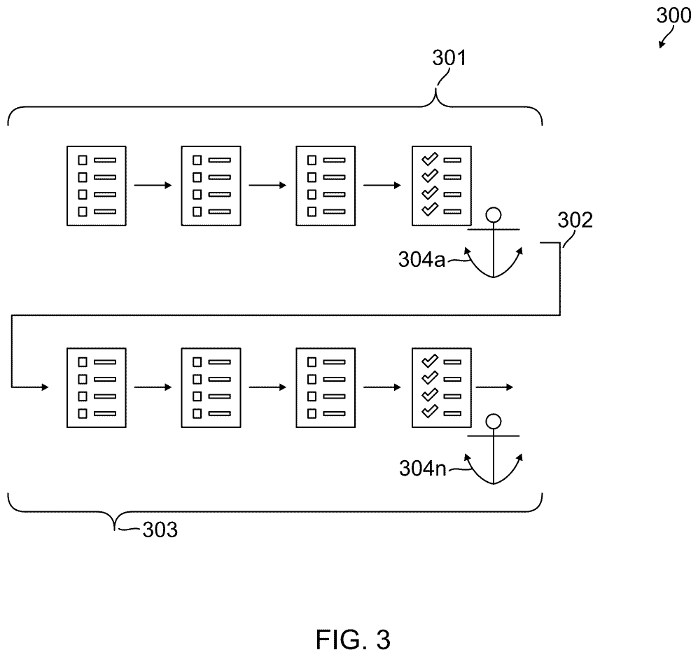

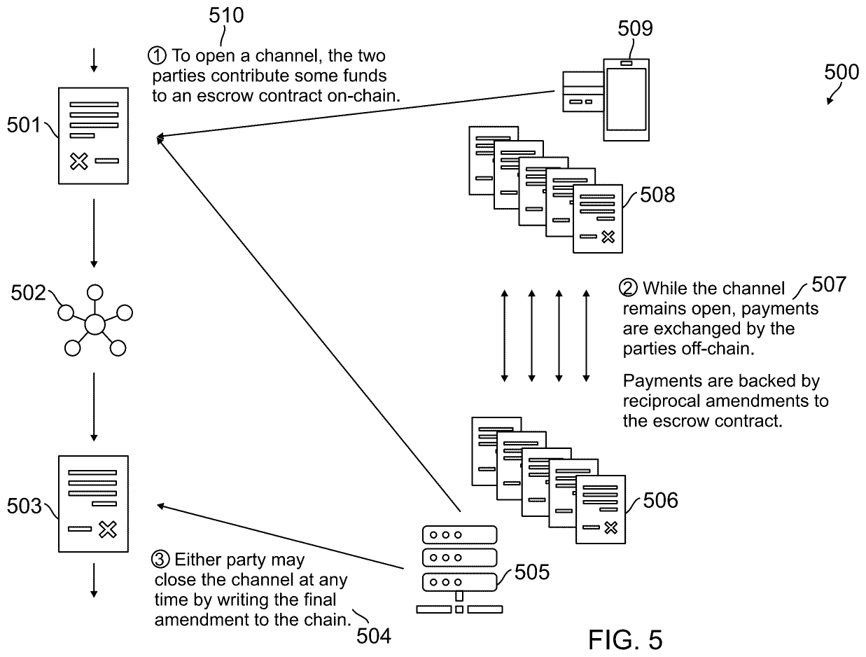

In various embodiments, such confirmation and security frameworks may be integrated with other security mechanisms including, but not limited to, anchor blocks (204a-n, 300a-n discussed below in relation to FIGS. 2 and 3, respectively) and payment channels (See, FIG. 5 discussed below). Some implementations may enable these various security mechanisms to work in concert, potentially providing enhanced protection against the potential impacts of reorganization (such as double-spends) while maintaining efficient transaction processing capabilities. Certain embodiments may employ these integrated security approaches to balance transaction speed requirements with security needs, potentially enabling rapid processing of lower-risk transactions while maintaining heightened security measures for higher-risk transactions.

### Anchor Block Backstop

Certain embodiments may employ “anchor blocks” as a means to reduce the likelihood, frequency, or impact of reorganizations. Such blocks may be periodically inserted into the blockchain, and thus act reduce the risk of reorganization of blocks preceding insertion point. The presence of anchor blocks within a blockchain restrict or reduce a maximum chain reorganization length, mitigating the risk of reorganization and of double-spend attacks. In various embodiments, anchor blocks may be validated and signed by a subset of block-building nodes explicitly designated as trusted.

In one or more embodiments, anchor blocks may act as backstops, limiting the possibility for blocks to be reorganized beyond a threshold block depth (distance from the most recent block). In one embodiment, anchor blocks may be spaced at regular intervals, and any proposed chain fork extending beyond a length of N blocks should include at least one anchor block at depth N or more recent to be accepted by the network. This approach effectively prevents malicious reorganization of the blockchain past the anchor block.

In various embodiments, the interval between anchor blocks may vary based on network parameters, such as the number of active miners and the total computational power of the network. Depending on the embodiment, in a smaller network, anchor blocks may occur, for example, as frequently as every few minutes or even multiple times in a minute, whereas in a larger network, intervals may range, for example, from days to weeks. In some embodiments, such intervals may be adjustable and configurable based on network requirements and desired security thresholds.

Certain embodiments may implement dynamic adjustment of the interval based on real-time network metrics. For example, some implementations may decrease the interval (thereby increasing anchor block frequency) if the network size decreases below certain thresholds, or increase the interval if the network grows beyond certain thresholds. Various embodiments may also consider additional factors such as network hash rate, mining difficulty, or various other metrics determinable the blockchain global state and/or on-chain data when determining appropriate intervals between anchor blocks.

In one or more embodiments, blockchain records and/or transactions achieve finality when the block containing said record or transaction is followed by a defined number of additional blocks, including one or more anchor blocks. This multi-block confirmation process ensures that transactions are secure against potential reorganizations. The inclusion of an anchor block may in some embodiments reduce reorganization risk to near zero.

FIG. 2 shows an illustration 200 of certain anchor block concepts, according to at least one example embodiment. Such anchor blocks 204a-n may, in certain implementations, be subject to additional validation requirements beyond standard consensus rules. For example, some embodiments may require that every Nth block be validated and signed by one of a limited set of trusted nodes. In certain embodiments, the system may be configured to avoid repetition in block-building responsibility among these trusted nodes, and/or it may be configured to permit said trusted nodes to compete among themselves to generate a new block. Double spends 201 may happen when forks emerge that are longer than expected. In one or more embodiments, anchor blocks 204a-n may provide an upper limit for the length of forks that may contain a double-spend attack. Unless 202 a fork is longer than length N is signed by at least one anchor node 204a-n, it that fork may not be accepted by the rest of the network. Double spends may be avoided 203 with greater certainty by not accepting a transaction's finality until the block that contains it is built upon by a chain of length N.

Depending on the embodiment, the time interval between anchor blocks may be fixed, or it be configured to vary based on some on-chain metric, for instance total network computational power, the difficulty of an algorithmic problem being solved, the aggregate value of locked tokens, or the number of block-building nodes participating in the network, with smaller networks or networks achieving lower metrics benefiting from and configuring smaller intervals than larger networks or networks achieving higher metrics.

Various embodiments may employ said anchor blocks to reduce the risk or negative impact of a reorganization that may result from a blockchain fork. For example, in some embodiments, a fork of length greater than N may be rejected by the network unless it contains at least one authorized anchor node 202 at a depth less than N, or alternately at a depth less than N+1. In certain embodiments, a blockchain network may assign higher trust values to anchor blocks they create compared to blocks created by standard nodes. This trust differential may enable anchor blocks to function as secure backstops, potentially establishing hard upper limits on record and/or transaction confirmation time that may be independent of network size.

In one or more embodiments, anchor blocks may be produced through competitive processes rather than through direct selection. For example, some implementations may allow both trusted nodes and untrusted nodes to compete to produce a block at any given block height. Various embodiments may provide trusted nodes with certain probabilistic advantages in such competition. In some embodiments, for instance within a proof-of-work system, trusted nodes may be assigned lower difficulty targets to satisfy algorithmic requirements compared to untrusted nodes. Some embodiments may implement other probabilistic selection processes wherein trusted nodes may be given higher selection probabilities compared to untrusted nodes.

In certain embodiments, while trusted nodes may enjoy competitive advantages, such advantages may be probabilistic in nature and may not guarantee selection of trusted nodes' blocks. For example, some implementations operating with larger networks may still frequently select blocks produced by untrusted nodes despite the probabilistic advantage given to trusted nodes. Various embodiments may configure trusted nodes to compete with each other on equal footing. Some implementations may distribute unequal competitive advantages among trusted nodes according to one or more objectively-determined metrics.

In various embodiments, while anchor blocks produced by trusted nodes may serve particular security functions as described herein, the competitive block production process may continue to provide opportunities for untrusted nodes to contribute blocks to the chain, even if designated anchor block heights are specified by the embodiment. Some implementations may dynamically adjust the probabilistic advantages given to trusted nodes based on network conditions such as size, security requirements, or other metrics.

In contrast, in alternate embodiments, the anchor block mechanism may, provide a deterministic approach to transaction finality by ensuring that a valid fork should contain anchor blocks.

In one or more embodiments, trusted nodes may attempt to communicate with each other outside the public blockchain protocol, in order to detect if the blockchain fork they are connecting to is also subscribed-to by a minimum threshold of trusted nodes, or if the fork may be a minority fork, an isolated fork, or may otherwise be subject to reorganization in the future. In such an embodiment, a trusted node that finds itself out-of-sync with other trusted nodes may abstain from generating any anchor blocks, and any wallet node or interface node services or activities provided in conjunction with said trusted node may be paused until said trusted node synchronizes its version of the global state with the majority fork, connected fork, or whatever other fork is likely to persist due to the participation of other trusted nodes.

### Payment Channel Networks, Structures And Processes

Embodiments described herein also contemplate the use of payment channels and payment channel networks to optimize transaction scalability, reduce fees, and enhance privacy. In one or more embodiments, payment channels operate as time-locked escrow contracts, enabling two parties to transact off-chain while potentially utilizing the blockchain only for the opening and closing of the channel.

Payment channel networks, such as the Bitcoin Lightning Network, offer substantial advantages over traditional on-chain blockchain payments by enabling faster, more cost-effective, and scalable transactions. These networks allow participants to conduct off-chain transfers, reducing congestion and transaction fees while maintaining the security of the underlying blockchain. By aggregating the value multiple payments into a single on-chain settlement, users minimize fees and optimize efficiency, particularly during periods of high blockchain activity.

A key benefit of these networks is near-instantaneous payment processing. Once a payment channel is established, value can be transferred without waiting for block confirmations, making payment channel networks ideal for applications such as retail payments, micropayments, and cross-border transfers. Additionally, payment channel networks enhance scalability by shifting many payments off-chain, potentially reducing record and/or transaction processing load of a blockchain, and increasing payment throughput of the overall system.

In one or more embodiments, payment channel networks may also provide enhanced resilience to blockchain reorganizations, which may occur, for example, in the context of a network partition, 51% attack or similar disruption. By facilitating payments off-chain, payment channels may reduce the exposure of individual payments to the risk of reversal or invalidation. In certain embodiments, only the opening and closing events of the channel are recorded on-chain, and these on-chain events may optionally incorporate additional protective mechanisms. In certain embodiments, such protective mechanisms may include anchor blocks and/or configurable confirmation delays, to further mitigate risks. This configuration allows one or more payment channels to avoid being disrupted by a blockchain reorganization, thereby reducing the likelihood of financial losses or service disruptions for participants.

Payment channels and payment channel networks also provide a significant advancement over traditional consumer payment networks, such as Visa and Mastercard, by enabling instantaneous or near-instantaneous settlement between the payer, merchant, and intermediaries. In a payment channel network, funds received can be immediately reused, even before being recorded back on the blockchain, allowing for real-time liquidity. Syncing the payment channel to the blockchain for final settlement incurs only minimal delay, ensuring rapid and seamless finalization.

Additionally, payment channels eliminate the risks of default and chargebacks that are present in traditional payment systems. Transactions within payment channels are cryptographically secured and finalized through mutually signed amendments, ensuring they are irrevocable and fraud-resistant. This design removes reliance on third-party arbitration, providing both payers and merchants with greater security, certainty, and efficiency compared to conventional payment networks.

Payment channels are created and controlled by signatures added to payment channel records and/or transactions, which signatures are generated by keys, which keys are associated with addresses or accounts. A signature signs a transaction to create an account, and a signature authorizes the various transactions that update the account.

Nodes within a payment channel network each control one or more blockchain addresses or accounts, which blockchain addresses or accounts provide the node with the ability to open channels with other nodes in the network, and exchange value within the network.

The lifecycle of a payment channel typically involves several key steps, beginning with opening the channel, where two parties contribute value to a shared escrow contract. This transaction is recorded on the blockchain as the opening transaction, establishing the initial state of the channel. During the off-chain transactions phase, the parties exchange payments privately through signed amendments that update the escrow balance without interacting with the blockchain. These amendments serve as a secure record of the transaction history, maintaining the confidentiality of individual payment details. To enhance efficiency and ensure synchronization with the blockchain, the payment channel supports periodic updates. These updates allow the current state of the channel to be recorded on the blockchain at predefined intervals or upon mutual agreement, ensuring consistency and reducing potential disputes, all without requiring the channel to be closed. Finally, in the closing phase, either party may submit the final amendment to the blockchain, prompting the escrow contract to distribute the remaining balances according to the latest agreed state, thereby concluding the channel's lifecycle.

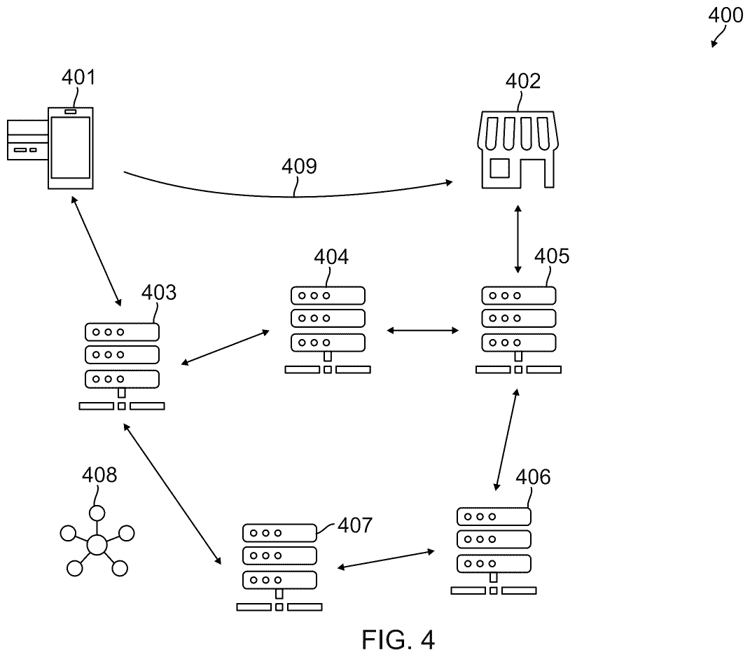

FIG. 4 shows a payment channel network 400 illustrating the progress of a payment in a network, and how a payment is conveyed to a recipient from a sender, according to at least one example embodiment. Various embodiments may implement a decentralized payment channel network structure comprising multiple interconnected components. In some implementations, the network may include one or more block-building nodes 408 that validate and process on-chain transactions, such as channel opening and closing operations, while a plurality of payment channel nodes 403, 404, 405, 406, and 407 form the core of the off-chain payment routing infrastructure, including edge nodes 403 and 405, as well as interconnection nodes 404, 407, and 406. Each payment channel node may maintain multiple payment channels with other payment channel nodes, enabling the formation of diverse payment routes through the network while reducing on-chain transactions. The payment channel node with which a node has opened a payment channel is the channel partner of that node.

According to certain embodiments, end-user components may interface with the network through specialized access points. For example, sender wallet (payment channel wallet) nodes 401 may comprise user interface elements and cryptographic capabilities that enable users to initiate payments, but such wallet nodes may interact with the network exclusively through one or more edge nodes 403. Similarly, payment channel merchant or recipient interfaces 402 may comprise point-of-sale or payment acceptance wallet nodes or interface nodes which may connect through one or more separate edge nodes 405. This structure may create an architecture where wallet nodes and interface nodes connect to edge nodes, and interconnect nodes maintain interconnected payment channels with each other, while a plurality of these components exchange data and synchronize state with block building nodes 408, which update the global state by incorporating records and/or transactions generated by the other components of the system.

In some implementations, the relationships between components may be governed by specific rules and constraints. Payment channel nodes 403, 404, 405, 406 and 407 may establish and maintain off-chain payment channels with multiple peer payment channel, creating a plurality of possible payment routes, while also serving as access points for their associated wallets and merchant interfaces. Block-building nodes 408 may process and validate the on-chain transactions that secure these payment channels, including channel creation, closure, and dispute resolution operations, without being directly involved in individual payments. This architecture may enable high-throughput payment flows while maintaining security through a combination of off-chain efficiency and on-chain settlement guarantees.

According to various embodiments, a payment flow through a decentralized payment channel network 400 may be described. Said payment flow may be initiated when a merchant or other intended recipient desires to receive payment. In some implementations, the recipient's system may generate a unique secret confirmation code and establish a conditional payment route through the network, communicating this secret code to the prospective sender through a payment initiation message 409. This secret confirmation code may serve multiple purposes: it may prove payment completion, prevent intermediate nodes from claiming funds without recipient confirmation, and ensure atomic execution of the multi-hop payment.

In certain embodiments, the payment process may begin at a sender's wallet node 401. This wallet node 401 may maintain an exclusive relationship with a specific payment channel node 403, which may serve as the wallet's sole entry point into the payment channel network. One or more embodiments may require the wallet node 401 to operate as a captive system of its associated edge node 403, necessarily accepting the fee structures and operational parameters established by that edge node; alternate embodiments allow wallet nodes to connect to multiple edge nodes. The edge node 403, upon receiving a payment request from its associated wallet node 401, may begin orchestrating the payment's journey through the network.

Various embodiments may implement various routing mechanisms as the payment propagates through the network of payment channel nodes 403, 404, 405, 406, and 407. Payment channel nodes may maintain fee schedules for routing services, and the network may employ pathfinding algorithms to identify optimal routes. These algorithms may consider multiple factors, including but not limited to: aggregate routing fees across each potential path, available channel liquidity, channel reliability metrics, and historical performance data. The system may dynamically adjust routes based on real-time network conditions and may maintain alternative routes as contingencies.

In certain embodiments, the sender 401 and recipient 402 may operate using different tokens, currencies, or other units of value, requiring currency conversion or token exchange as part of the payment flow. Some implementations may enable payment channel nodes 403, 404, 405, 406, and 407 to maintain current exchange rate information and offer different conversion rates for various token pairs or currency pairs. The pathfinding algorithms may incorporate these exchange rates alongside routing fees to optimize various payment parameters according to configured preferences. For example, some embodiments may optimize routes to maximize the value received by the recipient 402 by identifying paths with favorable combinations of exchange rates and routing fees. Other implementations may optimize to minimize the amount the sender 401 should pay to deliver a specified value to the recipient 402. Various embodiments may enable participants to specify their optimization preferences, such as fastest settlement time, lowest aggregate fees, best exchange rates, or weighted combinations thereof. The system may calculate optimal routes that satisfy these preferences while accounting for the available liquidity in each candidate payment channel and the various exchange rates and fees offered by each payment channel node 403, 404, 405, 406, and 407 along potential paths.

In certain embodiments, the payment channel nodes 403, 404, 405, 406, and 407 may implement a staged settlement protocol that ensures payment security and atomicity. Each payment channel node's channel update may be conditional upon successful completion of all subsequent hops, with the secret confirmation code serving as proof of completion. This staging mechanism may protect against partial payments, ensure that routing nodes cannot lose funds due to downstream payment failures, and maintain the atomic nature of the overall transaction.

According to some implementations, each hop in the payment route may establish conditional payment commitments that are secured by cryptographic hashes of the secret confirmation code. When the payment reaches the recipient's payment channel node 405, the recipient 402 may verify the incoming payment details and reveal the secret code to claim the funds. This revelation of the secret confirmation code may trigger a cascade of settlement operations, propagating backward through the payment route. Each participating payment channel node 405, 404, and 403 may validate the secret code, settle its incoming payment channel, and reveal the secret to its predecessor in the route, creating an atomic chain of settlements that either completes fully or fails completely.

Various implementations may employ timeouts and fallback mechanisms at each hop to handle potential failures or delays. If the recipient 402 fails to reveal the secret confirmation code within a specified timeframe, or if any intermediate node becomes unresponsive, the conditional payments may automatically cancel, releasing reserved funds and allowing nodes to attempt alternate routes. This timeout mechanism may work in conjunction with the routing system to ensure reliable payment delivery while protecting participants from locked funds or incomplete transfers.

In certain embodiments of a payment channel network, said secret confirmation code comprises a hash pre-image of a cryptographic hash function (the pre-image), which is initially shared by the sender wallet node with the recipient wallet node or interface node in a direct communication, and which in the final stage may be propagated from the recipient wallet node or interface node 402 back to the original sender, facilitating the settlement of the payment across the network of payment channels.

In various embodiments, a payment channel network payment relies on Hash Time-Locked Contracts (HTLCs), which may require the recipient of a payment to reveal the pre-image in order to claim funds. The pre-image is a piece of data that satisfies the hash condition and unlocks the payment, as per the mechanism of the HTLC. When the ultimate receiver of the payment claims the funds associated with the HTLC, the receiver wallet node or interface node may share the pre-image with their edge node, which will in turn share it with its direct channel partner, in at least one embodiment by signing and sharing an updated payment channel record or transaction that includes the pre-image and resolved HTLC. The channel partner may then reclaim their portion of the payment from the next channel in the chain, by in turn revealing the pre-image to their next channel partner in the chain, in an embodiment by signing and sharing an updated payment channel record or transaction that includes the pre-image and resolved HTLC. The propagation of the pre-image continues in a reverse sequence, with each channel partner updating their respective channel state and exchanging new transactions with their counterparty to reflect the settled HTLC.

As the pre-image propagates back toward the original sender, each intermediate channel updates its local state, reducing the locked HTLC funds and restoring available liquidity. This process ensures that each intermediary receives their portion of the payment, covering the amount they forwarded plus any fees they are entitled to for routing the payment. The final settlement results in updated channel balances for all participating nodes, ensuring that the payment is securely and efficiently processed end-to-end.

In certain embodiments, if the pre-image required to resolve HTLC is not shared, the payment cannot be settled, and the locked funds remain inaccessible until the contract expires, effectively nullifying or voiding the payment. This may occur if the recipient chooses not to claim the payment, communication fails, or the network is disrupted. The system enforces atomicity, ensuring incomplete payments do not affect channel balances, and participants can take corrective actions if needed.

In various embodiments, this propagation mechanism enables trustless, atomic multi-hop payments. It ensures that funds are only released when the ultimate receiver claims the payment and provides the required pre-image, preventing any intermediate node from being at risk of loss. This process is non-limiting and may vary in specific implementations, as alternative methods of propagating the pre-image or resolving HTLCs could be employed while maintaining the principles of atomicity, security, and decentralization.

FIG. 5 shows a diagram 500 illustrating that in various embodiments, the individual payment channels established between nodes (i.e. between channel partners) are implemented as a payment channel structure 500 which may be established through a sequence of defined steps and states. Initially, during a channel establishment phase, two participating nodes may contribute funds to an escrow contract 501 that may be recorded on a blockchain network 502 for processing. This initial escrow contract may establish starting parameters including, but not limited to, initial value allocations, time lock parameters, and penalty conditions.

Some embodiments may maintain two sets of reciprocal amendments to the initial payment channel escrow contract, wherein a first set of contract amendments 508 may be stored off-chain in a first channel partner's node 509, while a mirrored set of contract amendments 506 may be maintained at a second channel partner's node 505. Each reciprocal amendment may already be signed by one channel partner node and sent to the other channel partner node, such that either node may close and settle the escrow contract by cryptographically signing and submitting to the blockchain network the amendment shared by its counterparty 502. In at least one implementation, said contract amendments (508, 506) may be implemented as zero-knowledge payment channel records.

In certain embodiments, while the payment channel remains open, parties may exchange payments 507 through the transfer of signed reciprocal amendments to the escrow contract. These amendments may update the escrow balance to reflect the value that has been transferred. Each time a new set of reciprocal amendments is generated, prior amendments representing old escrow states may be discarded and replaced. The block-building node 502 may ultimately process these amendments during channel closing events, or, alternately, on-chain updates to the channel that do not close the channel. However, in various embodiments, all or most amendments are held off-chain while the payment channel stays open.

Various embodiments may protect against fraudulent submissions through a “token penalty” mechanism, which token penalty may be imposed by the application of a “revocation key”. If a cheating channel partner attempts to submit an outdated amendment through the blockchain network 502, the counterparty channel partner may write the revocation key to the blockchain, causing the revocation penalty to be paid to the counterparty channel partner at the expense of the cheating channel partner. This penalty mechanism may be enforced through time-locked amendments that prevent immediate settlement, providing time for a penalty record or transaction to be incorporated into the blockchain.

Some embodiments may implement settlement procedures wherein either party's node 505, 509 may initiate channel closure 504 by submitting a final contract state in the form of a final update or closing payment channel record or transaction 503 to the blockchain network 502. To enable penalty enforcement, the escrow may remain frozen during a lock period to give counterparties time to submit penalty keys if outdated amendments are broadcast.

In certain implementations, every time new amendments are exchanged between the channel partner's nodes 505, 709, revocation keys pertaining to the previous generation of amendments may also be exchanged, effectively invalidating those prior amendments and rendering them worthless if submitted to the blockchain network 502.

Various embodiments may enable the channel to remain open indefinitely, with the first channel partner node 509 and second channel partner node 505 continuing to exchange payments and amendments 507 with only the opening payment channels being incorporated into the blockchain through the block-building node 502, with a closing payment channel record being held off-chain until the point that the channel is closed. In alternate embodiments, a payment channel may remain open indefinitely, but an update payment channel record or transaction may be periodically added to the blockchain periodically; such a record may act as the equivalent of a close payment channel record or transaction immediately followed by an open payment channel record between the same channel partners.

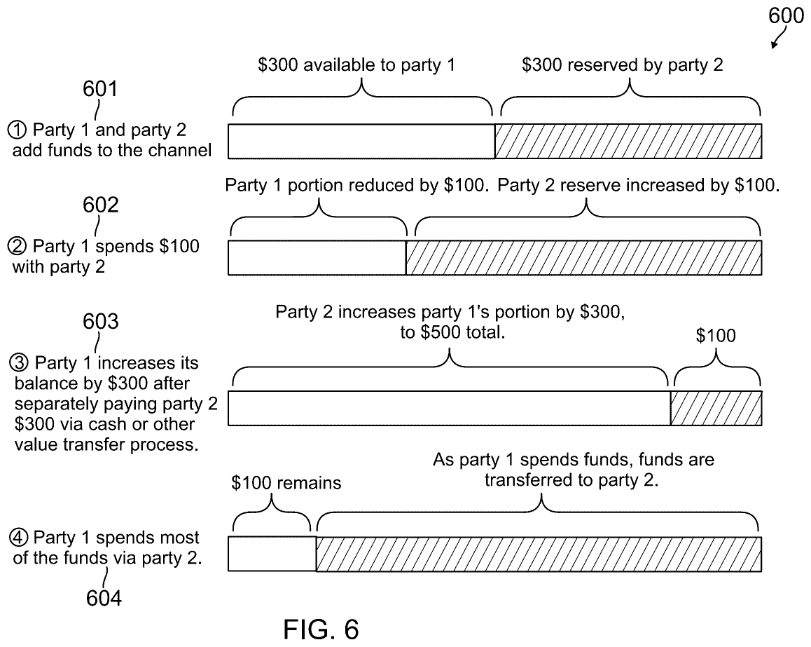

FIG. 6 shows a diagram 600 illustrating a payment channel lifecycle demonstrating how two channel partners may conduct multiple value transfers while maintaining only two on-chain transactions, according to an embodiment. During channel establishment, depicted in element 601, a first channel partner and a second channel partner may each commit value to a shared escrow contract, with the first channel partner making $300 available in its unspent portion and the second channel partner maintaining $300 in its reserve portion, in the example shown. This establishment may be recorded as a single on-chain transaction creating a cryptographically secure escrow.

In accordance with some embodiments, following establishment, the first channel partner may initiate a payment of $100 to the second channel partner as depicted 602. To effectuate this payment, the channel partners may exchange cryptographically signed state update or closing payment channel records or transactions that reflect adjusted channel balances. Through this exchange of reciprocal records, the first channel partner's available portion may be decremented by the value spent (depicted as $100 in the example shown) while the second channel partner's escrow amount may be incremented by the same amount. This modification of escrow balances may be maintained off-chain between the parties, avoiding the need to synchronize with the blockchain.

Subsequently, in some embodiments, value may shift from one channel partner to the other in response to an external payment 603. In the example shown, after the first channel partner transfers $300 to the second channel partner through a separate off-chain payment, the parties exchange updated payment channel records or transactions reflecting an increase in the first channel partner's escrow balance by $300, and a decrease in the second channel partner's escrow balance by an equivalent amount. An embodiment implementing such a method of modifying channel balances following an external provides a means for external funds to be added to a channel partner's account.

In accordance with some embodiments, as depicted in element 604, the first party may conduct multiple sequential payments through the second party. As the first party depletes their available funds, the state updates may continuously adjust the balance allocation between the parties, with each update superseding all previous states.

When all desired transfers are complete, in some embodiments, either party may initiate channel closure by broadcasting the most recent valid state to the blockchain. This settlement, representing only the second on-chain transaction in the channel's lifecycle, may distribute the escrowed funds according to the final agreed-upon allocation. Through this mechanism, the payment channel may enable an unlimited number of value transfers while requiring only two on-chain transactions—one for opening and one for closing.

It should be understood that while specific currency amounts are shown in FIG. 6 600, these values are exemplary only. Actual implementations may support any denomination of value compatible with the underlying blockchain system, bounded only by the initial channel capacity established during funding. The illustrated amounts serve primarily to demonstrate the relative relationships between sequential channel states and the preservation of total value across all state transformations.

### Payment Channels and Reorganizations

Payment channels may, in various embodiments, provide enhanced protection against blockchain reorganization through multiple coordinated timing mechanisms. In some implementations, initial protection may be achieved by requiring that no payments be processed across a payment channel until some margin of time after the on-chain transaction that opened the payment channel achieves finality (in whatever manner finality might be determined for said embodiments). After such point, subsequent payments across that payment channel may be considered to have to have immediate effective finality, effectively eliminating reorganization risk for those in-channel transactions.

The specific nature of finality for certain such embodiments is important, however. Further protection may, in some implementations, be required, which requirement may be satisfied through specification of a time-lock period for channel-closing operations that extends beyond the maximum duration typically required for on-chain finalization. Such extended time-lock periods may enable the correction of any attempted cheating, as they may provide sufficient time for payment channel penalty records or transactions to be successfully incorporated into the blockchain even if such transactions are initially reorganized out during an attack. However, depending on the embodiment, the time-lock period may need to be as long as 1×, 2×, or 3× the time required for the blockchain to reach finality, or longer, so as to eliminate the possibility of a penalty record ultimately not being incorporated into the blockchain in time.

FIG. 3 shows a diagram 300 illustrating how anchor blocks may serve as an additional risk mitigator for payment channel operations, also referred to as payment channel finalization with anchor blocks, according to an embodiment. Such anchor blocks may be implemented as specialized confirmation points created by trusted nodes, potentially providing definitive finalization of both channel-opening and channel-closing events. When channel operations achieve finalization through one or more anchor blocks, certain implementations may guarantee all payments within that channel for all participating parties, potentially providing comprehensive protection against various attack vectors including double-spend attempts and reorganizations.

According to some embodiments, blockchain records and/or transactions in general which exceed certain value thresholds may be subject to enhanced confirmation requirements 303. Depending on the nature of the embodiment, such high-value transactions may need to be followed on-chain by one or more anchor blocks before being considered final. The escrow size specified as part of open payment channel records and/or transactions may also be subject to size limitations that correspond to network security parameters, in some embodiments. The time-lock periods applied to channel escrow contracts may, in various embodiments, be coordinated with anchor block timing and network security metrics to maintain appropriate security levels throughout channel operation lifecycle 301-302.

The implementation of anchor blocks may, in various embodiments, provide a mechanism for establishing and maintaining transaction finality across different network scales and conditions. Such flexibility may enable efficient operation of payment channels while maintaining robust security against various risk scenarios.

### Payment Channel Liquidity Solutions

Various embodiments disclosed herein relate to payment channel liquidity and provide payment channel liquidity solutions.

A major challenge that confronts known payment channel networks such as the Bitcoin Lightning network is capital efficiency. This challenge emerges from the fact that tokens are placed in escrow within the individual payment channels. A payment channel protocol depends on all participating parties putting sufficient tokens in escrow to cover the maximum payment outflow each will undertake while operating the channel.

Token quantities locked in escrow on a payment channel network are not otherwise available for use-investable or spendable outside of the payment channel network-because they cannot be transferred out of escrow without closing, resetting, or modifying the channel on-chain. A frequent operating objective of payment channel networks is to avoid on-chain syncing of the payment channel state with the blockchain, so any re-allocation of escrowed tokens that may require on-chain syncing runs counter to that purpose.

Depending on the nature of the implementation, a payment channel may yield a return to a channel operator who connects multiple channels together via one or more nodes that provide connection between consumers and/or between consumers and businesses. Such nodes may be termed interconnection nodes. An interconnection node may generate a yield from the fees that are charged, or from an exchange rate margin that may be earned when payments traverse such an interconnection node (said payments constituting the node's payment flow). However, by definition, the percentage yield (which may be considered a return on capital) is inversely proportional to the value of tokens locked in such an interconnection node's payment channels. Said percentage yield (which as stated above may be considered a return on capital) is lower the greater the value of tokens locked in payment channel escrow in service of such a node, given a comparable payment flow. Inversely, the percentage yield is higher the lesser the value of tokens are locked, given a comparable payment flow. If more fees are generated with less token utilization inside the channels, the profit-per-token-value-locked is higher, meaning the percentage yield and return on capital is higher.

Businesses and investors that have the capacity to operate or fund interconnection nodes will often prefer to allocate money and/or capital (including tokens) in a manner that generates a yield. Conversely, many individual consumers and/or businesses may have a low expectation of any investment return or yield from accounts held for the purpose of every-day payments, particularly if they prioritize flexibility in the use of money and/or capital. Such consumers and/or businesses may lack a strong incentive to re-invest escrowed tokens, because there are often fewer competitive alternatives.

A category of businesses that may not require or desire a yield to be earned on some portion of tokens that they hold are the issuers of currency-denominated tokens; it is possible such issuers may themselves hold an unlimited number of such tokens they themselves have issued without incurring any opportunity cost. Such issuers may not have any requirement to hold reserves backing such tokens if they are not issued or distributed to any third party. Under various circumstances, such issuers may lack such a reserve requirement (meaning, a requirement to hold assets backing the value of tokens issued) when such tokens are issued on-chain but are held within their own “treasury” account.

An issuer of currency-denominated tokens (also called stablecoins) may be required by law, regulation, or market expectation to hold 100% reserves, meaning such an issuer is required to hold one liquid unit of currency (as, for example but not limited to, cash, government debt, and/or bank account balance) for every corresponding unit of currency-denominated tokens issued. However, in many instances no such requirement exists for tokens recorded on-chain by the issuer, but held by the issuer itself; this may be because there is no counter-party who would attempt to redeem such tokens. In fact, the process of redemption itself may involve the redeeming counter party transferring such tokens to the issuer's account on-chain before receiving the redemption payment off-chain.

Alternately, such issuers of currency-denominated tokens may lack any reserve requirement at all.

### Capital-Efficient Payment Channels

At least one possible embodiment of the present invention comprises a capital-efficient system and/or method to operate a payment channel network that processes and facilitates payments denominated in official currency or national currency.

One or more possible embodiments comprise a payment channel network configured in such a manner that currency-denominated token issuers function as operators of interconnection nodes. Such currency-denominated token issuers (also referred to herein simply as “issuers”) may be able to fund their portion of the escrow using tokens that they themselves have issued without any corresponding off-chain reserve being in place backing those tokens.

When creating such a payment channel, the counterparty of such an issuer may optionally fund the counterparty portion of the escrow using tokens issued to the counterparty by said issuer; alternately, said counterparty may fund the counterparty portion of the escrow using tokens purchased by the counterparty from the issuer or some third party.

When creating such a payment channel, an issuer may optionally fund their own portion of said escrow using tokens that have been issued to the issuer themselves.

In an embodiment, tokens held by the counterparty's escrow within such a payment channel may need to be fully-reserved by the issuer, while tokens held by the issuer's escrow within the payment channel would not implicate the issuer holding any additional reserves. This means that, in such an embodiment, only the portion of the escrow held by the issuer's counter-party would potentially carry a capital cost.

One or more possible embodiments of the present invention may comprise a mechanism that functions in such a way that a transfer of tokens from the token issuer to its counterparty via the payment channel would be accompanied by some transfer of liquid assets from the counterparty to the issuer.

In one or more embodiments, an issuer may transfer tokens to a counterparty within a payment channel after receiving notification that a credit card payment, debit card payment, or other electronic payment has been made in its favor-sent from the counterparty or from another third party to the issuer in order to fund a transfer. Such a credit-card payment would create a cash-equivalent receivable asset that would result in a bank deposit some time after the payment is originally made. In at least one such embodiment, if such a receivable is considered to be a cash-equivalent asset, said issuer's cash-equivalent assets and receivables would increase in an amount equal to the number of tokens issued and held by third-parties.

In one or more embodiments, an issuer may transfer tokens to a counterparty within a payment channel after receiving notification of the completion of a bank wire transfer or clearing house payment made in its favor-sent from the counterparty or from another party in order to fund the transfer. Such a transfer or payment may increase the balance of a bank account held by the issuer in an amount equal to the amount transferred over the payment channel.

In one or more embodiments, a token issuer may receive a transfer of third-party blockchain tokens from a counterparty, and then send a payment to the counterparty via the payment channel, while maintaining its reserve coverage requirement. In at least one such embodiment, said third-party blockchain tokens may comprise liquid currency-denominated tokens (meaning currency-denominated tokens that are redeemable at will or which can be sold and purchased at will in liquid market) which tokens are issued by another qualified issuer. In an embodiment such tokens may also satisfy reserve requirements, insofar as they function as a cash-equivalent asset.

In one or more embodiments, an issuer may transfer tokens to a first counterparty within the payment channel upon instructions being received from a second counterparty, which second counterparty shares a separate second payment channel with the issuer. This second counterparty party may transfer tokens to the issuer via this separate second payment channel, with the expectation that the issuer will forward the payment to the ultimate receiver via the first channel. In at least one such embodiment, the issuer will have gained control of currency-denominated tokens via the second payment channel in an amount equivalent to the tokens transferred via the first payment channel, reserve requirements are met.

In one or more possible embodiments, by such a mechanism, a currency-denominated token issuer may act as a connecting node within a payment-channel network without incurring a high cost of capital:
The issuer may issue, generate or mint tokens that reside in its own treasury account or accounts on-chain. These tokens may not be reserve-backed in that they are not formally issued (meaning, they are not in the possession of third parties). Optionally, other tokens issued by the same issuer may be reserve-backed in the case that such tokens reside in third-party accounts.
The issuer may open one or more payment channels with one or more various counterparties, and may fund its own portion of each payment channel using tokens from its own treasury account. Optionally, because these escrowed tokens remain under the issuer's full control, they would not be reserve-backed. Conversely, tokens contributed by a counterparty, which may reside within the counterparty's portion of the escrow, may be reserve-backed. However, it is not necessarily required that the counterparty contribute any tokens to the escrow initially.
Upon receipt of external funding from a counterparty, the issuer may transfer tokens over the payment channel to the counterparty. Such funding may come from a bank wire or bank transfer, a credit- or debit-card payment, or other source. The proceeds of such funding may optionally be retained by the issuer and may contribute to the reserve backing the tokens transferred to the counterparty.

In an embodiment, a first counterparty may transfer funds to an issuer with instructions to forward the transfer to a second counterparty of the issuer, via a second payment channel; the issuer satisfies the instructions by forwarding the transfer to said second counterparty. Because the funds received by the issuer and funds sent by the issuer are equivalent (setting aside any fees or exchange rate conversion between unlike tokens) there is no net change to the number of tokens generated by the issuer and in the hands of third parties.

In an embodiment, a counterparty may withdraw funds from the system, by transferring tokens to the issuer via the payment channel, and requesting that the issuer give or send the counterparty an equivalent value in currency via some payment medium. The counterparty may receive such value in the form of physical cash, a bank wire or bank transfer, or other means of conveying value.

In an embodiment, either the issuer or a counterparty may close a channel, causing the tokens held in escrow to revert to each party's blockchain account. Alternately, via similar means, either the issuer or a counterparty may reduce the size of their escrow contribution. Neither such operation should affect the size of the issuer's reserve, nor would either operation change the quantity of currency-denominated tokens issued by the issuer and in the hands of third-parties.

### Permissioning Constraints, Device Cryptographic Keys, Identity Determination

One or more possible embodiments of the present invention comprise a blockchain configured to record one or more accounts or addresses within the blockchain's global state, and to associate one or more accounts and/or addresses within said global state with one or more corresponding cryptographic hash digests. Each said hash digest may be generated by performing a hash operation on an underlying data structure, which underlying data structure is a standardized representation of underlying data comprising the various details of the identity of an individual or business. A user of such a blockchain may separately hold onto said underlying data off-chain, and may share elements of the underlying data with third parties that said user may desire to reveal elements of their identity to. Said hash digest effectively stamps the identity of the user on the blockchain without revealing it publicly; the user may optionally reveal the details to select third parties, and prove that the identity details correspond to the hash digest.

In one embodiment, the user may prove that the identity details correspond to the hash digest by performing a hash operation on a standardized representation of all or a portion of the underlying data, and by comparing the hash digest output with the hash digest associated with that user's blockchain account or address.

In one or more embodiments, the underlying data structure may be constructed as a hash tree, such that hash digests are generated for different elements within the data structure individually, or aggregated together into sub-groups, which hash digests are included in the data structure, and are combined with other hash digests similarly derived from other elements of the data structure, in a tree structure, such that the ultimate hash digest of the whole data structure is ultimately derived from the penultimate nodes of the tree, and is effectively a root of the tree. A type of hash tree is a Merkle tree. In at least one embodiment, the underlying data structure is a Merkle tree.

In one or more embodiments, any individual element or aggregated group of elements that correspond to a hash digest within a hash tree can be shared with a third party in the form of a “hash tree proof”, which includes all the hashes leading from the root to the data being shared (hash nodes), along with the sibling hashes of all such hash nodes, and the sibling hashes of the data being shared, without including any data underlying these hashes, other than the data being shared. The hash tree proof may be used to demonstrate that the shared data, when combined with the hash nodes and siblings, is a contributing element of the root hash. Using a hash tree proof, an individual whose identity has been recorded on the blockchain may reveal a select portion of the underlying data, without revealing all of the information, and prove that the revealed portion of the underlying data corresponds to and is contained in the cryptographic hash digest. A type of hash tree proof is a Merkle proof. In at least one embodiment, the hash proof used is a Merkle proof.

In one or more embodiments, the blockchain may be configured to accept a decision indicator, which the decision indicator references some element or data on the blockchain. In an embodiment, the decision indicator may be used as evidence that a particular third party has taken a decision with regards to said element or data on the blockchain.

For example, a blockchain may optionally be configured to accept a decision indicator from a third party identity verifier, where the decision indicator indicates that the third party identity verifier has received the underlying data, and has verified that the cryptographic hash digest corresponding to the underlying data (as formatted in a canonical manner) is equal to the hash digest written to the blockchain, and that the underlying data does accurately reflect the identity of the owner of the blockchain account or address.

In an embodiment, the third party identity verifier knows that the owner of the account or address is the same party that has shared the underlying data with it because the identity verifier will have (a) received a cryptographically signed record or transaction which the verifier would be able to determine was signed by a cryptographic key pair corresponding to the account or address; and (b) because the underlying data would be shared along with various identity documents (potentially including digital identity documents) that are difficult or impossible for an impersonator to obtain. Because the third-party identity verifier has cryptographically signed the decision indicator using a public-private key signing scheme, third parties may reliably assume that the third-party identity verifier has verified the underlying data associated with the cryptographic hash digest, and that the underlying data is a reliable representation of the identity of the owner of the account or address.

In one or more embodiments, the blockchain may be configured to implement a permissioning system, which permissioning system filters out transactions or records that do not satisfy one or more permissioning constraints configured on the blockchain. A transaction or record that does not satisfy one or more potentially required permissioning constraints would be discarded or would be added to the blockchain, but would fail to effectuate the state transaction encoded in that transaction or record.

An alternate name for these permissioning constraints is “authorization filters” or “auth filters”. Under other circumstances, these permissioning constraints might be called “authorization subroutines”, “auth subroutines” or “authroutines”. More generally these permissioning constraints may be referred to as “permission encodings” or as a “permission encoding”.

In various alternate embodiments, these permissioning constraints may be implemented in various ways: as a pattern matching system like regular expressions; as a Turing complete programming language or execution environment; as an expression language that is lacking such programmatic elements as conditionals, loops and recursion; or as an encoding otherwise interpretable by a blockchain system.

In other possible embodiments, permissioning constraints may be configured for certain accounts or addresses, such that any transactions or records associated with those accounts or addresses would need to satisfy the permissioning constraints.

In one or more embodiments, tokens that are issued on the blockchain may be configured with permissioning constraints, such that any transaction or records associated with those tokens would need to satisfy the permissioning constraints. Using permissioning constraints associated with a token, a token issuer optionally may, for instance, restrict the utilization of the token to certain specific circumstances, which circumstances are determined according to the policies of the issuer. The token issuer may construct one or more permissioning constraints which cause one or more records to be discarded or to fail in the event that such a record did not conform to the requirements specified by the issuer.

For instance, in an embodiment a token issuer may require that the owner of an account have had its identity confirmed by the token issuer, which confirmation would be reflected by the account being associated with a cryptographic hash digest conforming to identity data that the issuer acting as an identity verifier had reviewed and confirmed, and by a decision indicator having been added by the issuer, confirming that the issuer had reviewed and confirmed the account owner's identity data.

In at least one embodiment, the token issuer may construct one or more permissioning constraints which cause one or more records to be discarded or to fail if the account or address signing that record is not associated with a cryptographic hash digest together with a decision indicator that had been added by the issuer itself.

In one or more embodiments, a blockchain may be configured such that accounts or addresses on that blockchain are associated with alternate sets of cryptographic keys in addition to the cryptographic key set first used to generate the account or address. These cryptographic keys may be held by different physical devices, giving those devices separate and independent ability to update the account or address by individually signing records that would update the account or address or some other blockchain state when added to the blockchain. An account or address may be associated with one or more device configurations, each of which device configurations is associated with a distinct cryptographic key set.

In one or more embodiments, using permissioning constraints associated with an account or address, a user may, for instance, restrict the utilization of that account or address to certain specific circumstances, which circumstances are determined according to the configuration specified by the user. Permissioning constraints may be constructed by the user which permissioning constraints cause any record to be discarded or to fail in the event that the record did not conform to the configuration specified by the user.

For example, in an embodiment, the user may configure the permissioning constraints to cause certain records or transactions to be valid if signed one set of cryptographic keys associated with an account or address, but invalid if signed by a different set of cryptographic keys associated with that account or address. Or, optionally, a record or transaction may be valid if signed by one device, but invalid if signed by another device.

### Payment Channel Permissioning

Various embodiments of the present invention may relate to payment channel permissioning. Such embodiments may provide means by which to ensure that certain legal compliance objective, risk-mitigation objectives, and other business objectives with regards to payment channel operation are satisfied.

Another known challenge faced by operators of payment channel networks is compliance with legal mandates. Bank-secrecy rules, anti-money-laundering rules, know-your-customer rules, sanctions rules, and other laws and regulations related to value transfer often mandate that individuals sending and receiving value be clearly identifiable and that any participating organization analyze activity on a platform for suspicious activity. In addition, user privacy expectations or legal mandates may dictate that customer activity be kept private and hidden from view.

One possible way to ensure compliance with legal mandates on a payment channel network is to restrict participation to entities that are explicitly authorized to participate. A network may be configured such that only authorized entities are able to operate nodes on the network.

In one or more embodiments of the present invention, a token issuer may restrict the use of its token in the network only to those nodes that the token issuer has explicitly approved. Entities controlling such nodes may act as responsible parties, fulfilling legal or regulatory compliance objectives for the network or for the token issuer. In the event that any such entity does not to fulfill its responsibilities, the token issuer may remove its authorization to operate a payment channel using that token.

In one or more embodiments, a blockchain may be configured so as to associate one or more accounts with a decision indicator that is an approval decision indicator. An approval decision indicator being associated with an account may allow the creator of the approval decision indicator to mark an account as having been approved in some capacity by that creator. In an embodiment, a token issuer may optionally associate a token with permissioning constraints that stop one or more accounts or addresses on the blockchain from opening a payment channel using that token unless said accounts or addresses are associated with an approval decision indicator created by the token issuer or some other party.

In an embodiment, by the mechanism of associating an account with an approval decision indicator in this way, the issuer of a token may implement a restriction on the accounts or addresses that are able to open or operate payment channels of that particular token. The token issuer may in this manner optionally configure the permissioning constraints to allow only approved accounts or addresses (meaning, accounts or addresses associated with an approval decision indicator) to open or otherwise interact with payment channels.

In such an embodiment, only accounts or addresses verified by the token issuer—or in an alternate embodiment, verified by another entity designated by the token issuer for such purpose-would be associated with an approval decision indicator. By this mechanism, only accounts or addresses that are used or managed in a legal and compliant manner may be permitted to interact with payment channels.

Nodes within a payment channel network may be characterized either as edge nodes or interconnection nodes. Edge nodes connect with or are managed by end-users, and interconnection nodes link edge nodes together in the network.

In various possible embodiments of the present invention, compliance requirements may differ between edge nodes and interconnection nodes. Edge nodes may be mandated to preserve and maintain records of payments across the network, including records of senders and ultimate receivers. Edge nodes may be allowed to connect with any user whose identity had been confirmed, but not users whose identity has not been confirmed. Conversely, interconnection nodes may not need to detailed records of all payments, but may be restricted in terms of the entities with which they are permitted to form payment channels.

In one or more potential embodiments of the present invention, the blockchain may be configured to associate an approval decision indicator with an edge node's blockchain account or address, with said approval decision indicator indicating that the account or address in question belongs to an edge node. Such accounts or addresses may be deemed to have been labeled as edge accounts or edge addresses. The blockchain may also be configured to associate an approval decision indicator with an interconnection node's blockchain account or address, with said approval decision indicator indicating that the account or address in question belongs to an interconnection node. Such accounts or addresses may be deemed to have been labeled as interconnection accounts or addresses.

In an embodiment, a token on such a blockchain may be configured with one or more permissioning constraints that permit interconnection accounts or addresses to open payment channels only with other interconnection accounts or addresses or with edge accounts or addresses, which payment channels are opened by each participating account or address signing one or more payment channel records or transactions, and which one or more permissioning constraints prohibit payment channel records or transactions that are signed by any interconnection account but do not also reference as counterparty an interconnection account or address or edge account or address.

In one or more possible embodiments, the blockchain may be configured with accounts or addresses that are consumer accounts or addresses.

Such consumer accounts or addresses may optionally be associated with a cryptographic hash digest together with a decision indicator that had been added by an issuer of a token on the blockchain. The issuer of said token may in some cases add such a decision indicator after it has confirmed that the cryptographic hash preimage of the cryptographic hash digest is an accurate representation of the real-world identity of the person that controls the account or address.

In at least one embodiment, a token may be configured with one or more permissioning constraints that permit edge accounts or addresses to open payment channels only with interconnection accounts or addresses, with other edge accounts or addresses, or with consumer accounts or addresses, which payment channels are opened by each participating account or address signing one or more payment channel records or transactions, and which one or more permissioning constraints prohibit payment channel records or transactions that are signed by an edge account but do not also reference as counterparty an interconnection account or address, an edge account or address, or a consumer account or address.

### Zero-Knowledge Payment Channels

Embodiments of the present invention may relate to zero-knowledge payment channels. A known privacy benefit of payment channel networks like the Bitcoin Lightning network is that payments that traverse the network are not publicly disclosed, unlike transactions or records written to a blockchain. The opening of each payment channel may be written to the blockchain, as well as the final closing of each payment channel. In between the opening and closing of a payment channel, other records or transactions pertaining to the payment channel may or may not be written to the blockchain. Information regarding the individual payments back and forth between users may only pass through the nodes necessary to traverse a route through the network, not to be reflected on the public blockchain.

A payment channel network may also provide further privacy via the implementation of an onion routing protocol, such that each node participating in a payment would only know the specific details necessary to transmit payment to the next hop in the route the payment is following to traverse the network. This privacy is maintained because only the details of the next hop are exposed to any node in the path; the details of subsequent hops are encrypted using the public cryptographic key of the next node, such that only the next node will know the next step in the route, etc.

In spite of the privacy protections present in current known payment-channel implementations, the fact that the transactions or records that effectuate (a) the funding of the channel and (b) the closing of the channel should both be written to the blockchain means that the number of tokens in the channel, the number of tokens individually contributed to the channel by each participant and the net number of tokens transferred over the channel in its lifetime are all publicly disclosed, on the blockchain. This public disclosure can be eliminated through one or more possible embodiments of the present invention, comprising a system and method involving zero-knowledge proofs.

In one or more embodiments, a blockchain may be configured to open, to close and optionally to update payment channels on-chain through zero-knowledge payment channel records or transactions, which are blockchain records or transactions that use non-interactive zero-knowledge proofs to hide the transformation of blockchain global state implicated by on-chain payment channel activity.

In an embodiment, accounts or addresses on such a blockchain may be configured with one or more private ledgers, which one or more private ledgers are represented in the blockchain global state by one or more cryptographic hash digests. Such a cryptographic hash digest is a masked private ledger of said accounts or addresses. Said cryptographic hash digest is generated by hashing a standardized, canonical representation of certain token balances held within said private ledger. This canonical representation—the cryptographic hash preimage of the masked private ledger—is the unmasked private ledger of said accounts or addresses.

In an embodiment, open payment channels may be configured on the blockchain with a channel private ledger, which channel private ledger encodes the token balances of the two participants within the payment channel. Such a channel private ledger may be represented on the blockchain by a cryptographic hash digest, which cryptographic hash digest is associated with the payment channel configured on the blockchain. This cryptographic hash digest (the masked channel private ledger) is a cryptographic hash of a standard or canonical representation of the escrow token balances of the two participants (the unmasked channel private ledger). A payment channel that includes a channel private ledger may be called a “zero-knowledge payment channel”.

In one or more embodiments, each participant in a zero-knowledge payment channel may store the unmasked private ledger of their own account or address off-chain without sharing it publicly or with the counterparty. Both participants each store the unmasked channel private ledger. Such unmasked channel private ledger may be stored in an of a variety of memory storage devices, including a rotating magnetic disk hard drive, a solid-state drive or NAND memory device, a random access memory device, a magnetic tape, or other modifiable storage device. The unmasked channel private ledger stored by the participants may be updated whenever payments are made (value is transferred) across the channel by participants.

In one or more embodiments, various zero-knowledge algorithmic encodings may be implemented, each zero-knowledge algorithmic encoding corresponding to a pre-defined type of global state transformation. Each type of global state transformation may correspond to one or more transformations of the blockchain's global state which transformation is embodied by a zero-knowledge record or transaction. Non-interactive zero-knowledge proofs may be constructed using one or more zero-knowledge algorithmic encodings through a process described elsewhere herein.

In an embodiment, an algorithmic encoding may be encoded that undertakes to move some portion of the token balance or token balances held in the private ledger of one or more of the participants to the private ledger of the payment channel.

In an embodiment, an algorithmic encoding may be encoded that undertakes to move one or more token balances from the private ledger of the payment channel to the private ledger or ledgers of one or more of the participants.

In an embodiment, an algorithmic encoding may be encoded that undertakes to move tokens within the channel private ledger of a payment channel, from one participant to the other.

### Time Locks and Zero-Knowledge Payment Channel Revocation

One essential known concept of payment channels is “time locking”. Payment channels include time locks, such that any record or transaction that closes a payment channel is delayed (i.e. locked) in its execution or is otherwise blocked until the specified time has passed. This mechanism is included in payment channel protocols to ensure that a revoked payment channel record imposes a penalty if the record or transaction is added to the blockchain after it should have been discarded.

In the event that a revoked payment channel record or transaction is added to the blockchain—with the effect that one of the two parties (the cheating party) receives an undeserved excess portion of the tokens held by the payment channel-a revocation key can be used to cause the payment channel to assign all or some portion of the cheating party's payment channel escrow balance (i.e. the token penalty comprising penalty tokens) to the other party (i.e. the non-cheating party). This mechanism creates an incentive for participants in payment channel networks such as the Bitcoin Lightning network to discard revoked records or transactions, to avoid this penalty.

In one or more embodiments of the present invention, a global state transformation embodied by a zero-knowledge payment channel record may be delayed for a certain number of blocks after the record is added to the blockchain, which delay lasts for as many blocks as may be configured on the blockchain. In the event that a revoked zero-knowledge payment channel record is added to the blockchain, the non-cheating party may intervene by adding a channel penalty record to the blockchain, which channel penalty record includes the revocation key and causes the token penalty to be imposed on the cheating party.

In one or more embodiments, zero-knowledge payment channel records that close zero-knowledge payment channels—or, optionally, that modify zero-knowledge payment channels—may include one or more of the following fields, among other fields:
A revocation key evidence, which is a data particle that can used to confirm knowledge of the revocation key. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
A payment channel reference, which is a reference to the zero-knowledge payment channel being closed or modified
Revision data, which includes any revision made to the on-chain masked channel private ledger, and which may, in the case of a channel closing record, include an update to the on-chain masked private ledger of each participant's account or address.
A first zero-knowledge channel proof, which is a non-interactive zero-knowledge proof provided by one of the two parties.
A second zero-knowledge channel proof, which is a non-interactive zero-knowledge proof provided by the other party.

In one or more possible embodiments of the present invention, a zero-knowledge payment channel record that is configured with two zero-knowledge channel proofs allows each of the payment channel participants to hide from the other their respective unmasked private ledger even when the token balances within each private ledger are being modified. Each such zero-knowledge channel proof acts as a separate proof of tokens being moved between the payment channel's private ledger and the respective participant's private ledger, exclusive of any effect on the other party's private ledger.

In one or more alternate embodiments, if only one zero-knowledge channel proof is used, then that combined zero-knowledge channel proof acts as a proof of tokens being moved among the channel's private ledger and the private ledgers of both participants. The party that generates such a combined zero-knowledge channel proof should have access to the unmasked private ledger of both participants, so that such data may be included among the private inputs to the corresponding algorithmic encoding.

In one or more embodiments, a zero-knowledge payment channel record that only moves tokens between private ledger balances within a zero-knowledge payment channel, without effectuating any change to the private ledger balances of either participant's accounts or addresses, may only configure a single zero-knowledge channel proof, not two. This may be the case when the private input to the algorithmic encoding used to generate the zero-knowledge channel proof excludes the unmasked private ledgers of the participants' accounts or addresses. The unmasked channel private ledger, which both participants hold, may be included with the private input to the algorithmic encoding used to generate said single zero-knowledge payment channel proof.

In one or more embodiments, when generating either party's zero-knowledge channel proof, various private inputs may be passed into the relevant circuit. This information may include one or more of the following: (a) that party's unmasked private ledger cryptographic hash; (b) the channel's unmasked private ledger cryptographic hash; (c) the quantity of tokens intended to be moved or transferred from one party to the other by inclusion of the zero-knowledge payment channel record on the blockchain. Public inputs passed to the circuit may include one or more masked private ledger cryptographic hash digests that have been written to the blockchain previously. The circuit output may include revision data, including replacement masked private ledger cryptographic hash digests.

In one or more embodiments, when a payment is negotiated between two participants in a zero-knowledge payment channel, through what can be called a “payment negotiation” process or method, each party provides to the other party certain information intended to stay private, and certain information that may become public. The participants retain other information-private information—that is not exchanged or disclosed at all.

In an embodiment, the party that is initiating the optional creation, modification, or closing of a zero-knowledge channel (the initiating party) may provide information to the other party (the responding party) including a zero-knowledge payment channel record. Such a record may be used by the responding party to update or close the channel if necessary at any point following the payment negotiation. This zero-knowledge payment record may include one or more of the following elements, among others:
A revocation key evidence previously shared by the responding party. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
A zero-knowledge payment channel proof generated by the initiating party, but not the zero-knowledge channel proof generated by the responding party.
The revision data related to the zero-knowledge payment channel's masked private ledger and possibly the revision data related to the initiating party's masked private ledger, but not the revision data related to the responding party's masked private ledger.

In an embodiment, prior to its inclusion on the blockchain, other elements may be added by the responding party, including, for instance, a zero-knowledge channel proof generated by the responding party, and/or revision data related to the responding party's masked private ledger.

However, in order to ensure that the elements included in this zero-knowledge payment channel record by the initiating party are not tampered with, the initiating party may cryptographically sign this zero-knowledge payment channel record before providing it to the responding party. The responding party may itself also sign the record before adding it to the blockchain.

In an embodiment, the initiating party may also provide the responding party such information as may be needed by the responding party to complete the zero-knowledge payment channel record, including such information as may be necessary for the responding party to generate its own zero-knowledge payment channel proof, with the intention of adding said proof to the zero-knowledge payment channel record shared by the initiating party. This may include one or more of the following possible private inputs to the algorithmic encoding which information is intended to remain private between the participants:
The quantity of tokens that are moving within the channel from one participant's balance to the other within the channel's private ledger.
The quantity of tokens moving between the initiating party's private ledger to the payment channel's private ledger.
The unmasked private ledger of the zero-knowledge proof.

In an embodiment, the information provided by the responding party to the initiating party may include a second zero-knowledge payment channel record. Such a record may be used by the initiating party to update or close the channel if necessary at any point following the payment negotiation. This zero-knowledge payment record may include one or more of the following elements, among others:
a revocation key evidence previously shared by the initiating party. Among other possibilities, this revocation key evidence may comprise:
   (a) a public cryptographic key (which may be used in combination with a cryptographic signature to confirm knowledge of a private key), or
   (b) a cryptographic hash (which may be used in combination with a cryptographic hash preimage to confirm knowledge of the cryptographic hash preimage), or
   (c) a public input and output of a non-interactive zero-knowledge proof (which may be used in combination with a non-interactive zero-knowledge proof to confirm knowledge of a private input to the non-interactive zero-knowledge proof)
a zero-knowledge payment channel proof generated by the responding party, but not the zero-knowledge channel proof generated by the initiating party.
the revision data related to the zero-knowledge payment channel's masked private ledger and possibly the revision data related to the responding party's masked private ledger, but not the revision data related to the initiating party's masked private ledger.

In an embodiment, prior to its inclusion on the blockchain, other elements may be added by the initiating party, including, for instance, a zero-knowledge channel proof generated by the initiating party, and/or revision data related to the initiating party's masked private ledger.

However, in order to ensure that the elements included in this zero-knowledge payment channel record by the responding party are not tampered with, the responding party may cryptographically sign this zero-knowledge payment channel record before providing it to the initiating party. The initiating party may itself also sign the record before adding it to the blockchain.

In an embodiment, the responding party may also provide the initiating party such information as may be needed by the initiating party to complete the zero-knowledge payment channel record, including such information as may be necessary for the initiating party to generate its own zero-knowledge payment channel proof, with the intention of adding said proof to the zero-knowledge payment channel record shared by the responding party.

However, in at least one embodiment, the initiating party may already hold at least some portion of the private inputs it would pass to an algorithmic encoding when generating the zero-knowledge payment channel proof, because it would have already passed this information to the responding party. This may include one or more of the following elements:
The quantity of tokens that are moving within the channel from one participant's balance to the other within the channel's private ledger, or
The quantity of tokens moving between the initiating party's private ledger to the payment channel's private ledger.
The unmasked private ledger of the zero-knowledge proof.

In one or more possible embodiments, in addition to the preceding exchange of information, the two parties may also provide to each other revocation keys for any zero-knowledge payment channel records previously exchanged, which revocation keys optionally may also be publicly broadcast or shared across the payment channel network or otherwise. By providing the revocation keys for these preceding records, the parties make themselves unable to cheat by adding revoked records to the blockchain, due to the fact that any cheating party that does add such a revoked record to the blockchain would expose themselves to a penalty.

Furthermore, in one or more embodiments, the parties may share with each other the revocation key evidence that may be used during the next payment negotiation to create each respective zero-knowledge payment channel record. By sharing the revocation key evidence for the next payment negotiation in advance, the parties avoid needing to exchange the revocation key evidence at the time of the next transaction. Conversely, in one or more alternate embodiments, the revocation key evidence for the next payment negotiation is not exchanged at the end of each preceding payment negotiation, and exchanging revocation key evidence constitutes a necessary first step of each payment negotiation.

### Revocation Mechanism Execution

In one or more possible embodiments of the present invention, when a zero-knowledge payment channel record is added to the blockchain, some or all of the modifications to the global state implicated by that record may be delayed if the record is configured with a time lock.

In one or more embodiments, a delayed execution ledger may be associated on-chain with a zero-knowledge payment channel. During the period of a time lock, some elements of the zero-knowledge payment channel record may be written to a delayed execution ledger associated on-chain with the zero-knowledge payment channel in question. Such elements written to said delayed execution ledger are those relevant elements sufficient to effectuate the modifications to the global state which are embodied by the zero-knowledge payment channel record.

In an embodiment, the delayed execution ledger, in addition to storing the relevant elements of the zero-knowledge payment channel record, may record an effective block height, after which block height any interaction with the payment channel may cause the zero-knowledge payment channel record to update the global state. Such an update to the global state may include updates to the private ledgers of each participant, reflected on-chain by a replacement of the masked private ledger of each participant's account or address.

In an embodiment, if a cheating party adds a revoked zero-knowledge payment channel record to the blockchain, another zero-knowledge payment channel record containing the revocation key may be added to the blockchain by the non-cheating party, or by another party. This record, a zero-knowledge payment channel penalty record, may include one or more of the following elements, possibly among others:
The revocation key, which in combination with the revocation key evidence stored in the delayed execution ledger may be used to prove that the zero-knowledge payment channel record had indeed been revoked.
Revision data, including an updated masked private ledger of the non-cheating party, which updated masked private ledger reflects the transfer of the token penalty to the non-cheating party.
A zero-knowledge channel penalty proof, which proves that the updated masked private ledger is a cryptographic hash digest derived from the new unmasked private ledger updated after receiving the token penalty from the payment channel.

In an embodiment, a zero-knowledge payment channel penalty record may be generated by a non-cheating party using private data held by the non-cheating party, as well as public data. Such a record may be used to cause the penalty tokens to be transferred to the non-cheating party any time after the revoked zero-knowledge payment channel record is added to the blockchain, provided it is before the end of the time-lock period.

In an embodiment, so as to effectuate such a transfer, a zero-knowledge payment channel penalty record may be broadcast to the blockchain network by a non-cheating party, which record, upon being incorporated in a new block, may effectuate a transformation to the blockchain's global state, which transformation comprises the transfer of penalty tokens to the non-cheating party.

The preceding described embodiments comprising one or more zero-knowledge systems or methods of opening, modifying and closing zero-knowledge payment channels allows the users of payment channel networks to enjoy the known benefits payment channel networks fast payments, quick settlement, reduced counter-party risk—with the added benefits of maintaining privacy at the channel-opening and channel-closing stages, and of keeping their own token ledger balances private between themselves.

### Persistent Server Permissioning (Safe Off-Line Payment Channel Availability)

A further challenge faced by participants using known payment channel networks such as the Bitcoin Lightning network is that participating nodes should be online and connected to the network in order to send and receive payments. Given these limitations, if a node goes offline, then payments can neither be sent or received to or from that node.

This presents a problem if one of the participants-particularly the recipient—is using a personal device to connect to the network. For instance, if the recipient of a transaction is using a smartphone to connect to the network, if the smartphone is turned off, or is unable to connect to the internet, the transaction cannot be completed and the recipient will not receive payment. It is frequently the case, however, that recipients want to receive payment when their device is offline. Note that this is less of an issue for senders, because users in general expect to need to connect to the Internet to initiate or send an electronic payment. However, recipients typically expect to be able to receive payments when they are offline, and do not desire to connect to the network every time someone wants to send them a payment.

Per known practice, users of the Bitcoin Lightning network work around this limitation by using persistent servers to handle connections to the network. These persistent servers hold the cryptographic key or keys necessary to sign payment channel records, transactions, updates, etc., on behalf of the users of these servers. When a payment is sent to such a user, the persistent server negotiates the updates that should be made to the payment channel in order to receive the payment, which requires the use by the server of the user's cryptographic keys.

When such a user wishes to send a payment, the user sends a request to the persistent server instructing the server to initiate the payment. The persistent server updates the payment channel so as to transmit the payment, which transmission should include the negotiation of a payment channel update, which should include the use by the server of the user's cryptographic keys.

This arrangement allows users to receive payments when their personal device is offline, but at the cost of giving the cryptographic keys that control their entire payment channel to the persistent server. If such persistent server is compromised, then the entire payment channel can be drained of tokens by an attacker. Most such persistent servers are managed by third parties, who maintain payment channels on behalf of multiple users. Any such third party will need to be trusted by the users of the server that it manages, and may exploit that trust by stealing funds from those users.

One or more possible embodiments of the present invention provide a solution to this problem, comprising the use of separate cryptographic keys for the sending and receiving of payments across the payment channel network.

In such an embodiment, the payment channel records exchanged in the negotiation of a payment received are signed by cryptographic keys the use of which may be restricted to negotiating the receipt of a payment, and not the sending of a payment. Furthermore, the use of such keys may optionally also be restricted such that they cannot be used for other activities on the blockchain.

A persistent server that is limited to using keys that have one or more such restrictions will not have any ability to send funds out of a user's account or wallet, but it will be able to negotiate the receipt of funds to that user's account, which would not be possible without these restricted keys. Even if the security of such a server is compromised, it will not provide an attacker an opportunity to exfiltrate tokens from users of the server, nor will a third-party manager of such a server have any ability to steal any users' tokens.

Conversely, in one or more embodiments, initiating and sending a payment across a payment channel network may involve updating a payment channel using a separate, more privileged set of cryptographic keys, which keys may be held by the user themselves on their preferred device. In a possible embodiment, such a device may be a smartphone or other device capable of connecting to a computer network, which device may connect to the payment channel network—either to the persistent server, or to another node on the network—when the user is initiating payment. Upon connecting, the device may use the cryptographic keys to negotiate the sending of a payment across the payment channel, and may optionally disconnect after the payment has been sent.

In an embodiment, the negotiation of an update to a payment channel may involve the exchange of records between the two participants of the payment channel. Each side signs a record updating the payment channel escrow balances such that they reflect the transfer of value from one account or address to the other.

In one or more possible embodiments, as a means of restricting the ability of a persistent server to only negotiate the receiving of payments to an account or address over the payment channel, and not the sending of payments from the account or address, the user of an account or address may:
Generate a new alternate pair of cryptographic keys and provide those keys to the persistent server; and
Associate that account or address with permissioning constraints restricting the use of that new pair of cryptographic keys such that they may only be used to sign payment channel records or transactions that update payment channels in such a manner that the user's payment channel balance increases compared to the previous channel state.

In such an embodiment, any payment negotiated using keys held by the persistent server should be in the direction of the user of said account.

In one or more embodiments of the present invention, because the previous channel balance on-chain is synced infrequently-often only at the point that the channel is opened—the direction of a particular payment within the channel may not be determinable from on-chain information. In an embodiment, one or more permissioning constraints determine whether one or more cryptographic keys are permitted to authorize a payment channel record or transaction depending on whether the new channel state is greater or less than the previous channel state. In such an embodiment, because a permissioning constraint in general may only make a determination using on-chain data and data encoded in the record or transaction being evaluated, a previous channel state should somehow be encoded in the payment channel record or transaction being evaluated.

In an embodiment, a previous off-chain channel state may be validated when validating and evaluating a payment channel transaction or record, which validation in part comprises an evaluation of the history of payments within the channel-back and forth between the parties from the last time the payment channel state was synced with the blockchain until the moment the new payment channel record or transaction is generated-which history is encoded in the payment channel record or transaction.

In an embodiment, a history of payments may be included in the payment channel record or transaction in the form of a list or array of integers, which list may represent a sequence of escrow balance states, or a sequence of payments. The directionality of the payment can be determined by comparing the new state against the preceding state as validated against this list of integers.

In an embodiment, a history of payments included in the payment channel record or transaction may include one or more cryptographic signatures of the parties. In an embodiment, said cryptographic signatures may be used to establish that the payments within the history of payments were authorized by valid and appropriate public keys of the parties.

In an embodiment, a history of payments included among the private inputs to an algorithmic encoding may include one or more cryptographic signatures of the parties.

In an embodiment, a history of payments may be included among the private inputs to an algorithmic encoding that is used to generate a non-interactive zero-knowledge proof, which non-interactive zero-knowledge proof is included with the payment channel record.

In an embodiment, in addition to a history of payments, the private inputs to an algorithmic encoding may include one or more cryptographic signatures of the parties, which cryptographic signatures may correspond to each payment included in the history of payments. In an embodiment, a non-interactive zero-knowledge proof may be used to demonstrate that the payments within the history of payments each correspond to cryptographic signatures created by valid and appropriate public keys of the parties.

In an embodiment, the directionality of the last payment may be incorporated as a public input or output to the non-interactive zero-knowledge proof, and may be used by one or more permissioning constraints applied to said record or transaction. In an alternate embodiment, whether the device signing said record or transaction is permitted to do so may be determined within logic encoded in an algorithmic encoding such that a non-interactive zero-knowledge proof only produces a valid result if the permitted device is used.

In one or more embodiments, the use of the cryptographic keys held by the persistent server may be restricted, such that said keys are only able to sign records or transactions that update payment channels that increase the user's payment channel balance. The persistent server is thereby only able to receive payment channel payments, and is unable to send payment channel payments, or to perform any other blockchain activity on behalf of that user and their account or address on-chain.

Another risk presented by the use of persistent servers by users of existing known payment channel networks is that that any entity that negotiates the processing of any payment across a channel—whether that payment be sent or received by such an entity-will have at least temporary access to revoked payment channel records, and may have a long list of said records. A malicious persistent server may collude with a malicious counterparty to purposefully write a revoked payment channel record or transaction to the blockchain, with the intention of the malicious counterparty subsequently using the revocation key to claim the penalty, which would be paid from the user's portion of the payment channel tokens.

In an embodiment of the present invention, a purposeful writing of a revoked payment channel record to the blockchain by a persistent server may be prevented by requiring that payment channel escrow transactions are signed by participants in a certain order. In such an embodiment, any payment channel escrow transaction that is first signed by a counterparty should be signed by the more privileged set of keys of the counterparty's account. A persistent server's keys may not be sufficient to sign such a payment channel record or transaction that is subject to revocation by a counterparty. In such an embodiment, a payment channel record may only be valid if signed by the keys held and controlled by the user themselves, and not the persistent server.

In an embodiment, these requirements may be implemented through the use of permissioning constraints that enforce such restrictions on payment channel records or transactions.

### Consensus Scaling Solutions

According to various embodiments of the present invention, a novel blockchain scaling system and method is implemented, which overcomes limitations of existing scaling solutions, improving the data management, performance and decentralization of high-throughput blockchain networks.

Known high-throughput blockchain systems face significant challenges related to data management, which may impact their scalability, performance, and decentralization. A rapid growth in transaction volume may lead to substantial increases in data storage utilization, making it difficult for new nodes to join and synchronize with the network. Verifying large volumes of data may also place a significant burden on consensus mechanisms, exacerbating state management issues as the size of the global state data increases. As the size of global state data grows, maintaining data availability and accessibility becomes increasingly complex, and hardware utilization increases, often necessitating centralized or permissioned solutions that compromise decentralization.

Existing solutions, such as sharding, offer partial remedies but come with certain limitations. Known sharding methods attempt to improve scalability by partitioning a blockchain network into smaller segments called shards, with the intention of processing transactions and smart contracts in parallel. Such known sharding techniques impose significant complexity in terms of cross-shard communication and transaction coordination; ensuring consistency and security across shards is challenging, and cross-shard transactions may require intricate protocols to prevent double-spending and to maintain atomicity. Additionally, such known sharding techniques can weaken security by distributing the network's validation power across multiple shards, making smaller shards more vulnerable to attacks like collusion or takeover by malicious actors.

Uniquely, one or more embodiments of the present invention divide the global state of a blockchain system into various shards, rather than dividing the blockchain network into shards. In such embodiments, block-building nodes and validator nodes comprising the blockchain system remain connected in a unified network, and cross-shard transactions are integrated as standard transactions within the protocol, avoiding complexity overhead. In addition, in contrast to known sharding methods, in at least one embodiment, the data of each shard is mutually exclusive of data of all other shards, reducing or eliminating the possibility of double-spending within the operation of the blockchain system.

In one or more embodiments, said scaling system or method may be implemented in combination with a fitness-gradient consensus methodology, a consensus mechanism designed to optimize the selection and validation of new blocks by evaluating their “fitness” based on predefined metrics. Fitness gradient consensus resolves forking conflicts by calculating the most-optimal fitness value among competing blocks, incentivizing rapid block propagation and improving both the speed and security of the network. Variants such as hash distance consensus and trust-but-verify data propagation further enhance scalability and efficiency, making it suitable for high-throughput blockchain applications.

### Fitness-Gradient Consensus

According to one or more embodiments of the present invention, a Fitness Gradient Consensus methodology is applied by determining the most-optimal fitness value among competing new blocks or blockchain segments in order decide upon which new blocks or blockchain segments will be built upon by future blocks. In certain embodiments, the selection as to which new blocks are built upon determines how block-building fees and/or rewards are allocated on-chain, which fees and/or rewards may comprise an allocation of tokens to the account of the winning block-building node.

Fitness gradient consensus, as implemented in various embodiments of the present invention, is a consensus methodology that calculates a deterministic fitness value for each block, based on the local features of that block, potentially in combination with certain mid-term-stable features of the blockchain state. In such a methodology, every fork of the blockchain has a determinable fitness value that is an aggregate of the fitness values of all blocks within that fork. In certain embodiments, a block carries its own fitness value, as well as the fitness value of a chain of which it is the head. This form of consensus allows many candidate forks to be evaluated concurrently, and may remove a limitation of Nakamoto proof-of-work consensus that only a certain limited number of forks will be evaluated at any given time by the network.

Under fitness-gradient consensus, according to certain embodiments, block headers are propagated to direct peers soon after they are validly constructed. Direct peers compare the fitness values of the block headers received, and then share the most-optimal fitness blocks or block headers onward to other peers. The network converges on a small subset of the most-optimal fitness blocks after block headers have been propagated across the network and prioritized. According to at least one embodiment, each block-building node and validator choses a small subset of blocks to validate, and it downloads the transactions for those blocks and performs validations in parallel in separate threads.

In various embodiments, the highest-fitness-value block may be most optimal; such that if a first output of a fitness algorithm calculation is higher than a second output, the first output is deemed to be a more-optimal fitness value. In alternate embodiments optimality may be determined according to some other scale. In certain embodiments, the lower output values of a fitness algorithm may be deemed more optimal than higher output values. In any case, in various embodiments, when the individual fitness of a first pair of blocks is each deemed more optimal than the individual fitness of each block of a second pair of blocks, the combined fitness of the first pair will be higher than the combined fitness of the second pair, and when the individual fitness of a first collection of blocks is each deemed more optimal than the individual fitness of each block of second collection of blocks, for instance in the case of a blockchain segment or block ring, the combined or aggregate fitness of the first collection will be higher than the combined or aggregate fitness of the second colletion.

In various embodiments, potentially any formula outputting a scalar value may be used to determine a block's fitness value. One possible formula, according to several embodiments, is to calculate the block's “hash distance.” A “hash distance” nay be defined as the numerical distance between the block hash and a pre-determined target hash for that block. Depending on the embodiment, the distribution of “hash distance” values may be evenly distributed over the entire network. According to several embodiments, “hash distance” is determinable for every block without performing proof-of-work. Although extra work can be performed in order for a block-building node to reduce the “hash distance” of a given block (by incrementing some nonce included within the block to search for a block with a shorter hash distance), the instant that a block is produced may be is valid and may potentially be built upon by one or more blocks of the next round of block building. In various alternative embodiments, other formulas may also be used in order to determine fitness of blocks within a network.

### Fitness Variations

The fitness gradient consensus methodology is flexible enough to allow various means, methods and algorithms to be used in calculating a fitness value, according to various embodiments. If a raw block hash output is not suitable, in certain embodiments, the bits of the block hash may be flipped (0x1111 . . . 11111 xor BLOCKHASH), and/or the value may be passed into a fitness function to obtain a fitness calculation. In various embodiments, a fitness value may be a discrete integer, so at the most optimal fitness level, depending on the size of the hash output, there may be ties.

According to at least one embodiment, a minimum threshold fitness value may need to be calculated, and the fitness determination may include generating a block hash for a new block, iterating over sequential “nonce” values, trying to get it as close to a target as possible. If the fitness calculation is too small, the nonce may be incremented, and the block may be re-hashed, and fitness re-calculated, iterating until a fitness threshold is reached. Alternate embodiments, however, may implement means to avoid, discourage or prevents such a re-hashing.

In various embodiments, the fitness of a block is equal to the aggregate value of the fitness calculation of all or a certain number of preceding blocks, plus the fitness value for that specific block. A recency bias may be incorporated, such that past fitness values may be discounted before being added to the fitness value of the current block. The recency bias may need to be balanced so that an old, formerly-discarded chain fork does not displace an otherwise more-optimal-fitness fork, but also so that an un-merged fork is incentivized to merge sooner than later, and trigger a reorganization, so that it doesn't lose out on its gain if it discovers a highly optimal-fitness block. A risk of an un-balanced recency bias may be the following: a low-fitness chain fork is built on by a low-compute network partition for a an extended period; after a period of low compute power, the partition increases its compute to a majority of the overall network's resources; if the low-fitness history of that fork is overly discounted, the sudden surge of compute power may allow the fork to merge and displace the primary fork of the primary partition.

In at least one alternate embodiment, a hash-distance function may somehow randomize the target hash for each block, such that each block has a radically different target; and in calculating a block's fitness, the distance of N previous blocks' hashes to that target may be averaged with along with the distance of the current block's hash to that target. By calculating a blockchain segment's fitness in this manner, the difficulty of maintaining a secret double-spend chain may be increased, and its likelihood decreased, in certain alternate variations.

Among certain alternate embodiments, an “aggregate token value” fitness function may be used instead of a hash-distance approach. An “aggregate token value” approach may act to eliminate the advantage of excess or enhanced computational power among block-building nodes, by providing a metric that is independent from pure algorithmic performance. In certain variant embodiments, aggregate token value may act as a tie-breaker used after hash-distance fitness is calculated-used only when deciding between otherwise equivalent blocks with regards to the next block to build upon; alternately, it may be incorporated into the fitness function itself, such that the aggregate token value may be reflected in the fitness of every block in a blockchain segment.

In certain embodiments, “aggregate token value” may comprise a measurement of the aggregate tokens locked or staked for a given block-either tokens in a locked state for the duration of the block, or tokens being locked or staked as part of the block's state transformation. In other embodiments, “aggregate token value” may comprise a measurement of the aggregate value of all tokens used or transferred within the execution of a block, which calculation may depend on the use of a relative pricing mechanism so as to aggregate the value of different types of tokens into a single value number.

Certain embodiments may implement consensus staking records, which records, when included in a new block, may cause a specified quantity of a sending account's tokens to be staked or locked. In at least one embodiment, staked or locked tokens may used to determine “aggregate token value” as described above; in other embodiments, staked or locked tokens may serve a different purpose. Accounts that stake or lock tokens using consensus staking records may share in block rewards or fees of certain blocks, as an incentive and reward. Such staking records may comprise one or more of the following, without limitation: (1) the block hash of the preceding block, (2) the block number of the preceding block, (3) an expiration block number that is no more than a certain number of blocks ahead of the preceding block, (4) the tokens staked, (5) the staking period (which may be short-term or long-term, or some variation thereof), (6) fee tokens bid for inclusion, and (7) the originating account.

### Bucket Consensus Variation (Hash-Distance Consensus)

In one or more embodiments, a “bucket consensus” variation of hash-distance consensus may be implemented, which variation employs a technique of using token staking in order to determine a target hash for a block, which target hash may be used to determine a fitness value of the block. According to at least one embodiment, consensus staking records may be deemed to contribute tokens to buckets according to a certain formula, and the bucket(s) that are deemed to contain the most tokens may be used to determine the target hash for a block.

In certain embodiments, the bucket that a consensus staking record belongs to may be determined by combining a preceding block hash with the hash of the originating account, which may involve operations such as bitwise XOR or concatenation followed by re-hashing. The resulting hash combination is then used to assign the staking record and staked tokens to a specific bucket, which bucket may be determined by performing a modulo operation on the hash combination, or by applying some other function to the same. According to an embodiment, the set of buckets participating in this process may be distributed evenly across the domain of possible hash values, ensuring a random assignment of staking records to buckets.

In one or more embodiments, a bucket consensus process may be implemented to incorporate one or more elements of the following procedure, without limitation:
a) The target hash for a given block N may be defined as the midpoint of the bucket with the highest aggregate value of staking records at a prior block N-G, where G is a predefined offset, enforced by the protocol, and N is the current block height.
b) The fitness of a block N may be calculated as the difference between the block hash of block N and the target hash at N-G, divided by the tokens staked within block N, and then added to the fitness of block N−1.
c) For each block, only a certain number of staking records may be included, these being the highest-bidding, unexpired, and yet-to-be-included records. This ensures prioritization of the most valuable staking records while adhering to network constraints.
d) Rewards for block building are distributed between the block-building node of the current block N and the accounts the staking records of which contributed to the target hash in block N-G. Rewards may be allocated proportionally based on the size of the stake associated with each account at block N-G, ensuring equitable distribution among contributors.
e) To maintain a consistent block creation time (Tb), block-building nodes initiate the block-building process at time TO by verifying the preceding block and iteratively attempting nonce variations to construct a new block. At a defined time Tn, the block-building node broadcasts the version of the block with the most optimal fitness (for example, the block with the lowest hash distance to the target hash). Block-building nodes may continue nonce iteration until Tb, at which point the block with the most optimal fitness—either from the block-building node's own efforts or received from the network—is finalized and used as the basis for the next block.
f) If a version of block N−1 having a more optimal fitness is discovered during this process, the block-building node may opt to build on the newly discovered block, discarding prior work on alternate chains if necessary. Any staking records from discarded blocks may be returned to the record pool for inclusion in future blocks.

### Verifiable Delay Functions

In various embodiments, a verifiable delay function (VDF) may be incorporated into the consensus process. A VDF is a cryptographic function designed to produce an output that requires a predetermined amount of sequential computation to generate, but which output can be verified for correctness efficiently and non-sequentially. Examples may include, for example, such VDF algorithms as Wesolowski's VDF, Pietrzak's VDF, and Class Group VDF.

Because the operations to be performed to produce a valid VDF output are non-parallelizable, a VDF can be used to force a certain amount of time to pass within a larger algorithm. Adding CPUs or CPU cores to an effort to compute a VDF does not speed up performance; a faster result is only possible if a CPU with a faster clock speed is employed. The validity of a verifiable delay function's output can be assessed with trivial computation, however, such that it is possible to assess almost instantaneously whether a computational delay of a certain length of time has in fact occurred.

One or more embodiments of the present invention may use VDF algorithms to ensure that block-building nodes are allowing sufficient time to pass between blocks, and/or to prevent a surge of computational power from accelerating block production. In such embodiments, a block or block header is only valid if it contains a VDF output corresponding to a minimum execution time specified by the blockchain protocol. Such a VDF requirement implemented in various embodiments may thereby force block-building nodes to ensure that a new block has not started building before a minimum amount of time has passed since a previous block started building.

In certain embodiments, the output value of a VDF can function as a tiebreaker in the event that the fitness value of two blocks is the same. In other embodiments, a VDF output may be incorporated into the fitness value calculation, for instance by including it in the block data that is hashed and then evaluated as part of a hash-distance calculation. In certain embodiments, this second approach ensures that block-building-nodes cannot try to re-calculate a fitness value by making small iterative changes to the block contents.

Various embodiments may include a VDF output in the pre-images of block hashes used to calculate fitness. Because said block hashes cannot be calculated without including VDF outputs, it should not be possible to know what the fitness value may be of a particular block with particular content until the VDF has completed its calculation. In order to obtain its VDF, each separate version of a block may utilize a separate parallel CPU core. Following such an approach, the utility of mining rigs is reduced, and the likelihood of a 51%-style double-spend attack is reduced.

Certain embodiments may incorporate VDF calculations in their implementations as follows: at the onset of building a new block, a first VDF calculation begins, with the block hash(es) of one or more previous blocks being passed in as input; simultaneously, the records and/or transactions constituting the block are selected and executed, applying the various state transformations of the new block; following the completion of both processes, the output of the VDF calculation is combined with a hash output of the block building process, said hash output comprising, for example, without limitation, the new state Merkle root, receipt Merkle root, transaction Merkle root, or some combination or transformation thereof; this combined value then forms the input of a second VDF calculation, which calculation runs until some point near to the end of the block interval. In at least one embodiment, this output is sufficient as an input to a fitness function; or it may alternatively be combined with other values of the block to generate the fitness value.

Various embodiments may configure VDF execution times so that VDFs of a new block execute for some ratio of the total time taken to process and/or execute the records and/or transactions that constitute that new block. Depending on the embodiment, a total-block-time to record/transaction-execution-time ratio of 2-to-1, 3-to-1, or 4-to-1 may be used, or some other appropriate ratio. An objective of one or more embodiments may be to configure a VDF function to execute for a long-enough duration that even a large block-building node or a large cluster of block-building nodes cannot work to build valid blocks faster than the rest of the network, due to the limitations of the VDF. A large block-building node network might be able to calculate the most-optimal next block, but it cannot run ahead. That being said, in various embodiments, some variability should be assumed among the computational units used to perform the VDF calculation, such that the same complexity target may result in a variety of calculation times; in any event, the complexity of the combined VDF of a block should be less than the maximum complexity the slowest participating computational unit is able to compute within the protocol's time interval between blocks.

Certain embodiments may implement one or more of the following (without limitation) when calibrating the complexity value that a block-building nodes use when invoking verifiable delay functions:
a) A block's gas limit may be proportional to one or more complexity values of one or more VDFs executed while building the block, such that higher complexity values determine a higher gas limit. “Gas” herein refers to approximate units of computation, and “gas limit” refers to a limit on the computation to be performed evaluating and/or executing records and/or transactions included in the block. A higher gas limit may result in more transactions or more complex transactions being included in a block, and may result in more transaction fees collected.
b) When starting to build a block, a block-building node may select one or more complexity values of one or more VDFs to be executed while building the block, provided that said complexity values exceed a minimum threshold. In some embodiments, said threshold may be defined as a weighted average of complexity values of recent blocks.
c) The complexity values of a VDF computation may be included with the VDF result, and may be used in verifying the result; blocks or block headers specifying complexity values which are below a certain threshold may be deemed invalid.
d) The initial complexity values used by a block-building node will be specified in an initial, user-modifiable node configuration, but the block-building node may gradually adjust the complexity value upward, until the total time of execution for each new block is some small margin less than (slightly less than, not exactly equal to) the block duration time, in an attempt to maximize the gas limit of the block, and the transaction fees to be earned by the block-building node.
e) In the event that the total time of execution for new blocks goes too high, the complexity value may be reduced.

### Trust-but-Verify

In one or more embodiments, new blocks may be built before all block records and/or transactions have been validated, and before the global state has been updated by processing this data. New blocks may be built on top of yet-unprocessed blocks, which new blocks may include only transactions that operate on accounts other than the accounts that were operated upon by recent prior blocks.

According to a trust-but-verify data propagation methodology, as implemented in one or more embodiments, new block headers may be shared across the network without said blocks' records and/or transactions fully propagating across the network. By using trust-but-verify consensus methodology, the new blocks may be built while records and/or transactions of previous blocks are still propagating over the network. In such an embodiment, a block-building node may share its most-optimal fitness block with its peer block-building nodes; one of said peers may respond either that the block shared is the most-optimal-fitness it has recorded, or it may respond with the details of the most-optimal-fitness block it has recorded.

According to various embodiments, blocks processed in series may need to operate on mutually-exclusive sets of accounts. One or more such embodiments may use a Bloom filter method to ensure that blocks processed in series satisfy this requirement. In an embodiment, a block may specify the accounts that it operates upon through the use of a Bloom filter, which Bloom filter may record all the account addresses operated upon in the block. As new transactions are read from the mempool's priority queue, the accounts they operate upon are searched for in one or more Bloom filters of recently preceding blocks. If those accounts are found in the one or more Bloom filters, then the transaction is placed in a retry queue of the blockchain network's mempool, rather than being included in the new block. In an embodiment, before a new block is built, the Bloom filters of preceding blocks that have not yet been processed are united into a single Bloom filter, and only that Bloom filter is searched.

The specific number of recently preceding blocks operating on mutually-exclusive sets of accounts with regards to a new block may differ among embodiments. In one or more embodiments, for example, every other block may build on overlapping subsets of the global state, such that proximate blocks operate on mutually-exclusive subsets. In certain other embodiments the time interval between blocks may be shorter (so that it takes the time duration of two blocks for a full set of transactions to propagate), and every third block may build on overlapping subsets of the global state, so that within a group of three sequential blocks the subsets of data being operated upon are mutually exclusive with each other.

In variant embodiments, if a block's transactions have been downloaded before a certain timeout, and the block has been verified, then the next block may expand beyond the limitation of the trust-but-verify Bloom filter in terms of which transactions may be added.

### Sharding

According to various embodiments, a computer-implemented blockchain sharding system is implemented, comprising a global state of a blockchain system and two or more block-building nodes of a blockchain network. In certain embodiments said global state may comprise at minimum four shards, and in other embodiments, said global state may comprise at minimum two shards, in either case each shard comprising a portion of the global state which is mutually-exclusive with the portion of the global state of all other shards.

The block-building nodes of the system, in various embodiments, each store and operate on at minimum two shards, although alternate embodiments may only require block-building nodes to store and operate on at minimum a single shard. The scalability benefits of various embodiments of the sharding system begin when at least one block-building node excludes from its storage (and from its operation) at least two shards; certain alternate embodiments, however, may experience scalability benefits when at least one block building node excludes from its storage and operation at minimum one shard.

Various embodiments implement a consensus procedure performed in sequential rounds, each new block built belonging to a specific round, operating on, at minimum, two shards of the global state, and each round comprising one or more new blocks operating on non-overlapping, mutually-exclusive shards of the global state. Each such new block may also comprise a block hash of one or more preceding blocks of the preceding round, such block hash referencing a preceding block operating on at least one of the same shards as the new block also operates on. Alternate embodiments may require that each block-building node operate only on one shard at minimum, rather than two.

In various embodiments, the shards of the global state exclude blocks, records and/or transactions. Shards, in such embodiments, comprise elements of the present global state, excluding a comprehensive record if its history. Archived and/or retained blocks, records, and/or transaction data may represent a history of state transformations previous applied to the global state; shards, by contrast, may comprise state elements to which state transformations encoded in blocks, records, and/or transaction are applied. In one or more embodiments, a block may comprise records and/or transactions which touch on, reference, operate on, read, or modify data of one or more shards which the block in question is said to comprise, or to operate on.

According to one or more embodiments, one or more shards may comprise one or more groups of data elements. Different embodiments may employ various other algorithms to distribute data among different groups, although embodiments employing algorithms that distribute data evenly may experience advantages in, for example, performance, data availability, and decentralization. In one or more embodiments, addresses or accounts may be placed in mutually-exclusive groups, with each group assignment being made according to a modulo operation of the address or account address (for example, address modulo number of groups). Each group may be encoded as a single shard data structure, with each shard data structure comprising a separate data structure (for example, without limitation, a Merkle tree or Merkle trie) having a separate root and root hash digest, which root hash digest incorporates and/or is derived from, directly or indirectly, all data contributing to the data structure. In one or more embodiments, one or more block-building nodes store, manage, and/or operate on the data of two or more shards, in which case other shards may be left to be managed by other block-building nodes.

In one or more embodiments, a block-building node processes and/or executes only records and/or transactions that touch on, reference, operate on, read, or modify the data of the shards and/or shard data structures that it stores, manages and/or operates on, and it discards or ignores other records and/or transactions. In such embodiments, when building new blocks, each such node only builds blocks that include transactions that read from or write to accounts or addresses within the shards that it manages. When verifying new blocks (and updating state) a node may have to assume the correctness and sufficiency of record and/or transaction state transformations affecting the shards and shard data structures it does not manage.

In various embodiments, each block-building node or validator node may retain records of the blocks that touch on, reference, operate on, read, or modify the data of the shards and/or shard data structures that it stores and/or manages, along with all the records and/or transactions of those blocks. In various embodiments, each block may touch on on at least two shards; therefore, a block-building node or validator node may keep record of blocks that touch on, reference, operate on, read, or modify data other than and in addition to its own data. In the event that such a node performs a rebuild of its own shard data (as, for example, in a reorganization), the node will assume the correctness and sufficiency of record and/or transaction state transformations affecting the shards and shard data structures it does not manage. In some embodiments, transaction and/or record data older than a certain threshold may be discarded or purged, however.

In various embodiments of the present invention, in order to allow only a portion of a multi-shard record or transaction to be validated and executed, a receipt data structure may incorporate the output data and/or general state transformation details of smart contracts that are invoked, and/or the accounts or addresses that are touched on, referenced, operated on, read, or modified as the record or transaction is processed. Such a receipt data structure (i.e. “receipt”) may include details of the outcome of the record or transaction's state transformation sufficient for a block-building node or validator node to validate and apply the portion of said state transformation that corresponds to the node's own one or more shards, without the node needing to store or manage all shards affected by said state transformation.

A receipt is a data structure generated by a block-building node upon the execution of a record or transaction, derived from the state changes resulting from the execution of the record or transaction, and recording the outcome of the transaction, including status, logs produced, and any gas or computational resources consumed. In various embodiments, such receipts may be propagated through the network together with records and/or transactions, or separate from them, following a processing of the receipt's associated records and/or transaction; alternately, they may be propagated as part of the data of the block which comprises them. Receipt data may be consulted in various embodiments by a block-building node or a validator node as it processes or validates a record or transaction associated with said receipt. In various embodiments, when receipt information is invalid, incorrect or otherwise wrong, a block-building node or validator node may discover the error during record and/or transaction validation or processing, after which said error may be reported to the other nodes of the blockchain network. In the event that a record, transaction or block is implicated by such an error, one or more nodes of the blockchain network may designate such a record, transaction and/or block as invalid, and may discarded it. In some embodiments, this may force a reorganization in the event that said one or more nodes had already accepted and incorporated said repudiated record, transaction, and/or block.

According to various embodiments of the present invention, a consensus process may be implemented comprising various sequential rounds or iterations. During each round or iteration block-building nodes may build blocks, which blocks may be designated as belonging to said round or iteration, and may encode the round number or iteration number as a block height or block number.

### Block Rings

In one or more embodiments, each round may comprise the instantiation of a “block ring” comprising blocks generated by block-building nodes in that round, which blocks have been accepted by the network as constituting the accepted blocks of that round, and with reference to which the blocks of the subsequent round will be built. Each block of a block ring is deemed to operate on particular shards, which shards correspond to the shards operated on by the records and/or transactions of the block. In one or more embodiments, each block of a block ring may operate on mutually-exclusive shards. In certain embodiments, a block ring may incorporate blocks that operate on all the shards, without any missing shards, even if the block comprising a shard comprises no records or transactions operating on that shard; in other embodiments, however, block rings may be missing certain shards.

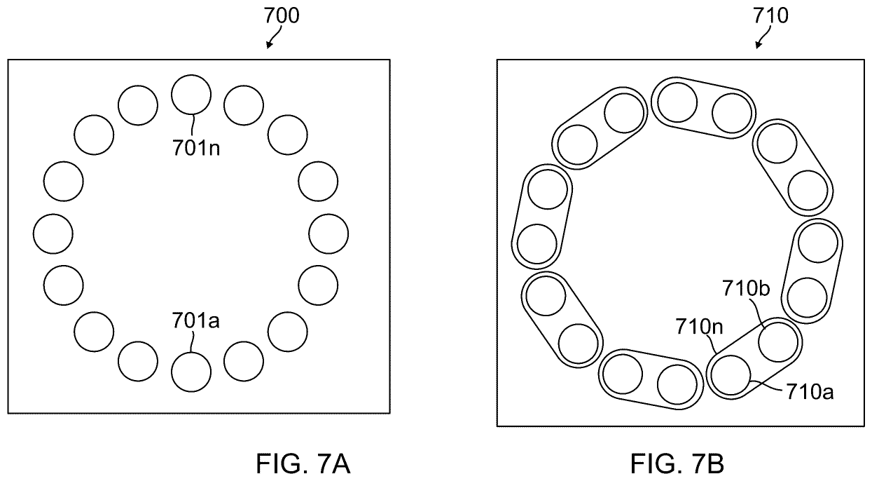

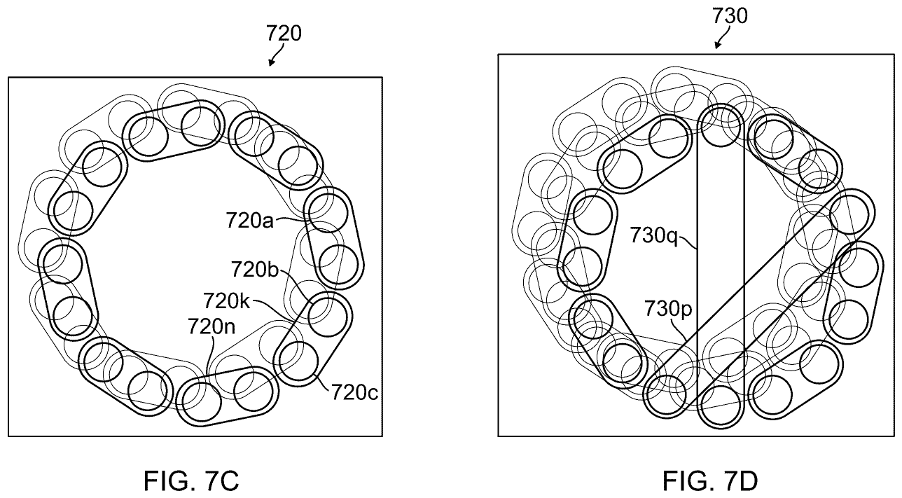

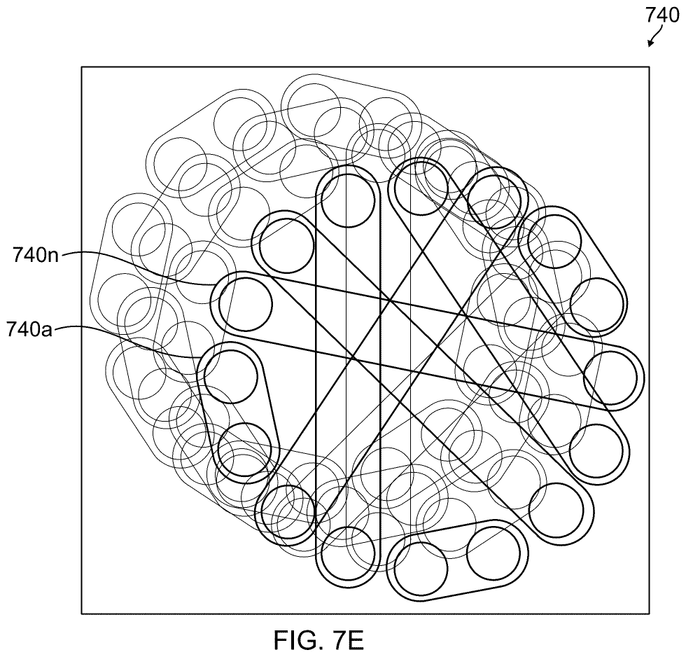

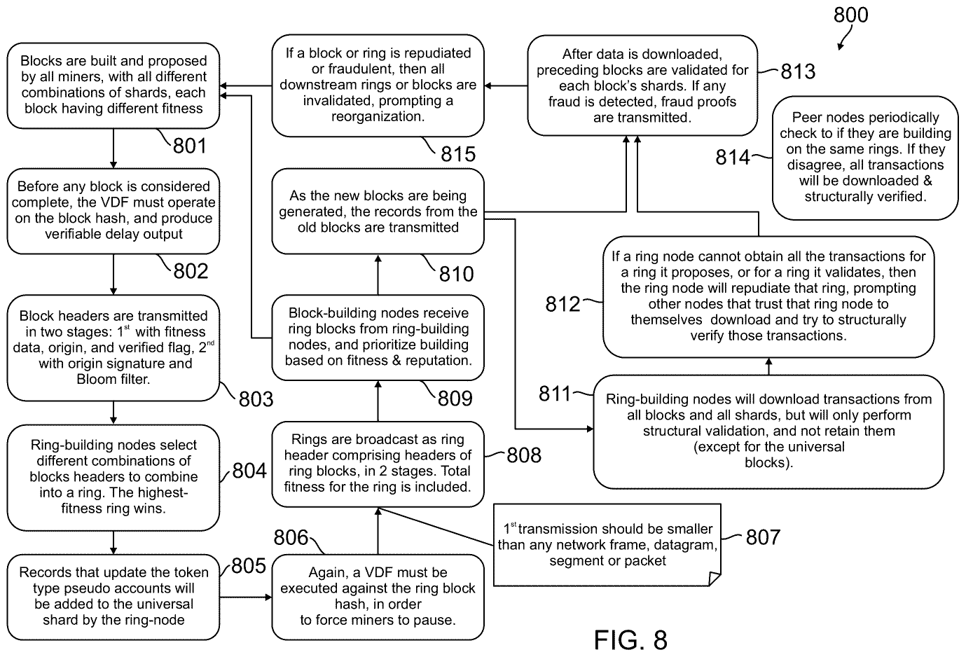

FIGS. 7A-7E show diagrams 700-740, respectively, illustrating the nature and evolution of “block ring” instances over the course of multiple sequential rounds, in an example embodiment. Said figures reflect a blockchain sharding system comprising 16 shards, although in practice any number of shards may be employed. Optimal embodiments may implement a number of shards which are a power of 2, possibly ranging, for instance, between 4 and 64 shards. FIG. 7A shows a schematic illustration 700 of said 16 shards (700a-700n), without including an illustration of any blocks. FIG. 7B shows a schematic illustration 710 of a block ring including eight blocks (for example, 710n), each block comprising two shards (including 700a-700b); note that in this illustration of an example embodiment, each shard is incorporated into one block.

According to various embodiments of the present invention, the sharding system's blockchain network should comprise at least one block-building node to manage each combination of two or more shards. In alternate embodiments, some combinations of shards may not correspond to any block-building nodes of the blockchain network, in which case records or transactions touching on, referencing, operating on, reading, or modifying one of said combinations of shards may be processed and/or executed by block-building nodes comprising supersets of said one combination. In one or more embodiments, each block-building node builds and propagates blocks incorporating state transformations pertaining to the shards that it comprises.

In various embodiments of the present invention, a different set of nodes may participate during each consensus round, resulting in the instantiation of a new block ring comprising blocks with different combinations of nodes. Each different node may operate on a different combination of shard data. In one or more embodiments, however, this behavior is an emergent characteristic resulting on each block-building node working to generate the most-optimal fitness block it can that touches on, references, operates on, reads, or modifies the data of its own shards; the particular blocks selected to constitute a block ring in such circumstances may be a combination of mutually-exclusive blocks built and propagated during that round having the best or most optimal aggregate or combined fitness value among various such combinations of the round.

In various embodiments, different nodes may operate on different combinations of shards and/or shard data structures. During each iteration, according to embodiments implementing a fitness gradient consensus, nodes may attempt to generate the most-optimal-fitness block that operates on its own shards. Between each round, or as an integral part of each round, one or more nodes may attempt to form the most-optimal-fitness block ring by evaluating combinations of the most-optimal-fitness blocks that operate on mutually-exclusive data; different rings may be proposed, but the block ring with the most optimal aggregate fitness will be built upon in the next round.

FIG. 7C shows diagram 720 illustrating, in an embodiment, the round subsequent to the round illustrated in diagram 710 of FIG. 7B, each block of the block ring comprising a different combination of shards than the combinations shown in FIG. 7B. Note that shard 720b, corresponding to shard 711b in FIG. 7B, now shares block 720k with shard 720c, rather than sharing a block with 720a, as was the case when shard 710b shared block 710n with shard 710a in the previous round illustrated in FIG. 7B. Note however, that block 720k will comprise back references to both block 710a and block 710n of FIG. 7B. In at least one embodiment, each block comprises back references to the blocks of the preceding round which blocks comprised one or more of the same shards. In this manner, for each shard, an unbroken chain of back references exists leading from the most recent round to the earliest one or more rounds of the blockchain, which unbroken chain may form a part of a larger directed-acyclic-graph or lattice structure forming the blockchain of at least one embodiment of the present invention. In certain embodiments, a new block's back references will only include references to blocks of the preceding block ring which blocks comprise one or more of the same shards and/or shard data structures; in other alternate embodiments, however, additional back references to other blocks in the preceding block ring may also be included with a block.

FIG. 7D shows diagram 730 illustrating, in an example embodiment, a consensus round subsequent to the round illustrated in FIG. 7C, with one or more blocks of the new block ring comprising new and different combinations of shards compared to blocks of the preceding round. Note, however, that, in FIG. 7D, block 730p shares the same combination of shards as block 710n of FIG. 7B, and that block 730q shares the same combination of shards as block 720n of FIG. 7C. According to one or more embodiments, it is not necessary that all of the blocks of a given block ring comprise different combinations of shards as every block of the preceding block ring; rather, among such embodiments, it is simply necessary that an optimal or near-optimal combination of mutually-exclusive blocks be selected. Nonetheless, some other, alternative embodiments may impose a non-repetition requirement.

FIG. 7E illustrates, in an example embodiment, a consensus round subsequent to the round illustrated in FIG. 7D. Note again that one or more blocks of the new block ring comprise new and different combinations of shards. Although these illustrations show blocks comprising two shards, in various embodiments blocks that include 3 or more shards may also be acceptable.

According to certain embodiments, a methodology of identifying which shards and/or shard data structures a particular record, transaction, or block touches on, references, operates on, reads, or modifies may be implemented with the use of a bitmap. As per this methodology, a bitmap comprising a byte, byte array, integer, or integer array may be encoded, which bitmap contains at least as many bits as there are shards of the global state. The particular combination of shards of a record, transaction or block may be encoded by such a bitmap; each distinct shard may corresponds to one of the bits of the bitmap, so that if a shard is touched on, referenced by, operated on, read, or modified by said record, transaction or block, that particular bit is set to one; otherwise, the bit is set to zero. For example, in at least one embodiment, a block that comprises the first, fifth, eighth and eleventh shards may also comprise a bitmap with the first, fifth, eighth and eleventh bits set to one, and the remaining bits set to zero.

In certain embodiments, each shard may be represented by a single bit within a bitmap with a size equal to the number of shards constituting the global state. A node may declare which shards it is managing by including a bitmap of those shards with the blocks that it creates.

In certain embodiments, the particular shards that a record or transaction touches on, references, operates on, reads, or modifies may be determined by performing an operation on the addresses or accounts that the record or transaction touches on, references, operates on, reads, or modifies. Specifically, each account may be determined to belong to a shard having a shard index number equal to the address modulo the number of shards, or equal to the account address modulo the number of shards, which the address or account address is itself a number. In one or more embodiments, a record or transaction touches on, references, operates on, reads, or modifies whatever shards that contain the account or address data of the accounts or addresses that the record or transaction touches on, references, operates on, reads, or modifies.

In some embodiments, a block may have a shard bitmap equal to all of the shard bitmaps of the records or transactions of that block, combined together by the iterative application of bit-wise OR operations. In the formation of a block ring, in some embodiments, a block ring may be deemed to be valid if none of the block bitmaps share any bits; an efficient algorithm may make a determination by setting an accumulator bitmap to all zeros, then iterating over all the bitmaps of the blocks, for each bitmap performing a bitwise AND with the accumulator before combining the bitmap with the accumulator with a bitwise OR, and determining that the block ring is invalid if any bitwise AND outputs any non-zero number.

In various embodiments of the present invention, as block-building round follows block-building round, block ring formation follows block building, and block building follows block ring formation, ad infinitum, until such time as the blockchain may stop operating.

The formation of a block ring—which comprises a process of selecting blocks for inclusion in a block ring—may, in certain embodiments, be performed by one or more specialized nodes. In other embodiments, one or more non-specialized block-building nodes may perform the task of selecting blocks for inclusion in a block ring. In some embodiments, a block ring formation may be performed by either a specialized node or by a non-specialized block-building node, potentially involving one or the other from one round to the next. According at least one embodiment, each block-building node may make a local determination as to what role will play within the network, including one or more of, without limitation: whether participate in the process of forming and proposing block rings; whether to participate in the process of building and propagating blocks; and/or which shards to store, manage and operate on. In certain variations and embodiments, block rings may be formed by specialized nodes that do not themselves validate the blocks which constitute the rings being formed.

In one or more embodiments, the maximum-fitness block ring propagated across the network may be selected to be built upon by subsequent blocks; any combination of blocks may be selected, provided that the individual blocks and the block ring itself are valid. Block rings comprising blocks that do not fit together—meaning, blocks having overlapping shards—are invalid. Among embodiments that utilize shard bitmaps, account bitmaps are guaranteed to be mutually exclusive for blocks that operate on different shards; the blocks of a block ring may be deemed to be mutually exclusive if their account bitmaps are mutually exclusive.

In some embodiments, the block ring formation process may result in the generation of a data structure comprising references to all blocks in the block ring, which data structure is incorporated in the blockchain as a ring formation block. New blocks of the subsequent round may be created with reference to the preceding rounds' ring formation block. In certain alternate embodiments, a block ring may instead be an implicit feature of the sharding system, embodied by the blocks built upon and validated by nodes of the network, computed in volatile memory during the block selection and validation process, identifiable in retrospect by observing the blocks that constitute the blockchain as it extends back to its origin, but without an explicit declaration as such in the blockchain.

In certain embodiments, block ring formation may happen through a trust-but-verify process. A verifiable delay function may be executed during each round to ensure that there is a minimum time separation between rounds. The VDF of a new round may be running while the previous one or two blocks' transactions are transmitted and downloaded, and while the previous one or two blocks are validated. Subsequent to block formation and propagation, fraud proofs shared among nodes may impeach or repudiate rings that are invalid, or may impeach or repudiate individual fraudulent or invalid blocks. In certain embodiments, a block-building node may assign reputation values to one or more other block-building nodes based on those nodes' past performance of producing valid or invalid block rings.

In one or more embodiments, the number of shards of the global state may be effectively variable, determinable based on the number of nodes participating in the consensus effort. In one such embodiment, a maximum number of shards may be set (for instance, 64, 128, or 256 shards, etc.), but the division of the global state data into separate shards may be limited according to actual usage. For instance, in certain embodiments, the block ring formation process may incorporate an evaluation whereby the number of shards referenced by blocks within the ring is proportional to the number of records and/or transactions—or, alternately, the aggregate gas usage of such records and/or transactions—that have been incorporated into blocks produced in recent consensus rounds. In such an embodiment, only if a certain gas threshold or quantity threshold has been exceeded, will a larger number of independent shards be permitted.

### 64-Bit Evolution

In one or more embodiments, an optimization approach may be implemented, such that 64 shards are configured as a maximum quantity of shards, and quantity of 8 “super-shards” forming groupings of the 64 shards may be defined. Each such super-shard groups the shards together by a numerical proximity, which may be encoded using a shard bitmap. By way of example and illustration, shards 0001 0000 0000 0000 0000 . . . , 0010 0000 0000 0000 0000 . . . , 0100 0000 0000 0000 0000 . . . , and 1000 0000 0000 0000 0000 . . . , may belong to shard group 1111 1111 0000 0000 0000 . . . , etc.

In one or more embodiments, when the aggregate amount of data of the network is below a certain limit, or, in an alternate embodiment, when the maximum size of any single shard is below a certain limit, then block-building nodes should claim shards that fully intersect with these pre-determine shard groups. During this period, according to such an embodiment, a block-building node's claimed shards (i.e. a new block's claimed shards) should overlap with the permitted shard definitions.

In various embodiments, additional thresholds may exist, such that at a higher level of system load, or a higher quantity of aggregate data present in a network or within a certain shard, smaller super-shard groups may be activated—for instance, groups of 4 shards, rather than 8 shards-such that a block-building node's claimed shards may overlap with these combinations of shards.

In various embodiments, nodes may maintain and operate on copies of at least two shards. Some nodes may maintain and operate on copies of up to 32 shards. Each node thus has a bitmap/filter that corresponds to the shards that it maintains. In one or more embodiments, pairings may be implemented of the shard bitmap modulo 4 shards; pairings may be implemented of the shard bitmap modulo 8 shards; pairings may be implemented of the shard bitmap modulo 16 shards; pairings may be implemented of the shard bitmap modulo 32 shards; pairings may be implemented of the shard bitmap modulo 64 shards

In certain embodiments, either a wallet node or the block-building node may determine the accounts or address that a record or transaction reads, modifies, or operates on. This may be translated into a bitmap representing the shards that the transaction reads, modifies, or operates on. The accounts and address that a transaction corresponds may be determined statically, in two groups-read-from accounts and address, and write-to accounts and addresses.

In one or more embodiments, shard that an account belongs to may be determined by taking the modulo 64 output of the address, and then determining the corresponding bit in a 64-bit word. This bit may then be compared to the filter of a shard using bit-wise operators in order to determine if the bit belongs to that shard. By way of example, either of the following may indicate in an example implementation that an address or account belongs to a shard (where ACCOUNT_BIT is a bitmap with only the bit corresponding to the account being set to one):

| | |
|---|---|
| a) | ACCOUNT_BIT \| SHARD_FILTER == SHARD_FILTER |
| b) | ACCOUNT_BIT & SHARD_FILTER != 0 |

### Shared Global Data

In certain embodiments, the sharding approach herein described may require special treatment of certain shared global data that may be commonly referenced or used across a broad set of accounts, addresses, records, transactions, or blocks (universal data).

For example, in at least one embodiment, one or more blockchain tokens may be commonly referenced or used throughout the system, such that it would be difficult or impossible to build multiple concurrent blocks that do not all reference or operate on said tokens and their configurations, potentially at the same time.

In one or more embodiments, certain smart contracts may present a similar challenge, in that they may involve state transformations to multiple shards through the same execution invocation event. Certain smart contracts in such an embodiment may comprise shared global data.

According to various embodiments, at least one separate universal shard may be implemented, separate and apart from and in addition to the other shards of the global state described herein (“standard shards”). In order to avoid conflicts with state transformations operating on standard shards, any records and/or transactions that modify data present in such a universal shard may be executed as a separate step apart from the general block-building process, and may constitute a “universal block” separate and apart from the blocks produced during the general block-building process described elsewhere herein (“standard blocks”). In this way, in such embodiments, read-only references to shared global state (such as, for example, read-only references to token configurations) may be included in any and all blocks without conflict, relying on the fact that concurrent updates will not occur until block execution terminates.

In certain embodiments, however, state transformations made to shared global state may be delayed a certain number of blocks, and records and/or transactions effectuating changes to shared global state (such as, for example, token configuration changes) may include a delayed execution parameter or an “effective block number” field, which controls the block height at which the configuration change goes into effect. In at least one embodiment, a “no earlier than” field may also be added to records and/or transactions, which field may specify a block height before which the record cannot be included in any block. This “no earlier than” field may facilitate having the record or transaction fully distributed across the network before any attempt is made to add a record to a block; this would help to ensure that all block-building nodes would tie on the first fitness criteria.

In some embodiments, if a state transformation applied to a universal shard element is combined with a transformation applied to a standard shard, for example in one atomic transaction or composite transaction that combines other records and/or transactions, or through the execution of a smart contract, then the universal shard may be included in a standard block. In certain such embodiments, each block-building node and/or validator node may store and maintain said universal shard, in addition to whatever other standard shards each block maintains and operates on. Furthermore, each block-building node may validate these universal shards, and may also participate in building universal blocks, in addition to standard blocks.

In one or more embodiments, records and/or transactions configured to effectuate state transformations to a universal shard element may be automatically prioritized for inclusion in the blockchain, and do not require a gas payment. In one or more embodiments, the fitness value or fitness determinant of a universal block may be the number of token configuration records or other universal data updates included in the block; the universal block selected in may be the block having the most such updates included.

In at least one embodiment, the records and/or transactions that update one or more universal shards may all need to be shared by every node, each of which would update one or more universal shards shared by all nodes. According to an embodiment, only the universal block would make updates to these one or more universal shards, but all nodes would perform reads against these shards. According to an alternate embodiment, certain records or transactions that implicate the universal shard and other shards may be included in one or more other blocks.

In various embodiments, token configurations may be encoded in token configuration data structures, which token configurations may be associated with the universal shard, and which token configuration data structures may be incorporated into a universal shard data structure. In certain embodiments, a token configuration data structure may be addressed within the universal shard data structure with a reference comprising a token pseudo account address, and the token configuration data structure may comprise a token pseudo account.

In one or more embodiments, a similar challenge may be presented by order book and token trading data. In a non-sharded system, such data may act as a singular system-wide source of pricing and order prioritization, with said pricing and prioritization state being updated as orders are matched during the course of the block being built and records and/or transactions being executed. In various embodiments of the sharding system described herein, updates may be localized to blocks comprising shards that only account for a portion of the global state; as a result, a trade that is available to be executed by one block will not, by definition, be available in another block to be executed, and pricing and prioritization information will not be updated during the course of a block's execution.

A solution provided by certain embodiments of the present invention may be to impellent a separate, parallel pricing and prioritization state in each shard, so that order matching and pricing may be executed within each shard, without a shared global state. By such a mechanism, each block-building node may have a separate price for a given pair of tokens or assets—or no price at all. However, a deterministic order-matching algorithm may be applied which causes purchase orders to be matched to the best-priced sale orders among the sale orders of the various shards of a block. Market-driven arbitrage activities of various users driven by profit motive may standardize prices among shards, and individual users wishing to avoid local pricing irregularities present in certain shards may specify a minimum or maximum price as part of a limit order, so that their order is only matched in a block that is able to satisfy their price.

### Implementation Approaches

### Various Features

In one more embodiments, a block reward may be allocated for each shard, so an incentive exists to mine extra shards if a block-building node has the capability to do so. However, according to certain embodiments, a two-shard block-building node may run faster, possibly giving it an advantage in improving its blocks' fitness value.

In various embodiments, when a new a block-building node first joins the blockchain network, it may choose the one shard that belongs to its own account; when selecting additional shards, it may choose one or more shards randomly, or it may decide on such shards deliberately—for instance by selecting an account that it may want to optimize a connection to. In certain embodiments, a new block-building node may download the data pertaining to each of its shards—and only its shards. Accounts may be divided among the shards, each account belonging to only one shard. Records and/or transactions may belong to one or more shards, depending on what accounts are involved with that transaction.

In one or more embodiments, a block-building node may build any block that contains only transactions that pertain to accounts within its shards. Blocks may declare which combination of shards it reads, modifies, otherwise operates on, which may be encoded in block headers. In certain embodiments a block may also contain one or more Bloom filters, encoded in a block header, representing the accounts that it has interacted with or operated on. In an embodiment, if a record or transaction reads, references, modifies or operates on any accounts that are not included in one of the block-building node's shards, then that transaction may not be included in any block created that block-building node-it will instead need to be incorporated into a block by another block-building node that includes in its various shards all of the accounts read, referenced, modified, or operated on by said record or transaction.

In certain embodiments, a record that invokes a smart contract may declare the accounts or addresses that the smart contract may read, reference, modify or otherwise operate on, and list said accounts or addresses in a smart contract execution record, in order to statically validate that the smart contract is compatible with the block-building node's shards, without first needing to execute the smart contract. Alternately, in an alternate embodiment, the block-building node may statically validate the smart contract invocation only with regards to the sender account and receiver smart contract accounts, execute the smart contract, and if the smart contract touches on any other account that is not found in one of the block-building node's shards, treat the contract invocation as invalid, and add the smart contract invocation record to the blockchain in a failed state. In at least one such embodiment, however, to save space, account annotations should only accompany a smart contract invocation that might read, reference, modify or otherwise operate on an account other than the sender account and the smart contract itself.

### One Implementation

According to various embodiments, the following example implementation of a sharding consensus procedure may be provided.

In certain embodiments, at a certain time offset within a round, each block-building node may share its most-optimal-fitness blocks to all peers. Block-building nodes may also forward block header information it has received or generated of blocks that are the most-optimal-fitness blocks for each shard. In an embodiment, said time offset may be determined through the use of a verifiable delay function, which forces the block-building nodes to wait a specific and verifiable amount of time before broadcasting any blocks (the blocks would have to contain the verifiable delay proof).

In one or more embodiments, block-building nodes may then shift to trying to find the block ring with the most optimal aggregate fitness for that generation. Finding the absolute optimum-fitness block ring combination may be beyond the computational capabilities of an embodiment, so heuristic approaches that may or may not be stochastic in nature may be taken. Therefore, an optimization result may be non-deterministic—there may be no single best result that can be known within the timeframe of the round. In an embodiment, a block-building node may share its most-optimal-fitness solution to a block-ring combination problem after a certain time has passed.

In several embodiments, a block ring that is formed may have one or more of the following qualities:
a) Every shard of the global state to be included, with at least one block covering each shard.
b) Any two blocks that cover the same shard not to have account bloom filters that intersect (each block to deal with mutually exclusive accounts)
c) All blocks to be specified or declared when identifying the block ring of that particular round.
d) The block ring to have a hash digest, comprising a cryptographic hash of a deterministically generated data structure comprising block hashes of included block.

In at least one embodiment, optimal-fitness block ring combinations may be shared when they are found. In an embodiment, more than one combination may be shared, because of the possibility that one or more of the block rings formed may be fraudulent. If the multiple block rings that are shared or proposed are mutually exclusive, such that no two blocks are shared between the competing block rings proposed, according to an embodiment, these block rings may be combined into a single block ring.

According to various embodiments, various optimization algorithms may be employed to find the most-optimal-fitness combination of already-created blocks to form a ring optimal for a round. After the block-ring fitness values and formation details are shared across the network, the network should converge on a single most-optimal-fitness ring, or on a small set of highly-optimal-fitness rings.

According to certain embodiments, block-building nodes are incentivized to share their most-optimal-fitness combinations. Few block-building nodes may be in a position to validate every shard, and therefore various nodes rely on other validator nodes and block-building nodes in the network to validate other shards. In an embodiment, the more block-building nodes that receive the shared blocks, the more likely that each block will be validated by at least one trustworthy party. According to at least one embodiment, at least one trustworthy party validates each shard of each block built.

In an embodiment, the next generation of blocks will be built in reference to the optimal block ring of the previous generation.

According one or more embodiments, each block-building node may run multiple threads:
a) A building thread for each shard and/or ring.
b) A validation thread for each shard and/or ring.

In certain embodiments, each validating thread may execute the records or transactions of the block ring block(s) corresponding to its designated shard, but it only validates the state transitions pertaining to the accounts within its designated shard; it may assume that the state transitions pertaining to the other shard(s) within the block(s) are valid.

In various embodiments, threads of a block-building node may build new blocks in parallel; additional threads may validate the shards of unverified blocks of various chains that have been selected for validation. Validation may proceed from the oldest block within each fork until the most recent block. The number of competing forks that will be simultaneously validated and built upon may be a function of how many total threads (i.e., cores) the block-building node has available. With each old block that is evaluated, a block-building node may only validate the portion of that block that corresponds to the shards that it maintains. If at any point within the validation process an invalid step is detected, then a fork including all subsequent blocks may be deemed invalid.

### Fraud Proofs and Reputation

In one or more embodiments, block-building nodes and validator nodes may only validate state transformations that affect their own shards, when evaluating records and/or transactions of new blocks built by other nodes. Block-building nodes and validator nodes, in such embodiments, should operate as if state transformations applied to other shards are valid, because said nodes do not store the state data needed to validate these state transformations. Furthermore, in embodiments that employ trust-but-verify methodologies, block-building nodes may assemble and build new blocks before the validity of preceding blocks has been verified. As a result, it may be possible to for a malicious actor propagate erroneous records and/or transactions across a blockchain network of one or more embodiments, and/or build fraudulent or invalid blocks, possibly propagating such data to nodes that are, by design, unable to fully verity such data, or which, depending on the embodiment, may be delayed in performing such a verification.

The terms “fraud” and “fraudulent”, as used in herein with regards to transactions, records, messages, blocks, block headers, block rings and other data, as implemented in one or more embodiments of the present invention, refer to such data that has been formulated or encoded by a blockchain node or other computer device in such a manner as to be invalid or unverifiable, and having potential to disrupt, interrupt, misdirect or otherwise undermine the ideal operation of the blockchain system, with the possible effect of slowing network operation, overloading blockchain nodes or other computer devices, corrupting global state data, presenting misleading information, inducing double spending, or otherwise reducing the integrity, effectiveness and reliability of the system.

Although many instances of fraud described herein may ultimately be discovered without the various mitigation techniques, time and resources may be wasted when block-building nodes are induced to build new blocks on top of fraudulent blocks that are not yet known to be fraudulent. In various embodiments, a block that is discovered to have been built on a fraudulent block should be discarded, wasting the resources that were used to build that block.

Various solutions are provided by one or more embodiments of the present invention, and are described herein. Certain embodiments implement “fraud proofs” which penalize block-building nodes that act maliciously, and thereby disincentivize the incidence of fraud. Another solution provided by one or more embodiments is a reputation-tracking mechanism, which may be used in combination with fraud proofs, or without them, to reduce or eliminate the possibility that a block-building node will tricked into building upon a fraudulent block. Various other solutions pertaining to a number of embodiments are also described herein.

### Fraud Proofs

Fraud proofs are data structures that provide cryptographic evidence of fraudulent data being included in one or more blocks. Such fraud proofs, in one or more embodiments, may comprise one or more Merkle proofs, which Merkle proofs are known cryptographic proof data structures comprising a sequence of hash values that, when combined with the hash of a revealed data element, enables the reconstruction and verification of a Merkle root within a Merkle data structure (such as a Merkle tree or a Merkle trie). A Merkle proof enables the verification of a revealed data element's inclusion within a Merkle-data-structure-encoded dataset by reconstructing the Merkle root without requiring access to the entire dataset except for the revealed data element.

A fraud proof in one or more embodiments of the present invention incorporates one or more block header data elements, along with one or more Merkle proofs, which in combination may provide a step-by-step linkage between one or more blocks and a demonstrable contradiction or violation of protocol rules encoded in the data. A blockchain node or other computer device in possession of a fraud proof is enabled to identify one or more blocks as definitively fraudulent-a result of the demonstrable contradiction or violation of protocol rules encoded in the block-without said node or device needing to have access to various other data which constitute the block.

The precise nature of a fraud proof may depend on the nature of the fraudulent block or transaction being impeached or repudiated by the fraud proof. For example, in one embodiment, if the fraud is a structural invalidity localized in a single transaction, then only a single Merkle proof revealing that structurally invalid transaction will be included in the fraud proof, along with the block header which comprises the Merkle root of the Merkle proof. More complex incidences of fraud, however, may require more than one block header, and/or more than one Merkle proof. If, for example, the structural invalidity is localized in the receipt, or if the receipt does not match the record or transaction, then Merkle proofs of both the transaction and receipt are included, along with a block header containing Merkle roots of both.

According to various embodiments of the present invention, fraud proof records may be implemented as blockchain records and/or transactions comprising one or more fraud proofs. In various embodiments, fraud proof records contain fraud proof data structures that share a portion of the block header, system state, transaction, and/or receipt data that is necessary to prove that a referenced block is fraudulent. In one or more embodiments, a fraud proof record may effectuate a transfer of tokens from an account of a malicious actor that has cryptographically signed and propagated to the blockchain network a fraudulent block, to an account that is specified within the fraud proof record.

According to certain embodiments, a block-building node may place a number of tokens “at risk” with a block that it builds, which tokens are held by an account the private key of which it uses to cryptographically sign the block or its block header. In certain embodiments embodiment, such “tokens-at-risk” may function as a “guarantee” ensuring that the block is not fraudulent; if the block is proved to be fraudulent, then the tokens-at-risk may be lost. In at least one embodiment, a proof record may seize all or a portion of the tokens-at-risk of a block, transferring all or a portion to the sender of the fraud proof, and in the process impeach, repudiate or invalidate a block for the whole network. In one or more embodiments, a block header may only be valid if the number of tokens placed at risk is greater than the number of tokens held by the block-building node account that has signed the block header.

In certain embodiments, a fraud proof record may be intercepted before being included in a block, and may be font-run by a block-building node that discovers the fraud-proof record before it has been included in the blockchain-meaning, the block-building node strips the fraud proof from the fraud proof record, and then submits the fraud proof record with its cryptographic signature, seizing the “tokens-at-risk” for the block-building node's own benefit. Therefore, it is in the interest of a block-building node only to generate and incorporate a fraud-proof record into the block that it itself decides to build. From a network perspective, however, a fraud proof record that is front-run has the same positive impact on network stability and security as an original fraud proof record.

### Types of Fraud

### Malformed-Data Fraud

In various embodiments, a malformed-data fraud may occur, in which a record, transaction, receipt and/or other data constituting a block may not be properly structured or encoded according to the rules of the blockchain protocol. In certain embodiments, an instance of a malformed-data fraud may occur when an element within a hash-based data structure of a block (such as a Merkle tree or Merkle trie) hashes to the same hash digest that contributed to the formation of the hash-based data structure, such that the hash-based data structure itself is valid when formed inclusive of the data element in question, but where the data element itself is malformed, invalid, incorrectly encoded, or otherwise contradicts the protocol rules. An instance of malformed-data fraud may be considered an instance of block-construction fraud.

In one or more embodiments, a malformed-data fraud proof may comprise a block header and one or more cryptographic proofs (for example, one or more Merkle proofs), which cryptographic proofs provide evidence that one or more records, transactions, receipts and/or other data of a block is structurally malformed. Within each cryptographic proof, the structurally malformed data is included among the revealed data. No global state or shard data needs to be included in a malformed-data fraud proof, because by definition the invalidity is structural and unrelated to global state.

In one or more embodiments, if the structural invalidity is of a record or transaction, then only a single record- or transaction-specific cryptographic proof need be included in the fraud proof. However, if the structural invalidity is of a receipt, then a single receipt-specific cryptographic proof may need to be included; and if the structure or type of a receipt is not correct for a record or transaction associated with the receipt, then both a transaction-specific cryptographic proof and a record- or transaction-specific cryptographic proof may be included in the fraud proof. In certain embodiments, the record- or transaction-specific cryptographic proof may be implemented as Merkle proof, and/or the receipt cryptographic proof may be implemented as a Merkle proof.

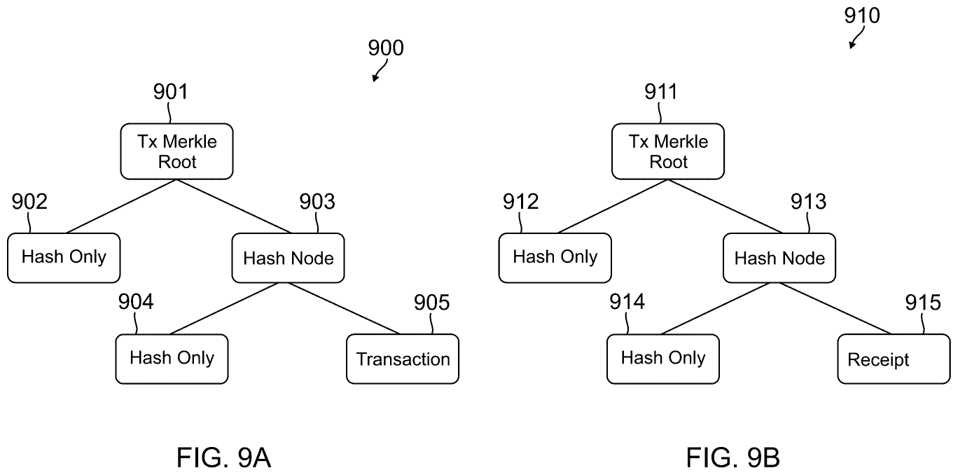

FIG. 9A illustrates a transaction-specific cryptographic proof, and FIG. 9B illustrates a receipt-specific cryptographic proof, each implemented as a binary Merkle proof in this example embodiment. A malformed transaction is shown as revealed data at 905, and a malformed receipt is shown as revealed data at 915. Merkle roots (901, 911) comprise root hash derived from the constituent leaf and branch node hash digests, according to a standard binary Merkle proof algorithm.

A blockchain node or other computation device evaluating and/or confirming a malformed-data fraud proof may implement one or more of the following steps, without limitation:
a) Compare one or more root hashes of the cryptographic proofs to one or more hash digests of the block header, to confirm that the cryptographic proofs do correspond to hash-based data structures of the block. For example, a root hash of a receipt-specific cryptographic proof may equal the hash digest of the block's receipt data structure.
b) Evaluate the revealed data in order to establish that it is, indeed, malformed.
c) In an embodiment, the block header may be cryptographically signed by the block-building node that created or built the block, in which event the block-building node or validator node may also verify the signature of the block.

### State-Disjunction Fraud

According to one or more embodiments, a receipt corresponding to a record or transaction may contain one or more hash digests of one or more global state data structures as they exist prior to execution of a record or transaction, and one or more hash digests of new versions of said one or more global state data structures as they exist after execution of the record or transaction. Normally, a new global state after executing a record or transaction is equivalent to a prior global state of the next transaction, before it executes. A state-disjunction may be deemed to occur when a hash digest of a new global state (“post-execution hash”) of a record or transaction (i.e. record or transaction T) does not match a hash digest of the corresponding prior global state (“pre-execution hash”) of the subsequent record or transaction (i.e. record or transaction T+1), as encoded by the receipts associated with said records and/or transactions. The transactions (i.e. T and T+1) in such circumstance may be considered “disjoint”; an instance of state-disjunction fraud may be considered an instance of block-construction fraud.

In one or more embodiments, a state-disjunction fraud proof may be implemented in two forms. If the state disjunction is between two sequential transactions of the same block, then the fraud proof may comprise a block header of the block and a receipt-specific cryptographic proof revealing the receipt data structures of the disjoint transactions. If the state disjunction is between the first transaction of a block, and the last transaction of a preceding block, then the fraud proof may comprise the block headers of the two blocks, and receipt-specific cryptographic proofs of each block revealing the receipt data structures of the disjoint transactions. Said cryptographic proofs may in certain embodiments be implemented as Merkle proofs of Merkle data structures such as, for example, Merkle trees or Merkle tries.

Alternately, variant embodiments may implement block headers which themselves comprise both a hash digest of an initial global state data structure (initial state hash), and a hash digest of a final global state data structure (final state hash), where said initial global state data structure is a data structure of the global state before execution of the block's functionality, and said final global state data structure is a data structure of the global state after execution of the block's functionality. In such an embodiment of the present invention, a state-disjunction fraud proof demonstrating a disjunction between the first record or transaction of a block and the last record or transaction of a preceding block may comprise block headers of said blocks, without including Merkle proofs.

In one or more embodiments that implement a multi-shard global state, each shard of a global state may comprise its own global state data structure, and may comprise its own hash digest-which hash digest may be a root hash of the shard state data structure, in the case that said state data structure is implemented as a hash-based data structure, like a Merkle tree or Merkle trie. In such an embodiment, a receipt may comprise a separate pre-execution hash and a separate post-execution hash for each shard referenced, read, modified or otherwise operated on by a record or transaction; and in certain variant embodiments, a block header may comprise a separate pre-execution hash and a separate post-execution hash for each shard referenced, read, modified or otherwise operated on by its block and/or its records and/or transactions. In various embodiments, a state-disjunction fraud proof may occur when a post-execution hash included in a receipt or block header, which post-execution hash is of a particular shard data structure, fails to match a pre-execution hash included in an immediately subsequent receipt or block header, which pre-execution hash is of the subsequent version of the same shared data structure.

A blockchain node or other computation device evaluating and/or confirming a state-disjunction fraud proof within one block may implement one or more of the following steps, without limitation:
a) Comparing the hash digest (i.e. root hash) of the receipt-specific cryptographic proof to the receipt hash digest of the block header, to confirm that the cryptographic proofs do correspond to hash-based data structures of the block.
b) Evaluating the revealed receipt data to confirm that a post-execution hash of a first receipt indeed does not match a corresponding pre-execution hash of a second receipt.
c) In an embodiment in which the block header may be cryptographically signed by the block-building node that created or built the block, verifying the validity of the cryptographic signature of the block.

A blockchain node or other computer device evaluating and/or confirming a state-disjunction fraud proof between two blocks may implement one or more of the following steps, without limitation:
a) Confirming that the more recent of the block headers includes a back reference to the older of the block headers, which back reference comprises a cryptographic hash digest of the block header.
b) In an embodiment that includes one or more receipt-specific cryptographic proofs revealing receipts of disjoint transactions, comparing the hash digest (i.e. root hash) of each receipt-specific cryptographic proof to the receipt hash digest of each corresponding block header, to confirm that the cryptographic proofs do correspond to hash-based data structures of each block.
c) In an embodiment that includes one or more receipt-specific cryptographic proofs added to the fraud proof, confirming that the post-execution hash of a first receipt in fact does not match the corresponding post-execution hash of a second receipt.
d) In an embodiment that includes one or more initial state hashes and one or more final state hashes in block headers, confirming that a final state hash of a first block header in fact does not match the corresponding initial state hash of a second block header of an immediately subsequent block.
e) In an embodiment in which the block header may be cryptographically signed by the block-building node that created or built the block, verifying the validity of the cryptographic signature of the block.

In an embodiment in which a state-disjunction fraud proof implicates a state disjunction between the last transaction of a block, and the first transaction of an immediately subsequent block, it is the immediately subsequent block that may be considered fraudulent. In an embodiment in which a valid fraud proof record comprising a state-disjunction fraud proof is added to a new block by a block-building node, and such state-disjunction fraud proof implicates a state disjunction between last transaction of a block and the first transaction of an immediately subsequent block, tokens placed at risk by a cryptographic signer of the immediately subsequent block may be transferred to a blockchain account specified by the fraud proof record.

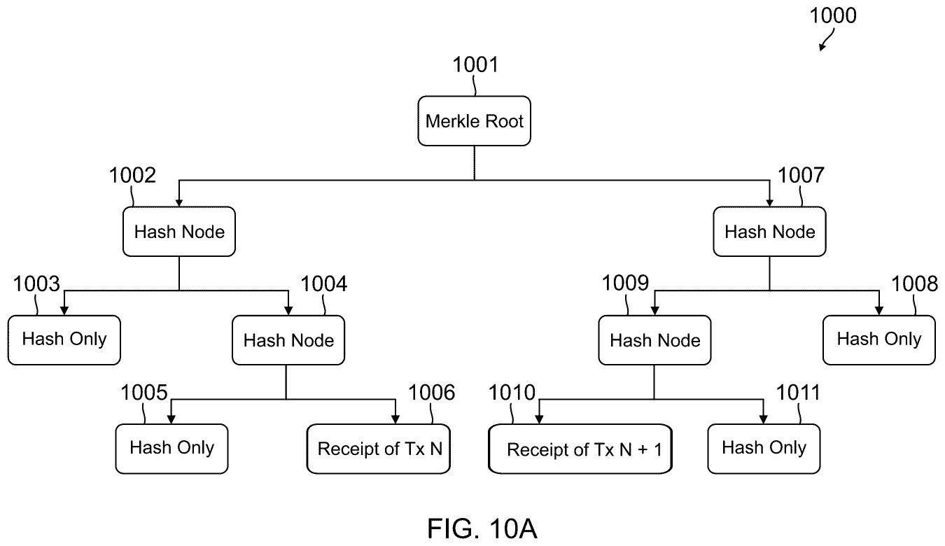

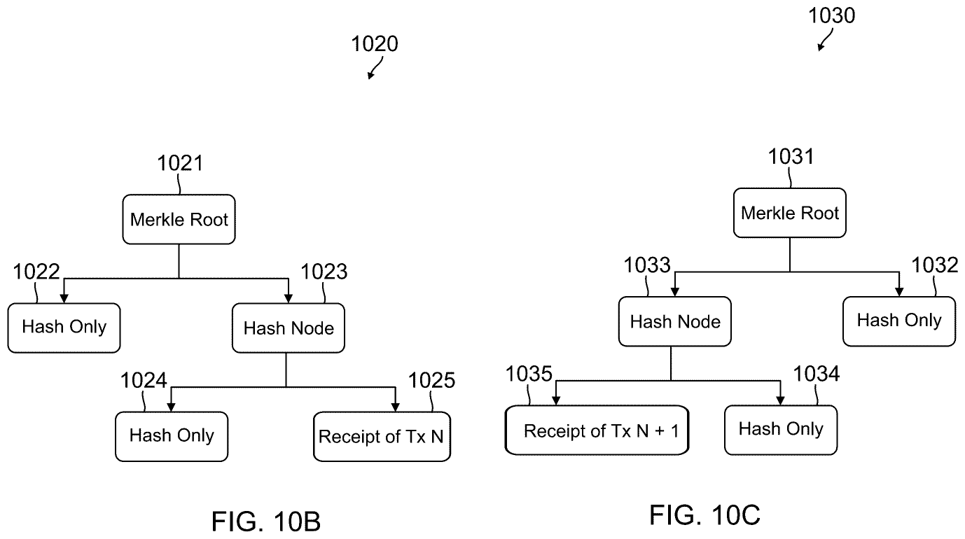

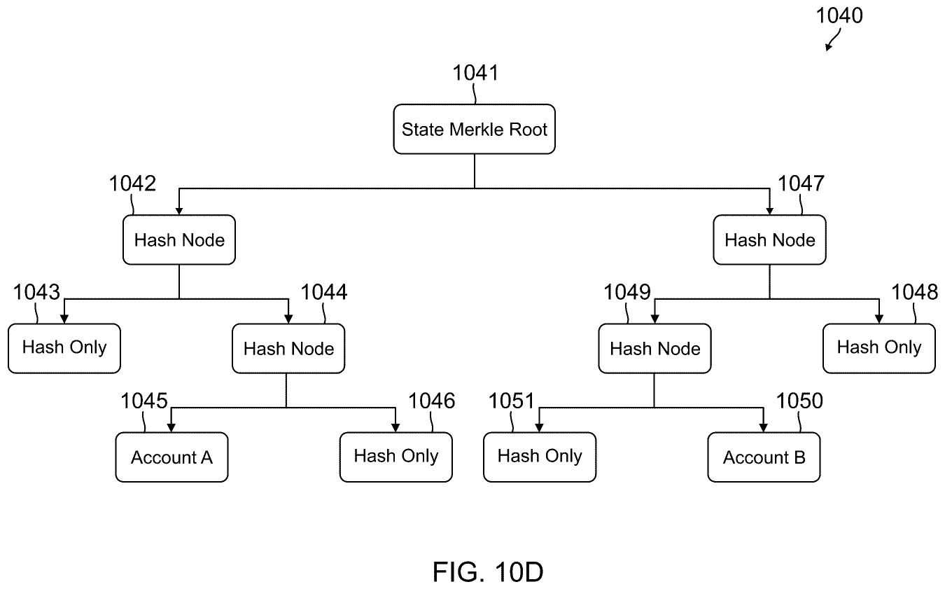

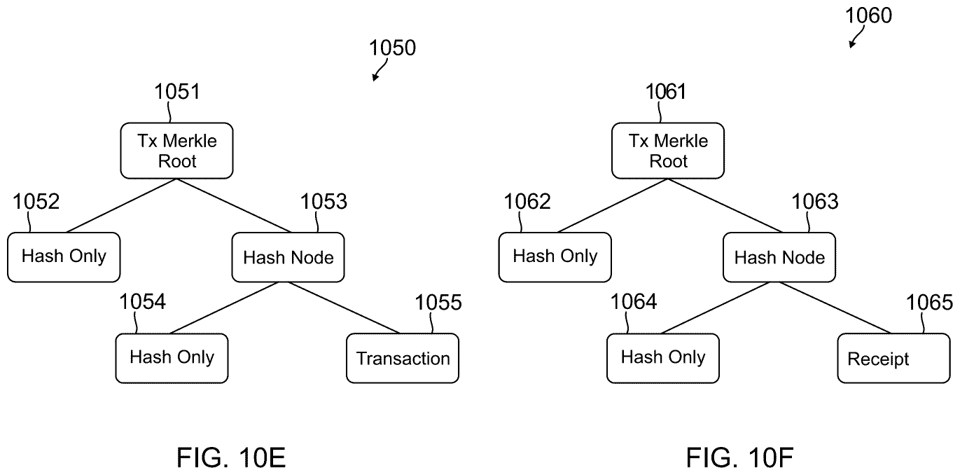

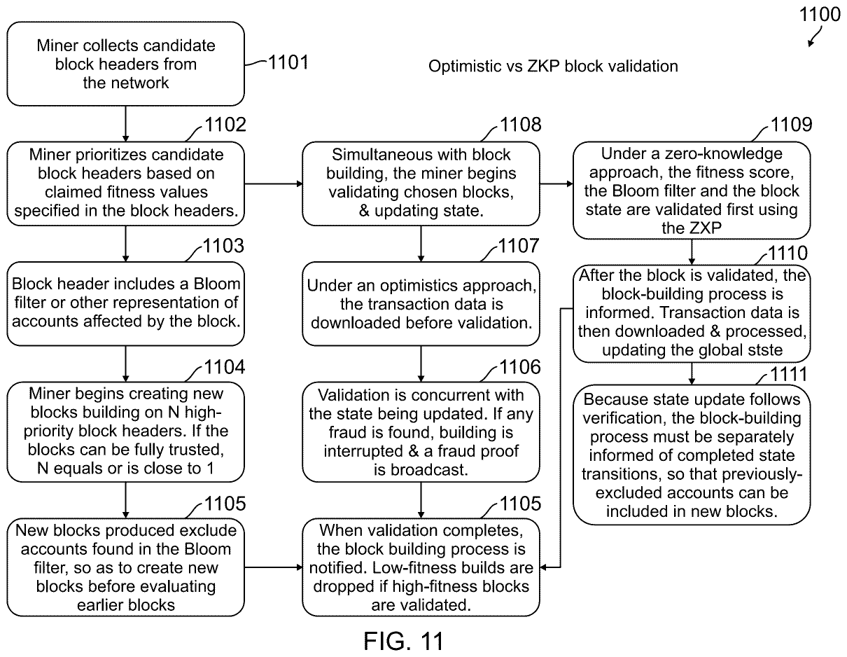

FIG. 10A illustrates Merkle proof elements that may be included in a state-disjunction fraud proof in one or more embodiments. A receipt Merkle proof is presented as a binary Merkle proof (1000), although an alternate implementation may alternate cryptographic proof data structures. Revealed data elements (1006, 1010) may include receipt data structures associated with the disjoint records and/or transactions. Other leaf nodes of the tree (1003, 1005, 1011, 1008) comprise hash digests of other data of the original hash-based data structure which is not revealed; this hidden data may not be relevant for the generation or evaluation of the fraud proof, but the included hash digests may be necessary for the verification of the Merkle proof itself. The Merkle root (1001) is calculated according to the standard known algorithm for generating the hash digests that constitute a binary Merkle proof, by first hashing all revealed data, then combining hashes of leaf and branch nodes in pairs, and hashing each pair, starting at the bottom, and proceeding upwards level-by-level, until all hashes are combined into the hash root.

FIGS. 10B and 10C illustrate, in an example embodiment, separate receipt Merkle proofs (1020, 1030) that may be included in a fraud proof created in the event of a state disjunction between two blocks are also presented; in alternate embodiments that rely on one or more hash digests included in block headers, these may be omitted. The first receipt Merkle proof comprises a revealed receipt (1025), two leaf nodes comprising hash digests of hidden data (1022, 1024), and a receipt Merkle root (1021) derived from the constituent leaf and branch node hash digests, according to a standard binary Merkle proof algorithm. The second receipt Merkle proof comprises a revealed receipt (1035), two leaf nodes comprising hash digests of hidden data (1034, 1032), and a receipt Merkle root (1031) derived from the constituent leaf and branch node hash digests, according to a standard binary Merkle proof algorithm. In various embodiments, these account Merkle roots may match hash digests of the block headers included with the fraud proof.

### Invalid-Transition Fraud

In various embodiments, a receipt may include a hash digest of a version of a global state data structure immediately prior to execution of the record or transaction associated with the receipt; said hash digest may be referred to as a pre-execution hash, and said version of the global state data structure may be referred to as a pre-execution state. A receipt may also include a hash digest of a version of the global state data structure immediately following execution of the record or transaction associated with the receipt; said hash digest may be referred to as a post-execution hash, and said version of the global state data structure may be referred to as a post-execution state.

In various embodiments, an invalid-transition fraud may occur in which a record or transaction associated with a receipt does not result in a new state reflected by the receipt. In other words, an invalid-transition fraud may occur when a pre-execution state conforming to a pre-execution hash does not transform into a version of the global state conforming to a post-execution hash when the record or transaction associated with the receipt is applied.

According to various embodiments, each record, transaction and/or receipt may also incorporate a reference to all accounts or addresses read, operated on or modified by that transaction. In certain embodiments a receipt may also include one or more hash digests of affected account or address data stored in the global state, and/or may include certain individual details of the account or address data.

In one or more embodiments, when an invalid-transition fraud occurs, data of an account or address as it exists immediately prior to the execution of a record or transaction will not be transformed into the data of the same account or address as it is hashed or encoded in the corresponding receipt. In certain embodiments, in order to prove that a transaction is fraudulent, and in turn, that a block is fraudulent, it may be sufficient to prove that one or more such account or address data transformations are inconsistent with state data hashed and encoded in a receipt.

In one or more embodiments, a validator node or a block-building node performing validation of a block may construct a fraud proof through a process involving the following steps, without limitation:
a) A node identifies all elements of a pre-execution state that are read, referenced, modified by, or otherwise operated on by a fraudulent record or transaction. These elements are added to a Merkle proof, in which Merkle proof only these elements are revealed, and which proofs Merkle root hash is the same as the pre-execution hash of the block, encoded in the block header. This Merkle proof is the pre-execution Merkle proof. In order to arrive at the precise pre-execution state, in one or more embodiments, the node may need to execute all records and/or transactions preceding the fraudulent record and/or transaction.
b) The node performs a transformation of the pre-execution Merkle proof by executing the one or more state transformations embodied by the fraudulent record or transaction, and then updating the hash digests of the proof and the Merkle root hash. This results in a new Merkle proof in which the revealed data comprises the state elements that have been read, referenced, modified by or otherwise operated on by the fraudulent record or transaction. This Merkle proof is the post-execution Merkle proof.
c) The fraud is proven by demonstrating that the pre-execution Merkle proof root hash is the same pre-execution hash encoded in the fraudulent block or in the fraudulent block's block header, and that the post-execution Merkle proof's root hash differs from the post-execution hash encoded in the fraudulent block or in the fraudulent block's block header.

In one or more embodiments, an invalid-transition fraud proof may be encoded comprising one or more of the following, without limitation: the block header and block hash of the fraudulent block, the cryptographic signature of the block-building node that built the fraudulent block (if it is not directly incorporated with the block header), the fraudulent record or transaction, the associated receipt, and the pre-execution Merkle proof.

In various embodiments, a blockchain node or other computer device may evaluate and/or confirm said invalid-transition fraud proof first by confirming that a root hash of a pre-execution Merkle proof matches a pre-execution hash of a block header, then by executing one or more state transformations of a fraudulent record or transaction against the pre-execution Merkle proof revealed data elements, then by generating a confirmation Merkle proof from the results of said execution, and lastly by confirming that the confirmation Merkle proof root hash is distinct from a post-execution hash of the block header. In some embodiments, a post-execution Merkle proof may also be included in the fraud proof, to provide an additional point of comparison against the confirmation Merkle proof.

In one or more embodiments, an invalid-transition fraud proof may also include one or more Merkle proofs corresponding to each record, transaction and/or receipt referenced by or included in the fraud proof; in such an embodiment, the process of constructing a fraud proof may contain one or more steps wherein said Merkle proofs are constructed proving the presence of said records, transactions, and/or receipts in the record, transaction or receipt data structures of the block. In at least one embodiment, a process of evaluating and/or confirming a fraud proof may include one or more steps verifying that the root hashes of said one or more Merkle proofs are equal to the corresponding record, transaction, and/or receipt root hashes included in the block's block header.

In one or more embodiments that implement a multi-shard global state, each shard of a global state may comprise its own global state data structure, and may comprise its own hash digest-which hash digest may be a root hash of the shard state data structure in the case it is implemented as a hash-based data structure like a Merkle tree or Merkle trie. In such an embodiment, a receipt may comprise a separate pre-execution hash and a separate post-execution hash for each shard referenced, read, modified or otherwise operated on by a record or transaction. Likewise, a fraud proof implemented in such an embodiment may include a separate pre-execution Merkle proof for each such shard.

In an embodiment that includes additional global state data elements in a receipt, an additional verification may be performed-either in the creation of the fraud proof, or in the verification of it, or both-comparing the data elements of the confirmation Merkle proof against the global state data elements included in the block header. For example, if a receipt includes information regarding token balances of an account or address updated by a record or transaction, such data may be subject to comparison against the data of the confirmation Merkle proof; if the information is inconsistent, then an invalid-transition fraud proof may be constructed.

FIGS. 10D, 10E and 10F illustrate Merkle proof elements that may be included in an invalid-transition fraud proof in one or more embodiments. First, the pre-execution Merkle proof is presented as a binary Merkle proof (1041), although an alternate implementation may alternate cryptographic proof data structures. Revealed data elements (1045, 1050) may include account data of accounts identified as being read, referenced, modified or otherwise operated on by the fraudulent record or transaction. Other leaf nodes of the tree (1043, 1046, 1050, 1048) comprise hash digests of other data of the original hash-based data structure which is not revealed; this hidden data may not be relevant for the generation or evaluation of the fraud proof, but the hash digests may be necessary for the verification of the Merkle proof itself. The Merkle root (1041) is calculated according to the standard known algorithm for generating the hash digests that constitute a binary Merkle proof, by first hashing all revealed data, then combining hashes of leaf and branch nodes in pairs, and hashing each pair, starting at the bottom, and proceeding upwards level-by-level, until all hashes are combined into the hash root.

A transaction binary Merkle proof (1050) and a receipt binary Merkle proof (1060) are also presented; in alternate embodiments, other cryptographic proof data structures may be used instead. The transaction Merkle proof comprises a revealed transaction (1055), two leaf nodes comprising hash digests of hidden data (1052, 1054), and an transaction Merkle root (1051) derived from the constituent leaf and branch node hash digests, according to a standard binary Merkle proof algorithm. The receipt Merkle proof comprises a revealed record (1064), two leaf nodes comprising hash digests of hidden data (1062, 1065), and a receipt Merkle root (1061) derived from the constituent leaf and branch node hash digests, according to a standard binary Merkle proof algorithm. In various embodiments, this account Merkle root and this receipt Merkle root may match a transaction root hash and a record root hash of the block header included with the fraud proof.

### Missing Transaction Fraud

In various embodiments of the present invention, a “missing-transaction fraud” may occur when one or more hash roots (for example, Merkle roots) included in a block header fail to be substantiated because one or more (or all) of the records, transactions, receipts and/or other data are unavailable.

Although missing data may be attributed to network interruptions, network partitions, incompatibilities in software, hardware failure, or other innocent explanations, block data may also be unavailable when the block is entirely invented or contrived, or because data is intentionally withheld. Regardless as to its origin or explanation, however, and as to whether any intention may be attributed to it, the impact of an instance of missing-transaction fraud is likely to be the same, and the mechanics for mitigating the impact of such a fraud may remain the same. In various embodiments, at a fundamental level, an instance of missing-transaction fraud occurs because the block-building node that created or built the block header failed transmit, share or propagate said data; the response is not dependent on the explanation as to why.

In one or more embodiments, missing-transaction fraud may be definitively ruled-out by downloading all the records, transactions, receipts and/or other data of a block, performing a structural validation of those transactions, and then verifying the one or more hash roots of the block header which are derived from that data. Because full validation is not necessary for structural validation, a bock-building node or a validator node may perform a structural validation of records, transactions, receipts and/or other data belonging to shards that it does not manage or operate on. While disproving a missing-transaction fraud may be feasible, proving a missing-transaction fraud amounts to proving a negative. In various embodiments, because proof of fraud is not possible, other strategies should be employed to suppress, reduce and/or control missing transaction fraud.

Certain embodiments of the present invention may implement a universal structural verification process, such that each block-building node and validator node performs structural validation of all block data-even data that is does not retain and/or that does not interact with or operate on the shards it comprises. However, this approach may substantially increase overall network traffic of the blockchain system, and may increase the computational requirements of each block-building node and validator node.

One or more embodiments may suppress, mitigation, reduce and/or control missing transaction fraud through one or more of the following techniques (strategies), in combination or individually, without limitation:
a) by block building nodes performing structural validation of blocks that are selected to be built upon, which structural validation in various embodiments may be performed before beginning to build a subsequent block, while building a subsequent block, or after building a subsequent block (as may be the case when trust-but-verify methodologies are employed);
b) by setting a timing threshold, which timing threshold comprises duration of time after a block-building node has begun downloading a block, at the end of which all data constituting a block should have been downloaded and structurally validated, or any new blocks being built upon that block may be discarded;
c) through the use of verifiable delay functions and/or fitness gradient consensus, as noted elsewhere herein;
d) through the use of insufficiency reputation messages and related processes, as described elsewhere herein;
e) through the implementation of a reputation-tracking mechanism

In one or more embodiments, missing-transaction fraud notices (for example, insufficiency repudiation messages) sent between nodes may be unreliable-meaning that a node receiving such a message may not have sufficient information to determine its veracity. For example, an insufficiency repudiation message may be purposefully false, having the effect of causing nodes on the network to do unnecessary work, or inadvertently false, as in the case of a network partition causing a node to lose access to other nodes. In such embodiments, a block or block ring should not be assumed to be valid until all transactions are downloaded and structurally verified. In one or more embodiments, a block or block ring may be built upon simultaneously while data is being downloaded and structural validation is being performed.

Structural validation, as used herein with regards to various embodiments of the present invention, refers to the process of evaluating a record or transaction to determine if it is encoded in a manner consistent with the requirements of a blockchain protocol, without regards to the compatibility or validity of said record or transaction in relation to the global state or any data thereof. A block may be said to have been structurally validated if its records, transactions, and/or receipts have been downloaded, and if structural validation has been performed on those records, transactions and/or receipts. A block, record and/or a transaction may be said to be structurally valid if structural validation may be successfully performed thereon. A block, record and/or a transaction may be considered structurally invalid if any

### Data Withholding Attack

A data withholding attack, according to various embodiments, consists of an attack whereby one or more malicious block-building nodes transmit and propagate one or more new block headers of one or more new blocks, without transmitting, sharing or propagating the data constituting the block, such as records, transactions and/or receipts. In one or more embodiments, a data withholding attack may be a malicious and intentional result of one or more missing transaction fraud instances perpetrated by one or more block-building nodes.

In various embodiments of the present invention, block-building nodes that receive a block header may begin building on the block optimistically, working to produce one or more new blocks. However, unless all elements of block state are obtained by said nodes-including, but not limited to, records, transactions, receipts, and/or other data elements—in at least one embodiment, the global state cannot be updated, or the validity of the block cannot be determined, or both.

In certain embodiments, a data withholding attack may cause block-building nodes to waste time building on a block, the data of which may never be fully disclosed. In one or more embodiments that implement fitness-gradient consensus, a data withholding attack may induce a reorganization when data of an optimal-fitness block is withheld, if one or more block building nodes discard one or more other competing blocks because they decide to build on said optimal-fitness block at the expense of other blocks, but are ultimately unable to.

Various embodiments of the present invention may implement one or more methodologies or techniques to mitigate the disruptive effects of data withholding attacks, which mitigation techniques may include techniques and strategies implemented to suppress, mitigation, reduce and/or control missing transaction fraud.

### Reputation Tracking

Various fraud mitigation approaches implemented by various embodiments of the present invention allow fraudulent blocks to be identified, invalidated, impeached and/or repudiated in a retroactive manner. An implication of this is that even after a block or a block ring has been selected and built upon, the work performed to build upon that block or that block ring may yet need to be discarded if fraud is discovered. The success of these various fraud mitigation approaches depend on whether reputation heuristics can slow the spread of fraudulent blocks so that they do not displace valid blocks before the fraud is detected.

In one or more embodiments, a reputation-tracking block-building node (i.e. a “reputation-tracking node”) may store one or more reputation values corresponding to each of its peer block-building nodes (“peers” collectively, or individually, “peer”, referring to a node with which a block-building node maintains a connection and exchanges data), and in certain embodiments may also store a reputation value for other block-building nodes. According to various embodiments, reputation values may be separate and apart from the global state, and may consist of local data stored and maintained only the reputation-tracking node itself, although in certain embodiments the reputation data may be shared with other nodes that may be operating in combination with that node or in a cluster with that node. In one or more implementations, the blockchain protocol rules are indifferent as to the reputation-tracking methodology and reputation heuristics that each node implements; the performance of the network may be enhanced if nodes implement effective reputation tracking, but it is nonetheless only implemented conventionally by nodes at their option.

In one or more embodiments, such one or more reputation values may correspond to accounts or addresses of the various block-building nodes of the network, which block-building nodes each cryptographically sign the encoded blocks or block header data structures that are propagated across the network. Reputation values may also be stored to correspond with direct peers according to the network connection maintained between the reputation-tracking node and each peer. In certain embodiments, a peer may authenticate its affiliation or control of an on-chain account by cryptographically signing a challenge that is shared by the reputation-tracking block-building node, which challenge may be a random string or other value generated by the reputation-tracking block-building node for this purpose. This challenge-signing, which may in certain embodiments be a part of a larger peering network protocol, and in other embodiments may be part of a different protocol, may prove to a reputation-tracking block-building node that a peer does in fact control a particular blockchain account. A peer's reputation may be stored according to the connection maintained, or according to the authenticated account or address.

In one or more embodiments of the present invention, each block built may be signed by the account of the block-building node that builds it. In certain such embodiments, reputation may be tracked according to the account of the block-building node; if a block-building node changes the account or address it uses to sign blocks it builds, then its reputation resets.

According to one or more embodiments, a reputation-tracking node may improve or increase a block-building node's reputation value when one or more non-fraudulent blocks created or signed by the block-building node are validated successfully by the reputation-tracking node. In certain embodiments, a detection or awareness by a reputation-tracking node of one or more fraudulent or repudiated blocks signed by a block-building node may penalize or reduce that block-building node's reputation value stored by the reputation-tracking node.

In one or more embodiments, a reputation-tracking node may penalize or reduce the reputation of a peer if it has transmitted or shared a fraudulent or repudiated block; this may occur in certain embodiments even if said peer did not itself build or cryptographically sign the fraudulent or repudiated block. In various embodiments, a reputation-tracking node may not penalize or may not reduce the reputation of a peer that shares or transmits a fraudulent or repudiated block if said peer includes a flag or other indicator with the block indicating the block is “unverified” by the peer. A reputation-tracking node may penalize or reduce the reputation of a peer if the peer indicates a fraudulent or repudiated block received from a third party as being “verified”.

In at least one embodiment, blocks built by a block-building node having a low reputation may rarely be processed, even if those blocks have an optimal fitness in an embodiment that impalements a fitness gradient consensus. By default, a block built by a low-reputation node having a reputation value below a certain threshold may be discarded or ignored by a reputation-tracking node, such that neither the block nor its block header may be processed, validated, nor propagated by the reputation-tracking node. In certain embodiments, however, low-reputation blocks may nonetheless be processed and/or validated periodically by reputation-tracking nodes, which may serve to prevent calcification of a reputation-tracking system, and may serve to balance the influence of high-reputation nodes on a network.

In various embodiments, a reputation-tracking node may select for processing and/or for validation certain blocks built by lower-reputation block-building nodes—or by nodes having a reputation value below a rejection threshold-according to a variety of criteria, including but not limited to:
a) according to a random selection process, whereby blocks that would otherwise be discarded or ignored are randomly selected for processing regardless of the reputation score of the block-building node;
b) according to a fitness ranking function that blends or combines a separately-calculated block or blockchain segment fitness value with a reputation value, which may produce a composite ranking that discounts a more-optimal fitness value in light of a lower reputation value, but which may allow a more-optimal-fitness block produced by a lower-reputation block-building node to be selected for inclusion, to be built upon instead of a lower-fitness block produced by a higher-reputation block-building node;
c) according to a consideration of tokens or other units of value placed at risk by the lower-reputation block-building node, which “tokens-at-risk” may be claimed by one or more block-building-nodes that build subsequent blocks directly or indirectly referencing the block produced by the lower-reputation block-building node, and/or which “tokens-at-risk” may be claimed by an account signing a valid fraud proof record which fraud proof repudiates the block; or
d) a combination thereof.

In one or more of these embodiments, a process of selecting a block to build upon-which selection process considers reputation-operates independently of protocol considerations, and only utilizes local data of the reputation-tracking node. In a variety of embodiments, one or more such process may be implemented in parallel with one or more separate block-selection and block-building processes that select and build upon blocks built by higher-reputation block-building nodes.

### Reputation and Block Building

In one or more embodiments of the present invention, a reputation-tracking node may download and validate the records and/or transactions of a block after deciding as to whether the block should be built upon. In one or more embodiments, a reputation-tracking node may decide to build one or more new blocks upon a certain block as a result of making an evaluation of the reputation of the block-building node that built that block, and/or as a result of an making an evaluation of the reputation of the peer that shared the block or block-header data with the reputation-tracking node. According to various embodiments, a block-building node or a validator node may determine the validity of a block or a block ring after downloading and validating all the records and/or transactions of that block or that block ring. However, a block-building node may select a block or a block ring to be built upon before validity is determined; or, in some embodiments, a block-building node may build select a block or a block ring to be built upon without definitively determining validity.

In various embodiments, a block-building node may use one or more heuristic algorithms to decide whether a block should be built upon before all transactions may be downloaded; one such algorithm may, when selecting, give extra weight to a block that includes a tokens-at-risk payment guarantee.

In one or more embodiments, a node that forms or proposes a block ring may be referred to as a “ring formation node”, or alternately as a “ring-building node”. In certain embodiments, a ring formation node may be required to explicitly confirm and/or repudiate a block ring that it forms or proposes, within a certain number of blocks of the block height of the block ring's consensus round. In such embodiments, a block ring may be confirmed after all block headers, records, transactions and/or receipts of that block ring (meaning, of the of the blocks constituting that block ring) are download and are structurally validated by the node forming or proposing the block ring; and a block ring may be repudiated the ring formation node fails to download or is unable to download one or more block headers, records, transactions or receipts constituting of the block ring, or if any downloaded data fails structural validation.

Structural validation, as used herein with regards to various embodiments of the present invention, refers to the process of evaluating a record or transaction to determine if it is encoded in a manner consistent with the requirements of a blockchain protocol, without regards to the compatibility or validity of said record or transaction in relation to the global state or any data thereof. A block may be said to have been structurally validated if its records, transactions, and/or receipts have been downloaded, and if structural validation has been performed on those records, transactions and/or receipts. A block, record and/or a transaction may be said to be structurally valid if structural validation may be successfully performed thereon. A block, record and/or a transaction may be considered structurally invalid if any

### Repudiation Handshaking

According to various embodiments, a node may repudiate a block or a block ring under the circumstance that the node is unable to download one or more block headers, records, transactions, and/or receipts or other data elements that may constitute a block or a block ring. A repudiation of this type may be referred to as an insufficiency repudiation.

In one or more embodiments, an insufficiency repudiation may affect reputation without effectuating any on-chain transformation of a global state of the blockchain system. A fraud proof may act as a form of repudiation in certain embodiments; however, an insufficiency repudiation cannot be formed into a fraud proof, because it is not possible for a node to prove definitively that it has not received data. Rather, an insufficiency repudiation in certain embodiments may act as an indication to the network that a node is unable to confirm the existence of block headers, records, transactions and/or receipts or other data elements purported to constitute a block and/or a block ring, providing a non-definitive indicator to the network that a block and/or a block ring may be difficult or impossible to validate. According to various embodiments, an insufficiency repudiation message references the specific block that is unsubstantiated (meaning, the block that may be missing one or more block headers, records, transactions and/or receipts or other data elements).

A node that sends an insufficiency repudiation message pertaining to a block may be missing one or more records, transactions, and/or receipts or other data elements of that block for a variety of reasons, including, but not limited to:
a) the block may be purely fraudulent; for instance, there may exist no set of transactions that would validly constitute the block as it is encoded;
b) the block-building node that generated the block may be off-line and unable to transmit or share all of the data elements that constitute the block; or
c) the block may be valid, but the block-building node is trying to induce one or more block-building nodes of the network to repudiate the block in order to decrease network efficiency, or possibly even induce a fork in the network.

As implemented in certain embodiments, an insufficiency repudiation message may itself constitute part of an attack by a malicious actor; such an attacker may repudiate a valid block in order to induce one or more block-building nodes to download records, transactions and/or receipts or other data elements they may not otherwise download, and then to perform structural validation of those various data elements, which may clog the network. In one or more embodiments, various methods of reducing the occurrence of this risk may be employed.

According to one or more embodiments of the present invention, an insufficiency repudiation handshaking procedure may include one or more of the following elements, without limitation:
a) If a reputation-tracking node is unable to download all the transactions of a block, it may send, share, broadcast or propagate to the blockchain network a tentative insufficiency repudiation message pertaining to the block in question. Such a message may be sent to peers, and in certain embodiments may be forwarded onward to the peers of the peers;
b) A block-building node that has performed structural validation on the block may broadcast a response message to the network, or respond directly to the reputation-tracking node, informing the reputation-tracking node that the transactions are available for download, which information in certain embodiments may be encoded in an “availability message”. Upon receipt of one or more availability messages pertaining to missing data, the reputation-tracking node may begin downloading the missing data;
c) If the reputation-tracking node is unable to download and structurally validate any of the missing block headers, records, transactions, and/or receipts or other data element of the block before a specific amount of time has passed, then it broadcasts a final insufficiency repudiation message for the block. Otherwise, the reputation-tracking node broadcasts a retraction message; or
d) Upon receipt of an insufficiency repudiation message (tentative or final), other block-building nodes that have built upon the block in question may attempt to download and structurally validate the block's data, if they have not already done so; however, in certain embodiments, this act of downloading and validating the block's data may be contingent on the reputation value the other block-building nodes may have assigned to the block-building node that has issued the repudiation message.

In one or more embodiments, the reputational effects of an insufficiency repudiation handshaking procedure (such as the above) may be evaluated individually by one or more block-building nodes. In at least one embodiment, a first block-building node that receives a tentative repudiation message for a block that it has already structurally validated-meaning that the node has already downloaded all data constituting that block and can prove that the retraction is unfounded—may send an availability message. In certain embodiments, if the first block-building node does not receive a retraction message within a specific duration of time after said availability has been sent, then the first block-building node may penalize or reduce the reputation value of a second block-building node that sent the tentative repudiation message.

In various embodiments of the present invention, a block-building node that has cryptographically signed a block will be available to transmit or propagate to one or more of the other nodes of the network all the records, transactions, receipts, and/or other data that constitutes that block. In at least one embodiment, said node may respond to a tentative repudiation message by sharing, transmitting, re-transmitting or propagating one or more transactions that may be missing from the block-building node that sent to tentative repudiation message. One or more reputation-tracking nodes may penalize or lower the reputation of a block-building node that does not respond in this way to a tentative repudiation message pertaining to a block that the block-building node has signed. In at least one embodiment, a block that is successfully repudiated should result in a penalization or a reduction of a reputation value of the block-building node that built that block.

In at least one embodiment, if a block-building node having a reputation value below a certain threshold repudiates a block that is not directly in a block-building node's own shard chain-which, for example, may be a block that is in a preceding ring, but operating on different shards-then a reputation-tracking node may elect not to download the block's constituent data. Said threshold may be a function of the reputation of the block-building node signing the repudiation message.

In one or more embodiments, a ring formation node may repudiate a block of its block ring, and if the block ring is already being built upon by a second node, then that second node may download the block's transactions to verify them structurally. This may be done in certain embodiments to verify the correctness of the repudiation, so as to detect, for for example, if the ring formation node is somehow being blocked from downloading one or more block headers, records, transactions, receipt, or other data. The probability that a block-building node receiving a repudiation message will act on message is determined by the reputation of the originator of the message.

In one or more embodiments, if a block is successfully repudiated, then the reputation of the original block-building node may be penalized by various reputation-tracking nodes, regardless as to which block-building node originated the repudiation message. In certain embodiments, when a parent or ancestor block is successfully repudiated by a block-building node, and said block had previously been endorsed by another block-building node as having been validated successfully, then one or more reputation-tracking nodes will penalize and lower the reputation value of the peer or other node that endorsed the block.

In at least one embodiment, when a block is proven fraudulent through a fraud proof, a reputation-tracking node will penalize or reduce the reputation value of the block-building node originating the fraudulent block. In certain embodiments, one or more “downstream” block-building nodes-block-building nodes that had built blocks on a now-impeached or -repudiated block—may also be penalized. In one such embodiment, the greater the distance from the offending block, the less the reduction of the reputation value; in an alternate embodiment, the opposite: the greater the distance from the offending block, the greater the reduction of the reputation value.

Various embodiments may implement a reputation tracking mechanism with different configurations regarding a variety of factors that may impact the effectiveness of the mechanism. Different embodiments may implement a reputation tracking mechanism with different configurations for one or more of the following elements, without limitation:
a) A configured probability that a low-reputation block will be selected for validation or to be built upon by a block-building node or a validator node, determined according to the operation of a random number generator or a pseudo random number generator;
b) A configured probability that a low-reputation block's insufficiency repudiation messages will be trusted by a reputation-tracking node, determined according to the operation of a random number generator or a pseudo random number generator;
c) A function that determines the specific reputation value or change in reputation value that a reputation-tracking node assigns to a block-building node after each evaluation of blocks created by that block-building node;
d) A reputation penalty (decrease in reputation value) levied against a block-building node for successful insufficiency repudiation of a block it has produced;
e) A reputation penalty (decrease in reputation value) levied against a block-building node is a block cryptographically signed by that node is successfully proven fraudulent through a fraud proof;
f) A reputation penalty (decrease in reputation value) levied against a downstream block-building node that directly or indirectly builds on a block that has been successfully proven fraudulent; or
g) A reputation penalty (decrease in reputation value) levied against a block-building node that marks a block as validated, which block later proves to be fraudulent, or is successfully repudiated.

At least one embodiment of the present invention may implement a block-building procedure comprising one or more of the following steps, without limitation:
a) After one or more ring formation nodes formulate block rings, block ring headers (each block ring header being a block header of the ring formation block) are shared with the whole network;
b) Block-building nodes build new blocks on the most-optimal-fitness block rings comprising blocks built by the highest-reputation block-building nodes;
c) Simultaneously, block-building nodes verify and validate the one or more preceding blocks and/or block rings upon which new blocks are bult-meaning, the one or more blocks and/or block rings to which said new blocks have a back reference;
d) Individual block-building nodes validate blocks of the prior consensus round that operate on the same one or more shards as the block-building nodes;
e) Any block-building node that discovers a fraudulent or contradictory condition within the block, or that fails to download all the block data, repudiates the block
f) A repudiation message is broadcast across the network (in some embodiments, utilizing a gossip protocol) to be shared with all miners; or
g) Once the various block-building nodes finish building blocks, at least one ring formation node assembles a block ring, and announces it again.

### Guarantee Avoidance

Various embodiments of the present invention herein described implement a “tokens-at-risk” mechanism, by which a block-building node may place at risk tokens of one or more addresses or accounts it controls, to be included as part of a block that it builds (an “incentivized block), in order to incentivize other block building nodes to build one or more subsequent blocks with reference back to the incentivized block. Several embodiments may implement a means by which the tokens at risk may be claimed and transferred to an account that signs a fraud proof record proving that the incentivized block is invalid.

In one or more embodiments, a blockchain system implementing “tokens-at-risk” incentives for block acceptance may be susceptible to a guarantee-avoidance attempt. In such embodiments, guarantee-avoidance is an attempt by a malicious actor operating a block-building node to avoid losing tokens placed at risk, even if a fraudulent block is produced and said tokens should be lost. One means by which a malicious actor may avoid losing tokens placed at risk, in certain embodiments, is by themselves generating, and cryptographically signing with the keys of an account they control, the fraud proof record which invalidates the block, thereby surreptitiously re-capturing the tokens placed at risk.

Another means by which a malicious actor may avoid losing tokens placed at risk, in certain embodiments, is by diverting tokens-at-risk from an account before a fraudulent block is discovered. In such event, the malicious actor may participate in building two separate forks: a first fork built by a block-building node controlled by the malicious actor, which fork includes a “tokens-at-risk” token allocation, and which fork contain a block-construction fraud; and a second fork built by another block-building node, which node may or may not be controlled by the malicious actor, and which second fork includes one or more transactions that may attempt to empty the account or address used to sign the first fork and fund the “tokens-at-risk”.

Guarantee-avoidance presents a certain risk to embodiments that implement “tokens-at-risk” incentives for block acceptance; specifically, it creates an opportunity for malicious actors to generate fraudulent blocks (for instance blocks that comprise a block-construction fraud) without needing to incur the monetary penalty that the “tokens-at-risk” mechanism is intended to impose. If malicious actors are able to avoid forfeiting the “tokens-at-risk” that they ostensibly include in fraudulent block, the “tokens-at-risk” mechanism may cease to function as an incentive against malicious action, and/or may cease to act a signaling mechanism among the block-building nodes.

A number of features implemented by various embodiments of the present invention may reduce the risk of guarantee-avoidance fraud spam, however. In a number of embodiments, a requirement to include a verifiable delay function (VDF) output of a certain complexity level in each block header imposes a computational cost on the building of every block. In such embodiments, a malicious actor may not propagate a fraudulent block to the network without first executing the VDF; if a malicious actor's block-building node does not execute the VDF in such embodiments, then any fraudulent block it creates may simply be discarded or ignored by peer nodes, and will fail to propagate widely. In one or more embodiments, the requirement to execute a VDF means that the maximum number of fraudulent blocks a malicious actor may produce may not exceed the number of computer processors or computer processor cores that the malicious actor controls and is able to operate concurrently.

Furthermore, in an embodiment that implements fitness gradient consensus in combination with VDF, the fitness value of a block—fraudulent or otherwise—may not be known or even knowable until after the VDF has completed executing. In certain embodiments that implement the hash-distance variant of fitness-gradient consensus, the fitness value may be unaffected by any fraud attempt within the block construction; in at least one such embodiment, a fitness value may be derived entirely from the data encoded in the block header, and therefore may not be susceptible to fraud at all. Therefore, as a result, each fraudulent block produced may also need to be among the most-optimal-fitness blocks produced during a consensus round, or it may not even be evaluated.

For these reasons, in various embodiments of the present invention, a malicious actor may need to marshal significant computational resources in order to produce enough guarantee-avoidance fraud attempts—or potentially any other fraud attempts, generally—to have a meaningful impact on the blockchain system's performance. If, however, these mechanisms are insufficient to deter or limit malicious actors, additional “tokens-at-risk” mechanisms may also be employed which may provide solutions the guarantee-avoidance problem described above.

According to at least one embodiment, only a portion of the tokens placed at risk for a block may be transferred to an account that signs a fraud proof record impeaching or repudiating that block; a portion of the tokens-at-risk of a fraudulent block may, for instance, be allocated to the block-building node that built the block containing the fraud proof record—or may more generally be included in a block reward pool or transaction fee pool of the block comprising the record, to be allocated to various recipients; or may potentially be destroyed or deleted, not to be allocated to any account. In one or more embodiments of the present invention, a block reward pool may be distributed to a combination of block-building node accounts, accounts that have recently staked or locked tokens through the inclusion in the blockchain of consensus staking records, and/or other accounts.

Another mitigation strategy may also be implemented by various embodiments of the present invention. In certain embodiments, tokens placed at risk through a “tokens-at-risk” mechanism may first need to be staked or locked through the operation of a consensus staking record—or a lock record-signed by an account of the same block-building node that is placing said tokens at risk in an incentivized block. Staked or locked tokens may be eligible to be placed at risk if the beginning of the staking or locking period is a certain minimum number of blocks preceding the incentivized block, and/or if the completion of the staking or locking period is a certain minimum number of blocks following the incentivized block. In certain embodiments, staked or locked tokens are not available to be moved, spent, transferred or otherwise used for the duration of the staking or locking period, except to be placed at risk as part of the “tokens-at-risk” mechanism. In one or more embodiments, in the event that the “tokens-at-risk” are transferred to an account cryptographically signing a fraud proof that impeaches or repudiates the incentivized block comprising the tokens-at-risk, the tokens will remain staked or locked until the end of the staking or locking period; in one or more alternate embodiments, the staking or locking period would immediately end, and the tokens would be available for use.

### Token Locking

Various embodiments may implement one or more “lock” records, which records may lock a certain number of tokens for a locking period lasting a certain number of blocks, which number of tokens and number of blocks may be encoded as fields of the lock record. An account signing a lock record may lock said account's tokens for a certain number of blocks, during which time the tokens may not be sold, staked, or spent.

In certain embodiments, locked tokens may receive a portion of the block rewards, which may be paid out when the tokens are unlocked—or, alternately, when a user attempts to access or use the tokens following termination of the lock period.

In one or more embodiments, a limited number of “slots” may be available for lock records, each slot providing authorization for one account to lock tokens for a single unit of time, such that no more accounts than a number of slots defined may lock tokens at any one time. An algorithmic pricing model may be implemented to decide the price to be paid for slots; according to one embodiment, the pricing model may be implemented as an automated market maker that exchanges slots for gas; as more slots are filled, the gas price to be paid approaches infinity. In at least one embodiment, lock records may optionally be configured to opt out of earning rewards, in which case the lock transaction may have a fixed gas price rather than a price determined by an algorithm.

In one or more embodiments of the present invention, tokens-at-risk may be specified in reference to locked tokens. By specifying tokens-at-risk in terms of locked tokens, certain embodiments may prevent a cheating block-building node from avoiding a fraud penalty in the event the cheating block-building node generates a fraudulent record or transaction, or possibly generates a fraudulent receipt. Without this locking requirement, the system may be susceptible to a “nothing at risk” attack. In such embodiments, only tokens that have been locked for a certain number of blocks “N”, and which are not unlocked before “X” blocks have passed after a block is created, may be specified as tokens—at risk for that block. If the tokens-at-risk are not fully locked within the (“N”, “X”) window, then the block may not be not valid. Fraud proof records transfer the ownership of the locked tokens if the referenced block is invalid. These tokens may remain locked for the pre-specified period, and the reward may be paid to the sender of the proof.

The token locking mechanism described here is similar to the token staking mechanism described elsewhere herein. In one or more embodiments of the present invention, token locking and token staking as described herein may be combined into a single mechanism serving the purposes of both mechanisms described. In other alternate embodiments, separate token locking and token staking mechanisms may be implemented.

### Zero-Knowledge Consensus Enhancements

Various embodiments of the present invention may implement a zero-knowledge block-building methodology which reduces need for fraud mitigation techniques as described herein.

In certain embodiments, a block may comprise a zero-knowledge record, which zero-knowledge record may comprise:
a) one or more addresses and/or account addresses which reference and localize one or more data structures within the global state, which one or more data structures may be transformed by the execution of the zero-knowledge record, or which may be evaluated by or implicated by a zero-knowledge algorithmic encoding used to generate a non-interactive zero-knowledge proof of said transformation;
b) one or more pre-execution hash digests of said one or more data structures;
c) a set of data elements to be directly inserted into, or to replace elements of, said one or more data structures, so as to effectuate the state transformation embodied by said zero-knowledge record; and
d) a non-interactive zero-knowledge proof proving the validity of said state transformation.

In one or more embodiments, said set of data elements may be encoded as one or more account Merkle proofs, each account Merkle proof corresponding to one or more post-execution data structures which result from the state transformation embodied by the zero-knowledge record. Said account Merkle proofs may incorporate the data elements of the set of data elements as revealed data (i.e. non-hashed data), and may position said data elements in the relative positions they may occupy within said one or more post-execution data structures,

In one or more embodiments, said non-interactive zero-knowledge proof may be generated using a zero-knowledge algorithmic encoding which includes among its public inputs and/or outputs: the one—or more pre-execution hash digests, the set of data elements, and, optionally, one or more other data elements that may be encoded in the zero-knowledge record. In one or more embodiments, said zero-knowledge algorithmic encoding may include among its private inputs one or more data structures, which one or more data structures are elements of the global state localized at said addresses and/or account addresses prior to execution of the zero-knowledge record, and which may be cryptographically hashed to produce one or more hash digests that are equal to the pre-execution hash digests specified by the zero-knowledge record.

In certain embodiments, said zero-knowledge algorithmic encoding may also include among its private inputs other elements specific to the particular state transition type that the particular zero-knowledge algorithmic encoding corresponds to.

In one or more embodiments which implement a multi-shard global state, wherein each shard comprises a distinct global state data structure, said one or more data structures may belong to different shards, and the specified replacements and insertions may be applied to data in different shards.

In various embodiments, a validator node or a block-building node that processes such a zero-knowledge record may only insert and replace data pertaining to one or more shards that the validator node or block-building node operates on. In such embodiments, provided that the validator node or block-building node verifies that each of the applicable pre-execution hash digests is equal to the hash-digest of the corresponding data structure within the applicable shard at the time of evaluation, the specified replacements and insertions that apply to the node's one or more shards may be applied to the one or more shards directly without additional computation.

In various embodiments, when a zero-knowledge record is executed and applied, an associated receipt is generated which receipt includes one or more pre-execution hash digests of the global state prior to the execution and application of the zero-knowledge record's state transformation, and one or more post-execution hash digests of the global state following execution and application of the zero-knowledge record's state transformation. In an embodiment implementing a multi-shard global state, a separate pre-execution hash digest and post-execution hash digest would be included in the receipt for each shard.

In one or more embodiments, if a block contains only zero-knowledge records, and no other types of record or transaction, a validation of the block may be reduced to only a structural validation of the zero-knowledge records, which structural validation includes a verification of the non-interactive zero-knowledge proof of each record, and a verification that the one or more pre-execution hash digests of each record is equal to one or more hash digests of the one or more data structures as they exist within the global state at the time that each zero-knowledge record is executed and each state transformation is applied.

In one or more such embodiments, in order to allow this verification of hash digests to be reduced to a structural validation that does not require reference to the global state—or to one or more shards of the global state-one or more Merkle proofs (block Merkle proofs) may be included with the block header, each Merkle proof comprising all of the individual hash digests of the global state, and each Merkle proof corresponding to a shard data structure read, modified by, or operated on by the block. A structural validation of said zero-knowledge only blocks may proceed by first verifying the validity and internal consistency of the one or more block Merkle proofs; second confirming that the root hash(es) of the one or more block Merkle proofs are equal to one or more pre-execution global state hash digests included in the block header; third confirming that the hash digest or root hash of the set of zero-knowledge records is equal to a record hash digest of the block header, and that the hash digest or root hash of the set of associated receipts is equal to a receipt hash digest of the block header; and then iterating over each zero-knowledge record of the block and each associated receipt:
first, confirming that the one or more pre-execution hash digests specified within the zero-knowledge record match the hash digests that can be found within the one or more block Merkle proofs at the locations of the one or more addresses or account addresses specified in the zero-knowledge record;
second, verifying that the hash roots of the one or more block Merkle proofs match the corresponding pre-execution hash digest(s) of the associated receipt;
third, verifying the non-interactive zero-knowledge proof of the zero-knowledge record and confirming that the zero-knowledge record is structurally valid,
fourth, updating the block Merkle proof data, replacing the hash digests that can be found within the one or more block Merkle proofs at locations corresponding to the one or more addresses or account addresses, each hash digest to be replaced by a hash root of each account Merkle proof of the zero-knowledge record, each account Merkle proof corresponding to an address or account address of the one or more addresses or account addresses;
fifth, recalculating the various derived hashes of the one or more block Merkle proofs in light of the preceding changes, and confirming that the new hash roots of the one or more block Merkle proofs match the corresponding post-execution hash digest(s) of the associated receipt.
sixth, proceeding to the next zero-knowledge record, without resetting the data of the one or more block Merkle proof(s), such that each zero-knowledge record is evaluated with reference to the version of the block Merkle proof produced during the prior iteration; except that upon reaching the last transaction of the block, the hash root(s) of the one or more block Merkle proof may be compared to one or more post-execution global state hash digests included in the block header, to confirm that they are equal.

In one or more embodiments that implement a multi-shard global state, a separate block Merkle proof will be implemented for each shard read, referenced, modified by or operated on by a block. In such embodiments, the above-described procedure may be implemented such that each pre-execution hash digest and post-execution hash digest of each receipt is calculated with respect to a particular shard, and a separate pre-execution global state hash and a separate post-execution global state hash is included in the block header for every shard read, referenced, modified by or operated on by the block in question.

In certain embodiments, a block-building node may generate a block zero-knowledge proof, which block zero-knowledge proof is a non-interactive zero knowledge proof generated with the use of a zero-knowledge algorithmic encoding that implements the structural validation procedure described above with regards to blocks that contain only zero-knowledge records. In one or more embodiments, the public inputs of said zero-knowledge algorithmic encoding may comprise, without limitation, the one or more pre-execution global state hash digests of the block header, the one or more post-execution global state hash digests of the block header, a receipt hash digest of the block header, and a zero-knowledge record hash digest of the block header. In certain embodiments, the private inputs of said zero-knowledge algorithmic encoding may comprise, without limitation, the one or more block Merkle proofs, the list of zero-knowledge records of the block, and the list of associated receipts.

In at least one embodiment, a block-building node may generate a zero-knowledge block header, which zero-knowledge block header may include, without limitation, one or more back references to one or more preceding blocks, which back references may be implemented as hash digests of the block header or some other aspect of the preceding block (“block hashes”); the one or more pre-execution global state hash digests of the block header; the one or more post-execution global state hash digests of the block header; a receipt hash digest of the block header; a zero-knowledge record hash digest of the block header; and said block zero-knowledge proof, proving, for instance, that the zero-knowledge records and associated receipts are valid and conform to the various hash digests that constitute the block header. In one or more embodiments, a zero-knowledge block header may form the block header of a block that only contains zero-knowledge records, and no other records or transactions.

In various embodiments, a zero-knowledge block header may be evaluated and confirmed to be valid by any computer device-including any verifier node or block-builder node—that knows the block hashes of one or more preceding blocks, that knows one or more post-execution global state hashes of one or more preceding blocks, and that implements a zero-knowledge proof verifier that is compatible with the zero-knowledge prover implemented by the block-building node that created the block header. In one or more embodiments, a zero-knowledge proof verifier may be compatible with a zero-knowledge proover if, for example, they both implement the same zero-knowledge protocol, and have reference to the same zero-knowledge algorithmic circuits. Such a computer device may verify the validity of a zero-knowledge block header by verifying the non-interactive zero-knowledge proof, and by confirming that the back references and pre-execution global state hash digests of the zero-knowledge block header are consistent with one or more preceding block headers.

Because access to the global state, including any shards of the global state, is unnecessary to verify the validity of a zero-knowledge block header, a blockchain sharding system that exclusively uses zero-knowledge records in lieu of any other type of record or transaction—and that exclusively generates zero-knowledge block headers in lieu of any other type of block header-will never generate a block that requires access to the global state to be validated. In one or more embodiments, any fraudulent block scenarios may be eliminated, and a number of mechanisms intended to mitigate the impact of fraud become redundant, unnecessary or counterproductive.

Nevertheless, in various embodiments, block-building nodes which build zero-knowledge blocks nonetheless should download zero-knowledge records in order to perform specific updates to the global state, and to build new blocks and generate receipts. Although validation of zero-knowledge block headers may be possible without access to global state and without access to zero-knowledge records, the generation of a new block header requires access to zero-knowledge records that are included in the block, and access to all global state data structures that might be read, referenced, modified or operated on by said zero-knowledge records. As a result, in various embodiments, a zero-knowledge block-building methodology may still be susceptible to instances of missing transaction fraud and data withholding attacks, and may therefore benefit from the implementation of a reputation-tracking mechanism as described herein.

FIG. 19B is a simplified block diagram showing exemplary blockchain layers according to an embodiment. Blockchain layers 1908 may include infrastructure (tier 1) layer 1910, data (tier 2) layer 1920, network (tier 3) layer 1930, consensus (tier 4) layer 1940, and application (tier 5) layer 1950. The infrastructure layer 1910 may be a hardware/software/firmware layer and may include one or more virtual machines (VMs) 1911 and/or one or more oracles 1912. A virtual machine (VM) 1911 may provide a runtime environment for transaction execution in the blockchain. In an embodiment, a VM 1911 may be, for example, stack-based and may enable untrusted code to be executed by a global peer-to-peer (P2P) network of computers. An oracle 1912 may provide a third-party service that connects smart contracts executing on the blockchain with off-chain data sources. For example, an oracle 1912 may query, verify, and/or authenticate one or more external data sources for the system 100 (FIG. 1) and/or system 200 (FIG. 2). According to an embodiment, external data sources may include, e.g., one or more legacy systems 314 and/or one or more external compliance systems and/or databases 1913. In an example embodiment, the blockchain system may be configured to execute embodiments disclosed herein, such as interfacing with payment channels and payment channel networks, a point of sale system 1301 (ISO 8583 Service, HTTP Web Service, Lightning/Payment Channel Connection), Microservice API external web services 1309, or off-chain databases or external data management systems, including such systems as relational databases, relational database management systems (RDBMS), document-oriented databases, graph databases, key-value stores, time-series databases, and other data management systems.

In an example embodiment, a blockchain system implementing a zero-knowledge capabilities as provided for herein may be operate within said blockchain layers (1908). A wallet comprising a wallet node (1952) may implement a zero-knowledge proof prover in software, and may execute said zero-knowledge proof prover so as to generate a zero-knowledge proof and incorporate said zero-knowledge proof in a zero-knowledge record. Said wallet node may submit said zero-knowledge record through a network message to a block-building node (1941) which may then execute a zero-knowledge proof verifier implemented as software and incorporated into the blockchain software implementation of said block-building node, which software may execute in a virtual machine (1911). In the event that said verification of said zero-knowledge proof is successful according to the execution of the zero-knowledge proof verifier, then said block-building node may incorporate said zero-knowledge record into the blockchain (1921) stored in its data layer (1920), and update the system's global state.

### Description Terms and Language are Non-Limiting

Any references herein to specific technologies, systems, or protocols are intended to provide context and are not to be construed as limiting. The invention is applicable to any environment or system that can achieve substantially the same results, whether or not such technologies or systems are specifically referenced in this document. Additionally, where specific embodiments are described in detail, the inventions are intended to extend to any other embodiments that fall within the same principles and claims.

The descriptions, terms, and embodiments provided in this specification are illustrative and are not intended to limit the scope of the invention. Any mention of specific examples, configurations, or implementations is provided solely for the purpose of enabling understanding of the invention and its potential applications. The scope of the invention is intended to encompass all equivalents, modifications, and adaptations that fall within the scope of the claims.

The terminology used in this specification is chosen to best describe the concepts and mechanisms of the invention and should not be interpreted as restrictive. Words and phrases such as “includes,” “comprises,” “such as,” “for example,” and “may” are intended to indicate non-limiting inclusion and should be construed to encompass additional elements, processes, or features that are not explicitly listed or described herein. Furthermore, any description of a specific component or functionality may encompass variations, alternatives, and equivalents that perform substantially the same function in substantially the same way.

Where methods or processes are described in a particular sequence of processes, it should be understood that such sequences are illustrative and not restrictive. Unless explicitly stated otherwise, the processes may be performed in any logical order, simultaneously, or with intervening processes that do not materially affect the purpose or outcome of the method or process. The invention is intended to encompass all variations and rearrangements of processes that achieve substantially the same results.

It should be noted that any figures referenced herein are provided merely by way of example, and should not be construed as limiting the present disclosure to the specific embodiment(s) illustrated therein. In particular, the depicted structures, components, and configurations may be adapted, modified, or substituted in numerous ways without departing from the scope and spirit of the invention as defined by the claims. The figures and their accompanying descriptions are intended to assist those skilled in the art in understanding certain illustrative implementations, but the inventive concepts, functionalities, and principles described herein may be embodied in other forms, arrangements, and variations that achieve similar results.

The use of specific examples, values, or ranges is intended solely to illustrate possible implementations of the invention and should not be interpreted as limiting the scope of the invention to these examples or ranges. In particular, the numerical ranges disclosed herein should be interpreted to include all sub-ranges and intermediate values therein unless specifically excluded. The invention encompasses variations and equivalents that fall within the broader conceptual framework described herein.

While example embodiments have been particularly shown and described, it will be understood by those skilled in the art that various changes in form and details may be made therein without departing from the scope of the embodiments encompassed by the appended claims.

Example embodiments are disclosed in U.S. Provisional Application No. 63/608,018, filed on Dec. 8, 2023, including Appendices 1-7, which are incorporated herein by reference in their entirety.

1. A computer-implemented blockchain system comprising:
a global state and an assemblage of blocks, each block representing a collection of state transformation records, each state transformation record describing a state transformation performed on the global state, each block referencing one or more preceding blocks;
wherein preceding blocks referenced by any given block contain state transformation records describing state transformations performed on the global state prior to the evaluation of the given block; and
wherein at least one state transformation record is a zero-knowledge transformation record encoding a zero-knowledge state transformation description, which zero-knowledge transformation record comprises:
one or more addresses or paths identifying or referencing the one or more locations of the elements of a discrete data subset within the global state, wherein discrete data subset comprises either a contiguous subset or a non-contiguous subset of the data comprised by the global state;
a revised discrete data subset, representing a new revised version of at least a portion of or subset of the discrete data subset; and
a transition proof implemented as a non-interactive zero-knowledge proof, wherein the transition proof proves that the transition from the discrete data subset to the revised data subset follows the established rules of the blockchain system.

2. The system of claim 1, wherein the zero-knowledge transformation record comprises at least one of:
the discrete data subset; and
one or more cryptographic hashes of one or more elements of the discrete data subset.

3. The system of claim 1, wherein the transition proof corresponds to one of a set of pre-defined transition types for which corresponding non-interactive zero-knowledge proofs may be generated.

4. The system of claim 3, wherein each pre-defined transition type corresponds to an encoded state-transition implementation encoded as an algorithmic encoding;
wherein the algorithmic encoding comprises one or more of an algebraic circuit, a virtual algebraic circuit, an algebraic intermediary representation, or other algebraic encoding or algorithmic encoding.

5. The system of claim 4, where the encoded state-transition implementation receives input data, and generates output data, wherein a portion of the input data is private input data, and the remainder of the input data is public input data.

6. The system of claim 5, wherein the public input data comprises the discrete data subset.

7. The system of claim 5, wherein the output of the encoded state-transition implementation comprises the revised data subset.

8. The system of claim 4, wherein the transition proof is generated by a process, said process comprising:
a compilation process where the algorithmic encoding is compiled into a set of polynomial equations; and
an evaluation of the polynomical equations at one or more random points, producing values that are included in the transition proof.

9. The system of claim 8, wherein the transition proof is implemented as a zero-knowledge succinct non-interactive argument of knowledge (zk-SNARK).

10. The system of claim 8, wherein the transition proof is implemented as a zero-knowledge succinct transparent argument of knowledge (zk-STARK).

11. The system of claim 1, further comprising an issuer of a currency denominated token configured to hold a reserve for every corresponding unit of currency denominated tokens issued by the issuer.

12. The system of claim 1, further comprising a token issued by a token issuer to a plurality of users, the token issuer configured to: (i) approve use of the token to at least a subset of the plurality of users, and (ii) disapprove use of the token to at least a second subset of the plurality of users.

13. The system of claim 12, further comprising a decision indicator configured to mark at least a user of the plurality of users as approved, wherein only approved users may have access to a payment channel on the blockchain, wherein the decision indicator is a user account.

14. (canceled)

15. The system of claim 13, further comprising the decision indicator being associated with an edge node on the blockchain, the decision indicator further configured to indicate that an account belongs to an edge node or an interconnection node.

16. The system of claim 12, where the token is configured with a permissioning constraint configured to permit a first interconnection account to open a payment channel with a second interconnection account, wherein the payment channel is opened by at least the first account and the second account, and wherein at least one permission constraint prohibits the payment channel transactions or records that are signed by the first account but do not reference the second account.

17. The system of claim 1, further comprising using a first cryptographic key for sending payments across a payment channel network, and a second cryptographic key for receiving payments across the payment channel network.

18. The system of claim 17, wherein the first cryptographic key:
comprises a restriction disallowing funds to be removed from a wallet of a user; and
signs data elements sent during the receipt of payment.

19. The system of claim 17, further configured to:
generate, by a user, an alternative pair of cryptographic keys;
provide the alternative pair of cryptographic keys to a persistent server;
associate an account with at least one permissioning constraint configured to restrict the use of the alternative pair of cryptographic keys such that the pair of cryptographic keys may only be used to sign payment channel records or transactions that update payment channels in such a manner that the user's payment channel balance increases compared to the previous channel state.

20. The system of claim 17, further comprising one or more permissioning constraints configured to determine whether one or more cryptographic keys are permitted to authorize a payment channel record or transaction.

21. The system of claim 17, wherein any payment negotiated using a cryptographic key is in the direction of the user.

22. The system of claim 1, wherein the blockchain is further configured to open, close, and update payment channels on-chain through zero-knowledge payment channel records or transactions.

23. The system of claim 22, wherein an account on the blockchain is configured with one or more private ledgers represented in a blockchain global state by one or more cryptographic hash digests.

24. The system of claim 22, further comprising an open payment channel configured on the blockchain with a channel private ledger, wherein the channel private ledger is configured to encode a token balance of at least two participants within the payment channel.

25. The system of claim 22, further comprising implementing a zero-knowledge algorithmic encoding corresponding to a pre-defined type of global state information.

26. The system of claim 1, further comprising:
an expression of a permission constraint encoding corresponding to a zero-knowledge expression encoding, wherein zero-knowledge expression encoding comprises a zero-knowledge algorithmic encoding;
each zero-knowledge expression encoding configured to perform an operation that is encoded by its corresponding expression.

27. The system of claim 1, further comprising at least one anchor block configured to limit the reorganization of blocks beyond a threshold block depth.

28. The system of claim 27, wherein the anchor block further configured to be spaced at regular intervals.

29. The system of claim 1 further including validating and accepting zero-knowledge transformation records using:
a validating computer configured to store the blockchain's global state in a retrievable storage medium;
a wallet computer connected to the validating computer via a computer network, the wallet computer generating a new zero-knowledge transformation record; and
the validating computer receiving the zero-knowledge transformation record from the wallet computer, and subsequently performing validation of the zero-knowledge transformation record, said validation comprising:
the validating node retrieving a retrieved data subset from the global state, which subset of global state data corresponds to the discrete data subset referenced or included in the zero-knowledge transformation record;
the validating node verifying that the discrete data subset included in the zero-knowledge transformation record or referenced by the zero-knowledge transformation record is equivalent to the retrieved data subset;
the validating node verifying that the non-interactive zero-knowledge proof is valid when verified combination with the discrete data subset (or retrieved data subset) and revised data subset and possibly in combination additional Public Input Data included with the zero-knowledge record in certain cases; and
in the case that the non-interactive zero-knowledge proof is successfully verified and the zero-knowledge transformation record is deemed valid, the validating node replacing some portion of the discrete data subset with elements of the revised data subset, where the portion of the discrete data subset that is replaced by elements of the revised data subset is decided according to which pre-defined transition type the non-interactive zero-knowledge proof corresponds to.

30-66. (canceled)
